(19) United States
(12) Patent Application Publication
(10) Pub. No.: US 2012/0252803 A1
(43) Pub. Date: Oct. 4, 2012

(54) COMPOSITION AND METHOD FOR CONTROLLING ARTHROPOD PESTS

(75) Inventor: Junko Otsuki, Toyonaka (JP)

(73) Assignee: SUMITOMO CHEMICAL COMPANY, LIMITED, Chuo-ku, Tokyo (JP)

(21) Appl. No.: 13/502,815

(22) PCT Filed: Oct. 18, 2010
(86) PCT No.: PCT/JP2010/068777

§ 371 Date: Jun. 19, 2012

(30) Foreign Application Priority Data
Oct. 20, 2009 (JP) 2009-241743

(51) Int. Cl. A01N 43/40; A01N 43/90; A01P 7/00; A01N 43/84

(52) U.S. Cl. 514/233.8; 514/338; 514/333; 514/302

(57) ABSTRACT

The present invention provides: an arthropod pests control composition comprising, as active ingredients, a condensed heterocyclic compound and a pyrethroid compound; a method for controlling arthropod pests which comprises applying effective amounts of a condensed heterocyclic compound and a pyrethroid compound to the arthropod pests or a locus where the arthropod pests inhabit; and so on.

### TECHNICAL FIELD

The present invention relates to an arthropod pest control composition and an arthropod pest control method.

### BACKGROUND ART

Various compounds have been studied so far for the purpose of controlling harmful organisms, and such compounds have been practically used.

The specification of GB 895,431 A discloses that a benzoxazole compound is useful as a light-screening agent and/or a disinfectant. Chem. Pharm. Bull., 30(8), 2996 (1982) discloses a certain type of benzoxazole compound.

### DISCLOSURE OF THE INVENTION

It is an object of the present invention to provide an arthropod pest control composition and an arthropod pest control method, having an excellent controlling effect on arthropod pests.

The present invention provides an arthropod pest control composition and an arthropod pest control method, having an excellent controlling effect on arthropod pests by combined use of a condensed heterocyclic compound represented by formula (1) and a pyrethroid compound.

Specifically, the present invention includes the following [1] to [6]:

[1] An arthropod pests control composition comprising, as active ingredients, the following (A) and (B):

(A) a condensed heterocyclic compound represented by formula (1):

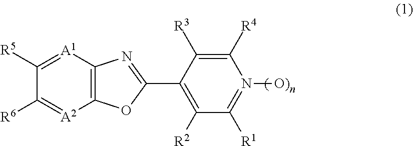

wherein

each of A¹ and A² independently represents a nitrogen atom or ═C(R⁷)—;

each of R¹ and R⁴ independently represents a halogen atom or a hydrogen atom;

each of R² and R³ independently represents a C1-C6 acyclic hydrocarbon group optionally substituted with one or more members selected from Group X; a C3-C6 alicyclic hydrocarbon group optionally substituted with one or more members selected from Group X; a phenyl group optionally substituted with one or more members selected from Group Y; a benzyl group optionally substituted with one or more members selected from Group Y; a 5- or 6-membered heterocyclic group optionally substituted with one or more members selected from Group Y; —OR⁸; —NR⁸R⁹; —NR⁸C(O)R⁹; —NR¹⁰C(O)NR⁹R¹⁴; —NR¹⁰CO₂R¹⁵; —S(O)ₘR⁸; —CO₂R¹⁰; —CONR⁸R⁹; —C(O)R¹⁰; —C(NOR⁸)R¹⁰; —CONR¹⁰NR¹¹R¹²; a cyano group; a nitro group; a halogen atom; or a hydrogen atom;

each of R⁵ and R⁶ independently represents a C1-C6 acyclic hydrocarbon group optionally substituted with one or more members selected from Group X; a C3-C6 alicyclic hydrocarbon group optionally substituted with one or more members selected from Group X; —OR¹³; —S(O)ₘR¹³; a halogen atom; or a hydrogen atom; except that both R⁵ and R⁶ represent hydrogen atoms; or R⁵ and R⁶, together with 6-membered ring constituent atoms to which they bind, may form a 5- or 6-membered ring optionally substituted with one or more members selected from Group Z;

R⁷ represents a C1-C3 alkyl group optionally substituted with one or more halogen atoms; a C1-C3 alkoxy group optionally substituted with one or more halogen atoms; a cyano group; a halogen atom; or a hydrogen atom;

each of R⁸ and R⁹ independently represents a C1-C6 acyclic hydrocarbon group optionally substituted with one or more members selected from Group X; a C4-C7 cycloalkylmethyl group optionally substituted with one or more members selected from Group X; a C3-C6 alicyclic hydrocarbon group optionally substituted with one or more members selected from Group X; a phenyl group optionally substituted with one or more members selected from Group Y; a benzyl group optionally substituted with one or more members selected from Group Y; a 5- or 6-membered heterocyclic group optionally substituted with one or more members selected from Group Y; or a hydrogen atom; provided that R⁸ does not represent a hydrogen atom when m in —S(O)ₘR⁸ is 1 or 2;

each of R¹⁰ and R¹⁴ independently represents a C1-C4 alkyl group optionally substituted with one or more halogen atoms; or a hydrogen atom;

each of R¹¹ and R¹² independently represents a C1-C4 alkyl group optionally substituted with one or more halogen atoms; a C2-C4 alkoxycarbonyl group; or a hydrogen atom;

R¹³ represents a C1-C6 acyclic hydrocarbon group optionally substituted with one or more members selected from Group X; or a C3-C6 alicyclic hydrocarbon group optionally substituted with one or more members selected from Group X;

R¹⁵ represents a C1-C4 alkyl group optionally substituted with one or more halogen atoms;

m represents 0, 1, or 2;

n represents 0 or 1;

Group X: the group consisting of a C1-C4 alkoxy group optionally substituted with one or more halogen atoms; a cyano group; and a halogen atom;

Group Y: the group consisting of a C1-C4 alkyl group optionally substituted with one or more halogen atoms; a C1-C4 alkoxy group optionally substituted with one or more halogen atoms; a cyano group; a nitro group; and a halogen atom; and

Group Z: the group consisting of a C1-C3 alkyl group optionally substituted with one or more halogen atoms; and a halogen atom; and

(B) a pyrethroid compound;

[2] The arthropod pests control composition according to [1], wherein the pyrethroid compound is selected from the group consisting of esfenvalerate, fenpropathrin, fenvalerate, alpha-cypermethrin, bifenthrin, cypermethrin, deltamethrin, ethofenprox, lambda-cyhalothrin, permethrin, tefluthrin and zeta-cypermethrin;

[3] The arthropod pests control composition according to [1] or [2], wherein a weight ratio of the condensed heterocyclic compound represented by formula (1) to the pyrethroid compound is in the range of 0.1:99.9 to 99.9:0.1;

[4] A method for controlling arthropod pests which comprises applying effective amounts of the condensed heterocyclic compound represented by formula (1) of [1] and a pyrethroid compound to the arthropod pests or a locus where the arthropod pests inhabit;

[5] A method for controlling arthropod pests which comprises applying effective amounts of the condensed heterocyclic compound represented by formula (1) of [1] and a pyrethroid compound to a plant or soil for growing plant; and

[6] Combined use of the condensed heterocyclic compound represented by formula (1) of [1] and a pyrethroid compound for controlling arthropod pests.

The arthropod pests control composition of the present invention has an excellent controlling effect on arthropod pests.

### MODE FOR CARRYING OUT THE INVENTION

The arthropod pests control composition of the present invention (hereinafter, sometimes referred to as “the composition of the present invention”) comprises, as active ingredients, a condensed heterocyclic compound represented by formula (1) (hereinafter, sometimes referred to as “the present active compound”) and a pyrethroid compound.

The present active compound will be described below.

Examples of substituents used in the present active compound include the following members.

In the present specification, for example, the term “C4-C7” used in the expression “C4-C7 cycloalkylmethyl group” means that the total number of carbon atoms constituting the cycloalkylmethyl group is within the range from 4 to 7.

The “halogen atom” means a fluorine atom, a chlorine atom, a bromine atom, and an iodine atom.

Examples of the “C1-C6 acyclic hydrocarbon group optionally substituted with one or more members selected from Group X” represented by R² or R³ include:

C1-C6 alkyl groups such as a methyl group, an ethyl group, a propyl group, an isopropyl group, a butyl group, an isobutyl group, a sec-butyl group, a tert-butyl group, a pentyl group, and a hexyl group;

C1-C6 alkyl groups substituted with one or more members selected from Group X, such as a methoxymethyl group, an ethoxymethyl group, and a trifluoromethyl group;

C2-C6 alkenyl groups such as an ethenyl group, a 1-propenyl group, a 2-propenyl group, a 1-methylethenyl group, a 2-methyl-1-propenyl group, a 1-butenyl group, a 2-butenyl group, a 3-butenyl group, a 1-pentenyl group, and a 1-hexenyl group;

C2-C6 alkenyl groups substituted with one or more members selected from Group X;

C2-C6 alkynyl groups such as ethynyl group, a propargyl group, a 2-butynyl group, a 3-butynyl group, a 1-pentynyl group, and a 1-hexynyl group; and

C2-C6 alkynyl groups substituted with one or more members selected from Group X.

Examples of the “C3-C6 alicyclic hydrocarbon group optionally substituted with one or more members selected from Group X” represented by R² or R³ include a cyclopropyl group, a cyclobutyl group, a cyclopentyl group, and a cyclohexyl group.

Examples of the “phenyl group optionally substituted with one or more members selected from Group Y” represented by R² or R³ include a phenyl group, a 2-chlorophenyl group, a 3-chlorophenyl group, a 4-chlorophenyl group, a 2-methylphenyl group, a 3-methylphenyl group, a 4-methylphenyl group, a 2-methoxyphenyl group, a 3-methoxyphenyl group, a 4-methoxyphenyl group, a 2-(trifluoromethyl)phenyl group, a 3-(trifluoromethyl)phenyl group, a 4-(trifluoromethyl)phenyl group, a 2-nitrophenyl group, a 3-nitrophenyl group, a 4-nitrophenyl group, a 2-cyanophenyl group, a 3-cyanophenyl group, and a 4-cyanophenyl group.

Examples of the “benzyl group optionally substituted with one or more members selected from Group Y” represented by R² or R³ include a benzyl group, a 2-chlorobenzyl group, a 3-chlorobenzyl group, a 4-chlorobenzyl group, a 2-methylbenzyl group, a 3-methylbenzyl group, a 4-methylbenzyl group, a 2-methoxybenzyl group, a 3-methoxybenzyl group, and a 4-methoxybenzyl group.

Examples of the “5-membered heterocyclic group optionally substituted with one or more members selected from Group Y” represented by R² or R³ include:

5-membered saturated heterocyclic groups such as a pyrrolidin-1-yl group and a tetrahydrofuran-2-yl group; and

5-membered aromatic heterocyclic groups such as a pyrazol-1-yl group, a 3-chloro-pyrazol-1-yl group, a 3-bromopyrazol-1-yl group, a 3-nitropyrazol-1-yl group, a 3-methylpyrazol-1-yl group, a 3-(trifluoromethyl)pyrazol-1-yl group, a 4-methylpyrazol-1-yl group, a 4-chloropyrazol-1-yl group, a 4-bromopyrazol-1-yl group, a 4-cyanopyrazol-1-yl group, an imidazol-1-yl group, a 4-(trifluoromethyl)imidazol-1-yl group, a pyrrol-1-yl group, a 1,2,4-triazol-1-yl group, a 3-chloro-1,2,4-triazol-1-yl group, a 1,2,3,4-tetrazol-1-yl group, a 1,2,3,5-tetrazol-1-yl group, a 2-thienyl group, and a 3-thienyl group.

Examples of the “6-membered heterocyclic group optionally substituted with one or more members selected from Group Y” represented by R² or R³ include:

6-membered saturated heterocyclic groups such as a piperidyl group, a morpholyl group, a thiomorpholyl group, and a 4-methylpiperazin-1-yl group; and

6-membered aromatic heterocyclic groups such as a 2-pyridyl group, a 3-pyridyl group, and a 4-pyridyl group.

Examples of the “C1-C6 acyclic hydrocarbon group optionally substituted with one or more members selected from Group X” represented by R⁵ or R⁶ include:

C1-C6 alkyl groups such as a methyl group, an ethyl group, a propyl group, an isopropyl group, an isobutyl group, a sec-butyl group, a tert-butyl group, a 1,1-dimethylpropyl group, a 2,2-dimethylpropyl group, and a 1-ethylpropyl group;

C1-C6 alkyl groups substituted with one or more members selected from Group X, such as a methoxymethyl group, a 1-methoxyethyl group, a 1,1-difluoroethyl group, a trifluoromethyl group, a pentafluoroethyl group, and a heptafluoroisopropyl group;

C2-C6 alkenyl groups such as an ethenyl group, a 1-propenyl group, a 2-propenyl group, a 1-methylethenyl group, a 1-methyl-1-propenyl group, a 1-methyl-2-propenyl group, a 1-butenyl group, a 2-butenyl group, and a 3-butenyl group;

C2-C6 alkenyl groups substituted with one or more members selected from Group X;

C2-C6 alkynyl groups such as an ethynyl group, a propargyl group, a 2-butynyl group, and a 3-butynyl group; and

C2-C6 alkynyl groups substituted with one or more members selected from Group X. A preferred example is a C1-C4 alkyl group substituted with one or more halogen atoms, and a more preferred example is a trifluoromethyl group.

Examples of the “C3-C6 alicyclic hydrocarbon group optionally substituted with one or more members selected from Group X” represented by R⁵ or R⁶ include a cyclopropyl group, a 1-methylcyclopropyl group, a cyclobutyl group, a cyclopentyl group, a 1-methylcyclopentyl group, a 1-cyclopentenyl group, and a cyclohexyl group.

Examples of the 5- or 6-membered ring formed with R⁵ and R⁶, together with 6-membered ring constituent atoms to which they bind, include the rings represented by the formulae (a), (b), (c), (d), (e), (f), (g), (h), and (i) as shown below, wherein A⁵ represents a 6-memberred ring carbon atom to which R⁵ binds, and A⁶ represents a 6-membered ring carbon atom to which R⁶ binds.

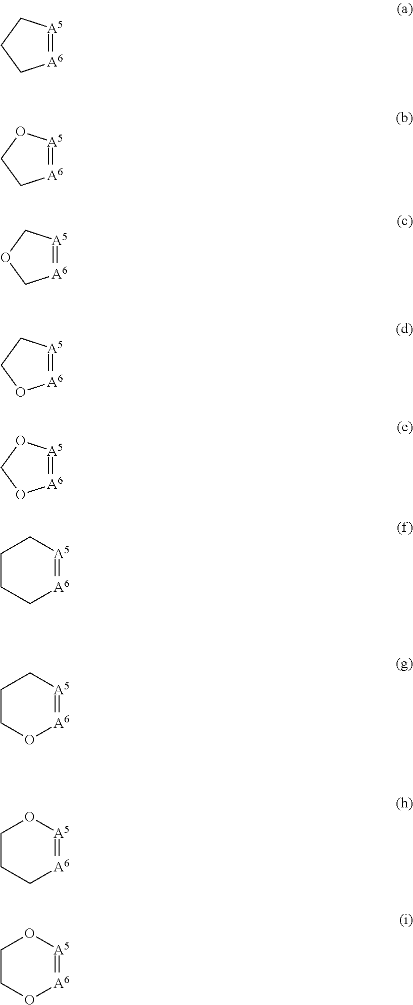

Examples of the “C1-C3 alkyl group optionally substituted with one or more halogen atoms” represented by R⁷ include a methyl group, an ethyl group, a propyl group, an isopropyl group, and a trifluoromethyl group.

Examples of the “C1-C3 alkoxy group optionally substituted with one or more halogen atoms” represented by R⁷ include a methoxy group, an ethoxy group, an isopropoxy group, a trifluoromethoxy group, and a difluoromethoxy group.

Examples of the “C1-C6 acyclic hydrocarbon group optionally substituted with one or more members selected from Group X” represented by R⁸ or R⁹ include:

C1-C6 alkyl groups such as a methyl group, an ethyl group, a propyl group, an isopropyl group, a butyl group, an isobutyl group, a sec-butyl group, a tert-butyl group, a 1-methylbutyl group, a 2-methylbutyl group, a 3-methylbutyl group, a 1-ethylpropyl group, a 1,2-dimethylpropyl group, a 2,2-dimethylpropyl group, a pentyl group, a 1,2-dimethylbutyl group, a 2,2-dimethylbutyl group, a 1-methylpentyl group, a 2-methylpentyl group, a 3-methylpentyl group, a 4-methylpentyl group, and a hexyl group;

C1-C6 alkyl groups substituted with one or more members selected from Group X, such as a cyanomethyl group, a difluoromethyl group, a trifluoromethyl group, a 2,2-difluoroethyl group, a 2,2,2-trifluoroethyl group, and a 1-methyl-2,2,2-trifluoroethyl group;

C3-C6 alkenyl groups such as a 2-propenyl group, a 1-methyl-2-propenyl group, a 2-methyl-2-propenyl group, a 2-butenyl group, a 3-butenyl group, a 1-methyl-2-butenyl group, and a 1-methyl-3-butenyl group;

C3-C6 alkenyl groups substituted with one or more members selected from Group X, such as a 3,3-dichloro-2-propenyl group and a 3,3-difluoro-2-propenyl group;

C3-C6 alkynyl groups such as a propargyl group, a 1-methyl-2-propynyl group, a 2-butynyl group, a 3-butynyl group, a 1-methyl-2-butynyl group, and a 1-methyl-3-butynyl group; and

C3-C6 alkynyl groups substituted with one or more members selected from Group X.

Examples of the C4-C7 cycloalkylmethyl group represented by R⁸ or R⁹ include a cyclopropylmethyl group, a cyclobutylmethyl group, a cyclopentylmethyl group, and a cyclohexylmethyl group.

Examples of the C3-C6 alicyclic hydrocarbon group represented by R⁸ or R⁹ include a cyclopropyl group, a cyclobutyl group, a cyclopentyl group, a cyclohexyl group, and a 2-cyclohexenyl group.

Examples of the “phenyl group optionally substituted with one or more members selected from Group Y” represented by R⁸ or R⁹ include a 2-chlorophenyl group, a 3-chlorophenyl group, a 4-chlorophenyl group, a 2-methylphenyl group, a 3-methylphenyl group, a 4-methylphenyl group, a 2-methoxyphenyl group, a 3-methoxyphenyl group, a 4-methoxyphenyl group, a 2-(trifluoromethyl)phenyl group, a 3-(trifluoromethyl)phenyl group, a 4-(trifluoromethyl)phenyl group, a 2-cyanophenyl group, a 3-cyanophenyl group, a 4-cyanophenyl group, a 2-nitrophenyl group, a 3-nitrophenyl group, and a 4-nitrophenyl group.

Examples of the “benzyl group optionally substituted with one or more members selected from Group Y” represented by R⁸ or R⁹ include a benzyl group, a 2-chlorobenzyl group, a 3-chlorobenzyl group, a 4-chlorobenzyl group, a 2-methylbenzyl group, a 3-methylbenzyl group, a 4-methylbenzyl group, a 2-methoxybenzyl group, a 3-methoxybenzyl group, and a 4-methoxybenzyl group.

Examples of the “5-membered heterocyclic group” represented by R⁸ or R⁹ include 5-membered aromatic heterocyclic groups such as a 2-thienyl group and a 3-thienyl group.

Examples of the “6-membered heterocyclic group” represented by R⁸ or R⁹ include 6-membered aromatic heterocyclic groups such as a 2-pyridyl group, a 3-pyridyl group, a 4-pyridyl group, a 2-pyrimidinyl group, and a 4-pyrimidinyl group.

Examples of the “C1-C4 alkyl group” represented by R¹⁰ or R¹⁴ include a methyl group, an ethyl group, a propyl group, an isopropyl group, a butyl group, an isobutyl group, a sec-butyl group, and a tert-butyl group.

Examples of the “C1-C4 alkyl group optionally substituted with one or more halogen atoms” represented by R¹¹ or R¹² include a methyl group, an ethyl group, a 2,2,2-trifluoroethyl group, a propyl group, an isopropyl group, a butyl group, an isobutyl group, a sec-butyl group, and a tert-butyl group.

Examples of the “C2-C4 alkoxycarbonyl group” represented by R¹¹ or R¹² include a methoxycarbonyl group, an ethoxycarbonyl group, a propoxycarbonyl group, and an isopropoxycarbonyl group.

Examples of the “C1-C6 acyclic hydrocarbon group optionally substituted with one or more members selected from Group X” represented by R¹³ include:

C1-C6 alkyl groups such as a methyl group, an ethyl group, a propyl group, an isopropyl group, a butyl group, an isobutyl group, a sec-butyl group, a 1-methylbutyl group, and a 2-methylbutyl group;

C1-C6 alkyl groups substituted with one or more members selected from Group X, such as a difluoromethyl group, a trifluoromethyl group, and a 2,2,2-trifluoroethyl group;

C3-C6 alkenyl groups such as a 2-propenyl group, a 1-methyl-2-propenyl group, a 2-methyl-2-propenyl group, a 2-butenyl group, and a 3-butenyl group;

C3-C6 alkenyl groups substituted with one or more members selected from Group X, such as a 2-chloro-2-propenyl group, a 3,3-difluoro-2-propenyl group, and a 3,3-dichloro-2-propenyl group;

C3-C6 alkynyl groups such as a propargyl group, a 1-methyl-2-propynyl group, a 2-butynyl group, and a 3-butynyl group; and

C3-C6 alkynyl groups substituted with one or more members selected from Group X. A preferred example is a C1-C4 alkyl group substituted with one or more halogen atoms, and a more preferred example is a trifluoromethyl group.

Examples of the “C3-C6 alicyclic hydrocarbon group optionally substituted with one or more members selected from Group X” represented by R¹³ include a cyclopropyl group, a cyclobutyl group, a cyclopentyl group, a cyclohexyl group, and a 2-cyclohexenyl group.

Examples of the “C1-C4 alkyl group” represented by R¹⁵ include a methyl group, an ethyl group, a propyl group, an isopropyl group, a butyl group, an isobutyl group, a secbutyl group, and a tert-butyl group.

One embodiment of the present active compound is the compound represented by formula (2), for example:

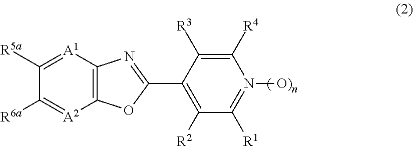

wherein A¹, A², R¹, R², R³, R⁴, and n have the same meaning as defined above,

each of R^{5a} and R^{6a} independently represents a C1-C6 acyclic hydrocarbon group which is substituted with one or more halogen atoms; a C3-C6 alicyclic hydrocarbon group which is substituted with one or more halogen atoms; —OR^{13a}; —S(O)ₘR^{13a}; a halogen atom; or a hydrogen atom; except that both R^{5a} and R^{6a} represent members selected from the group consisting of a halogen atom and a hydrogen atom; or R^{5a} and R^{6a}, together with 6-membered ring constituent atoms to which they bind, may form a 5- or 6-membered ring which is substituted with one or more halogen atoms; and

R^{13a} represents a C1-C6 acyclic hydrocarbon group which is substituted with one or more halogen atoms; or a C3-C6 alicyclic hydrocarbon group which is substituted with one or more halogen atoms.

Examples of the “C1-C6 acyclic hydrocarbon group which is substituted with one or more halogen atoms” represented by R^{5a} or R^{6a} include a 1,1-difluoroethyl group, a trifluoromethyl group, a pentafluoroethyl group, and a heptafluoroisopropyl group. Of these, a trifluoromethyl group is preferable.

Examples of the C3-C6 alicyclic hydrocarbon group represented by R^{5a} or R^{6a} include a cyclopropyl group, a cyclobutyl group, a cyclopentyl group, and a cyclohexyl group.

Examples of the “5- or 6-membered ring substituted with one or more halogen atoms” which is formed with R^{5a} and R^{6a}, together with 6-membered ring constituent atoms to which they bind, include the rings represented by the formulae (j), (k), (l), (m), (n), (o), (p), (q), (r), and (s) as shown below, wherein A⁵ represents a 6-memberred ring carbon atom to which R^{5a} binds, and A⁶ represents a 6-membered ring carbon atom to which R^{6a} binds.

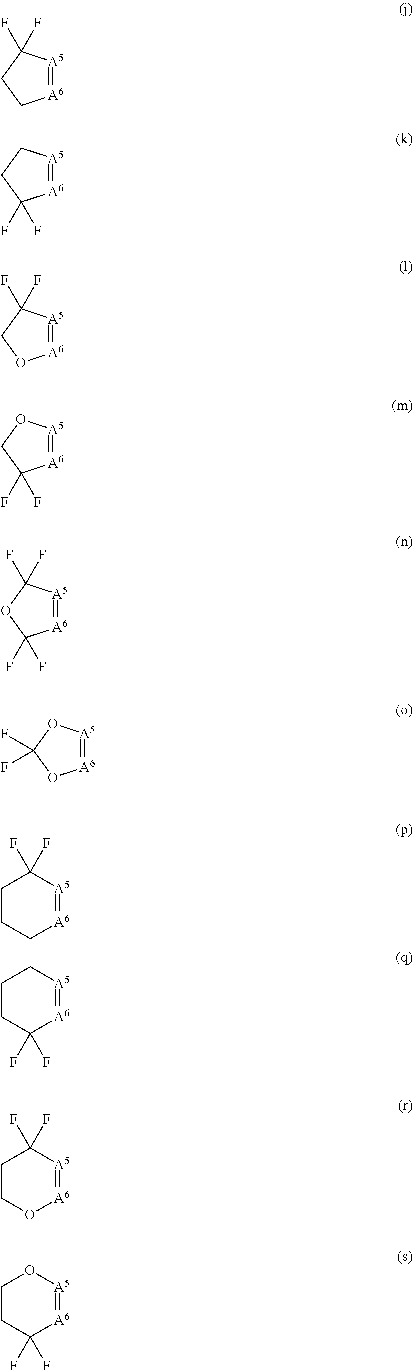

Examples of the “C1-C6 acyclic hydrocarbon group which is substituted with one or more halogen atoms” represented by R^{13a} include a trifluoromethyl group, a difluoromethyl group, and a 2,2,2-trifluoroethyl group. Of these, a trifluoromethyl group is preferable.

Examples of the C3-C6 alicyclic hydrocarbon group in the “C3-C6 alicyclic hydrocarbon group which is substituted with one or more halogen atoms” represented by R^{13a} include a cyclopropyl group, a cyclobutyl group, a cyclopentyl group, and a cyclohexyl group.

Embodiments of the present invention include a composition comprising at least one of the following condensed heterocyclic compounds as the present active compound, one of the active ingredients of the composition:

a compound, wherein, in the formula (1),

each of R² and R³ independently represents a C1-C6 acyclic hydrocarbon group optionally substituted with one or more members selected from Group X; a C3-C6 alicyclic hydrocarbon group optionally substituted with one or more members selected from Group X; a phenyl group optionally substituted with one or more members selected from Group Y; a benzyl group optionally substituted with one or more members selected from Group Y; a 5- or 6-membered heterocyclic group optionally substituted with one or more members selected from Group Y; —OR⁸; —NR⁸R⁹; —NR⁸C(O)R⁹; —S(O)ₘR⁸; —CO₂R¹⁰; —CONR⁸R⁹; —CONR¹⁰NR¹¹R¹²; a cyano group; a nitro group; a halogen atom; or a hydrogen atom; and

each of R⁸ and R⁹ independently represents a C1-C6 acyclic hydrocarbon group optionally substituted with one or more members selected from Group X; a C3-C6 alicyclic hydrocarbon group optionally substituted with one or more members selected from Group X; a phenyl group optionally substituted with one or more members selected from Group Y; a 5- or 6-membered heterocyclic group optionally substituted with one or more members selected from Group Y, or a hydrogen atom, provided that R⁸ does not represent a hydrogen atom when m in —S(O)ₘR⁸ is 1 or 2;

a compound, wherein, in the formula (1), R¹ and R⁴ represent a hydrogen atom;

a compound, wherein, in the formula (1), R² represents a hydrogen atom or a halogen atom;

a compound, wherein, in the formula (1), R³ represents a C3-C6 alicyclic hydrocarbon group optionally substituted with one or more members selected from Group X, a phenyl group optionally substituted with one or more members selected from Group Y; a benzyl group optionally substituted with one or more members selected from Group Y; or a 5- or 6-membered heterocyclic group optionally substituted with one or more members selected from Group Y;

a compound, wherein, in the formula (1), R³ represents a C1-C6 acyclic hydrocarbon group optionally substituted with one or more members selected from Group X; —OR⁸; —NR⁸R⁹; —NR⁸C(O)R⁹; —NR¹⁰C(O)NR⁹R¹⁴; —NR¹⁰CO₂R¹⁵; —S(O)ₘR⁸; —CO₂R¹⁰; —CONR⁸R⁹; —C(O)R¹⁰; —C(NOR⁸)R¹⁰; —CONR¹⁰NR¹¹R¹²; a cyano group; a nitro group; a halogen atom; or a hydrogen atom; and

each of R⁸ and R⁹ independently represents a C1-C6 acyclic hydrocarbon group optionally substituted with one or more members selected from Group X; or a hydrogen atom; provided that R⁸ represents a C1-C6 acyclic hydrocarbon group optionally substituted with one or more members selected from Group X when m in —S(O)ₘR⁸ is 1 or 2;

a compound, wherein, in the formula (1), R³ represents a C1-C6 acyclic hydrocarbon group optionally substituted with one or more members selected from Group X; —OR⁸; —NR⁸R⁹; —S(O)ₘR⁸; a halogen atom; or a hydrogen atom; and

each of R⁸ and R⁹ independently represents a C1-C6 acyclic hydrocarbon group optionally substituted with one or more members selected from Group X; or a hydrogen atom; provided that R⁸ represents a C1-C6 acyclic hydrocarbon group optionally substituted with one or more members selected from Group X when m in —S(O)ₘR⁸ is 1 or 2;

a compound, wherein, in the formula (1),

each of R⁵ and R⁶ independently represents a C1-C6 acyclic hydrocarbon group optionally substituted with one or more members selected from Group X; —OR¹³; —S(O)ₘR¹³; a halogen atom; or a hydrogen atom; except that both R⁵ and R⁶ represent hydrogen atoms; and

R¹³ represents a C1-C6 acyclic hydrocarbon group optionally substituted with one or more members selected from Group X;

a compound, wherein, in the formula (1), R⁵ represents a C1-C6 acyclic hydrocarbon group optionally substituted with one or more halogen atoms, or —OR¹³, and R¹³ represents a C1-C6 acyclic hydrocarbon group optionally substituted with one or more halogen atoms;

a compound, wherein, in the formula (1), R⁶ represents a C1-C6 acyclic hydrocarbon group optionally substituted with one or more halogen atoms, or —OR¹³, and R¹³ represents a C1-C6 acyclic hydrocarbon group optionally substituted with one or more halogen atoms;

a compound, wherein, in the formula (1), R⁵ represents a C1-C6 acyclic hydrocarbon group substituted with one or more halogen atoms, or —OR¹³, and R¹³ represents a C1-C6 acyclic hydrocarbon group substituted with one or more halogen atoms;

a compound, wherein, in the formula (1), R⁶ represents a C1-C6 acyclic hydrocarbon group substituted with one or more halogen atoms, or —OR¹³, and R¹³ represents a C1-C6 acyclic hydrocarbon group substituted with one or more halogen atoms;

a compound, wherein, in the formula (1), R⁵ represents a C1-C6 acyclic hydrocarbon group substituted with one or more halogen atoms;

a compound, wherein, in the formula (1), R⁵ represents a trifluoromethyl group;

a compound, wherein, in the formula (1), R⁵ represents a tert-butyl group;

a compound, wherein, in the formula (1), R⁶ represents a C1-C6 acyclic hydrocarbon group substituted with one or more halogen atoms;

a compound, wherein, in the formula (1), R⁶ represents a trifluoromethyl group;

a compound, wherein, in the formula (1), R⁶ represents a tert-butyl group;

a compound, wherein, in the formula (1), R⁵ represents —OR¹³, and R¹³ represents a C1-C6 acyclic hydrocarbon group substituted with one or more halogen atoms;

a compound, wherein, in the formula (1), R⁵ represents —OR¹³, and R¹³ represents a trifluoromethyl group or a difluoromethyl group;

a compound, wherein, in the formula (1), R⁶ represents —OR¹³, and R¹³ represents a C1-C6 acyclic hydrocarbon group substituted with one or more halogen atoms;

a compound, wherein, in the formula (1), R⁶ represents —OR¹³, and R¹³ represents a trifluoromethyl group or a difluoromethyl group;

a compound, wherein, in the formula (1), R⁵ represents a C1-C6 acyclic hydrocarbon group optionally substituted with one or more halogen atoms, and R⁶ represents a hydrogen atom or a halogen atom;

a compound, wherein, in the formula (1), R⁵ represents —OR¹³, R¹³ represents a C1-C6 acyclic hydrocarbon group optionally substituted with one or more halogen atoms, and R⁶ represents a hydrogen atom or a halogen atom;

a compound, wherein, in the formula (1), R⁵ represents a hydrogen atom or a halogen atom, and R⁶ represents a C1-C6 acyclic hydrocarbon group optionally substituted with one or more halogen atoms;

a compound, wherein, in the formula (1), R⁵ represents a hydrogen atom or a halogen atom, R⁶ represents —OR¹³, and R¹³ represents a C1-C6 acyclic hydrocarbon group optionally substituted with one or more halogen atoms;

a compound, wherein, in the formula (1), R⁵ represents a C1-C6 acyclic hydrocarbon group substituted with one or more halogen atoms, R⁶ represents a hydrogen atom or a halogen atom;

a compound, wherein, in the formula (1), R⁵ represents —OR¹³, R¹³ represents a C1-C6 acyclic hydrocarbon group substituted with one or more halogen atoms, and R⁶ represents a hydrogen atom or a halogen atom;

a compound, wherein, in the formula (1), R⁵ represents a hydrogen atom or a halogen atom, and R⁶ represents a C1-C6 acyclic hydrocarbon group substituted with one or more halogen atoms;

a compound, wherein, in the formula (1), R⁵ represents a hydrogen atom or a halogen atom, R⁶ represents —OR¹³, and R¹³ represents a C1-C6 acyclic hydrocarbon group substituted with one or more halogen atoms;

a compound, wherein, in the formula (1), R⁵ represents a trifluoromethyl group, and R⁶ represents a hydrogen atom or a halogen atom;

a compound, wherein, in the formula (1), R⁵ represents a tert-butyl group, and R⁶ represents a hydrogen atom or a halogen atom;

a compound, wherein, in the formula (1), R⁵ represents —OR¹³, R¹³ represents a trifluoromethyl group or a difluoromethyl group, and R⁶ represents a hydrogen atom or a halogen atom;

a compound, wherein, in the formula (1), R⁵ represents a hydrogen atom or a halogen atom, and R⁶ represents a trifluoromethyl group;

a compound, wherein, in the formula (1), R⁵ represents a hydrogen atom or a halogen atom, and R⁶ represents a tert-butyl group;

a compound, wherein, in the formula (1), R⁵ represents a hydrogen atom or a halogen atom, R⁶ represents —OR¹³, and R¹³ represents a trifluoromethyl group or a difluoromethyl group;

a compound, wherein, in the formula (1), A¹ represents a nitrogen atom, A² represents ═C(R⁷)—, and R⁷ represents a hydrogen atom;

a compound, wherein, in the formula (1), A¹ represents ═C(R⁷)—, A² represents a nitrogen atom, and R⁷ represents a hydrogen atom;

a compound, wherein, in the formula (1), A¹ and A² each represent ═C(R⁷)—, and R⁷ represents a hydrogen atom;

a compound, wherein, in the formula (1), each of R² and R³ independently represents a C1-C4 alkyl group optionally substituted with one or more halogen atoms; a C2-C4 alkoxyalkyl group; a C2-C4 alkenyl group; a pyrrolidyl group; a piperidyl group; a morpholyl group; an imidazolyl group; a pyrazolyl group; a triazolyl group; a (C1-C3 alkyl group)-substituted pyrazolyl group; a (C1-C3 halogenated alkyl group)-substituted pyrazolyl group; a phenyl group; a pyridyl group; —OR^{8a}, wherein R^{8a} represents a C1-C4 alkyl group optionally substituted with one or more halogen atoms, a C3-C4 alkenyl group optionally substituted with one or more halogen atoms, a C3-C4 alkynyl group, a benzyl group, a C2-C4 alkoxyalkyl group, a C4-C7 cycloalkylmethyl group, or a hydrogen atom; —NR^{8b}R^{9a}, wherein each of R^{8b} and R^{9a} represents a C1-C4 alkyl group optionally substituted with one or more halogen atoms, or a hydrogen atom; —NHC(O)R^{9b}, wherein R^{9b} represents a C1-C4 alkyl group optionally substituted with one or more halogen atoms; —NHCO₂R^{15a}, wherein R^{15a} represents a C1-C4 alkyl group; —S(O)_{m 1}R^{8c}, wherein R^{8c} represents a C1-C4 alkyl group optionally substituted with one or more halogen atoms, and m1 represents 1 or 2; —SR^{8d}, wherein R^{8d} represents a C1-C4 alkyl group optionally substituted with one or more halogen atoms, or a hydrogen atom; a cyano group; a halogen atom; or a hydrogen atom;

a compound, wherein, in the formula (1), each of R² and R³ independently represents a C1-C4 alkyl group optionally substituted with one or more halogen atoms, —OR^{8a}, wherein R^{8a} represents a C1-C4 alkyl group optionally substituted with one or more halogen atoms; —NR^{8b}R^{9a}, wherein each of R^{8b} and R^{9a} represents a C1-C4 alkyl group optionally substituted with one or more halogen atoms, or a hydrogen atom; —S(O)_{m 1}R^{8c}, wherein R^{8c} represents a C1-C4 alkyl group optionally substituted with one or more halogen atoms, and m1 represents 1 or 2; —SR^{8d}, wherein R^{8d} represents a C1-C4 alkyl group optionally substituted with one or more halogen atoms, or a hydrogen atom; a halogen atom; or a hydrogen atom;

a compound, wherein, in the formula (1), at least one of R⁵ and R⁶ represents a C1-C3 alkyl group substituted with one or more halogen atoms, a C1-C4 alkyl group, or —OR^{13a}, and R^{13a} represents a C1-C3 alkyl group substituted with one or more halogen atoms;

a compound, wherein, in the formula (2), each of R² and R³ independently represents a C1-C6 acyclic hydrocarbon group optionally substituted with one or more members selected from Group X; a C3-C6 alicyclic hydrocarbon group optionally substituted with one or more members selected from Group X; a phenyl group optionally substituted with one or more members selected from Group Y; a benzyl group optionally substituted with one or more members selected from Group Y; a 5- or 6-membered heterocyclic group optionally substituted with one or more members selected from Group Y; —OR⁸; —NR⁸R⁹; —NR⁸C(O)R⁹; —S(O)ₘR⁸; —CO₂R¹⁰; —CONR⁸R⁹; —CONR¹¹R¹²; a cyano group; a nitro group; a halogen atom; or a hydrogen atom; and

each of R⁸ and R⁹ independently represents a C1-C6 acyclic hydrocarbon group optionally substituted with one or more members selected from Group X; a C3-C6 alicyclic hydrocarbon group optionally substituted with one or more members selected from Group X; a phenyl group optionally substituted with one or more members selected from Group Y; a 5- or 6-membered heterocyclic group optionally substituted with one or more members selected from Group Y; or a hydrogen atom; provided that R⁸ does not represent a hydrogen atom when m in —S(O)ₘR⁸ is 1 or 2;

a compound, wherein, in the formula (2), R¹ and R⁴ represent a hydrogen atom;

a compound, wherein, in the formula (2), R² represents a hydrogen atom or a halogen atom;

a compound, wherein, in the formula (2), R³ represents a C3-C6 alicyclic hydrocarbon group optionally substituted with one or more members selected from Group X; a phenyl group optionally substituted with one or more members selected from Group Y; a benzyl group optionally substituted with one or more members selected from Group Y; or a 5- or 6-membered heterocyclic group optionally substituted with one or more members selected from Group Y;

a compound, wherein, in the formula (2), R³ represents a C1-C6 acyclic hydrocarbon group optionally substituted with one or more members selected from Group X; —OR⁸; —NR⁸R⁹; —NR⁸C(O)R⁹; —NR¹⁰C(O)NR⁹R¹⁴; —NR¹⁰CO₂R¹⁵; —S(O)ₘR⁸; —CO₂R¹⁰; —CONR⁸R⁹; —C(O)R¹⁰; —C(NOR⁸)R¹⁰; —CONR¹⁰NR¹¹R¹²; a cyano group; a nitro group; a halogen atom; or a hydrogen atom; and each of R⁸ and R⁹ independently represents a C1-C6 acyclic hydrocarbon group optionally substituted with one or more members selected from Group X; or a hydrogen atom; provided that R⁸ represents a C1-C6 acyclic hydrocarbon group optionally substituted with one or more members selected from Group X when m in —S(O)ₘR⁸ is 1 or 2;

a compound, wherein, in the formula (2), R³ represents a C1-C6 acyclic hydrocarbon group optionally substituted with one or more members selected from Group X; —OR⁸; —NR⁸R⁹; —S(O)ₘR⁸; a halogen atom; or a hydrogen atom; and
each of R⁸ and R⁹ independently represents a C1-C6 acyclic hydrocarbon group optionally substituted with one or more members selected from Group X; or a hydrogen atom; provided that R⁸ represents a C1-C6 acyclic hydrocarbon group optionally substituted with one or more members selected from Group X when m in —S(O)ₘR⁸ is 1 or 2;

a compound, wherein, in the formula (2), R^{5a} represents a C1-C6 acyclic hydrocarbon group substituted with one or more halogen atoms, or —OR^{13a}, and R^{13a} represents a C1-C6 acyclic hydrocarbon group substituted with one or more halogen atoms;

a compound, wherein, in the formula (2), R^{6a} represents a C1-C6 acyclic hydrocarbon group substituted with one or more halogen atoms, or —OR^{13a}, and R^{13a} represents a C1-C6 acyclic hydrocarbon group substituted with one or more halogen atoms;

a compound, wherein, in the formula (2), R^{5a} represents a C1-C6 acyclic hydrocarbon group substituted with one or more halogen atoms,

a compound, wherein, in the formula (2), R^{5a} represents a trifluoromethyl group;

a compound, wherein, in the formula (2), R^{6a} represents a C1-C6 acyclic hydrocarbon group substituted with one or more halogen atoms;

a compound, wherein, in the formula (2), R^{6a} represents a trifluoromethyl group;

a compound, wherein, in the formula (2), R^{5a} represents —OR^{13a}, and R^{13a} represents a C1-C6 acyclic hydrocarbon group substituted with one or more halogen atoms;

a compound, wherein, in the formula (2), R^{5a} represents —OR^{13a}, and R^{13a} represents a trifluoromethyl group or a difluoromethyl group;

a compound, wherein, in the formula (2), R^{6a} represents —OR^{13a}, and R^{13a} represents a C1-C6 acyclic hydrocarbon group substituted with one or more halogen atoms;

a compound, wherein, in the formula (2), R^{6a} represents —OR^{13a}, and R^{13a} represents a trifluoromethyl group or a difluoromethyl group;

a compound, wherein, in the formula (2), R^{5a} represents a C1-C6 acyclic hydrocarbon group substituted with one or more halogen atoms, and R^{6a} represents a hydrogen atom or a halogen atom;

a compound, wherein, in the formula (2), R^{5a} represents —OR^{13a}, R^{13a} represents a C1-C6 acyclic hydrocarbon group substituted with one or more halogen atoms, and R^{6a} represents a hydrogen atom or a halogen atom;

a compound, wherein, in the formula (2), R^{5a} represents a hydrogen atom or a halogen atom, and R^{6a} represents a C1-C6 acyclic hydrocarbon group substituted with one or more halogen atoms;

a compound, wherein, in the formula (2), R^{5a} represents a hydrogen atom or a halogen atom, R^{6a} represents —OR^{13a}, and R^{13a} represents a C1-C6 acyclic hydrocarbon group substituted with one or more halogen atoms;

a compound, wherein, in the formula (2), R^{5a} represents a trifluoromethyl group, and R^{6a} represents a hydrogen atom or a halogen atom;

a compound, wherein, in the formula (2), R^{5a} represents —OR^{13a}, R^{13a} represents a trifluoromethyl group or a difluoromethyl group, and R^{6a} represents a hydrogen atom or a halogen atom;

a compound, wherein, in the formula (2), R^{5a} represents a hydrogen atom or a halogen atom, and R^{6a} represents a trifluoromethyl group;

a compound, wherein, in the formula (2), R^{5a} represents a hydrogen atom or a halogen atom, R^{6a} represents —OR^{13a}, and R^{13a} represents a trifluoromethyl group or a difluoromethyl group;

a compound, wherein, in the formula (2), A¹ represents a nitrogen atom, A² represents ═C(R⁷)—, and R⁷ represents a hydrogen atom;

a compound, wherein, in the formula (2), A¹ represents ═C(R⁷)—, A² represents a nitrogen atom, and R⁷ represents a hydrogen atom;

a compound, wherein, in the formula (2), A¹ and A² each represent ═C(R⁷)—, and R⁷ represents a hydrogen atom;

a compound, wherein, in the formula (2), each of R² and R³ independently represents a C1-C4 alkyl group optionally substituted with one or more halogen atoms; a C2-C4 alkoxyalkyl group; a C2-C4 alkenyl group; a pyrrolidyl group; a piperidyl group; a morpholyl group; an imidazolyl group; a pyrazolyl group; a triazolyl group; a (C1-C3 alkyl group)-substituted pyrazolyl group; a (C1-C3 halogenated alkyl group)-substituted pyrazolyl group; a phenyl group; a pyridyl group; —OR^{8a}, wherein R^{8a} represents a C1-C4 alkyl group optionally substituted with one or more halogen atoms, a C3-C4 alkenyl group optionally substituted with one or more halogen atoms, a C3-C4 alkynyl group, a benzyl group, a C2-C4 alkoxyalkyl group, a C4-C7 cycloalkylmethyl group, or a hydrogen atom; —NR^{8b}R^{9a}, wherein each of R^{8b} and R^{9a} represents a C1-C4 alkyl group optionally substituted with one or more halogen atoms, or a hydrogen atom; —NHC(O)R^{9b}, wherein R^{9b} represents a C1-C4 alkyl group optionally substituted with one or more halogen atoms; —NHCO₂R^{15a}, wherein R^{15a} represents a C1-C4 alkyl group; —S(O)_{m 1}R^{8c}, wherein R^{8c} represents a C1-C4 alkyl group optionally substituted with one or more halogen atoms, and m1 represents 1 or 2; —SR^{8d}, wherein R^{8d} represents a C1-C4 alkyl group optionally substituted with one or more halogen atoms, or a hydrogen atom; a cyano group; a halogen atom; or a hydrogen atom;

a compound, wherein, in the formula (2), each of R² and R³ independently represents a C1-C4 alkyl group optionally substituted with one or more halogen atoms; —OR^{8a}, wherein R^{8a} represents a C1-C4 alkyl group optionally substituted with one or more halogen atoms; —NR^{8b}R^{9a}, wherein each of R^{8b} and R^{9a} represents a C1-C4 alkyl group optionally substituted with one or more halogen atoms, or a hydrogen atom; —S(O)_{m 1}R^{8c}, wherein R^{8c} represents a C1-C4 alkyl group optionally substituted with one or more halogen atoms, and m1 represents 1 or 2; —SR^{8d}, wherein R^{8d} represents a C1-C4 alkyl group optionally substituted with one or more halogen atoms, or a hydrogen atom; a halogen atom; or a hydrogen atom; and

a compound, wherein, in the formula (2), at least one of R^{5a} and R^{6a} represents a C1-C3 alkyl group substituted with one or more halogen atoms, or —OR^{13a}, and R^{13a} represents a C1-C3 alkyl group substituted with one or more halogen atoms.

A method for producing the present active compound will be described below.

The present active compound can be produced, for example, by the following “Production Method 1” to “Production Method 14”.

In each production method, a compound represented by a specific formula may be indicated in the form of the compound followed by the number of the formula in parentheses. For example, a compound represented by formula (3) may be referred to as “compound (3).”

### Production Method 1

A compound (5), i.e., a compound of the formula (1) wherein n is 0, can be produced by reacting a compound (3) with a compound (4) in the presence of an acid,

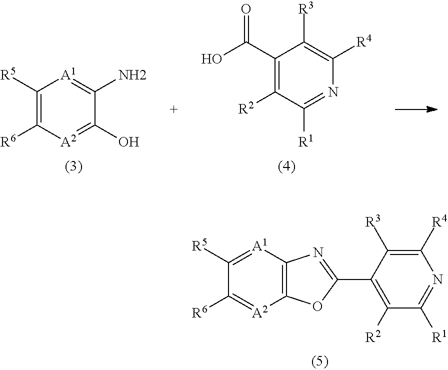

wherein R¹, R², R³, R⁴, R⁵, R⁶, A¹, and A² have the same meaning as defined above.

Examples of the acid include polyphosphoric acid and trimethylsilyl polyphosphate.

When polyphosphoric acid is used as an acid, the reaction is generally carried out in the absence of a solvent. However, the reaction may also be carried out in a solvent.

Examples of the solvent include: ethers such as tetrahydrofuran (hereinafter referred to as THF, at times), ethylene glycol dimethyl ether, or 1,4-dioxane; aromatic hydrocarbons such as toluene or xylene; halogenated hydrocarbons such as chlorobenzene or dichlorobenzene; and the mixtures thereof.

The compound (4) is generally used at a ratio of 1 to 3 moles relative to 1 mole of the compound (3).

The reaction temperature applied to the reaction is generally between 50° C. and 200° C., and the reaction time is generally between 0.5 and 24 hours.

After completion of the reaction, water is added to the reaction mixture, and the mixture is then extracted with an organic solvent. The organic layer is subjected to a post-treatment such as drying or concentration, so as to isolate the compound (5). The isolated compound (5) can be further purified by chromatography, recrystallization, etc.

### Production Method 2

The above compound (5) can be produced by reacting a compound (6) in the presence of an oxidizer,

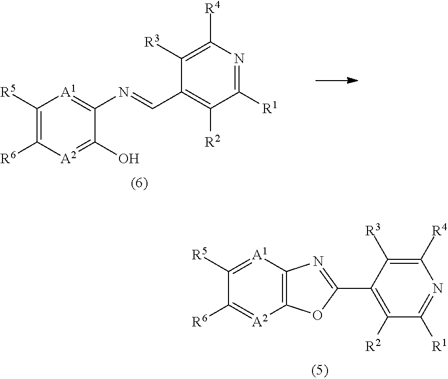

wherein R¹, R², R³, R⁴, R⁵, R⁶, A¹, and A² have the same meaning as defined above.

This reaction is generally carried out in the presence of a solvent.

Examples of the solvent include: ethers such as THF, ethylene glycol dimethyl ether, or 1,4-dioxane; aliphatic hydrocarbons such as hexane or heptane; aromatic hydrocarbons such as toluene or xylene; halogenated hydrocarbons such as dichloromethane, chloroform, or chlorobenzene; esters such as ethyl acetate or butyl acetate; alcohols such as methanol or ethanol; nitriles such as acetonitrile; acid amides such as N,N-dimethylformamide (hereinafter referred to as DMF, at times); sulfoxides such as dimethyl sulfoxide (hereinafter referred to as DMSO, at times); acetic acids; and the mixtures thereof.

Examples of the oxidizer include: metallic oxidizers such as lead(IV) acetate or lead(IV) oxide; and organic periodides such as iodobenzene diacetate.

Such oxidizer is generally used at a ratio of 1 to 3 moles relative to 1 mole of the compound (6).

The reaction temperature applied to the reaction is generally between 0° C. and 100° C., and the reaction time is generally between 0.1 and 24 hours.

After completion of the reaction, the reaction mixture is extracted with an organic solvent, and the organic layer is then subjected to a post-treatment such as drying or concentration, so as to isolate the compound (5). The isolated compound (5) can be further purified by chromatography, recrystallization, etc.

### Production Method 3

The above compound (5) can be produced by reacting a compound (7) in the presence of a dehydration-condensation agent,

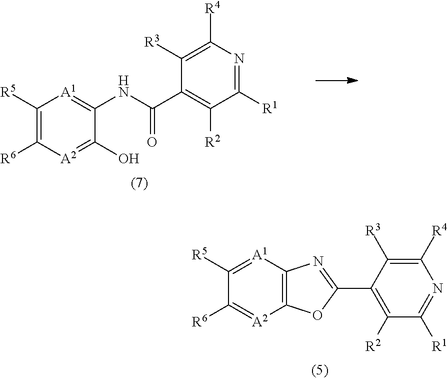

wherein R¹, R², R³, R⁴, R⁵, R⁶, A¹, and A² have the same meaning as defined above.

This reaction is generally carried out in the presence of a solvent.

Examples of the solvent include: ethers such as THF, ethylene glycol dimethyl ether, or 1,4-dioxane; aromatic hydrocarbons such as toluene or xylene; halogenated hydrocarbons such as dichloromethane, chloroform, carbon tetrachloride, or chlorobenzene; esters such as ethyl acetate or butyl acetate; nitriles such as acetonitrile; and the mixtures thereof. Of these, carbon tetrachloride can also be used as a dehydration-condensation agent.

Examples of the dehydration-condensation agent include: a mixture of triphenylphosphine, a base, and carbon tetrachloride or carbon tetrabromide; and a mixture of triphenylphosphine and an azodiester such as azodicarboxylic acid diethyl ester.

Examples of the base include tertiary amines such as triethylamine or diisopropylethylamine.

The dehydration-condensation agent is generally used at a ratio of 1 to 3 moles relative to 1 mole of the compound (7). The base is generally used at a ratio of 1 to 5 moles relative to 1 mole of the compound (7).

The reaction temperature applied to the reaction is generally between −30° C. and +100° C., and the reaction time is generally between 0.5 and 24 hours.

After completion of the reaction, the reaction mixture is extracted with an organic solvent, and the organic layer is then subjected to a post-treatment such as drying or concentration, so as to isolate the compound (5). The isolated compound (5) can be further purified by chromatography, recrystallization, etc.

### Production Method 4

The above compound (5) can be produced by reacting the compound (7) in the presence of an acid,

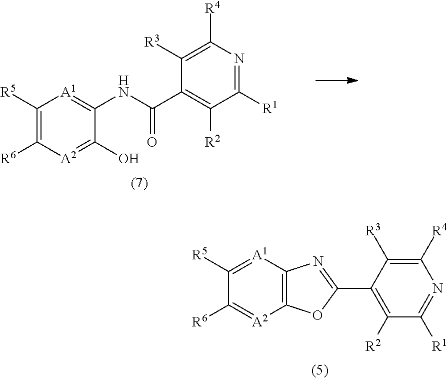

wherein R¹, R², R³, R⁴, R⁵, R⁶, A¹, and A² have the same meaning as defined above.

This reaction is generally carried out in the presence of a solvent.

Examples of the solvent include: ethers such as THF, ethylene glycol dimethyl ether, or 1,4-dioxane; aromatic hydrocarbons such as toluene or xylene; halogenated hydrocarbons such as dichloromethane, chloroform, or chlorobenzene; and the mixtures thereof.

Examples of the acid include: sulfonic acids such as p-toluenesulfonic acid; and polyphosphoric acid.

Such acid is generally used at a ratio of 0.1 to 3 moles relative to 1 mole of the compound (7).

The reaction temperature applied to the reaction is generally between 50° C. and 200° C., and the reaction time is generally between 1 and 24 hours.

After completion of the reaction, the reaction mixture is extracted with an organic solvent, and the organic layer is then subjected to a post-treatment such as drying or concentration, so as to isolate the compound (5). The isolated compound (5) can be further purified by chromatography, recrystallization, etc.

### Production Method 5

A compound (5-a), i.e., a compound of the formula (1) wherein n is 0 and R³ is —OR⁸, can be produced by reacting a compound (8) with a compound (9) in the presence of a base,

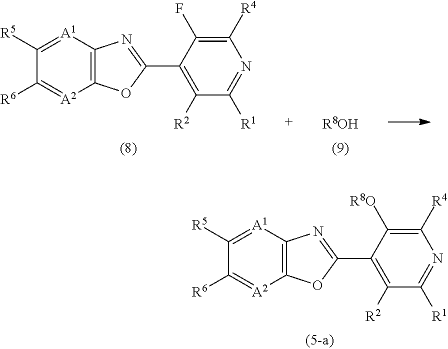

wherein R¹, R², R⁴, R⁵, R⁶, R⁸, A¹, and A² have the same meaning as defined above.

This reaction is generally carried out in the presence of a solvent. It may also be possible to use the compound (9) in a solvent amount.

Examples of the solvent include: ethers such as THF, ethylene glycol dimethyl ether, or 1,4-dioxane; aromatic hydrocarbons such as toluene or xylene; nitriles such as acetonitrile; acid amides such as DMF; sulfoxides such as DMSO; and the mixtures thereof.

Examples of the base include: alkali metal hydrides such as sodium hydride; and carbonates such as potassium carbonate.

The compound (9) is generally used at a ratio of 1 to 100 moles, and the base is generally used at a ratio of 1 to 10 moles, relative to 1 mole of the compound (8).

The reaction temperature applied to the reaction is generally between 0° C. and 120° C., and the reaction time is generally between 0.5 and 24 hours.

After completion of this reaction, known reactions such as a hydrogenation reaction, an oxidation reaction, and a reduction reaction, may be further carried out to convert R⁸ arbitrarily.

After completion of the reaction, the reaction mixture is extracted with an organic solvent, and the organic layer is then subjected to a post-treatment such as drying or concentration, so as to isolate the compound (5-a). The isolated compound (5-a) can be further purified by chromatography, recrystallization, etc.

### Production Method 6

A compound (5-b), i.e., a compound of the formula (1) wherein n is 0 and R³ is —SR⁸, can be produced by reacting the compound (8) with a compound (10) in the presence of a base,

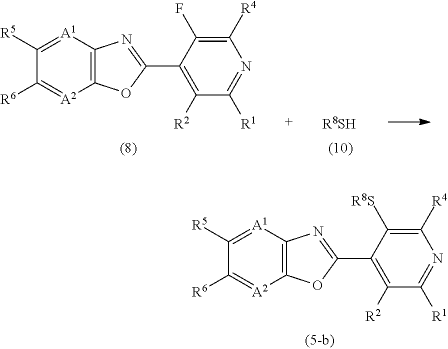

wherein R¹, R², R⁴, R⁵, R⁶, R⁸, A¹, and A² have the same meaning as defined above.

This reaction is generally carried out in the presence of a solvent.

Examples of the solvent include: ethers such as THF, ethylene glycol dimethyl ether, or 1,4-dioxane; aromatic hydrocarbons such as toluene or xylene; nitriles such as acetonitrile; acid amides such as DMF; sulfoxides such as DMSO; and the mixtures thereof.

Examples of the base include: alkali metal hydrides such as sodium hydride; and carbonates such as potassium carbonate.

The compound (10) is generally used at a ratio of 1 to 10 moles, and the base is generally used at a ratio of 1 to 10 moles, relative to 1 mole of the compound (8).

The reaction temperature applied to the reaction is generally between 0° C. and 100° C., and the reaction time is generally between 0.5 and 24 hours.

After completion of the reaction, the reaction mixture is extracted with an organic solvent, and the organic layer is then subjected to a post-treatment such as drying or concentration, so as to isolate the compound (5-b). The isolated compound (5-b) can be further purified by chromatography, recrystallization, etc.

After completion of this reaction, an oxidation reaction known to a person skilled in the art may be further carried out, so that —SR⁸ can be converted to —S(O)ₘ₁R⁸ wherein m1 is 1 or 2.

### Production Method 7

A compound (5-c), i.e., a compound of the formula (1) wherein n is 0 and R³ is —NR⁸R⁹, can be produced by reacting the compound (8) with a compound (11) in the presence of a base,

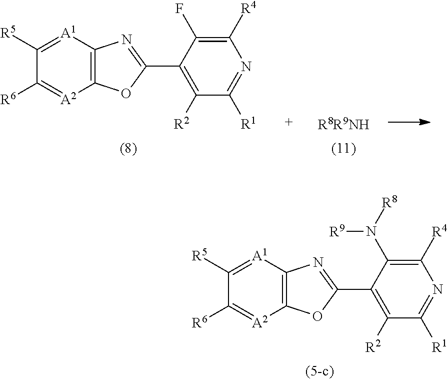

wherein R¹, R², R⁴, R⁵, R⁶, R⁸, R⁹, A¹, and A² have the same meaning as defined above.

This reaction is generally carried out in the presence of a solvent.

Examples of the solvent include: ethers such as THF, ethylene glycol dimethyl ether, or 1,4-dioxane; aromatic hydrocarbons such as toluene or xylene; nitriles such as acetonitrile; acid amides such as DMF; sulfoxides such as DMSO; and the mixtures thereof.

Examples of the base include: alkali metal hydrides such as sodium hydride; and carbonates such as potassium carbonate.

The compound (11) is generally used at a ratio of 1 to 10 moles, and the base is generally used at a ratio of 1 to 10 moles, relative to 1 mole of the compound (8).

The reaction temperature applied to the reaction is generally between 0° C. and 100° C., and the reaction time is generally between 0.1 and 24 hours.

After completion of the reaction, the reaction mixture is extracted with an organic solvent, and the organic layer is then subjected to a post-treatment such as drying or concentration, so as to isolate the compound (5-c). The isolated compound (5-c) can be further purified by chromatography, recrystallization, etc.

### Production Method 8

A compound (5-d), i.e., a compound of the formula (1) wherein n is 0 and R³ is —NR⁸COR⁹, can be produced by reacting a compound (12) with an acid anhydride represented by a formula (13) or an acid chloride represented by a formula (14),

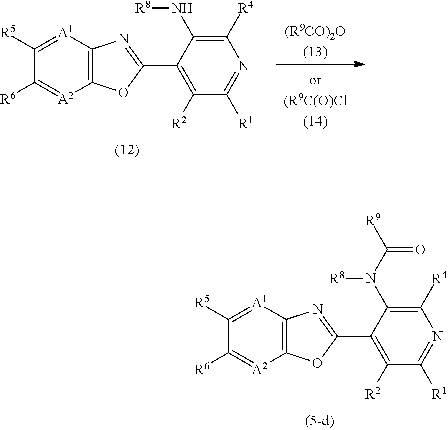

wherein R¹, R², R⁴, R⁵, R⁶, R⁸, R⁹, A¹, and A² have the same meaning as defined above.

This reaction is generally carried out in the presence of a solvent.

Examples of the solvent include: ethers such as THF, ethylene glycol dimethyl ether, or 1,4-dioxane; aromatic hydrocarbons such as toluene or xylene; nitriles such as acetonitrile; acid amides such as DMF; sulfoxides such as DMSO; nitrogen-containing aromatic compounds such as pyridine or quinoline; and the mixtures thereof. When the reaction is the reaction of the compound (12) with the compound (13), the compound (13) may be used in a solvent amount, instead of the above exemplified solvents.

The reaction may also be carried out in the presence of a base, as necessary.

Examples of the base include: alkali metal hydrides such as sodium hydride; carbonates such as potassium carbonate; tertiary amines such as triethylamine or diisopropylethylamine; and nitrogen-containing aromatic compounds such as pyridine or 4-dimethylaminopyridine.

The compound (13) or the compound (14) is generally used at a ratio of 1 to 10 moles relative to 1 mole of the compound (12). When the reaction is carried out in the presence of a base, the base is generally used at a ratio of 1 to 10 moles relative to 1 mole of the compound (12).

The reaction temperature applied to the reaction is generally between 0° C. and 120° C., and the reaction time is generally between 0.1 and 24 hours.

After completion of the reaction, the reaction mixture is extracted with an organic solvent, and the organic layer is then subjected to a post-treatment such as drying or concentration, so as to isolate the compound (5-d). The isolated compound (5-d) can be further purified by chromatography, recrystallization, etc.

### Production Method 9

A compound (5-e), i.e., a compound of the formula (1) wherein n is 0 and R³ is —R^{3x} as shown below, can be produced by reacting a compound (15) with a boronic acid compound represented by a formula (16) or a tin compound represented by a formula (17) in the presence of a palladium compound,

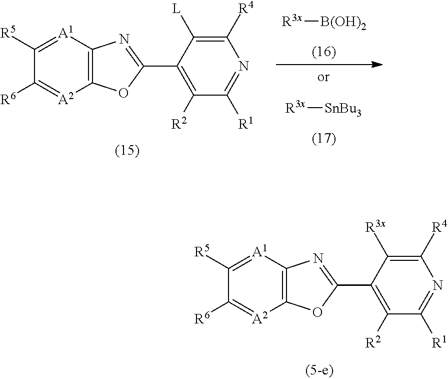

wherein R¹, R², R⁴, R⁵, R⁶, A¹, and A² have the same meaning as defined above, L represents a bromine atom or an iodine atom, and

R^{3x} represents a phenyl group optionally substituted with one or more members selected from Group Y, or a 5-membered aromatic heterocyclic group or 6-membered aromatic heterocyclic group optionally substituted with one or more members selected from Group Y wherein the aromatic heterocyclic group is limited to an aromatic heterocyclic group that binds to a pyridine ring on a carbon atom.

This reaction is generally carried out in the presence of a solvent.

Examples of the solvent include: ethers such as THF, ethylene glycol dimethyl ether, or 1,4-dioxane; alcohols such as methanol or ethanol; aliphatic hydrocarbons such as hexane, heptane, or octane; aromatic hydrocarbons such as toluene or xylene; acid amides such as DMF; water; and the mixtures thereof.

Examples of the palladium compound include palladium acetate, tetrakistriphenylphosphine palladium, a {1,1′-bis(diphenylphosphino)ferrocene}dichloropalladium dichloromethane complex, and dichlorobis(triphenylphosphine)palladium(II).

The compound (16) or the compound (17) is generally used at a ratio of 0.5 to 5 moles, and the palladium compound is generally used at a ratio of 0.001 to 0.1 mole, relative to 1 mole of the compound (15).

The reaction may also be carried out in the presence of a base and/or a phase transfer catalyst, as necessary.

Examples of the base include inorganic salts such as sodium acetate, potassium acetate, potassium carbonate, tripotassium phosphate, or sodium bicarbonate.

Examples of the phase transfer catalyst include quaternary ammonium salts such as tetrabutylammonium bromide or benzyltriethylammonium bromide.

The amount of the base or phase transfer catalyst may be selected, as appropriate, depending on the type of a compound used, and the like.

The reaction temperature applied to the reaction is generally between 50° C. and 120° C., and the reaction time is generally between 0.5 and 24 hours.

After completion of the reaction, the reaction mixture is extracted with an organic solvent, and the organic layer is then subjected to a post-treatment such as drying or concentration, so as to isolate the compound (5-e). The isolated compound (5-e) can be further purified by chromatography, recrystallization, etc.

### Production Method 10

A compound (5-f), i.e., a compound of the formula (1) wherein n is 0 R³ is R^{3y} as shown below, can be produced by reacting the compound (8) with a compound (18) in the presence of a base,

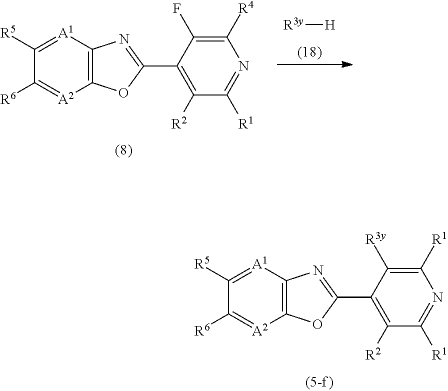

wherein R¹, R², R⁴, R⁵, R⁶, A₁, and A² have the same meaning as defined above, and

R^{3y} represents a 5- or 6-membered heterocyclic group optionally substituted with one or more members selected from Group Y wherein the heterocyclic group is limited to a heterocyclic group that binds to a pyridine ring on a nitrogen atom.

This reaction is generally carried out in the presence of a solvent.

Examples of the solvent include: ethers such as THF, ethylene glycol dimethyl ether, or 1,4-dioxane; aromatic hydrocarbons such as toluene or xylene; nitriles such as acetonitrile; acid amides such as DMF; sulfoxides such as DMSO; and the mixtures thereof.

Examples of the base include: alkali metal hydrides such as sodium hydride; and carbonates such as potassium carbonate.

The compound (18) is generally used at a ratio of 1 to 10 moles, and the base is generally used at a ratio of 1 to 10 moles, relative to 1 mole of the compound (8).

The reaction temperature applied to the reaction is generally between 0° C. and 150° C., and the reaction time is generally between 0.1 and 24 hours.

After completion of this reaction, known reactions such as a hydrogenation reaction, an oxidation reaction, a reduction reaction, and a hydrolysis reaction may be further carried out to convert R^{3y} arbitrarily.

After completion of the reaction, the reaction mixture is extracted with an organic solvent, and the organic layer is then subjected to a post-treatment such as drying or concentration, so as to isolate the compound (5-f). The isolated compound (5-f) can be further purified by chromatography, recrystallization, etc.

### Production Method 11

A compound (19), i.e., a compound of the formula (1) wherein n is 1, can be produced by reacting the compound (5) in the presence of an oxidizer,

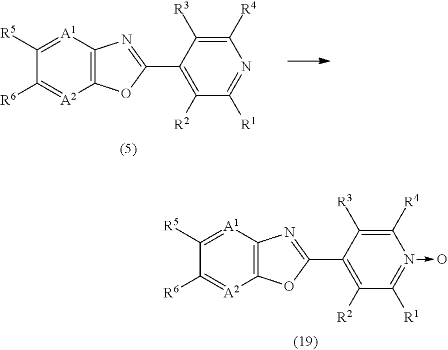

wherein R¹, R², R³, R⁴, R⁵, R⁶, A₁, and A² have the same meaning as defined above.

This reaction is generally carried out in the presence of a solvent.

Examples of the solvent include: aliphatic halogenated hydrocarbons such as dichloromethane or chloroform; acetic acids, water; and the mixtures thereof.

Examples of the oxidizer include: peroxycarboxylic acids, such as 3-chloroperbenzoic acid; and a hydrogen peroxide solution.

Such oxidizer is generally used at a ratio of 1 to 3 moles relative to 1 mole of the compound (5).

The reaction temperature applied to the reaction is generally between −20° C. and +100° C., and the reaction time is generally between 0.1 and 24 hours.

After completion of the reaction, the reaction mixture is extracted with an organic solvent. Thereafter, the organic layer is washed with an aqueous solution of a reducing agent and an aqueous solution of a base, as necessary, and it is then subjected to a post-treatment such as drying or concentration, so as to isolate the compound (19). The isolated compound (19) can be further purified by chromatography, recrystallization, etc.

Examples of the reducing agent include sodium sulfite and sodium thiosulfate. An example of the base is sodium bicarbonate.

### Production Method 12

A compound (5-a), i.e., a compound of the formula (1) wherein n is 0 R³ is —OR⁸, can be produced by reacting a compound (20) with a compound (21) in the presence of a base,

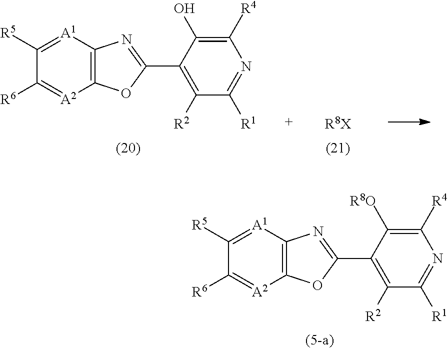

wherein R¹, R², R⁴, R⁵, R⁶, R⁸, A¹, and A² have the same meaning as defined above, and X represents a leaving group such as a chlorine atom, a bromine atom, an iodine atom, —OS(O)₂CF₃ and —OS(O)₂CH₃.

This reaction is generally carried out in the presence of a solvent.

Examples of the solvent include: ethers such as THF, ethylene glycol dimethyl ether, or 1,4-dioxane; aromatic hydrocarbons such as toluene or xylene; nitriles such as acetonitrile; acid amides such as DMF, sulfoxides such as DMSO; and the mixtures thereof.

Examples of the base include: alkali metal hydrides such as sodium hydride; and carbonates such as potassium carbonate.

The compound (21) is generally used at a ratio of 1 to 10 moles, and the base is generally used at a ratio of 1 to 10 moles, relative to 1 mole of the compound (20).

The reaction temperature applied to the reaction is generally between 0° C. and 120° C., and the reaction time is generally between 0.5 and 24 hours.

After completion of this reaction, known reactions such as a hydrogenation reaction, an oxidation reaction, and a reduction reaction, may be further carried out to convert R⁸ arbitrarily.

After completion of the reaction, the reaction mixture is extracted with an organic solvent. Thereafter, the organic layer is subjected to a post-treatment such as drying or concentration, so as to isolate the compound (5-a). The isolated compound (5-a) can be further purified by chromatography, recrystallization, etc.

### Production Method 13

A compound represented by the formula (5-g) can be produced by reacting the compound (15) with a compound (22) in the presence of a palladium compound, a base, and a copper salt,

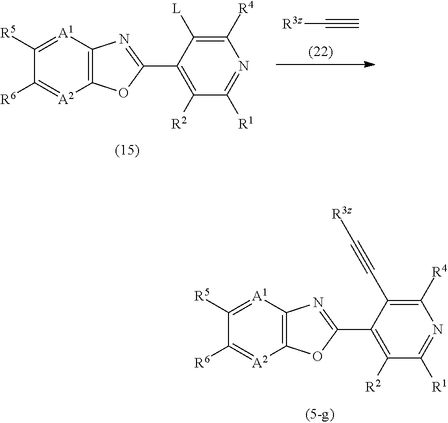

wherein R¹, R², R⁴, R⁵, R⁶, A¹, A², and L have the same meaning as defined above, and R^{3z} represents a C1-C4 acyclic hydrocarbon group optionally substituted with one or more members selected from Group X.

This reaction is generally carried out using a base as a solvent. An auxiliary solvent may also be used.

Examples of the base include amines such as triethylamine, diethylamine, or diisopropylethylamine.

Examples of the auxiliary solvent include: ethers such as THF, ethylene glycol dimethyl ether, or 1,4-dioxane; acid amides such as DMF; and the mixtures thereof.

Examples of the palladium compound include tetrakistriphenylphosphine palladium, a {1,1′-bis(diphenylphosphino)ferrocene}dichloropalladium dichloromethane complex, and dichlorobis(triphenylphosphine)palladium(II).

An example of the copper salt is copper(I) iodide.

The compound (22) is generally used at a ratio of 0.5 to 5 moles, the palladium compound is generally used at a ratio of 0.001 to 0.1 mole, and the copper salt is used at a ratio of 0.001 to 0.1, relative to 1 mole of the compound (15).

In addition to the palladium compound, base, and copper salt, a coordination compound capable of coordinating with the palladium compound may be further used to carry out the reaction.

Examples of the coordination compound include phosphines such as triphenylphosphine or tri(tert-butyl)phosphine.

The reaction temperature applied to the reaction is generally between 0° C. and 100° C., and the reaction time is generally between 0.5 and 24 hours.

After completion of the reaction, the reaction mixture is extracted with an organic solvent. Thereafter, the organic layer is subjected to a post-treatment such as drying or concentration, so as to isolate the compound (5-g). The isolated compound (5-g) can be further purified by chromatography, recrystallization, etc.

After completion of this reaction, known reactions such as a hydrogenation reaction, an oxidation reaction, a reduction reaction, and a hydrolysis reaction may be further carried out, so as to arbitrarily convert R^{3z}, and a triple bond that binds the R^{3z} with a pyridine ring.

A compound (23), wherein, in a formula (22), R^{3z} is a trimethylsilyl group, is reacted with the compound (15) in the presence of a palladium compound, a base, and a copper salt. A known desilylation reaction is further carried out on the compound obtained from the reaction, so as to obtain a compound (5-g1), wherein, in a formula (5-g), R^{3z} is a hydrogen atom. The compound (5g-1) is subjected to a known reaction such as a hydrogenation reaction, so as to convert the triple bond arbitrarily.

### Production Method 14

A compound (5-h), i.e., a compound of the formula (1) wherein n is 0 R³ is a cyano group, can be produced by reacting the compound (15) with a metal cyanide,

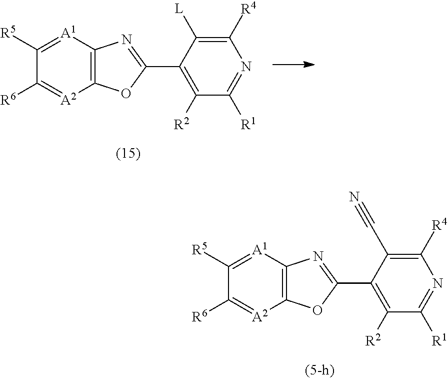

wherein R¹, R², R⁴, R⁵, R⁶, A¹, A², and L have the same meaning as defined above.

This reaction is generally carried out in the presence of a solvent.

Examples of the solvent include: ethers such as THF, ethylene glycol dimethyl ether, or 1,4-dioxane; acid amides such as DMF or 1-methyl-2-pyrrolidinone; sulfoxides such as DMSO; and the mixtures thereof.

An example of the metal cyanide is copper(I) cyanide.

Such metal cyanide is generally used at a ratio of 1 to 5 moles relative to 1 mole of the compound (15).

The reaction temperature applied to the reaction is generally between 50° C. and 200° C., and the reaction time is generally between 0.5 and 24 hours.

After completion of the reaction, the reaction mixture is extracted with an organic solvent. Thereafter, the organic layer is subjected to a post-treatment such as drying or concentration, so as to isolate the compound (5-h). The isolated compound (5-h) can be further purified by chromatography, recrystallization, etc.

An intermediate used in the production of the present active compound is commercially available, or is disclosed in known publications, or can be produced according to a method known to a person skilled in the art.

The intermediate of the present invention can be produced, for example, by the following methods.

### Intermediate Production Method 1

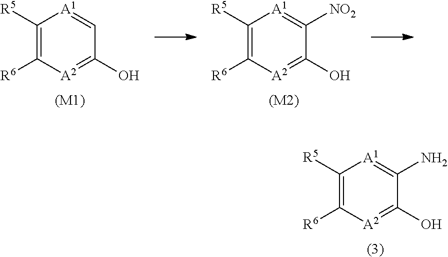

wherein R⁵, R⁶, A¹, and A² have the same meaning as defined above.

### (Step 1)

The compound (M2) can be produced by reacting the compound (M1) in the presence of a nitrating agent.

This reaction is generally carried out in the presence of a solvent.

Examples of the solvent include: aliphatic halogenated hydrocarbons such as chloroform; acetic acid; concentrated sulfuric acid; concentrated nitric acid; water; and the mixtures thereof.

An example of the nitrating agent is concentrated nitric acid.

Such nitrating agent is generally used at a ratio of 1 to 3 moles relative to 1 mole of the compound (M1).

The reaction temperature applied to the reaction is generally between −10° C. and +80° C., and the reaction time is generally between 0.1 and 24 hours.

After completion of the reaction, the reaction mixture is added to water, and it is then extracted with an organic solvent. Thereafter, the organic layer is subjected to a post-treatment such as drying or concentration, so as to isolate the compound (M2). The isolated compound (M2) can be further purified by chromatography, recrystallization, etc.

### (Step 2)

The compound (3) can be produced by reacting the compound (M2) with hydrogen in the presence of a catalyst for hydrogenation.

This reaction is generally carried out in a hydrogen atmosphere under 1 to 100 atmospheric pressures in the presence of a solvent.

Examples of the solvent used in the reaction include: ethers such as THF or 1,4-dioxane; esters such as ethyl acetate or butyl acetate; alcohols such as methanol or ethanol; water; and the mixtures thereof.

Examples of the catalyst for hydrogenation include transition metal compounds such as palladium on carbon, palladium hydroxide, Raney nickel, or platinum oxide.

The hydrogen is generally used at a ratio of 3 moles, and the catalyst for hydrogenation is generally used at a ratio of 0.001 to 0.5 moles, relative to 1 mole of the compound (M2).

An acid, a base, and the like may be added, as necessary, to carry out the reaction.

The reaction temperature applied to the reaction is generally between −20° C. and +100° C., and the reaction time is generally between 0.1 and 24 hours.

After completion of the reaction, the reaction mixture is filtrated, and it is then extracted with an organic solvent, as necessary. Thereafter, the organic layer is subjected to a post-treatment such as drying or concentration, so as to isolate the compound (3). The isolated compound (3) can be further purified by chromatography, recrystallization, etc.

### Intermediate Production Method 2

The compound (6) can be produced by reacting the compound (3) with a compound (M3),

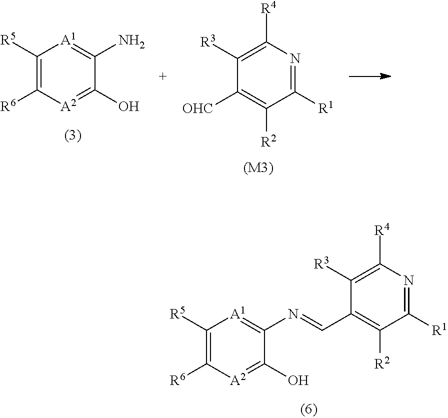

wherein R¹, R², R³, R⁴, R⁵, R⁶, A₁, and A² have the same meaning as defined above.

This reaction is generally carried out in the presence of a solvent.

Examples of the solvent include: alcohols such as methanol or ethanol; ethers such as THF, ethylene glycol dimethyl ether, or 1,4-dioxane; aromatic hydrocarbons such as toluene; and the mixtures thereof.

The compound (M3) is generally used at a ratio of 0.5 to 3 moles relative to 1 mole of the compound (3).

An acid, a base, and the like may be added, as necessary, to carry out the reaction.

The reaction temperature applied to the reaction is generally between 0° C. and 150° C., and the reaction time is generally between 0.1 and 24 hours.

After completion of the reaction, the reaction mixture is extracted with an organic solvent. Thereafter, the organic layer is subjected to a post-treatment such as drying or concentration, so as to isolate the compound (6). The isolated compound (6) can be further purified by chromatography, recrystallization, etc.

### Intermediate Production Method 3

The compound (7) can be produced by reacting the compound (3) with the compound (4) in the presence of a dehydration-condensation agent,

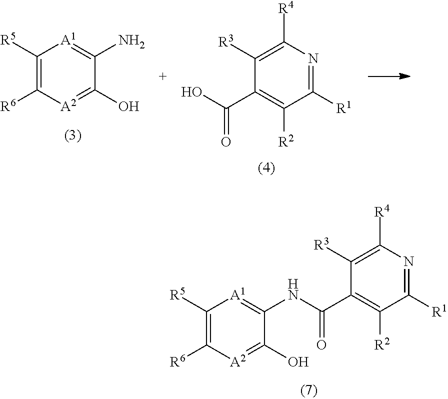

wherein R¹, R², R³, R⁴, R⁵, R⁶, A¹, and A² have the same meaning as defined above.

This reaction is generally carried out in the presence of a solvent.

Examples of the solvent include: ethers such as THF, ethylene glycol dimethyl ether, or 1,4-dioxane; aliphatic hydrocarbons such as hexane, heptane, or octane; aromatic hydrocarbons such as toluene or xylene; halogenated hydrocarbons such as chlorobenzene; esters such as ethyl acetate or butyl acetate; nitriles such as acetonitrile; acid amides such as DMF; sulfoxides such as DMSO; nitrogen-containing aromatic compounds such as pyridine or quinoline; and the mixtures thereof.

Examples of the dehydration-condensation agent include: carbodiimides such as 1-ethyl-3-(3-dimethylaminopropyl)carbodiimide hydrochloride (hereinafter referred to as WSC) or 1,3-dicyclohexylcarbodiimide; and (benzotriazol-1-yl-oxy)tris(dimethylamino)phosphonium hexafluorophosphate (hereinafter referred to as a BOP reagent).

The compound (4) is generally used at a ratio of 1 to 3 moles, and the dehydration-condensation agent is generally used at a ratio of 1 to 5 moles, relative to 1 mole of the compound (3).

The reaction temperature applied to the reaction is generally between 0° C. and 140° C., and the reaction time is generally between 0.1 and 24 hours.

After completion of the reaction, water is added to the reaction mixture, and it is then extracted with an organic solvent. Thereafter, the organic layer is subjected to a post-treatment such as drying or concentration, so as to isolate the compound (7). The isolated compound (7) can be further purified by chromatography, recrystallization, etc.

### Intermediate Production Method 4

The compound (7) can be produced by reacting the compound (3) with a compound (M4) in the presence of a base,

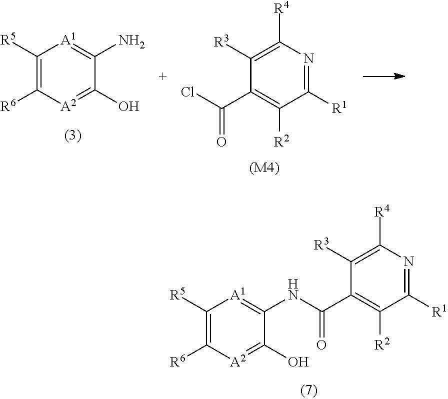

wherein R¹, R², R³, R⁴, R⁵, R⁶, A¹, and A² have the same meaning as defined above.

This reaction is generally carried out in the presence of a solvent.

Examples of the solvent include: ethers such as THF, ethylene glycol dimethyl ether, or 1,4-dioxane; aliphatic hydrocarbons such as hexane, heptane, or octane; aromatic hydrocarbons such as toluene or xylene; halogenated hydrocarbons such as chlorobenzene; esters such as ethyl acetate or butyl acetate; nitriles such as acetonitrile; acid amides such as DMF; sulfoxides such as DMSO; and the mixtures thereof.

Examples of the base include: alkali metal carbonates such as sodium carbonate or potassium carbonate; tertiary amines such as triethylamine or diisopropylethylamine; and nitrogen-containing aromatic compounds such as pyridine or 4-dimethylaminopyridine.

The compound (M4) is generally used at a ratio of 1 to 3 moles, and the base is generally used at a ratio of 1 to 10 moles, relative to 1 mole of the compound (3).

The reaction temperature applied to the reaction is generally between −20° C. and +100° C., and the reaction time is generally between 0.1 and 24 hours.

After completion of the reaction, water is added to the reaction mixture, and it is then extracted with an organic solvent. Thereafter, the organic layer is subjected to a post-treatment such as drying or concentration, so as to isolate the compound (7). The isolated compound (7) can be further purified by chromatography, recrystallization, etc.

### Intermediate Production Method 5

A compound (4-a), wherein, in a formula (4), R¹, R², and R⁴ represent a hydrogen atom, and R³ represents the following —R^{3p}, can be produced by a method as shown in the following scheme,

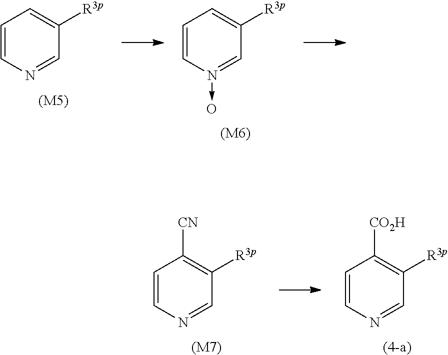

wherein R^{3p} represents a C1-C6 acyclic hydrocarbon group optionally substituted with one or more members selected from Group X, and a C3-C6 alicyclic hydrocarbon group optionally substituted with one or more members selected from Group X, and Group X has the same meaning as defined above.

### (Step 1)

The compound (M6) can be produced by reacting the compound (M5) in the presence of an oxidizer.

This reaction is generally carried out in the presence of a solvent.

Examples of the solvent include: aliphatic halogenated hydrocarbons such as dichloromethane or chloroform; acetic acid; water; and the mixtures thereof.

Example of the oxidizer include peroxycarboxylic acids, such as 3-chloroperbenzoic acid; and a hydrogen peroxide solution.

Such oxidizer is generally used at a ratio of 1 to 10 moles relative to 1 mole of the compound (M5).

The reaction temperature applied to the reaction is generally between −20° C. and +120° C., and the reaction time is generally between 0.1 and 24 hours.

After completion of the reaction, a base is added to the reaction mixture, as necessary, to neutralize it. Thereafter, the reaction mixture is extracted with an organic solvent, and the organic layer is then washed with an aqueous solution of a reducing agent and an aqueous solution of a base, as necessary, followed by a post-treatment such as drying or concentration, so as to isolate the compound (M6). The isolated compound (M6) can be further purified by chromatography, distillation, etc.

Examples of the base include alkali metal carbonates such as sodium carbonate, sodium bicarbonate, or potassium carbonate. Examples of the reducing agent include sodium sulfite, sodium hydrogen sulfite, and sodium thiosulfate

### (Step 2)

The compound (M7) can be produced by reacting the compound (M6) in the presence of an alkylating agent and a cyaniding agent.

This reaction is generally carried out in the presence of a solvent.

Examples of the solvent include: ethers such as 1,4-dioxane; water; and the mixtures thereof.

Examples of the alkylating agent include iodomethane, iodoethane, and dimethyl sulfate.

Examples of the cyaniding agent include sodium cyanide and potassium cyanide.

The alkylating agent is generally used at a ratio of 1 to 10 moles, and the cyaniding agent is generally used at a ratio of 1 to 3 moles, relative to 1 mole of the compound (M6).

The reaction temperature applied to the reaction is generally between 0° C. and 100° C., and the reaction time is generally between 0.1 and 24 hours.

After completion of the reaction, the reaction mixture is extracted with an organic solvent. Thereafter, the organic layer is subjected to a post-treatment such as drying or concentration, so as to isolate the compound (M7). The isolated compound (M7) can be further purified by chromatography, recrystallization, etc.

### (Step 3)

The compound (4-a) can be produced by subjecting the compound (M7) to a hydrolysis reaction in the presence of a base.

This reaction is generally carried out in the presence of a solvent.

Examples of the solvent include: ethers such as THF, ethylene glycol dimethyl ether, tert-butyl methyl ether, or 1,4-dioxane; alcohols such as methanol or ethanol; water; and the mixtures thereof.

Examples of the base include alkali metal hydroxides such as sodium hydroxide or potassium hydroxide.

Such base is generally used at a ratio of 1 to 10 moles relative to 1 mole of the compound (M7).

The reaction temperature applied to the reaction is generally between 0° C. and 120° C., and the reaction time is generally between 0.1 and 24 hours.

After completion of the reaction, the reaction solution is converted to an acidic solution, and the reaction mixture is then extracted with an organic solvent. Thereafter, the organic layer is subjected to a post-treatment such as drying or concentration, so as to isolate the compound (4-a). The isolated compound (4-a) can be further purified by chromatography, recrystallization, etc.

### Intermediate Production Method 6

A compound (4-b), wherein, in the formula (4), R³ represents the following —OR⁸, can be produced by a method as shown in the following scheme,

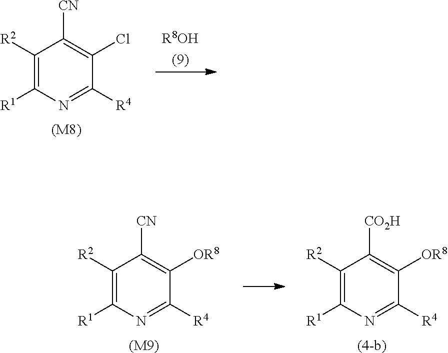

wherein R¹, R², R⁴, and R⁸ have the same meaning as defined above.

### (Step 1)

The compound (M9) can be produced by reacting the compound (M8) with the compound (9) in the presence of a base.

This reaction is generally carried out in the presence of a solvent.

Examples of the solvent include: ethers such as THF, ethylene glycol dimethyl ether, or 1,4-dioxane; aromatic hydrocarbons such as toluene or xylene; nitriles such as acetonitrile; acid amides such as DMF; sulfoxides such as DMSO; and the mixtures thereof.

Example of the base include alkali metal hydrides such as sodium hydride.

The compound (9) is generally used at a ratio of 1 to 10 moles, and the base is generally used at a ratio of 1 to 10 moles, relative to 1 mole of the compound (M8).

The reaction temperature applied to the reaction is generally between −20° C. and +100° C., and the reaction time is generally between 0.5 and 24 hours.

After completion of this reaction, known reactions such as a hydrogenation reaction, an oxidation reaction, and a reduction reaction may be further carried out to convert R⁸ arbitrarily.

After completion of the reaction, the reaction mixture is extracted with an organic solvent, and the organic layer is then subjected to a post-treatment such as drying or concentration, so as to isolate the compound (M9). The isolated compound (M9) can be further purified by chromatography, recrystallization, etc.

### (Step 2)

The compound (4-b) can be produced by subjecting the compound (M9) to a hydrolysis reaction in the presence of a base.

This reaction is generally carried out in the presence of a solvent.

Examples of the solvent include: ethers such as THF, ethylene glycol dimethyl ether, tert-butyl methyl ether, or 1,4-dioxane; alcohols such as methanol or ethanol; water; and the mixtures thereof.

Examples of the base include alkali metal hydroxides such as sodium hydroxide or potassium hydroxide.

Such base is generally used at a ratio of 1 to 10 moles relative to 1 mole of the compound (M9).

The reaction temperature applied to the reaction is generally between 0° C. and 120° C., and the reaction time is generally between 0.1 and 24 hours.

After completion of the reaction, the reaction solution is converted to an acidic solution, and the reaction mixture is then extracted with an organic solvent. Thereafter, the organic layer is subjected to a post-treatment such as drying or concentration, so as to isolate the compound (4-b). The isolated compound (4-b) can be further purified by chromatography, recrystallization, etc.

### Intermediate Production Method 7

A compound (4-c), wherein, in the formula (4), R³ represents the following —SR⁸, can be produced by a method as shown in the following scheme,

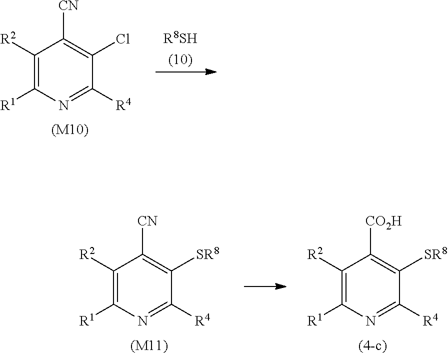

wherein R¹, R², R⁴, and R⁸ have the same meaning as defined above.

### (Step 1)

The compound (M11) can be produced by reacting the compound (M10) with the compound (10) in the presence of a base.

This reaction is generally carried out in the presence of a solvent.

Examples of the solvent include: ethers such as THF, ethylene glycol dimethyl ether, or 1,4-dioxane; aromatic hydrocarbons such as toluene or xylene; nitriles such as acetonitrile; acid amides such as DMF; sulfoxides such as DMSO; and the mixtures thereof.

Example of the base include: alkali metal hydrides such as sodium hydride; and carbonates such as potassium carbonate.

The compound (10) is generally used at a ratio of 1 to 10 moles, and the base is generally used at a ratio of 1 to 10 moles, relative to 1 mole of the compound (M10).

The reaction temperature applied to the reaction is generally between −20° C. and +100° C., and the reaction time is generally between 0.5 and 24 hours.

After completion of the reaction, the reaction mixture is extracted with an organic solvent, and the organic layer is then subjected to a post-treatment such as drying or concentration, so as to isolate the compound (M11). The isolated compound (M11) can be further purified by chromatography, recrystallization, etc.

### (Step 2)

The compound (4-c) can be produced by subjecting the compound (M11) to a hydrolysis reaction in the presence of a base.

This reaction is generally carried out in the presence of a solvent.

Examples of the solvent include: ethers such as THF, ethylene glycol dimethyl ether, tert-butyl methyl ether, or 1,4-dioxane; alcohols such as methanol or ethanol; water; and the mixtures thereof.

Examples of the base include alkali metal hydroxides such as sodium hydroxide or potassium hydroxide.

Such base is generally used at a ratio of 1 to 10 moles relative to 1 mole of the compound (M11). The reaction temperature applied to the reaction is generally between 0° C. and 120° C., and the reaction time is generally between 0.1 and 24 hours.

After completion of the reaction, the reaction solution is converted to an acidic solution, and the reaction mixture is then extracted with an organic solvent. Thereafter, the organic layer is subjected to a post-treatment such as drying or concentration, so as to isolate the compound (4-c). The isolated compound (4-c) can be further purified by chromatography, recrystallization, etc.

Specific examples of the present active compound will be given below.

In the following tables, Me represents a methyl group, Et represents an ethyl group, Pr represents a propyl group, iPr represents an isopropyl group, tBu represents a tert-butyl group, Ph represents a phenyl group, 2-Py represents a 2-pyridyl group, 3-Py represents a 3-pyridyl group, 4-Py represents a 4-pyridyl group, 1-Tz represents a 1,2,4-triazol-1-yl group, and 1-Pz represents a pyrazol-1-yl group.

The compound represented by the following formula (1-A):

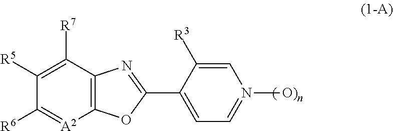

In the above formula (1-A), substituents used for R³, R⁵, R⁶, R⁷, A², and n are available in the combinations shown in the following Table 1 to Table 35.

TABLE 1

| R³ | R⁵ | R⁶ | R⁷ | A² | n |
|---|---|---|---|---|---|
| H | tBu | H | H | ═C(H)— | 0 |
| F | tBu | H | H | ═C(H)— | 0 |
| Cl | tBu | H | H | ═C(H)— | 0 |
| Br | tBu | H | H | ═C(H)— | 0 |
| I | tBu | H | H | ═C(H)— | 0 |
| Me | tBu | H | H | ═C(H)— | 0 |
| Et | tBu | H | H | ═C(H)— | 0 |
| Pr | tBu | H | H | ═C(H)— | 0 |
| MeO | tBu | H | H | ═C(H)— | 0 |
| EtO | tBu | H | H | ═C(H)— | 0 |
| PrO | tBu | H | H | ═C(H)— | 0 |
| CF₃CH₂O | tBu | H | H | ═C(H)— | 0 |
| iPrO | tBu | H | H | ═C(H)— | 0 |
| MeS | tBu | H | H | ═C(H)— | 0 |
| EtS | tBu | H | H | ═C(H)— | 0 |
| PrS | tBu | H | H | ═C(H)— | 0 |
| CF₃CH₂S | tBu | H | H | ═C(H)— | 0 |
| iPrS | tBu | H | H | ═C(H)— | 0 |
| Ph | tBu | H | H | ═C(H)— | 0 |
| 2-Py | tBu | H | H | ═C(H)— | 0 |
| 3-Py | tBu | H | H | ═C(H)— | 0 |
| 4-Py | tBu | H | H | ═C(H)— | 0 |
| 1-Tz | tBu | H | H | ═C(H)— | 0 |
| 1-Pz | tBu | H | H | ═C(H)— | 0 |

TABLE 2

| R³ | R⁵ | R⁶ | R⁷ | A² | n |
|---|---|---|---|---|---|
| H | tBu | H | H | ═C(H)— | 1 |
| Cl | tBu | H | H | ═C(H)— | 1 |
| Br | tBu | H | H | ═C(H)— | 1 |
| I | tBu | H | H | ═C(H)— | 1 |
| Me | tBu | H | H | ═C(H)— | 1 |
| Et | tBu | H | H | ═C(H)— | 1 |
| Pr | tBu | H | H | ═C(H)— | 1 |
| MeO | tBu | H | H | ═C(H)— | 1 |
| EtO | tBu | H | H | ═C(H)— | 1 |
| PrO | tBu | H | H | ═C(H)— | 1 |
| CF₃CH₂O | tBu | H | H | ═C(H)— | 1 |
| iPrO | tBu | H | H | ═C(H)— | 1 |
| Ph | tBu | H | H | ═C(H)— | 1 |
| H | CF₃ | H | H | ═C(H)— | 0 |
| F | CF₃ | H | H | ═C(H)— | 0 |
| Cl | CF₃ | H | H | ═C(H)— | 0 |
| Br | CF₃ | H | H | ═C(H)— | 0 |
| I | CF₃ | H | H | ═C(H)— | 0 |
| Me | CF₃ | H | H | ═C(H)— | 0 |
| Et | CF₃ | H | H | ═C(H)— | 0 |
| Pr | CF₃ | H | H | ═C(H)— | 0 |
| MeO | CF₃ | H | H | ═C(H)— | 0 |
| EtO | CF₃ | H | H | ═C(H)— | 0 |
| PrO | CF₃ | H | H | ═C(H)— | 0 |

TABLE 3

| R³ | R⁵ | R⁶ | R⁷ | A² | n |
|---|---|---|---|---|---|
| CF₃CH₂O | CF₃ | H | H | ═C(H)— | 0 |
| iPrO | CF₃ | H | H | ═C(H)— | 0 |
| MeS | CF₃ | H | H | ═C(H)— | 0 |
| EtS | CF₃ | H | H | ═C(H)— | 0 |
| PrS | CF₃ | H | H | ═C(H)— | 0 |
| CF₃CH₂S | CF₃ | H | H | ═C(H)— | 0 |
| iPrS | CF₃ | H | H | ═C(H)— | 0 |
| Ph | CF₃ | H | H | ═C(H)— | 0 |
| 2-Py | CF₃ | H | H | ═C(H)— | 0 |
| 3-Py | CF₃ | H | H | ═C(H)— | 0 |
| 4-Py | CF₃ | H | H | ═C(H)— | 0 |
| 1-Tz | CF₃ | H | H | ═C(H)— | 0 |
| 1-Pz | CF₃ | H | H | ═C(H)— | 0 |
| H | CF₃ | H | H | ═C(H)— | 1 |
| Cl | CF₃ | H | H | ═C(H)— | 1 |
| Br | CF₃ | H | H | ═C(H)— | 1 |
| I | CF₃ | H | H | ═C(H)— | 1 |
| Me | CF₃ | H | H | ═C(H)— | 1 |
| Et | CF₃ | H | H | ═C(H)— | 1 |
| Pr | CF₃ | H | H | ═C(H)— | 1 |
| MeO | CF₃ | H | H | ═C(H)— | 1 |
| EtO | CF₃ | H | H | ═C(H)— | 1 |
| PrO | CF₃ | H | H | ═C(H)— | 1 |
| CF₃CH₂O | CF₃ | H | H | ═C(H)— | 1 |

TABLE 4

| R³ | R⁵ | R⁶ | R⁷ | A² | n |
|---|---|---|---|---|---|
| iPrO | CF₃ | H | H | ═C(H)— | 1 |
| Ph | CF₃ | H | H | ═C(H)— | 1 |
| H | CF₃ | Cl | H | ═C(H)— | 0 |
| F | CF₃ | Cl | H | ═C(H)— | 0 |
| Cl | CF₃ | Cl | H | ═C(H)— | 0 |
| Br | CF₃ | Cl | H | ═C(H)— | 0 |
| I | CF₃ | Cl | H | ═C(H)— | 0 |
| Me | CF₃ | Cl | H | ═C(H)— | 0 |
| Et | CF₃ | Cl | H | ═C(H)— | 0 |
| Pr | CF₃ | Cl | H | ═C(H)— | 0 |
| MeO | CF₃ | Cl | H | ═C(H)— | 0 |
| EtO | CF₃ | Cl | H | ═C(H)— | 0 |
| PrO | CF₃ | Cl | H | ═C(H)— | 0 |
| CF₃CH₂O | CF₃ | Cl | H | ═C(H)— | 0 |
| iPrO | CF₃ | Cl | H | ═C(H)— | 0 |
| MeS | CF₃ | Cl | H | ═C(H)— | 0 |
| EtS | CF₃ | Cl | H | ═C(H)— | 0 |
| PrS | CF₃ | Cl | H | ═C(H)— | 0 |
| CF₃CH₂S | CF₃ | Cl | H | ═C(H)— | 0 |
| iPrS | CF₃ | Cl | H | ═C(H)— | 0 |
| Ph | CF₃ | Cl | H | ═C(H)— | 0 |
| 2-Py | CF₃ | Cl | H | ═C(H)— | 0 |
| 3-Py | CF₃ | Cl | H | ═C(H)— | 0 |
| 4-Py | CF₃ | Cl | H | ═C(H)— | 0 |

TABLE 5

| R³ | R⁵ | R⁶ | R⁷ | A² | n |
|---|---|---|---|---|---|
| 1-Tz | CF₃ | Cl | H | ═C(H)— | 0 |
| 1-Pz | CF₃ | Cl | H | ═C(H)— | 0 |
| H | CF₃ | Cl | H | ═C(H)— | 1 |
| Cl | CF₃ | Cl | H | ═C(H)— | 1 |
| Br | CF₃ | Cl | H | ═C(H)— | 1 |
| I | CF₃ | Cl | H | ═C(H)— | 1 |
| Me | CF₃ | Cl | H | ═C(H)— | 1 |
| Et | CF₃ | Cl | H | ═C(H)— | 1 |
| Pr | CF₃ | Cl | H | ═C(H)— | 1 |
| MeO | CF₃ | Cl | H | ═C(H)— | 1 |
| EtO | CF₃ | Cl | H | ═C(H)— | 1 |
| PrO | CF₃ | Cl | H | ═C(H)— | 1 |
| CF₃CH₂O | CF₃ | Cl | H | ═C(H)— | 1 |
| iPrO | CF₃ | Cl | H | ═C(H)— | 1 |
| Ph | CF₃ | Cl | H | ═C(H)— | 1 |
| H | CF₃ | H | Cl | ═C(H)— | 0 |
| F | CF₃ | H | Cl | ═C(H)— | 0 |
| Cl | CF₃ | H | Cl | ═C(H)— | 0 |
| Br | CF₃ | H | Cl | ═C(H)— | 0 |
| I | CF₃ | H | Cl | ═C(H)— | 0 |
| Me | CF₃ | H | Cl | ═C(H)— | 0 |
| Et | CF₃ | H | Cl | ═C(H)— | 0 |
| Pr | CF₃ | H | Cl | ═C(H)— | 0 |
| MeO | CF₃ | H | Cl | ═C(H)— | 0 |

TABLE 6

| R³ | R⁵ | R⁶ | R⁷ | A² | n |
|---|---|---|---|---|---|
| EtO | CF₃ | H | Cl | ═C(H)— | 0 |
| PrO | CF₃ | H | Cl | ═C(H)— | 0 |
| CF₃CH₂O | CF₃ | H | Cl | ═C(H)— | 0 |
| iPrO | CF₃ | H | Cl | ═C(H)— | 0 |
| MeS | CF₃ | H | Cl | ═C(H)— | 0 |
| EtS | CF₃ | H | Cl | ═C(H)— | 0 |
| PrS | CF₃ | H | Cl | ═C(H)— | 0 |
| CF₃CH₂S | CF₃ | H | Cl | ═C(H)— | 0 |
| iPrS | CF₃ | H | Cl | ═C(H)— | 0 |
| Ph | CF₃ | H | Cl | ═C(H)— | 0 |
| 2-Py | CF₃ | H | Cl | ═C(H)— | 0 |
| 3-Py | CF₃ | H | Cl | ═C(H)— | 0 |
| 4-Py | CF₃ | H | Cl | ═C(H)— | 0 |
| 1-Tz | CF₃ | H | Cl | ═C(H)— | 0 |
| 1-Pz | CF₃ | H | Cl | ═C(H)— | 0 |
| H | CF₃ | H | Cl | ═C(H)— | 1 |
| Cl | CF₃ | H | Cl | ═C(H)— | 1 |
| Br | CF₃ | H | Cl | ═C(H)— | 1 |
| I | CF₃ | H | Cl | ═C(H)— | 1 |
| Me | CF₃ | H | Cl | ═C(H)— | 1 |
| Et | CF₃ | H | Cl | ═C(H)— | 1 |
| Pr | CF₃ | H | Cl | ═C(H)— | 1 |
| MeO | CF₃ | H | Cl | ═C(H)— | 1 |
| EtO | CF₃ | H | Cl | ═C(H)— | 1 |

TABLE 7

| R³ | R⁵ | R⁶ | R⁷ | A² | n |
|---|---|---|---|---|---|
| PrO | CF₃ | H | Cl | ═C(H)— | 1 |
| CF₃CH₂O | CF₃ | H | Cl | ═C(H)— | 1 |
| iPrO | CF₃ | H | Cl | ═C(H)— | 1 |
| Ph | CF₃ | H | Cl | ═C(H)— | 1 |
| H | CF₃ | H | H | ═N— | 0 |
| F | CF₃ | H | H | ═N— | 0 |
| Cl | CF₃ | H | H | ═N— | 0 |
| Br | CF₃ | H | H | ═N— | 0 |
| I | CF₃ | H | H | ═N— | 0 |
| Me | CF₃ | H | H | ═N— | 0 |
| Et | CF₃ | H | H | ═N— | 0 |
| Pr | CF₃ | H | H | ═N— | 0 |
| MeO | CF₃ | H | H | ═N— | 0 |
| EtO | CF₃ | H | H | ═N— | 0 |
| PrO | CF₃ | H | H | ═N— | 0 |
| CF₃CH₂O | CF₃ | H | H | ═N— | 0 |
| iPrO | CF₃ | H | H | ═N— | 0 |
| MeS | CF₃ | H | H | ═N— | 0 |
| EtS | CF₃ | H | H | ═N— | 0 |
| PrS | CF₃ | H | H | ═N— | 0 |
| CF₃CH₂S | CF₃ | H | H | ═N— | 0 |
| iPrS | CF₃ | H | H | ═N— | 0 |
| Ph | CF₃ | H | H | ═N— | 0 |
| 2-Py | CF₃ | H | H | ═N— | 0 |

TABLE 8

| R³ | R⁵ | R⁶ | R⁷ | A² | n |
|---|---|---|---|---|---|
| 3-Py | CF₃ | H | H | ═N— | 0 |
| 4-Py | CF₃ | H | H | ═N— | 0 |
| 1-Tz | CF₃ | H | H | ═N— | 0 |
| 1-Pz | CF₃ | H | H | ═N— | 0 |
| H | CF₃O | H | H | ═C(H)— | 0 |
| F | CF₃O | H | H | ═C(H)— | 0 |
| Cl | CF₃O | H | H | ═C(H)— | 0 |
| Br | CF₃O | H | H | ═C(H)— | 0 |
| I | CF₃O | H | H | ═C(H)— | 0 |
| Me | CF₃O | H | H | ═C(H)— | 0 |
| Et | CF₃O | H | H | ═C(H)— | 0 |
| Pr | CF₃O | H | H | ═C(H)— | 0 |
| MeO | CF₃O | H | H | ═C(H)— | 0 |
| EtO | CF₃O | H | H | ═C(H)— | 0 |
| PrO | CF₃O | H | H | ═C(H)— | 0 |
| CF₃CH₂O | CF₃O | H | H | ═C(H)— | 0 |
| iPrO | CF₃O | H | H | ═C(H)— | 0 |
| MeS | CF₃O | H | H | ═C(H)— | 0 |
| EtS | CF₃O | H | H | ═C(H)— | 0 |
| PrS | CF₃O | H | H | ═C(H)— | 0 |
| CF₃CH₂S | CF₃O | H | H | ═C(H)— | 0 |
| iPrS | CF₃O | H | H | ═C(H)— | 0 |
| Ph | CF₃O | H | H | ═C(H)— | 0 |
| 2-Py | CF₃O | H | H | ═C(H)— | 0 |

TABLE 9

| R³ | R⁵ | R⁶ | R⁷ | A² | n |
|---|---|---|---|---|---|
| 3-Py | CF₃O | H | H | ═C(H)— | 0 |
| 4-Py | CF₃O | H | H | ═C(H)— | 0 |
| 1-Tz | CF₃O | H | H | ═C(H)— | 0 |
| 1-Pz | CF₃O | H | H | ═C(H)— | 0 |
| H | CF₃O | H | H | ═C(H)— | 1 |
| Cl | CF₃O | H | H | ═C(H)— | 1 |
| Br | CF₃O | H | H | ═C(H)— | 1 |
| I | CF₃O | H | H | ═C(H)— | 1 |
| Me | CF₃O | H | H | ═C(H)— | 1 |
| Et | CF₃O | H | H | ═C(H)— | 1 |
| Pr | CF₃O | H | H | ═C(H)— | 1 |
| MeO | CF₃O | H | H | ═C(H)— | 1 |
| EtO | CF₃O | H | H | ═C(H)— | 1 |
| PrO | CF₃O | H | H | ═C(H)— | 1 |
| CF₃CH₂O | CF₃O | H | H | ═C(H)— | 1 |
| iPrO | CF₃O | H | H | ═C(H)— | 1 |
| Ph | CF₃O | H | H | ═C(H)— | 1 |
| H | CF₃S | H | H | ═C(H)— | 0 |
| F | CF₃S | H | H | ═C(H)— | 0 |
| Cl | CF₃S | H | H | ═C(H)— | 0 |
| Br | CF₃S | H | H | ═C(H)— | 0 |
| I | CF₃S | H | H | ═C(H)— | 0 |
| Me | CF₃S | H | H | ═C(H)— | 0 |
| Et | CF₃S | H | H | ═C(H)— | 0 |

TABLE 10

| R³ | R⁵ | R⁶ | R⁷ | A² | n |
|---|---|---|---|---|---|
| Pr | CF₃S | H | H | ═C(H)— | 0 |
| MeO | CF₃S | H | H | ═C(H)— | 0 |
| EtO | CF₃S | H | H | ═C(H)— | 0 |
| PrO | CF₃S | H | H | ═C(H)— | 0 |
| CF₃CH₂O | CF₃S | H | H | ═C(H)— | 0 |
| iPrO | CF₃S | H | H | ═C(H)— | 0 |
| MeS | CF₃S | H | H | ═C(H)— | 0 |
| EtS | CF₃S | H | H | ═C(H)— | 0 |
| PrS | CF₃S | H | H | ═C(H)— | 0 |
| CF₃CH₂S | CF₃S | H | H | ═C(H)— | 0 |
| iPrS | CF₃S | H | H | ═C(H)— | 0 |
| Ph | CF₃S | H | H | ═C(H)— | 0 |
| 2-Py | CF₃S | H | H | ═C(H)— | 0 |
| 3-Py | CF₃S | H | H | ═C(H)— | 0 |
| 4-Py | CF₃S | H | H | ═C(H)— | 0 |
| 1-Tz | CF₃S | H | H | ═C(H)— | 0 |
| 1-Pz | CF₃S | H | H | ═C(H)— | 0 |
| H | H | tBu | H | ═C(H)— | 0 |
| F | H | tBu | H | ═C(H)— | 0 |
| Cl | H | tBu | H | ═C(H)— | 0 |
| Br | H | tBu | H | ═C(H)— | 0 |
| I | H | tBu | H | ═C(H)— | 0 |
| Me | H | tBu | H | ═C(H)— | 0 |
| Et | H | tBu | H | ═C(H)— | 0 |

TABLE 11

| R³ | R⁵ | R⁶ | R⁷ | A² | n |
|---|---|---|---|---|---|
| Pr | H | tBu | H | ═C(H)— | 0 |
| MeO | H | tBu | H | ═C(H)— | 0 |
| EtO | H | tBu | H | ═C(H)— | 0 |
| PrO | H | tBu | H | ═C(H)— | 0 |
| CF₃CH₂O | H | tBu | H | ═C(H)— | 0 |
| iPrO | H | tBu | H | ═C(H)— | 0 |
| MeS | H | tBu | H | ═C(H)— | 0 |
| EtS | H | tBu | H | ═C(H)— | 0 |
| PrS | H | tBu | H | ═C(H)— | 0 |
| CF₃CH₂S | H | tBu | H | ═C(H)— | 0 |
| iPrS | H | tBu | H | ═C(H)— | 0 |
| Ph | H | tBu | H | ═C(H)— | 0 |
| 2-Py | H | tBu | H | ═C(H)— | 0 |
| 3-Py | H | tBu | H | ═C(H)— | 0 |
| 4-Py | H | tBu | H | ═C(H)— | 0 |
| 1-Tz | H | tBu | H | ═C(H)— | 0 |
| 1-Pz | H | tBu | H | ═C(H)— | 0 |
| H | H | tBu | H | ═C(H)— | 1 |
| Cl | H | tBu | H | ═C(H)— | 1 |
| Br | H | tBu | H | ═C(H)— | 1 |
| I | H | tBu | H | ═C(H)— | 1 |
| Me | H | tBu | H | ═C(H)— | 1 |
| Et | H | tBu | H | ═C(H)— | 1 |
| Pr | H | tBu | H | ═C(H)— | 1 |

TABLE 12

| R³ | R⁵ | R⁶ | R⁷ | A² | n |
|---|---|---|---|---|---|
| MeO | H | tBu | H | ═C(H)— | 1 |
| EtO | H | tBu | H | ═C(H)— | 1 |
| PrO | H | tBu | H | ═C(H)— | 1 |
| CF₃CH₂O | H | tBu | H | ═C(H)— | 1 |
| iPrO | H | tBu | H | ═C(H)— | 1 |
| Ph | H | tBu | H | ═C(H)— | 1 |
| H | H | CF₃ | H | ═C(H)— | 0 |
| F | H | CF₃ | H | ═C(H)— | 0 |
| Cl | H | CF₃ | H | ═C(H)— | 0 |
| Br | H | CF₃ | H | ═C(H)— | 0 |
| I | H | CF₃ | H | ═C(H)— | 0 |
| Me | H | CF₃ | H | ═C(H)— | 0 |
| Et | H | CF₃ | H | ═C(H)— | 0 |
| Pr | H | CF₃ | H | ═C(H)— | 0 |
| MeO | H | CF₃ | H | ═C(H)— | 0 |
| EtO | H | CF₃ | H | ═C(H)— | 0 |
| PrO | H | CF₃ | H | ═C(H)— | 0 |
| CF₃CH₂O | H | CF₃ | H | ═C(H)— | 0 |
| iPrO | H | CF₃ | H | ═C(H)— | 0 |
| MeS | H | CF₃ | H | ═C(H)— | 0 |
| EtS | H | CF₃ | H | ═C(H)— | 0 |
| PrS | H | CF₃ | H | ═C(H)— | 0 |
| CF₃CH₂S | H | CF₃ | H | ═C(H)— | 0 |
| iPrS | H | CF₃ | H | ═C(H)— | 0 |

TABLE 13

| R³ | R⁵ | R⁶ | R⁷ | A² | n |
|---|---|---|---|---|---|
| Ph | H | CF₃ | H | ═C(H)— | 0 |
| 2-Py | H | CF₃ | H | ═C(H)— | 0 |
| 3-Py | H | CF₃ | H | ═C(H)— | 0 |
| 4-Py | H | CF₃ | H | ═C(H)— | 0 |
| 1-Tz | H | CF₃ | H | ═C(H)— | 0 |
| 1-Pz | H | CF₃ | H | ═C(H)— | 0 |
| H | H | CF₃ | H | ═C(H)— | 1 |
| Cl | H | CF₃ | H | ═C(H)— | 1 |
| Br | H | CF₃ | H | ═C(H)— | 1 |
| I | H | CF₃ | H | ═C(H)— | 1 |
| Me | H | CF₃ | H | ═C(H)— | 1 |
| Et | H | CF₃ | H | ═C(H)— | 1 |
| Pr | H | CF₃ | H | ═C(H)— | 1 |
| MeO | H | CF₃ | H | ═C(H)— | 1 |
| EtO | H | CF₃ | H | ═C(H)— | 1 |
| PrO | H | CF₃ | H | ═C(H)— | 1 |
| CF₃CH₂O | H | CF₃ | H | ═C(H)— | 1 |
| iPrO | H | CF₃ | H | ═C(H)— | 1 |
| Ph | H | CF₃ | H | ═C(H)— | 1 |
| H | Cl | CF₃ | H | ═C(H)— | 0 |
| F | Cl | CF₃ | H | ═C(H)— | 0 |
| Cl | Cl | CF₃ | H | ═C(H)— | 0 |
| Br | Cl | CF₃ | H | ═C(H)— | 0 |
| I | Cl | CF₃ | H | ═C(H)— | 0 |

TABLE 14

| R³ | R⁵ | R⁶ | R⁷ | A² | n |
|---|---|---|---|---|---|
| Me | Cl | CF₃ | H | ═C(H)— | 0 |
| Et | Cl | CF₃ | H | ═C(H)— | 0 |
| Pr | Cl | CF₃ | H | ═C(H)— | 0 |
| MeO | Cl | CF₃ | H | ═C(H)— | 0 |
| EtO | Cl | CF₃ | H | ═C(H)— | 0 |
| PrO | Cl | CF₃ | H | ═C(H)— | 0 |
| CF₃CH₂O | Cl | CF₃ | H | ═C(H)— | 0 |
| iPrO | Cl | CF₃ | H | ═C(H)— | 0 |
| MeS | Cl | CF₃ | H | ═C(H)— | 0 |
| EtS | Cl | CF₃ | H | ═C(H)— | 0 |
| PrS | Cl | CF₃ | H | ═C(H)— | 0 |
| CF₃CH₂S | Cl | CF₃ | H | ═C(H)— | 0 |
| iPrS | Cl | CF₃ | H | ═C(H)— | 0 |
| Ph | Cl | CF₃ | H | ═C(H)— | 0 |
| 2-Py | Cl | CF₃ | H | ═C(H)— | 0 |
| 3-Py | Cl | CF₃ | H | ═C(H)— | 0 |
| 4-Py | Cl | CF₃ | H | ═C(H)— | 0 |
| 1-Tz | Cl | CF₃ | H | ═C(H)— | 0 |
| 1-Pz | Cl | CF₃ | H | ═C(H)— | 0 |
| H | Cl | CF₃ | H | ═C(H)— | 1 |
| Cl | Cl | CF₃ | H | ═C(H)— | 1 |
| Br | Cl | CF₃ | H | ═C(H)— | 1 |
| I | Cl | CF₃ | H | ═C(H)— | 1 |
| Me | Cl | CF₃ | H | ═C(H)— | 1 |

TABLE 15

| R³ | R⁵ | R⁶ | R⁷ | A² | n |
|---|---|---|---|---|---|
| Et | Cl | CF₃ | H | ═C(H)— | 1 |
| Pr | Cl | CF₃ | H | ═C(H)— | 1 |
| MeO | Cl | CF₃ | H | ═C(H)— | 1 |
| EtO | Cl | CF₃ | H | ═C(H)— | 1 |
| PrO | Cl | CF₃ | H | ═C(H)— | 1 |
| CF₃CH₂O | Cl | CF₃ | H | ═C(H)— | 1 |
| iPrO | Cl | CF₃ | H | ═C(H)— | 1 |
| Ph | Cl | CF₃ | H | ═C(H)— | 1 |
| H | H | CF₃ | Cl | ═C(H)— | 0 |
| F | H | CF₃ | Cl | ═C(H)— | 0 |
| Cl | H | CF₃ | Cl | ═C(H)— | 0 |
| Br | H | CF₃ | Cl | ═C(H)— | 0 |
| I | H | CF₃ | Cl | ═C(H)— | 0 |
| Me | H | CF₃ | Cl | ═C(H)— | 0 |
| Et | H | CF₃ | Cl | ═C(H)— | 0 |
| Pr | H | CF₃ | Cl | ═C(H)— | 0 |
| MeO | H | CF₃ | Cl | ═C(H)— | 0 |
| EtO | H | CF₃ | Cl | ═C(H)— | 0 |
| PrO | H | CF₃ | Cl | ═C(H)— | 0 |
| CF₃CH₂O | H | CF₃ | Cl | ═C(H)— | 0 |
| iPrO | H | CF₃ | Cl | ═C(H)— | 0 |
| MeS | H | CF₃ | Cl | ═C(H)— | 0 |
| EtS | H | CF₃ | Cl | ═C(H)— | 0 |
| PrS | H | CF₃ | Cl | ═C(H)— | 0 |

TABLE 16

| R³ | R⁵ | R⁶ | R⁷ | A² | n |
|---|---|---|---|---|---|
| CF₃CH₂S | H | CF₃ | Cl | ═C(H)— | 0 |
| iPrS | H | CF₃ | Cl | ═C(H)— | 0 |
| Ph | H | CF₃ | Cl | ═C(H)— | 0 |
| 2-Py | H | CF₃ | Cl | ═C(H)— | 0 |
| 3-Py | H | CF₃ | Cl | ═C(H)— | 0 |
| 4-Py | H | CF₃ | Cl | ═C(H)— | 0 |
| 1-Tz | H | CF₃ | Cl | ═C(H)— | 0 |
| 1-Pz | H | CF₃ | Cl | ═C(H)— | 0 |
| H | H | CF₃ | Cl | ═C(H)— | 1 |
| Cl | H | CF₃ | Cl | ═C(H)— | 1 |
| Br | H | CF₃ | Cl | ═C(H)— | 1 |
| I | H | CF₃ | Cl | ═C(H)— | 1 |
| Me | H | CF₃ | Cl | ═C(H)— | 1 |
| Et | H | CF₃ | Cl | ═C(H)— | 1 |
| Pr | H | CF₃ | Cl | ═C(H)— | 1 |
| MeO | H | CF₃ | Cl | ═C(H)— | 1 |
| EtO | H | CF₃ | Cl | ═C(H)— | 1 |
| PrO | H | CF₃ | Cl | ═C(H)— | 1 |
| CF₃CH₂O | H | CF₃O | H | ═C(H)— | 1 |
| iPrO | H | CF₃O | H | ═C(H)— | 1 |
| Ph | H | CF₃O | H | ═C(H)— | 1 |
| H | H | CF₃O | H | ═C(H)— | 0 |
| F | H | CF₃O | H | ═C(H)— | 0 |
| Cl | H | CF₃O | H | ═C(H)— | 0 |

TABLE 17

| R³ | R⁵ | R⁶ | R⁷ | A² | n |
|---|---|---|---|---|---|
| Br | H | CF₃O | H | ═C(H)— | 0 |
| I | H | CF₃O | H | ═C(H)— | 0 |
| Me | H | CF₃O | H | ═C(H)— | 0 |
| Et | H | CF₃O | H | ═C(H)— | 0 |
| Pr | H | CF₃O | H | ═C(H)— | 0 |
| MeO | H | CF₃O | H | ═C(H)— | 0 |
| EtO | H | CF₃O | H | ═C(H)— | 0 |
| PrO | H | CF₃O | H | ═C(H)— | 0 |
| CF₃CH₂O | H | CF₃O | H | ═C(H)— | 0 |
| iPrO | H | CF₃O | H | ═C(H)— | 0 |
| MeS | H | CF₃O | H | ═C(H)— | 0 |
| EtS | H | CF₃O | H | ═C(H)— | 0 |
| PrS | H | CF₃O | H | ═C(H)— | 0 |
| CF₃CH₂S | H | CF₃O | H | ═C(H)— | 0 |
| iPrS | H | CF₃O | H | ═C(H)— | 0 |
| Ph | H | CF₃O | H | ═C(H)— | 0 |
| 2-Py | H | CF₃O | H | ═C(H)— | 0 |
| 3-Py | H | CF₃O | H | ═C(H)— | 0 |
| 4-Py | H | CF₃O | H | ═C(H)— | 0 |
| 1-Tz | H | CF₃O | H | ═C(H)— | 0 |
| 1-Pz | H | CF₃O | H | ═C(H)— | 0 |
| H | H | CF₃O | H | ═C(H)— | 1 |
| Cl | H | CF₃O | H | ═C(H)— | 1 |
| Br | H | CF₃O | H | ═C(H)— | 1 |

TABLE 18

| R³ | R⁵ | R⁶ | R⁷ | A² | n |
|---|---|---|---|---|---|
| I | H | CF₃O | H | ═C(H)— | 1 |
| Me | H | CF₃O | H | ═C(H)— | 1 |
| Et | H | CF₃O | H | ═C(H)— | 1 |
| Pr | H | CF₃O | H | ═C(H)— | 1 |
| MeO | H | CF₃O | H | ═C(H)— | 1 |
| EtO | H | CF₃O | H | ═C(H)— | 1 |
| PrO | H | CF₃O | H | ═C(H)— | 1 |
| CF₃CH₂O | H | CF₃O | H | ═C(H)— | 1 |
| iPrO | H | CF₃O | H | ═C(H)— | 1 |
| Ph | H | CF₃O | H | ═C(H)— | 1 |
| H | H | CF₃S | H | ═C(H)— | 0 |
| F | H | CF₃S | H | ═C(H)— | 0 |
| Cl | H | CF₃S | H | ═C(H)— | 0 |
| Br | H | CF₃S | H | ═C(H)— | 0 |
| I | H | CF₃S | H | ═C(H)— | 0 |
| Me | H | CF₃S | H | ═C(H)— | 0 |
| Et | H | CF₃S | H | ═C(H)— | 0 |
| Pr | H | CF₃S | H | ═C(H)— | 0 |
| MeO | H | CF₃S | H | ═C(H)— | 0 |
| EtO | H | CF₃S | H | ═C(H)— | 0 |
| PrO | H | CF₃S | H | ═C(H)— | 0 |
| CF₃CH₂O | H | CF₃S | H | ═C(H)— | 0 |
| iPrO | H | CF₃S | H | ═C(H)— | 0 |
| MeS | H | CF₃S | H | ═C(H)— | 0 |

TABLE 19

| R³ | R⁵ | R⁶ | R⁷ | A² | n |
|---|---|---|---|---|---|
| EtS | H | CF₃S | H | ═C(H)— | 0 |
| PrS | H | CF₃S | H | ═C(H)— | 0 |
| CF₃CH₂S | H | CF₃S | H | ═C(H)— | 0 |
| iPrS | H | CF₃S | H | ═C(H)— | 0 |
| Ph | H | CF₃S | H | ═C(H)— | 0 |
| 2-Py | H | CF₃S | H | ═C(H)— | 0 |
| 3-Py | H | CF₃S | H | ═C(H)— | 0 |
| 4-Py | H | CF₃S | H | ═C(H)— | 0 |
| 1-Tz | H | CF₃S | H | ═C(H)— | 0 |
| 1-Pz | H | CF₃S | H | ═C(H)— | 0 |

| | | | | |
|---|---|---|---|---|
| H | —CF₂OCF₂— | H | ═C(H)— | 0 |
| F | —CF₂OCF₂— | H | ═C(H)— | 0 |
| Cl | —CF₂OCF₂— | H | ═C(H)— | 0 |
| Br | —CF₂OCF₂— | H | ═C(H)— | 0 |
| I | —CF₂OCF₂— | H | ═C(H)— | 0 |
| Me | —CF₂OCF₂— | H | ═C(H)— | 0 |
| Et | —CF₂OCF₂— | H | ═C(H)— | 0 |
| Pr | —CF₂OCF₂— | H | ═C(H)— | 0 |
| MeO | —CF₂OCF₂— | H | ═C(H)— | 0 |
| EtO | —CF₂OCF₂— | H | ═C(H)— | 0 |
| PrO | —CF₂OCF₂— | H | ═C(H)— | 0 |
| CF₃CH₂O | —CF₂OCF₂— | H | ═C(H)— | 0 |
| iPrO | —CF₂OCF₂— | H | ═C(H)— | 0 |
| MeS | —CF₂OCF₂— | H | ═C(H)— | 0 |

TABLE 20

| | | | | | |
|---|---|---|---|---|---|
| R³ | R⁵ | R⁶ | R⁷ | A² | n |

| | | | | |
|---|---|---|---|---|
| EtS | —CF₂OCF₂— | H | ═C(H)— | 0 |
| PrS | —CF₂OCF₂— | H | ═C(H)— | 0 |
| CF₃CH₂S | —CF₂OCF₂— | H | ═C(H)— | 0 |
| iPrS | —CF₂OCF₂— | H | ═C(H)— | 0 |
| Ph | —CF₂OCF₂— | H | ═C(H)— | 0 |
| 2-Py | —CF₂OCF₂— | H | ═C(H)— | 0 |
| 3-Py | —CF₂OCF₂— | H | ═C(H)— | 0 |
| 4-Py | —CF₂OCF₂— | H | ═C(H)— | 0 |
| 1-Tz | —CF₂OCF₂— | H | ═C(H)— | 0 |
| 1-Pz | —CF₂OCF₂— | H | ═C(H)— | 0 |
| H | —CF₂OCF₂— | H | ═C(H)— | 1 |
| Cl | —CF₂OCF₂— | H | ═C(H)— | 1 |
| Br | —CF₂OCF₂— | H | ═C(H)— | 1 |
| I | —CF₂OCF₂— | H | ═C(H)— | 1 |
| Me | —CF₂OCF₂— | H | ═C(H)— | 1 |
| Et | —CF₂OCF₂— | H | ═C(H)— | 1 |
| Pr | —CF₂OCF₂— | H | ═C(H)— | 1 |
| MeO | —CF₂OCF₂— | H | ═C(H)— | 1 |
| EtO | —CF₂OCF₂— | H | ═C(H)— | 1 |
| PrO | —CF₂OCF₂— | H | ═C(H)— | 1 |
| CF₃CH₂O | —CF₂OCF₂— | H | ═C(H)— | 1 |
| iPrO | —CF₂OCF₂— | H | ═C(H)— | 1 |
| Ph | —CF₂OCF₂— | H | ═C(H)— | 1 |
| H | —CF₂CH₂CH₂— | H | ═C(H)— | 0 |

TABLE 21

| | | | | | |
|---|---|---|---|---|---|
| R³ | R⁵ | R⁶ | R⁷ | A² | n |

| | | | | |
|---|---|---|---|---|
| F | —CF₂CH₂CH₂— | H | ═C(H)— | 0 |
| Cl | —CF₂CH₂CH₂— | H | ═C(H)— | 0 |
| Br | —CF₂CH₂CH₂— | H | ═C(H)— | 0 |
| I | —CF₂CH₂CH₂— | H | ═C(H)— | 0 |
| Me | —CF₂CH₂CH₂— | H | ═C(H)— | 0 |
| Et | —CF₂CH₂CH₂— | H | ═C(H)— | 0 |
| Pr | —CF₂CH₂CH₂— | H | ═C(H)— | 0 |
| MeO | —CF₂CH₂CH₂— | H | ═C(H)— | 0 |
| EtO | —CF₂CH₂CH₂— | H | ═C(H)— | 0 |
| PrO | —CF₂CH₂CH₂— | H | ═C(H)— | 0 |
| CF₃CH₂O | —CF₂CH₂CH₂— | H | ═C(H)— | 0 |
| iPrO | —CF₂CH₂CH₂— | H | ═C(H)— | 0 |
| MeS | —CF₂CH₂CH₂— | H | ═C(H)— | 0 |
| EtS | —CF₂CH₂CH₂— | H | ═C(H)— | 0 |
| PrS | —CF₂CH₂CH₂— | H | ═C(H)— | 0 |
| CF₃CH₂S | —CF₂CH₂CH₂— | H | ═C(H)— | 0 |
| iPrS | —CF₂CH₂CH₂— | H | ═C(H)— | 0 |
| Ph | —CF₂CH₂CH₂— | H | ═C(H)— | 0 |
| 2-Py | —CF₂CH₂CH₂— | H | ═C(H)— | 0 |
| 3-Py | —CF₂CH₂CH₂— | H | ═C(H)— | 0 |
| 4-Py | —CF₂CH₂CH₂— | H | ═C(H)— | 0 |
| 1-Tz | —CF₂CH₂CH₂— | H | ═C(H)— | 0 |
| 1-Pz | —CF₂CH₂CH₂— | H | ═C(H)— | 0 |
| H | —CF₂CH₂O— | H | ═C(H)— | 0 |

TABLE 22

| | | | | | |
|---|---|---|---|---|---|
| R³ | R⁵ | R⁶ | R⁷ | A² | n |

| | | | | |
|---|---|---|---|---|
| F | —CF₂CH₂O— | H | ═C(H)— | 0 |
| Cl | —CF₂CH₂O— | H | ═C(H)— | 0 |
| Br | —CF₂CH₂O— | H | ═C(H)— | 0 |
| I | —CF₂CH₂O— | H | ═C(H)— | 0 |
| Me | —CF₂CH₂O— | H | ═C(H)— | 0 |
| Et | —CF₂CH₂O— | H | ═C(H)— | 0 |
| Pr | —CF₂CH₂O— | H | ═C(H)— | 0 |
| MeO | —CF₂CH₂O— | H | ═C(H)— | 0 |
| EtO | —CF₂CH₂O— | H | ═C(H)— | 0 |
| PrO | —CF₂CH₂O— | H | ═C(H)— | 0 |
| CF₃CH₂O | —CF₂CH₂O— | H | ═C(H)— | 0 |
| iPrO | —CF₂CH₂O— | H | ═C(H)— | 0 |
| MeS | —CF₂CH₂O— | H | ═C(H)— | 0 |
| EtS | —CF₂CH₂O— | H | ═C(H)— | 0 |
| PrS | —CF₂CH₂O— | H | ═C(H)— | 0 |
| CF₃CH₂S | —CF₂CH₂O— | H | ═C(H)— | 0 |
| iPrS | —CF₂CH₂O— | H | ═C(H)— | 0 |
| Ph | —CF₂CH₂O— | H | ═C(H)— | 0 |
| 2-Py | —CF₂CH₂O— | H | ═C(H)— | 0 |
| 3-Py | —CF₂CH₂O— | H | ═C(H)— | 0 |
| 4-Py | —CF₂CH₂O— | H | ═C(H)— | 0 |
| 1-Tz | —CF₂CH₂O— | H | ═C(H)— | 0 |
| 1-Pz | —CF₂CH₂O— | H | ═C(H)— | 0 |
| H | —CH₂CH₂CF₂— | H | ═C(H)— | 0 |

TABLE 23

| | | | | | |
|---|---|---|---|---|---|
| R³ | R⁵ | R⁶ | R⁷ | A² | n |

| | | | | |
|---|---|---|---|---|
| F | —CH₂CH₂CF₂— | H | ═C(H)— | 0 |
| Cl | —CH₂CH₂CF₂— | H | ═C(H)— | 0 |
| Br | —CH₂CH₂CF₂— | H | ═C(H)— | 0 |
| I | —CH₂CH₂CF₂— | H | ═C(H)— | 0 |
| Me | —CH₂CH₂CF₂— | H | ═C(H)— | 0 |
| Et | —CH₂CH₂CF₂— | H | ═C(H)— | 0 |
| Pr | —CH₂CH₂CF₂— | H | ═C(H)— | 0 |
| MeO | —CH₂CH₂CF₂— | H | ═C(H)— | 0 |
| EtO | —CH₂CH₂CF₂— | H | ═C(H)— | 0 |
| PrO | —CH₂CH₂CF₂— | H | ═C(H)— | 0 |
| CF₃CH₂O | —CH₂CH₂CF₂— | H | ═C(H)— | 0 |
| iPrO | —CH₂CH₂CF₂— | H | ═C(H)— | 0 |
| MeS | —CH₂CH₂CF₂— | H | ═C(H)— | 0 |
| EtS | —CH₂CH₂CF₂— | H | ═C(H)— | 0 |
| PrS | —CH₂CH₂CF₂— | H | ═C(H)— | 0 |
| CF₃CH₂S | —CH₂CH₂CF₂— | H | ═C(H)— | 0 |
| iPrS | —CH₂CH₂CF₂— | H | ═C(H)— | 0 |
| Ph | —CH₂CH₂CF₂— | H | ═C(H)— | 0 |
| 2-Py | —CH₂CH₂CF₂— | H | ═C(H)— | 0 |
| 3-Py | —CH₂CH₂CF₂— | H | ═C(H)— | 0 |
| 4-Py | —CH₂CH₂CF₂— | H | ═C(H)— | 0 |
| 1-Tz | —CH₂CH₂CF₂— | H | ═C(H)— | 0 |
| 1-Pz | —CH₂CH₂CF₂— | H | ═C(H)— | 0 |
| H | —CF₂CH₂CH₂CH₂— | H | ═C(H)— | 0 |

TABLE 24

| | | | | | |
|---|---|---|---|---|---|
| R³ | R⁵ | R⁶ | R⁷ | A² | n |

| | | | | |
|---|---|---|---|---|
| F | —CF₂CH₂CH₂CH₂— | H | ═C(H)— | 0 |
| Cl | —CF₂CH₂CH₂CH₂— | H | ═C(H)— | 0 |
| Br | —CF₂CH₂CH₂CH₂— | H | ═C(H)— | 0 |
| I | —CF₂CH₂CH₂CH₂— | H | ═C(H)— | 0 |
| Me | —CF₂CH₂CH₂CH₂— | H | ═C(H)— | 0 |
| Et | —CF₂CH₂CH₂CH₂— | H | ═C(H)— | 0 |
| Pr | —CF₂CH₂CH₂CH₂— | H | ═C(H)— | 0 |
| MeO | —CF₂CH₂CH₂CH₂— | H | ═C(H)— | 0 |
| EtO | —CF₂CH₂CH₂CH₂— | H | ═C(H)— | 0 |
| PrO | —CF₂CH₂CH₂CH₂— | H | ═C(H)— | 0 |
| CF₃CH₂O | —CF₂CH₂CH₂CH₂— | H | ═C(H)— | 0 |
| iPrO | —CF₂CH₂CH₂CH₂— | H | ═C(H)— | 0 |
| MeS | —CF₂CH₂CH₂CH₂— | H | ═C(H)— | 0 |
| EtS | —CF₂CH₂CH₂CH₂— | H | ═C(H)— | 0 |
| PrS | —CF₂CH₂CH₂CH₂— | H | ═C(H)— | 0 |
| CF₃CH₂S | —CF₂CH₂CH₂CH₂— | H | ═C(H)— | 0 |
| iPrS | —CF₂CH₂CH₂CH₂— | H | ═C(H)— | 0 |
| Ph | —CF₂CH₂CH₂CH₂— | H | ═C(H)— | 0 |
| 2-Py | —CF₂CH₂CH₂CH₂— | H | ═C(H)— | 0 |
| 3-Py | —CF₂CH₂CH₂CH₂— | H | ═C(H)— | 0 |
| 4-Py | —CF₂CH₂CH₂CH₂— | H | ═C(H)— | 0 |
| 1-Tz | —CF₂CH₂CH₂CH₂— | H | ═C(H)— | 0 |
| 1-Pz | —CF₂CH₂CH₂CH₂— | H | ═C(H)— | 0 |
| H | —CF₂CH₂CH₂O— | H | ═C(H)— | 0 |

TABLE 25

| | | | | | |
|---|---|---|---|---|---|
| R³ | R⁵ | R⁶ | R⁷ | A² | n |

| | | | | |
|---|---|---|---|---|
| F | —CF₂CH₂CH₂O— | H | ═C(H)— | 0 |
| Cl | —CF₂CH₂CH₂O— | H | ═C(H)— | 0 |
| Br | —CF₂CH₂CH₂O— | H | ═C(H)— | 0 |
| I | —CF₂CH₂CH₂O— | H | ═C(H)— | 0 |
| Me | —CF₂CH₂CH₂O— | H | ═C(H)— | 0 |
| Et | —CF₂CH₂CH₂O— | H | ═C(H)— | 0 |
| Pr | —CF₂CH₂CH₂O— | H | ═C(H)— | 0 |
| MeO | —CF₂CH₂CH₂O— | H | ═C(H)— | 0 |
| EtO | —CF₂CH₂CH₂O— | H | ═C(H)— | 0 |
| PrO | —CF₂CH₂CH₂O— | H | ═C(H)— | 0 |
| CF₃CH₂O | —CF₂CH₂CH₂O— | H | ═C(H)— | 0 |
| iPrO | —CF₂CH₂CH₂O— | H | ═C(H)— | 0 |
| MeS | —CF₂CH₂CH₂O— | H | ═C(H)— | 0 |
| EtS | —CF₂CH₂CH₂O— | H | ═C(H)— | 0 |
| PrS | —CF₂CH₂CH₂O— | H | ═C(H)— | 0 |
| CF₃CH₂S | —CF₂CH₂CH₂O— | H | ═C(H)— | 0 |
| iPrS | —CF₂CH₂CH₂O— | H | ═C(H)— | 0 |
| Ph | —CF₂CH₂CH₂O— | H | ═C(H)— | 0 |
| 2-Py | —CF₂CH₂CH₂O— | H | ═C(H)— | 0 |
| 3-Py | —CF₂CH₂CH₂O— | H | ═C(H)— | 0 |
| 4-Py | —CF₂CH₂CH₂O— | H | ═C(H)— | 0 |
| 1-Tz | —CF₂CH₂CH₂O— | H | ═C(H)— | 0 |
| 1-Pz | —CF₂CH₂CH₂O— | H | ═C(H)— | 0 |
| H | —CH₂CH₂CH₂CF₂— | H | ═C(H)— | 0 |

TABLE 26

| | | | | | |
|---|---|---|---|---|---|
| R³ | R⁵ | R⁶ | R⁷ | A² | n |

| | | | | |
|---|---|---|---|---|
| F | —CH₂CH₂CH₂CF₂— | H | ═C(H)— | 0 |
| Cl | —CH₂CH₂CH₂CF₂— | H | ═C(H)— | 0 |
| Br | —CH₂CH₂CH₂CF₂— | H | ═C(H)— | 0 |
| I | —CH₂CH₂CH₂CF₂— | H | ═C(H)— | 0 |
| Me | —CH₂CH₂CH₂CF₂— | H | ═C(H)— | 0 |
| Et | —CH₂CH₂CH₂CF₂— | H | ═C(H)— | 0 |
| Pr | —CH₂CH₂CH₂CF₂— | H | ═C(H)— | 0 |
| MeO | —CH₂CH₂CH₂CF₂— | H | ═C(H)— | 0 |
| EtO | —CH₂CH₂CH₂CF₂— | H | ═C(H)— | 0 |
| PrO | —CH₂CH₂CH₂CF₂— | H | ═C(H)— | 0 |
| CF₃CH₂O | —CH₂CH₂CH₂CF₂— | H | ═C(H)— | 0 |
| iPrO | —CH₂CH₂CH₂CF₂— | H | ═C(H)— | 0 |
| MeS | —CH₂CH₂CH₂CF₂— | H | ═C(H)— | 0 |
| EtS | —CH₂CH₂CH₂CF₂— | H | ═C(H)— | 0 |
| PrS | —CH₂CH₂CH₂CF₂— | H | ═C(H)— | 0 |
| CF₃CH₂S | —CH₂CH₂CH₂CF₂— | H | ═C(H)— | 0 |
| iPrS | —CH₂CH₂CH₂CF₂— | H | ═C(H)— | 0 |
| Ph | —CH₂CH₂CH₂CF₂— | H | ═C(H)— | 0 |
| 2-Py | —CH₂CH₂CH₂CF₂— | H | ═C(H)— | 0 |
| 3-Py | —CH₂CH₂CH₂CF₂— | H | ═C(H)— | 0 |
| 4-Py | —CH₂CH₂CH₂CF₂— | H | ═C(H)— | 0 |
| 1-Tz | —CH₂CH₂CH₂CF₂— | H | ═C(H)— | 0 |
| 1-Pz | —CH₂CH₂CH₂CF₂— | H | ═C(H)— | 0 |
| H | —OCH₂CH₂CF₂— | H | ═C(H)— | 0 |

TABLE 27

| | | | | | |
|---|---|---|---|---|---|
| R³ | R⁵ | R⁶ | R⁷ | A² | n |

| | | | | |
|---|---|---|---|---|
| F | —OCH₂CH₂CF₂— | H | ═C(H)— | 0 |
| Cl | —OCH₂CH₂CF₂— | H | ═C(H)— | 0 |
| Br | —OCH₂CH₂CF₂— | H | ═C(H)— | 0 |
| I | —OCH₂CH₂CF₂— | H | ═C(H)— | 0 |
| Me | —OCH₂CH₂CF₂— | H | ═C(H)— | 0 |
| Et | —OCH₂CH₂CF₂— | H | ═C(H)— | 0 |
| Pr | —OCH₂CH₂CF₂— | H | ═C(H)— | 0 |
| MeO | —OCH₂CH₂CF₂— | H | ═C(H)— | 0 |
| EtO | —OCH₂CH₂CF₂— | H | ═C(H)— | 0 |
| PrO | —OCH₂CH₂CF₂— | H | ═C(H)— | 0 |
| CF₃CH₂O | —OCH₂CH₂CF₂— | H | ═C(H)— | 0 |
| iPrO | —OCH₂CH₂CF₂— | H | ═C(H)— | 0 |
| MeS | —OCH₂CH₂CF₂— | H | ═C(H)— | 0 |
| EtS | —OCH₂CH₂CF₂— | H | ═C(H)— | 0 |
| PrS | —OCH₂CH₂CF₂— | H | ═C(H)— | 0 |
| CF₃CH₂S | —OCH₂CH₂CF₂— | H | ═C(H)— | 0 |
| iPrS | —OCH₂CH₂CF₂— | H | ═C(H)— | 0 |
| Ph | —OCH₂CH₂CF₂— | H | ═C(H)— | 0 |
| 2-Py | —OCH₂CH₂CF₂— | H | ═C(H)— | 0 |
| 3-Py | —OCH₂CH₂CF₂— | H | ═C(H)— | 0 |
| 4-Py | —OCH₂CH₂CF₂— | H | ═C(H)— | 0 |
| 1-Tz | —OCH₂CH₂CF₂— | H | ═C(H)— | 0 |
| 1-Pz | —OCH₂CH₂CF₂— | H | ═C(H)— | 0 |

TABLE 28

| R³ | R⁵ | R⁶ | R⁷ | A² | n |
|---|---|---|---|---|---|
| CH₃OCH₂ | tBu | H | H | ═C(H)— | 0 |
| CHF₂CH₂O | tBu | H | H | ═C(H)— | 0 |
| MeS(O) | tBu | H | H | ═C(H)— | 0 |
| MeS(O)₂ | tBu | H | H | ═C(H)— | 0 |
| EtS(O) | tBu | H | H | ═C(H)— | 0 |
| EtS(O)₂ | tBu | H | H | ═C(H)— | 0 |
| PrS(O) | tBu | H | H | ═C(H)— | 0 |
| PrS(O)₂ | tBu | H | H | ═C(H)— | 0 |
| CHF₂CH₂S | tBu | H | H | ═C(H)— | 0 |
| iPrS(O) | tBu | H | H | ═C(H)— | 0 |
| iPrS(O)₂ | tBu | H | H | ═C(H)— | 0 |
| CF₃ | tBu | H | H | ═C(H)— | 0 |
| CH₃OCH₂ | CF₃ | H | H | ═C(H)— | 0 |
| CHF₂CH₂O | CF₃ | H | H | ═C(H)— | 0 |
| MeS(O) | CF₃ | H | H | ═C(H)— | 0 |
| MeS(O)₂ | CF₃ | H | H | ═C(H)— | 0 |
| EtS(O) | CF₃ | H | H | ═C(H)— | 0 |
| EtS(O)₂ | CF₃ | H | H | ═C(H)— | 0 |
| PrS(O) | CF₃ | H | H | ═C(H)— | 0 |
| PrS(O)₂ | CF₃ | H | H | ═C(H)— | 0 |
| CHF₂CH₂S | CF₃ | H | H | ═C(H)— | 0 |
| iPrS(O) | CF₃ | H | H | ═C(H)— | 0 |
| iPrS(O)₂ | CF₃ | H | H | ═C(H)— | 0 |
| CF₃ | CF₃ | H | H | ═C(H)— | 0 |

TABLE 29

| R³ | R⁵ | R⁶ | R⁷ | A² | n |
|---|---|---|---|---|---|
| CH₃OCH₂ | CF₃O | H | H | ═C(H)— | 0 |
| CHF₂CH₂O | CF₃O | H | H | ═C(H)— | 0 |
| MeS(O) | CF₃O | H | H | ═C(H)— | 0 |
| MeS(O)₂ | CF₃O | H | H | ═C(H)— | 0 |
| EtS(O) | CF₃O | H | H | ═C(H)— | 0 |
| EtS(O)₂ | CF₃O | H | H | ═C(H)— | 0 |
| PrS(O) | CF₃O | H | H | ═C(H)— | 0 |
| PrS(O)₂ | CF₃O | H | H | ═C(H)— | 0 |
| CHF₂CH₂S | CF₃O | H | H | ═C(H)— | 0 |
| iPrS(O) | CF₃O | H | H | ═C(H)— | 0 |
| iPrS(O)₂ | CF₃O | H | H | ═C(H)— | 0 |
| CF₃ | CF₃O | H | H | ═C(H)— | 0 |
| CH₃OCH₂ | CF₃ | H | H | ═N— | 0 |
| CHF₂CH₂O | CF₃ | H | H | ═N— | 0 |
| MeS(O) | CF₃ | H | H | ═N— | 0 |
| MeS(O)₂ | CF₃ | H | H | ═N— | 0 |
| EtS(O) | CF₃ | H | H | ═N— | 0 |
| EtS(O)₂ | CF₃ | H | H | ═N— | 0 |
| PrS(O) | CF₃ | H | H | ═N— | 0 |
| PrS(O)₂ | CF₃ | H | H | ═N— | 0 |
| CHF₂CH₂S | CF₃ | H | H | ═N— | 0 |
| iPrS(O) | CF₃ | H | H | ═N— | 0 |
| iPrS(O)₂ | CF₃ | H | H | ═N— | 0 |
| CF₃ | CF₃ | H | H | ═N— | 0 |

TABLE 30

| R³ | R⁵ | R⁶ | R⁷ | A² | n |
|---|---|---|---|---|---|
| CH₃OCH₂ | H | tBu | H | ═C(H)— | 0 |
| CHF₂CH₂O | H | tBu | H | ═C(H)— | 0 |
| MeS(O) | H | tBu | H | ═C(H)— | 0 |
| MeS(O)₂ | H | tBu | H | ═C(H)— | 0 |
| EtS(O) | H | tBu | H | ═C(H)— | 0 |
| EtS(O)₂ | H | tBu | H | ═C(H)— | 0 |
| PrS(O) | H | tBu | H | ═C(H)— | 0 |
| PrS(O)₂ | H | tBu | H | ═C(H)— | 0 |
| CHF₂CH₂S | H | tBu | H | ═C(H)— | 0 |
| iPrS(O) | H | tBu | H | ═C(H)— | 0 |
| iPrS(O)₂ | H | tBu | H | ═C(H)— | 0 |
| CF₃ | H | tBu | H | ═C(H)— | 0 |
| CH₃OCH₂ | H | CF₃ | H | ═C(H)— | 0 |
| CHF₂CH₂O | H | CF₃ | H | ═C(H)— | 0 |
| MeS(O) | H | CF₃ | H | ═C(H)— | 0 |
| MeS(O)₂ | H | CF₃ | H | ═C(H)— | 0 |
| EtS(O) | H | CF₃ | H | ═C(H)— | 0 |
| EtS(O)₂ | H | CF₃ | H | ═C(H)— | 0 |
| PrS(O) | H | CF₃ | H | ═C(H)— | 0 |
| PrS(O)₂ | H | CF₃ | H | ═C(H)— | 0 |
| CHF₂CH₂S | H | CF₃ | H | ═C(H)— | 0 |
| iPrS(O) | H | CF₃ | H | ═C(H)— | 0 |
| iPrS(O)₂ | H | CF₃ | H | ═C(H)— | 0 |
| CF₃ | H | CF₃ | H | ═C(H)— | 0 |

TABLE 31

| R³ | R⁵ | R⁶ | R⁷ | A² | n |
|---|---|---|---|---|---|
| CH₃OCH₂ | H | CF₃O | H | ═C(H)— | 0 |
| CHF₂CH₂O | H | CF₃O | H | ═C(H)— | 0 |
| MeS(O) | H | CF₃O | H | ═C(H)— | 0 |
| MeS(O)₂ | H | CF₃O | H | ═C(H)— | 0 |
| EtS(O) | H | CF₃O | H | ═C(H)— | 0 |
| EtS(O)₂ | H | CF₃O | H | ═C(H)— | 0 |
| PrS(O) | H | CF₃O | H | ═C(H)— | 0 |
| PrS(O)₂ | H | CF₃O | H | ═C(H)— | 0 |
| CHF₂CH₂S | H | CF₃O | H | ═C(H)— | 0 |
| iPrS(O) | H | CF₃O | H | ═C(H)— | 0 |
| iPrS(O)₂ | H | CF₃O | H | ═C(H)— | 0 |
| CF₃ | H | CF₃O | H | ═C(H)— | 0 |
| CH₃OCH₂ | tBu | H | H | ═N— | 0 |
| CHF₂CH₂O | tBu | H | H | ═N— | 0 |
| MeS(O) | tBu | H | H | ═N— | 0 |
| MeS(O)₂ | tBu | H | H | ═N— | 0 |
| EtS(O) | tBu | H | H | ═N— | 0 |
| EtS(O)₂ | tBu | H | H | ═N— | 0 |
| PrS(O) | tBu | H | H | ═N— | 0 |
| PrS(O)₂ | tBu | H | H | ═N— | 0 |
| CHF₂CH₂S | tBu | H | H | ═N— | 0 |
| iPrS(O) | tBu | H | H | ═N— | 0 |
| iPrS(O)₂ | tBu | H | H | ═N— | 0 |
| CF₃ | tBu | H | H | ═N— | 0 |

TABLE 32

| R³ | R⁵ | R⁶ | R⁷ | A² | n |
|---|---|---|---|---|---|
| H | tBu | H | H | ═N— | 0 |
| F | tBu | H | H | ═N— | 0 |
| Cl | tBu | H | H | ═N— | 0 |
| Br | tBu | H | H | ═N— | 0 |
| I | tBu | H | H | ═N— | 0 |
| Me | tBu | H | H | ═N— | 0 |
| Et | tBu | H | H | ═N— | 0 |
| Pr | tBu | H | H | ═N— | 0 |
| MeO | tBu | H | H | ═N— | 0 |
| EtO | tBu | H | H | ═N— | 0 |
| PrO | tBu | H | H | ═N— | 0 |
| CF₃CH₂O | tButBu | H | H | ═N— | 0 |
| iPrO | tBu | H | H | ═N— | 0 |
| MeS | tBu | H | H | ═N— | 0 |
| EtS | tBu | H | H | ═N— | 0 |
| PrS | tBu | H | H | ═N— | 0 |
| CF₃CH₂S | tBu | H | H | ═N— | 0 |
| iPrS | tBu | H | H | ═N— | 0 |

| | | | | |
|---|---|---|---|---|
| CH₃OCH₂ | —CF₂OCF₂— | H | ═C(H)— | 0 |
| CHF₂CH₂O | —CF₂OCF₂— | H | ═C(H)— | 0 |
| MeS(O) | —CF₂OCF₂— | H | ═C(H)— | 0 |
| MeS(O)₂ | —CF₂OCF₂— | H | ═C(H)— | 0 |
| EtS(O) | —CF₂OCF₂— | H | ═C(H)— | 0 |
| EtS(O)₂ | —CF₂OCF₂— | H | ═C(H)— | 0 |

TABLE 33

| | | | | | |
|---|---|---|---|---|---|
| R³ | R⁵ | R⁶ | R⁷ | A² | n |

| | | | | |
|---|---|---|---|---|
| PrS(O) | —CF₂OCF₂— | H | ═C(H)— | 0 |
| PrS(O)₂ | —CF₂OCF₂— | H | ═C(H)— | 0 |
| CHF₂CH₂S | —CF₂OCF₂— | H | ═C(H)— | 0 |
| iPrS(O) | —CF₂OCF₂— | H | ═C(H)— | 0 |
| iPrS(O)₂ | —CF₂OCF₂— | H | ═C(H)— | 0 |
| CF₃ | —CF₂OCF₂— | H | ═C(H)— | 0 |
| H | —OC(CH₃)₂CH₂— | H | ═C(H)— | 0 |
| F | —OC(CH₃)₂CH₂— | H | ═C(H)— | 0 |
| Cl | —OC(CH₃)₂CH₂— | H | ═C(H)— | 0 |
| Br | —OC(CH₃)₂CH₂— | H | ═C(H)— | 0 |
| I | —OC(CH₃)₂CH₂— | H | ═C(H)— | 0 |
| Me | —OC(CH₃)₂CH₂— | H | ═C(H)— | 0 |
| Et | —OC(CH₃)₂CH₂— | H | ═C(H)— | 0 |
| Pr | —OC(CH₃)₂CH₂— | H | ═C(H)— | 0 |
| CH₃OCH₂ | —OC(CH₃)₂CH₂— | H | ═C(H)— | 0 |
| MeO | —OC(CH₃)₂CH₂— | H | ═C(H)— | 0 |
| EtO | —OC(CH₃)₂CH₂— | H | ═C(H)— | 0 |
| PrO | —OC(CH₃)₂CH₂— | H | ═C(H)— | 0 |
| CHF₂CH₂O | —OC(CH₃)₂CH₂— | H | ═C(H)— | 0 |
| CF₃CH₂O | —OC(CH₃)₂CH₂— | H | ═C(H)— | 0 |
| iPrO | —OC(CH₃)₂CH₂— | H | ═C(H)— | 0 |
| MeS | —OC(CH₃)₂CH₂— | H | ═C(H)— | 0 |
| MeS(O) | —OC(CH₃)₂CH₂— | H | ═C(H)— | 0 |
| MeS(O)₂ | —OC(CH₃)₂CH₂— | H | ═C(H)— | 0 |

TABLE 34

| | | | | | |
|---|---|---|---|---|---|
| R³ | R⁵ | R⁶ | R⁷ | A² | n |

| | | | | |
|---|---|---|---|---|
| EtS | —OC(CH₃)₂CH₂— | H | ═C(H)— | 0 |
| EtS(O) | —OC(CH₃)₂CH₂— | H | ═C(H)— | 0 |
| EtS(O)₂ | —OC(CH₃)₂CH₂— | H | ═C(H)— | 0 |
| PrS | —OC(CH₃)₂CH₂— | H | ═C(H)— | 0 |
| PrS(O) | —OC(CH₃)₂CH₂— | H | ═C(H)— | 0 |
| PrS(O)₂ | —OC(CH₃)₂CH₂— | H | ═C(H)— | 0 |
| CHF₂CH₂S | —OC(CH₃)₂CH₂— | H | ═C(H)— | 0 |
| CF₃CH₂S | —OC(CH₃)₂CH₂— | H | ═C(H)— | 0 |
| iPr | —OC(CH₃)₂CH₂— | H | ═C(H)— | 0 |
| iPrS(O) | —OC(CH₃)₂CH₂— | H | ═C(H)— | 0 |
| iPrS(O)₂ | —OC(CH₃)₂CH₂— | H | ═C(H)— | 0 |
| CF₃ | —OC(CH₃)₂CH₂— | H | ═C(H)— | 0 |
| H | —CH₂C(CH₃)₂O— | H | ═C(H)— | 0 |
| F | —CH₂C(CH₃)₂O— | H | ═C(H)— | 0 |
| Cl | —CH₂C(CH₃)₂O— | H | ═C(H)— | 0 |
| Br | —CH₂C(CH₃)₂O— | H | ═C(H)— | 0 |
| I | —CH₂C(CH₃)₂O— | H | ═C(H)— | 0 |
| Me | —CH₂C(CH₃)₂O— | H | ═C(H)— | 0 |
| Et | —CH₂C(CH₃)₂O— | H | ═C(H)— | 0 |
| Pr | —CH₂C(CH₃)₂O— | H | ═C(H)— | 0 |
| CH₃OCH₂ | —CH₂C(CH₃)₂O— | H | ═C(H)— | 0 |
| MeO | —CH₂C(CH₃)₂O— | H | ═C(H)— | 0 |
| EtO | —CH₂C(CH₃)₂O— | H | ═C(H)— | 0 |
| PrO | —CH₂C(CH₃)₂O— | H | ═C(H)— | 0 |

TABLE 35

| | | | | | |
|---|---|---|---|---|---|
| R³ | R⁵ | R⁶ | R⁷ | A² | n |

| | | | | |
|---|---|---|---|---|
| CHF₂CH₂O | —CH₂C(CH₃)₂O— | H | ═C(H)— | 0 |
| CF₃CH₂O | —CH₂C(CH₃)₂O— | H | ═C(H)— | 0 |
| iPrO | —CH₂C(CH₃)₂O— | H | ═C(H)— | 0 |
| MeS | —CH₂C(CH₃)₂O— | H | ═C(H)— | 0 |
| MeS(O) | —CH₂C(CH₃)₂O— | H | ═C(H)— | 0 |
| MeS(O)₂ | —CH₂C(CH₃)₂O— | H | ═C(H)— | 0 |
| EtS | —CH₂C(CH₃)₂O— | H | ═C(H)— | 0 |
| EtS(O) | —CH₂C(CH₃)₂O— | H | ═C(H)— | 0 |
| EtS(O)₂ | —CH₂C(CH₃)₂O— | H | ═C(H)— | 0 |
| PrS | —CH₂C(CH₃)₂O— | H | ═C(H)— | 0 |
| PrS(O) | —CH₂C(CH₃)₂O— | H | ═C(H)— | 0 |
| PrS(O)₂ | —CH₂C(CH₃)₂O— | H | ═C(H)— | 0 |
| CHF₂CH₂S | —CH₂C(CH₃)₂O— | H | ═C(H)— | 0 |
| CF₃CH₂S | —CH₂C(CH₃)₂O— | H | ═C(H)— | 0 |
| iPr | —CH₂C(CH₃)₂O— | H | ═C(H)— | 0 |
| iPrS(O) | —CH₂C(CH₃)₂O— | H | ═C(H)— | 0 |
| iPrS(O)₂ | —CH₂C(CH₃)₂O— | H | ═C(H)— | 0 |
| CF₃ | —CH₂C(CH₃)₂O— | H | ═C(H)— | 0 |

The compound represented by the following formula (1-B):

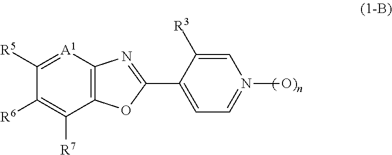

In the above formula (1-B), substituents used for R³, R⁵, R⁶, R⁷, A¹, and n are available in the combinations shown in the following Table 36 to Table 42.

TABLE 36

| R³ | R⁵ | R⁶ | R⁷ | A¹ | n |
|---|---|---|---|---|---|
| H | CH₃ | H | H | ═N— | 0 |
| F | CH₃ | H | H | ═N— | 0 |
| Cl | CH₃ | H | H | ═N— | 0 |
| Br | CH₃ | H | H | ═N— | 0 |
| I | CH₃ | H | H | ═N— | 0 |
| Me | CH₃ | H | H | ═N— | 0 |
| Et | CH₃ | H | H | ═N— | 0 |
| Pr | CH₃ | H | H | ═N— | 0 |
| CH₃OCH₂ | CH₃ | H | H | ═N— | 0 |
| MeO | CH₃ | H | H | ═N— | 0 |
| EtO | CH₃ | H | H | ═N— | 0 |
| PrO | CH₃ | H | H | ═N— | 0 |
| CHF₂CH₂O | CH₃ | H | H | ═N— | 0 |
| CF₃CH₂O | CH₃ | H | H | ═N— | 0 |
| iPrO | CH₃ | H | H | ═N— | 0 |
| MeS | CH₃ | H | H | ═N— | 0 |
| MeS(O) | CH₃ | H | H | ═N— | 0 |
| MeS(O)₂ | CH₃ | H | H | ═N— | 0 |
| EtS | CH₃ | H | H | ═N— | 0 |
| EtS(O) | CH₃ | H | H | ═N— | 0 |
| EtS(O)₂ | CH₃ | H | H | ═N— | 0 |
| PrS | CH₃ | H | H | ═N— | 0 |
| PrS(O) | CH₃ | H | H | ═N— | 0 |
| PrS(O)₂ | CH₃ | H | H | ═N— | 0 |

TABLE 37

| R³ | R⁵ | R⁶ | R⁷ | A¹ | n |
|---|---|---|---|---|---|
| CHF₂CH₂S | CH₃ | H | H | ═N— | 0 |
| CF₃CH₂S | CH₃ | H | H | ═N— | 0 |
| iPrS | CH₃ | H | H | ═N— | 0 |
| iPrS(O) | CH₃ | H | H | ═N— | 0 |
| IPrS(O)₂ | CH₃ | H | H | ═N— | 0 |
| CF₃ | CH₃ | H | H | ═N— | 0 |
| H | tBu | H | H | ═N— | 0 |
| F | tBu | H | H | ═N— | 0 |
| Cl | tBu | H | H | ═N— | 0 |
| Br | tBu | H | H | ═N— | 0 |
| I | tBu | H | H | ═N— | 0 |
| Me | tBu | H | H | ═N— | 0 |
| Et | tBu | H | H | ═N— | 0 |
| Pr | tBu | H | H | ═N— | 0 |
| CH₃OCH₂ | tBu | H | H | ═N— | 0 |
| MeO | tBu | H | H | ═N— | 0 |
| EtO | tBu | H | H | ═N— | 0 |
| PrO | tBu | H | H | ═N— | 0 |
| CHF₂CH₂O | tBu | H | H | ═N— | 0 |
| CF₃CH₂O | tBu | H | H | ═N— | 0 |
| iPrO | tBu | H | H | ═N— | 0 |
| MeS | tBu | H | H | ═N— | 0 |
| MeS(O) | tBu | H | H | ═N— | 0 |
| MeS(O)₂ | tBu | H | H | ═N— | 0 |

TABLE 38

| R³ | R⁵ | R⁶ | R⁷ | A¹ | n |
|---|---|---|---|---|---|
| EtS | tBu | H | H | ═N— | 0 |
| EtS(O) | tBu | H | H | ═N— | 0 |
| EtS(O)₂ | tBu | H | H | ═N— | 0 |
| PrS | tBu | H | H | ═N— | 0 |
| PrS(O) | tBu | H | H | ═N— | 0 |
| PrS(O)₂ | tBu | H | H | ═N— | 0 |
| CHF₂CH₂S | tBu | H | H | ═N— | 0 |
| CF₃CH₂S | tBu | H | H | ═N— | 0 |
| iPrS | tBu | H | H | ═N— | 0 |
| iPrS(O) | tBu | H | H | ═N— | 0 |
| iPrS(O)₂ | tBu | H | H | ═N— | 0 |
| CF₃ | tBu | H | H | ═N— | 0 |
| H | CF₃ | H | H | ═N— | 0 |
| F | CF₃ | H | H | ═N— | 0 |
| Cl | CF₃ | H | H | ═N— | 0 |
| Br | CF₃ | H | H | ═N— | 0 |
| I | CF₃ | H | H | ═N— | 0 |
| Me | CF₃ | H | H | ═N— | 0 |
| Et | CF₃ | H | H | ═N— | 0 |
| Pr | CF₃ | H | H | ═N— | 0 |
| CH₃OCH₂ | CF₃ | H | H | ═N— | 0 |
| MeO | CF₃ | H | H | ═N— | 0 |
| EtO | CF₃ | H | H | ═N— | 0 |
| PrO | CF₃ | H | H | ═N— | 0 |

TABLE 39

| R³ | R⁵ | R⁶ | R⁷ | A¹ | n |
|---|---|---|---|---|---|
| CHF₂CH₂O | CF₃ | H | H | ═N— | 0 |
| CF₃CH₂O | CF₃ | H | H | ═N— | 0 |
| iPrO | CF₃ | H | H | ═N— | 0 |
| MeS | CF₃ | H | H | ═N— | 0 |
| MeS(O) | CF₃ | H | H | ═N— | 0 |
| MeS(O)₂ | CF₃ | H | H | ═N— | 0 |
| EtS | CF₃ | H | H | ═N— | 0 |
| EtS(O) | CF₃ | H | H | ═N— | 0 |
| EtS(O)₂ | CF₃ | H | H | ═N— | 0 |
| PrS | CF₃ | H | H | ═N— | 0 |
| PrS(O) | CF₃ | H | H | ═N— | 0 |
| PrS(O)₂ | CF₃ | H | H | ═N— | 0 |
| CHF₂CH₂S | CF₃ | H | H | ═N— | 0 |
| CF₃CH₂S | CF₃ | H | H | ═N— | 0 |
| iPrS | CF₃ | H | H | ═N— | 0 |
| iPrS(O) | CF₃ | H | H | ═N— | 0 |
| iPrS(O)₂ | CF₃ | H | H | ═N— | 0 |
| CF₃ | CF₃ | H | H | ═N— | 0 |
| H | H | tBu | H | ═N— | 0 |
| F | H | tBu | H | ═N— | 0 |
| Cl | H | tBu | H | ═N— | 0 |
| Br | H | tBu | H | ═N— | 0 |
| I | H | tBu | H | ═N— | 0 |
| Me | H | tBu | H | ═N— | 0 |

TABLE 40

| R³ | R⁵ | R⁶ | R⁷ | A¹ | n |
|---|---|---|---|---|---|
| Et | H | tBu | H | ═N— | 0 |
| Pr | H | tBu | H | ═N— | 0 |
| CH₃OCH₂ | H | tBu | H | ═N— | 0 |
| MeO | H | tBu | H | ═N— | 0 |
| EtO | H | tBu | H | ═N— | 0 |
| PrO | H | tBu | H | ═N— | 0 |
| CHF₂CH₂O | H | tBu | H | ═N— | 0 |
| CF₃CH₂O | H | tBu | H | ═N— | 0 |
| iPrO | H | tBu | H | ═N— | 0 |
| MeS | H | tBu | H | ═N— | 0 |
| MeS(O) | H | tBu | H | ═N— | 0 |
| MeS(O)₂ | H | tBu | H | ═N— | 0 |
| EtS | H | tBu | H | ═N— | 0 |
| EtS(O) | H | tBu | H | ═N— | 0 |
| EtS(O)₂ | H | tBu | H | ═N— | 0 |
| PrS | H | tBu | H | ═N— | 0 |
| PrS(O) | H | tBu | H | ═N— | 0 |
| PrS(O)₂ | H | tBu | H | ═N— | 0 |
| CHF₂CH₂S | H | tBu | H | ═N— | 0 |
| CF₃CH₂S | H | tBu | H | ═N— | 0 |
| iPrS | H | tBu | H | ═N— | 0 |
| iPrS(O) | H | tBu | H | ═N— | 0 |
| iPrS(O)₂ | H | tBu | H | ═N— | 0 |
| CF₃ | H | tBu | H | ═N— | 0 |

TABLE 41

| R³ | R⁵ | R⁶ | R⁷ | A¹ | n |
|---|---|---|---|---|---|
| H | H | CF₃ | H | ═N— | 0 |
| F | H | CF₃ | H | ═N— | 0 |
| Cl | H | CF₃ | H | ═N— | 0 |
| Br | H | CF₃ | H | ═N— | 0 |
| I | H | CF₃ | H | ═N— | 0 |
| Me | H | CF₃ | H | ═N— | 0 |
| Et | H | CF₃ | H | ═N— | 0 |
| Pr | H | CF₃ | H | ═N— | 0 |
| CH₃OCH₂ | H | CF₃ | H | ═N— | 0 |
| MeO | H | CF₃ | H | ═N— | 0 |
| EtO | H | CF₃ | H | ═N— | 0 |
| PrO | H | CF₃ | H | ═N— | 0 |
| CHF₂CH₂O | H | CF₃ | H | ═N— | 0 |
| CF₃CH₂O | H | CF₃ | H | ═N— | 0 |
| iPrO | H | CF₃ | H | ═N— | 0 |
| MeS | H | CF₃ | H | ═N— | 0 |
| MeS(O) | H | CF₃ | H | ═N— | 0 |
| MeS(O)₂ | H | CF₃ | H | ═N— | 0 |
| EtS | H | CF₃ | H | ═N— | 0 |
| EtS(O) | H | CF₃ | H | ═N— | 0 |
| EtS(O)₂ | H | CF₃ | H | ═N— | 0 |
| PrS | H | CF₃ | H | ═N— | 0 |
| PrS(O) | H | CF₃ | H | ═N— | 0 |
| PrS(O)₂ | H | CF₃ | H | ═N— | 0 |

TABLE 42

| R³ | R⁵ | R⁶ | R⁷ | A¹ | n |
|---|---|---|---|---|---|
| CHF₂CH₂S | H | CF₃ | H | ═N— | 0 |
| CF₃CH₂S | H | CF₃ | H | ═N— | 0 |
| iPrS | H | CF₃ | H | ═N— | 0 |
| iPrS(O) | H | CF₃ | H | ═N— | 0 |
| iPrS(O)₂ | H | CF₃ | H | ═N— | 0 |
| CF₃ | H | CF₃ | H | ═N— | 0 |

The composition of the present invention may comprise a single species of the present active compound, or two or more species of the present active compounds. The composition of the present invention preferably comprises one or more and three or less species of the present active compounds.

For the present active compound, stereoisomers thereof may exist, and the present invention includes these isomers and mixture of these isomers.

The present active compound may form agrichemically acceptable salts. Examples of these salts include salts with inorganic bases (for example, alkali metals such as sodium, potassium and lithium, alkaline earth metals such as calcium and magnesium, and ammonia), organic bases (for example, pyridine, collidine, triethylamine and triethanolamine), inorganic acids (for example, hydrochloric acid, hydrobromic acid, hydroiodic acid, phosphoric acid, sulfuric acid and perchloric acid), organic acids (for example, formic acid, acetic acid, tartaric acid, malic acid, citric acid, oxalic acid, succinic acid, benzoic acid, picric acid, methanesulfonic acid and p-toluenesulfonic). The present active compound for use in the present invention include these salts.

Pyrethroid compounds for use in the composition of the present invention in combination with the present active compound will be described below.

The pyrethroid compounds are known compounds. Examples of the pyrethroid compounds include (1) esfenvalerate, (2) fenpropathrin, (3) fenvalerate, (4) alpha-cypermethrin, (5) bifenthrin, (6) cypermethrin, (7) deltamethrin, (8) ethofenprox, (9) lambda-cyhalothrin, (10) permethrin, (11) tefluthrin and (12) zeta-cypermethrin.

Esfenvalerate is described in “The Pesticide Manual, Fourteenth Edition” (edited by Clive Tomlin, published by The British Crop Protection Council and The Royal Society of Chemistry, 2006), No. 314 and commercially available.

Fenpropathrin is described in “The Pesticide Manual, Fourteenth Edition” (edited by Clive Tomlin, published by The British Crop Protection Council and The Royal Society of Chemistry, 2006), No. 353 and commercially available.

Fenvalerate is described in “The Pesticide Manual, Fourteenth Edition” (edited by Clive Tomlin, published by The British Crop Protection Council and The Royal Society of Chemistry, 2006), No. 360 and commercially available.

Alpha-cypermethrin is described in “The Pesticide Manual, Fourteenth Edition” (edited by Clive Tomlin, published by The British Crop Protection Council and The Royal Society of Chemistry, 2006), No. 205 and commercially available.

Bifenthrin is described in “The Pesticide Manual, Fourteenth Edition” (edited by Clive Tomlin, published by The British Crop Protection Council and The Royal Society of Chemistry, 2006), No. 78 and commercially available.

Cypermethrin is described in “The Pesticide Manual, Fourteenth Edition” (edited by Clive Tomlin, published by The British Crop Protection Council and The Royal Society of Chemistry, 2006), No. 204 and commercially available.

Deltamethrin is described in “The Pesticide Manual, Fourteenth Edition” (edited by Clive Tomlin, published by The British Crop Protection Council and The Royal Society of Chemistry, 2006), No. 226 and commercially available.

Ethofenprox is described in “The Pesticide Manual, Fourteenth Edition” (edited by Clive Tomlin, published by The British Crop Protection Council and The Royal Society of Chemistry, 2006), No. 331 and commercially available.

Lambda-cyhalothrin is described in “The Pesticide Manual, Fourteenth Edition” (edited by Clive Tomlin, published by The British Crop Protection Council and The Royal Society of Chemistry, 2006), No. 201 and commercially available.

Permethrin is described in “The Pesticide Manual, Fourteenth Edition” (edited by Clive Tomlin, published by The British Crop Protection Council and The Royal Society of Chemistry, 2006), No. 646 and commercially available.

Tefluthrin is described in “The Pesticide Manual, Fourteenth Edition” (edited by Clive Tomlin, published by The British Crop Protection Council and The Royal Society of Chemistry, 2006), No. 789 and commercially available.

Zeta-cypermethrin is described in “The Pesticide Manual, Fourteenth Edition” (edited by Clive Tomlin, published by The British Crop Protection Council and The Royal Society of Chemistry, 2006), No. 208 and commercially available.

The composition of the present invention may comprise a single species of the pyrethroid compound, or two or more species of the pyrethroid compounds. The composition of the present invention preferably comprises one or more and three or less species of the pyrethroid compounds.

For the pyrethroid compound, stereoisomers thereof may exist, and the present invention includes these isomers and mixture of these isomers.

In the composition of the present invention, the weight ratio of the present active compound to the pyrethroid compound is typically in the range of 0.1:99.9 to 99.9:0.1, preferably 20:80 to 80:20.

In general, the composition of the present invention comprises carriers and the like as described later, and they can be a preparation in the form of agrochemicals or animal drugs.

The composition of the present invention can be prepared, for example, as the following formulations according to known methods such as dissolution or dispersion of the present active compound and the pyrethroid compound in a suitable liquid carrier, mixing or adsorption of the present active compound and the pyrethroid compound with or on a suitable solid carrier or ointment base, or mixing or dispersion of the present active compound and the pyrethroid compound with or in a suitable gaseous carrier.

Examples of the formulations include an emulsion, an aqueous liquid agent, a microemulsion, a flowable agent, an oil agent, a wettable powder, a granulated wettable powder, a powder, a granule, a microgranule, a seed coating agent, a seed immersing agent, a fumigant, a tablet, a microcapsule, a spray, an aerosol, a carbon dioxide preparation, heated vaporization agents such as a mosquito coil, an electric mosquito mat or an electric mosquito liquid, an EW agent, an ointment, a toxic bait, a capsule, a pellet, a film, an injection, an embrocation, a resin preparation, and a shampoo.

During the preparation of the present composition, auxiliary agents for formulations such as an emulsifier, a suspending agent, a spreading agent, a penetrant, a wetting agent, a thickener, a stabilizer, a fixer, a binder, a dispersant, or a colorant may be added, as necessary.

Examples of the liquid carrier include: the substances listed in the EPA list (List Nos. 4A and 4B); water; alcohols (e.g. methyl alcohol, ethyl alcohol, n-propyl alcohol, isopropyl alcohol, butyl alcohol, hexyl alcohol, benzyl alcohol, ethylene glycol, propylene glycol, phenoxyethanol, etc.); ketones (e.g. acetone, methyl ethyl ketone, methyl isobutyl ketone, cyclohexanone, etc.); ethers (e.g. diisopropyl ether, 1,4-dioxane, tetrahydrofuran, ethylene glycol monomethyl ether, ethylene glycol dimethyl ether, diethylene glycol monomethyl ether, propylene glycol monomethyl ether, dipropylene glycol monomethyl ether, 3-methoxy-3-methyl-1-butanol, etc.); aliphatic hydrocarbons (e.g. hexane, cyclohexane, kerosine, coal oil, burning oil, machine oil, etc.); aromatic hydrocarbons (e.g. toluene, xylene, ethylbenzene, dodecylbenzene, phenyl xylyl ethane, solvent naphtha, methylnaphthalene, etc.); halogenated hydrocarbons (e.g. dichloromethane, trichloroethane, chloroform, carbon tetrachloride, etc.); acid amides (e.g. N,N-dimethylformamide, N,N-dimethylacetamide, N-methylpyrrolidone, N-octylpyrrolidone, etc.); esters (e.g. butyl lactate, ethyl acetate, butyl acetate, isopropyl myristate, ethyl oleate, diisopropyl adipate, diisobutyl adipate, propylene glycol monomethyl ether acetate, fatty acid glycerin ester, γ-butyrolactone, etc.); nitriles (e.g. acetonitrile, isobutyronitrile, propionitrile, etc.); carbonates (e.g. propylene carbonate, etc.); and vegetable oils (e.g. soybean oil, olive oil, linseed oil, coconut oil, copra oil, peanut oil, wheat germ oil, almond oil, sesame oil, mineral oil, rosemary oil, geranium oil, rapeseed oil, cottonseed oil, corn oil, safflower oil, orange oil, etc.). In the above-mentioned preparation, only a single type of liquid carrier may be used, or two or more types of liquid carriers may also be used. Preferably, one or more types to three or less types of liquid carriers are used. When two or more types of the liquid carriers are used, the liquid carriers may be mixed at an appropriate ratio and may be then used, depending on intended use and the like.

Examples of the solid carrier (diluent/thickener) include: the substances listed in the EPA list (List Nos. 4A and 4B); and micropowders and grains such as vegetable flours (e.g. soybean flour, tobacco flour, wheat flour, wood flour, etc.); mineral powders (e.g. clay such as kaoline clay, Fubasami clay, bentonite or Japanese acid clay; talc such as talcum powder or Roseki powder; silica such as diatomaceous earth or mica powder; etc.); synthetic hydrated silicon oxide; alumina; talc; ceramic; other inorganic minerals (sericite, quarz, sulfur, activated carbon, calcium carbonate, hydrated silica, etc.); and chemical fertilizers (ammonium sulfate, ammonium phosphate, ammonium nitrate, urea, ammonium chloride). In the above-mentioned preparation, only a single type of the solid carrier may be used, or two or more types of the solid carriers may also be used. Preferably, one or more types to three or less types of the solid carriers are used. When two or more types of the solid carriers are used, the solid carriers may be mixed at an appropriate ratio and may be then used, depending on intended use and the like.

Examples of the gaseous carrier include the substances disclosed in the EPA list (List Nos. 4A and 4B), fluorocarbon, butane gas, LPG (liquefied petroleum gas), dimethyl ether, and carbon dioxide. In the above-mentioned preparation, only a single type of the gaseous carrier may be used, or two or more types of the gaseous carriers may also be used. Preferably, one or more types to three or less types of the gaseous carriers are used. When two or more types of the gaseous carriers are used, the gaseous carriers may be mixed at an appropriate ratio and may be then used, depending on intended use and the like. It may also be used in combination with the liquid carrier.

Examples of the ointment base include: the substances disclosed in the EPA list (List Nos. 4A and 4B); polyethylene glycol; pectin; polyhydric alcohol esters of higher fatty acids, such as glycerin monostearate; cellulose derivatives such as methylcellulose; sodium alginate; higher alcohol; polyhydric alcohol such as glycerin; Vaseline; white petrolatum; liquid paraffin; lard; various types of vegetable oils; lanolin; anhydrous lanolin; hydrogenated oil; and resins. In the above-mentioned preparation, only a single type of ointment base may be used, or two or more types of the ointment bases may also be used. Preferably, one or more types to three or less types of the ointment bases are used. When two or more types of the ointment bases are used, the ointment bases may be mixed at an appropriate ratio and may be then used, depending on intended use and the like. Otherwise, the surfactants as described below may be added to the medicament, and may be then used.

In the medicament, a surfactant may be used as an emulsifier, a spreading agent, a penetrant, a dispersant, or the like.

Examples of such surfactant include nonionic and anionic surfactants such as: soaps; polyoxyethylene alkyl aryl ethers [e.g. Noigen (product name), EA142 (product name), manufactured by Dai-Ich Kogyo Seiyaku Co., Ltd; Nonal (product name), manufactured by Toho Chemical Industry Co., Ltd.]; alkyl sulfates [e.g. Emal 10 (product name), Emal 40 (product name), manufactured by Kao Corporation]; alkylbenzene sulfonates [e.g. Neogen (product name), Neogen T (product name), manufactured by Dai-Ichi Kogyo Seiyaku Co., Ltd.; Neoperex, manufactured by Kao Corporation]; polyethylene glycol ethers [e.g. Nonipol 85 (product name), Nonipol 100 (product name), Nonipol 160 (product name), manufactured by Sanyo Chemical Industries Ltd.]; polyoxyethylene alkyl ethers [e.g. Noigen ET-135 (product name), manufactured by Dai-Ich Kogyo Seiyaku Co., Ltd.]; polyoxyethylene-polyoxypropylene block polymers [e.g. Newpol PE-64 (product name), Sanyo Chemical Industries Ltd.]; polyhydric alcohol esters [e.g. Tween 20 (product name), Tween 80 (product name), manufactured by Kao Corporation]; alkyl sulfosuccinates [e.g. Sanmorin OT20 (product name), Sanyo Chemical Industries Ltd.; Newkalgen EX70 (product name), Takemoto Yushi K.K.]; alkyl naphthalene sulfonates [e.g. Newkalgen WG-1 (product name), Takemoto Yushi K.K.]; and alkenyl sulfonates [e.g. Sorpol 5115 (product name), Toho Chemical Co., Ltd.]. One or more types of (preferably one or more types to three or less types of) such surfactants may be mixed at an appropriate ratio and may be then used.

Other specific examples of the auxiliary agent for the medicament include casein, gelatin, sugars (starch, gum Arabic, a cellulose derivative, alginic acid, etc.), a lignin derivative, bentonite, a synthetic water-soluble polymer (polyvinyl alcohol, polyvinylpyrrolidone, polyacrylic acids, etc.), PAP (acidic isopropyl phosphate), BHT (2,6-di-tert-butyl-4-methylphenol), and BHA (a mixture of 2-tert-butyl-4-methoxyphenol and 3-tert-butyl-4-methoxyphenol).

The composition of the present invention may also comprise an insecticide, an acaricide, a nematicide, a microbicide, a plant hormone agent, a plant growth-control agent, a herbicide, a synergist or an antidote, in addition to the present active compound and the pyrethroid compound.

The content of the present active compound and the pyrethroid compound in the composition of the present invention is generally 0.01% to 95% by weight, preferably approximately 0.1% to 90% by weight, and more preferably approximately 5% to 70% by weight, based on the total amount of the composition of the present invention.

Specifically, when the composition of the present invention is in the form of an emulsion, a liquid agent, a wettable powder, or a granule wettable powder, the content of the present active compound is generally approximately 1% to 90% by weight, and preferably approximately 5% to 50% by weight, based on the total amount of the composition of the present invention. When the composition of the present invention is in the form of an oil agent or a powder agent, the content of the present active compound is generally approximately 0.1% to 50% by weight, and preferably approximately 0.1% to 20% by weight, based on the total amount of the composition of the present invention. When the composition of the present invention is in the form of a granule agent, the content of the present active compound is generally approximately 0.1% to 50% by weight, and preferably approximately 0.5% to 20% by weight, based on the total amount of the composition of the present invention.

The content of the other agricultural active ingredient (e.g. an insecticide, a herbicide, an acaricide and/or a microbicide) mixed into the composition of the present invention is preferably approximately 1% to 80% by weight, and more preferably approximately 1% to 20%, based on the total amount of the composition of the present invention.

The content of an additive other than the active ingredient differs depending on the type or content of an agricultural active ingredient, the formulation of a medicament, and the like. It is generally approximately 0.001% to 99.9% by weight, and preferably approximately 1% to 99% by weight, based on the total amount of the composition of the present invention. For example, a surfactant may be added at a percentage of generally approximately 1% to 20% by weight, and preferably approximately 1% to 15% by weight; a flowable agent may be added at a percentage of approximately 1% to 20% by weight; and a carrier may be added at a percentage of approximately 1% to 90% by weight, and preferably approximately 1% to 70% by weight, based on the total amount of the composition of the present invention. When the composition of the present invention is in the form of a liquid agent, a surfactant may be added at a percentage of generally 1% to 20% by weight, and preferably approximately 1% to 10% by weight, and water may be added at a percentage of approximately 20% to 90% by weight, based on the total amount of the composition of the present invention. Moreover, an emulsion, a wettable powder, a granule wettable powder, or the like may be appropriately extended with water or the like (for example, approximately 100 to 5,000 times) before use, and it may be then diffused.

Examples of an arthropod pest, on which the composition of the present invention has an effect, include the following harmful insects and harmful acarids.

Insect pests belonging to Hemiptera, including: Delphacidae such as Laodelphax striatellus, Nilaparvata lugens, or Sogatella furcifera; leafhoppers such as Nephotettix cincticeps, Nephotettix virescens, or Empoasca onukii; aphids such as Aphis gossypii, Myzus persicae, Brevicoryne brassicae, Aphis spiraecola, Macrosiphum euphorbiae, Aulacorthum solani, Rhopalosiphum padi, Toxoptera citricidus, or Hyalopterus pruni; Pentatomorpha such as Nezara antennata, Riptortus clavetus, Leptocorisa chinensis, Eysarcoris parvus, or Halyomorpha mista; white flies such as Trialeurodes vaporariorum, Bemisia tabaci, Dialeurodes citri, or Aleurocanthus spiniferus; scale insects such as Aonidiella aurantii, Comstockaspis perniciosa, Unaspis citri, Ceroplastes rubens, Icerya purchasi, Planococcus kraunhiae, Pseudococcus longispinis, or Pseudaulacaspis pentagona; tingis flies; bedbugs such as Cimex lectularius; psyllas; and others;

Insect pests belonging to Lepidoptera, including: pyralids such as Chilo suppressalis, Tryporyza incertulas, Cnaphalocrocis medinalis, Notarcha derogata, Plodia interpunctella, Ostrinia furnacalis, Hellula undalis, or Pediasia teterrellus; owlet moths such as Spodoptera litura, Spodoptera exigua, Pseudaletia separata, Mamestra brassicae, Agrotis ipsilon, Plusia nigrisigna, genus Trichoplusia, genus Heliothis, or genus Helicoverpa; cabbage butterflies such as Pieris rapae; tortrixes such as genus Adoxopheys, Grapholita molesta, Leguminivora glycinivorella, Matsumuraeses azukivora, Adoxophyes orana fasciata, Adoxophyes honmai, Homona magnanima, Archips fuscocupreanus, or Cydia pomonella; Gracillariidae such as Caloptilia theivora or Phyllonorycter ringoneella; Carposimidae such as Carposina niponensis; Lyonetiidae such as genus Lyonetia; Liparidae such as genus Lymantria or genus Euproctis; Yponomeutidae such as Plutella xylostella; Gelechiidae such as Pectinophora gossypiella or Phthorimaea operculella; Arctiidae such as Hyphantria cunea; Tineidae such as Tinea translucens or Tineola bisselliella; and others;

Insect pests belonging to Thysanoptera, including: thysanopterans such as Frankliniella occidentalis, Thrips parmi, Scirtothrips dorsalis, Thrips tabaci, or Frankliniella intonsa; and others;

Insect pests belonging to Diptera, including: Culex such as Culex pipiens pallens, Culex tritaeniorhynchus, or Culex quinquefasciatus; genus Aedes such as Aedes aegypti or Aedes albopictus; genus Anopheles such as Anopheles sinensis; Chironomus; Muscidae such as Musca domestica or Muscina stabulans; Calliphoridae; Sarcophagidae; Fanniidae; Anthomyiidae such as Delia platura or Delia antiqua; Agromyzidae such as Agromyza oryzae, Hydrellia griseola, Liriomyza sativae, Liriomyza trifolii, or Chromatomyia horticola; Carnoidea such as Chlorops oryzae; Tephritoidea such as Dacus cucurbitae or Ceratitis capitata; Drosophila; Phoridae such as Megaselia spiracularis; Psychodidae such as Clogmia albipunctata; Simuliidae; Tabanidae such as Tabanus trigonus; Stomoxys; and others;

Insect pests belonging to Coleoptera, including: Corn Rootworms such as Diabrotica virgifera virgifera or Diabrotica undecimpunctata howardi; Scarabaeidae such as Anomala cuprea, Anomala rufocuprea, or Popillia japonica; Curculionidae such as Sitophilus zeamais, Lissorhoptrus oryzophilus, Callosobruchuys chienensis, Echinocnemus squameus, Anthonomus grandis, or Sphenophorus venatus; Tenebrionoidea such as Tenebrio molitor or Tribolium castaneum;

Chrysomelidae such as Oulema oryzae, Aulacophora femoralis, Phyllotreta striolata, or Leptinotarsa decemlineata; Dermestidae such as Anthrenus verbasci or Dermestes maculates; Anobiidae such as Lasioderma serricorne; Epilachna such as Epilachna vigintioctopunctata; Scolytidae such as Lyctus brunneus or Tomicus piniperda; Bostrichidae; Ptimidae; Cerambycidae such as Anoplophora malasiaca; Agriotes spp.; Paederus fuscipes, and others;

Insect pests belonging to Orthoptera, including: Locusta migratoria, Gryllotalpa Africana, Oxya yezoensis, Oxya japonica, Grylloidea; and others;

Insect pests belonging to Siphonaptera, including Ctenocephalides felis, Ctenocephalides canis, Pulex irritans, Xenopsylla cheopis, and others;

Insect pests belonging to Anoplura, including Pediculus humanus corporis, Phthirus pubis, Haematopinus eurysternus, Dalmalinia ovis, Haematopinus suis, and others;

Insect pests belonging to Hymenoptera, including: Formicidae such as Monomorium pharaosis, Formica fusca japonica, Ochetellus glaber, Pristomyrmex pungens, Pheidole noda, Acromyrmex spp., Solenopsis spp.; Vespidae; Bethylidae; Tenthredinidae such as Athalia rosae or Athalia japonica; and others;

Insect pests belonging to Blattariae, including: Blattella germanica, Periplaneta fuliginosa, Periplaneta americana, Periplaneta brunnea, Blatta orientalis, and others;

Insect pests belonging to Acarina, including: Tetranychidae such as Tetranychus urticae, Tetranychus kanzawai, Panonychus citri, Panonychus ulmi, or genus Oligonicus; Eriophyidae such as Aculops pelekassi, Phyllocoptruta citri, Aculops lycopersici, Calacarus carinatus, Acaphylla theavagrans, Eriophyes chibaensis, or Aculus schlechtendali; Tarsonemidae such as Polyphagotarsonemus latus; Tenuipalpidae such as Brevipalpus phoenicis; Tuckerellidae; Ixodidae such as Haemaphysalis longicornis, Haemaphysalis flava, Dermacentor taiwanicus, Ixodes ovatus, Ixodes persulcatus, Ixodes scapularis, Boophilus microplus, or Rhipicephalus sanguineus; Acaridae such as Tyrophagus putrescentiae or Tyrophagus similis; Epidermoptidae such as Dermatophagoides farinae or Dermatophagoides ptrenyssnus; Cheyletidae such as Cheyletus eruditus, Cheyletus malaccensis, or Cheyletus moorei; Dermanyssidae such as Ornithonyssus bacoti, Ornithonyssus sylvairum, or Dermanyssus gallinae; Trombiculidae such as Leptotrombidium akamushi; Arachnida such as Chiracanthium japonicum or Latrodectus hasseltii; and others;

Chilopoda including Thereuonema hilgendorfi, Scolopendra subspinipes, and others;

Diplopoda including Oxidus gracilis, Nedyopus tambanus, and others;

Isopoda including Armadillidium vulgare, and others; and

Gastropoda including Limax marginatus, Limax flavus, and others.

Arthropod pests, on which the composition of the present invention has a high effect, are insect pests belonging to Hemiptera.

Among the arthropod pests, an example of insect pest to timber products is Isoptera. Specific examples of such Isoptera will be given below.

Mastotermitidae, Termopsidae [genus Zootermopsis, genus Archotermopsis, genus Hodotermopsis, genus Porotermes, and genus Stolotermes], Kalotermitidae [genus Kalotermes, genus Neotermes, genus Cryptotermes, genus Incistermes, and genus Glyptotermes], Hodotermitidae [genus Hodotermes, genus Microhodotermes, and genus Anacanthotermes], Rhinotermitidae [genus Reticulitermes, genu Heterotermes, genus Coptotermes, and genus Schedolinotermes], Serritermitidae, and Termitidae {genus Amitermes, genus Drepanotermes, genus Hopitalitermes, genus Trinervitermes, genus Macrotermes, genus Odontotermes, genus Microtermes, genus Nasutitermes, genus Pericapritermes, and genus Anoplotermes}.

Of these, specific examples of Isoptera as a target to be controlled include Reticulitermes speratus, Coptotermes formosanus, Incisitermes minor, Cryptotermes domesticus, Odontotermes formosanus, Neotermes koshunensis, Glyptotermes satsumensis, Glyptotermes nakajimai, Glyptotermes fuscus, Glyptotermes kodamai, Glyptotermes kushimensis, Hodotermopsis japonica, Coptotermes guangzhoensis, Reticulitermes miyatakei, Reticulitermes flaviceps amamianus, Reticulitermes sp., Nasutitermes takasagoensis, Pericapritermes nitobei, Sinocapritermes mushae, Reticulitermes flavipes, Reticulitermes hesperus, Reticulitermes virginicus, Reticulitermes tibialis, Heterotermes aureus, and Zootermopsis nevadensis.

Insects other than Isoptera that are harmful to timber products include coleopteran insects such as Lyctidae, Bostrichidae, Anobiidae, and Cerambycidae.

The composition of the present invention can be used to control arthropods internally or externally parasitizing in vertebrate animals such as a human, a bovine, a sheep, a goat, a swine, a fowl, a dog, a cat, and fish in the field of treatment of animal diseases and in the livestock industry, so as to maintain public health. Examples of such harmful organisms include: Ixodes spp. such as Ixodes scapularis; Boophilus spp. such as Boophilus microplus; Amblyomma spp.; Hyalomma spp.; Rhipicephalus spp. such as Rhipicephalus sanguineus; Haemaphysalis spp. such as Haemaphysalis longicornis; Dermacentor spp.; Ornithodoros spp. such as Ornithodoros moubata; Dermahyssus gallinae; Ornithonyssus sylviarum; Sarcoptes spp. such as Sarcoptes scabiei; Psoroptes spp.; Chorioptes spp.; Demodex spp.; Eutrombicula spp.; Aedes spp. such as Aedes albopictus; Anopheles spp.; Culex spp.; Culicodes spp.; Musca spp.; Hypoderma spp.; Gasterophilus spp.; Haematobia spp.; Tabanus spp.; Simulium spp.; Triatoma spp.; Phthiraptera such as Damalinia spp., Linognathus spp., or Haematopinus spp.; Ctenocephalides spp. such as Ctenocephalides felis; Xenosylla spp.; and Monomorium pharaonis.

In the method for controlling arthropod pests of the present invention (hereinafter, sometimes referred to as “the controlling method of the present invention”), effective amounts of the present active compound and the pyrethroid compound are applied to the arthropod pests or a locus where the arthropod pests inhabit.

In the controlling method of the present invention, effective amounts of the present active compound and the pyrethroid compound are applied to a plant or soil for growing plant.

By the controlling method of the present invention, arthropod pests can be controlled.

According to the control method of the present invention, the present active compound and the pyrethroid compound may be directly applied without any other ingredients, or the present active compound and the pyrethroid compound may be applied in combination with the above-described other agents such as an insecticide, an acaricide, a nematicide, or a microbicide. Alternatively, the present active compound and the pyrethroid compound may also be applied in combination with natural enemy organisms or natural enemy microorganisms. The present active compound and the pyrethroid compound may be separately applied for the same period, but those are typically applied as the composition of the present invention in terms of simplicity of the application.

Examples of the areas where the arthropod pests inhabit include a plant, a paddy field, a dry field, a farm land, a tea garden, an orchard, a nonagricultural land, a house, a seedling-raising tray, a seedling-raising box, a seedling-raising soil, a seedling-raising mat, and a water culture medium in a hydroponic farm.

As a plant which is the object of application, stalk and leaves of the plant, seed of the plant, seed tuber of the plant, bulbs of the plant and seedling of the plant can be included. Here, the bulb means a bulb, corm, rhizoma, stem tuber, root tuber and rhizophore.

In the control method of the present invention, the present active compound and the pyrethroid compound can be applied to arthropod pests or areas where arthropod pests inhabit by allowing the compound to come into contact with the arthropod pests or causing the arthropod pests to ingest the compound, according to the same method as in the case of conventional arthropod pest control agents.

Examples of such application method include a spraying treatment, a soil treatment, a seed treatment, and a water culture medium treatment.

The spraying treatment is a treatment method, which comprises spraying an active ingredient (the present active compound and the pyrethroid compound) onto the surface of a plant body, for example, according to foliage spraying or truck spraying, or onto an arthropod pest itself, so as to exhibit a controlling effect on the arthropod pests.

The soil treatment is, for example, a treatment method, which comprises giving an active ingredient to the root portion of a crop to be protected so as to directly control arthropod pests, or penetrating such active ingredient into a plant body to control such arthropod pests.

Specific examples of the soil treatment include a planting hole treatment (planting hole spraying and planting hole-treated soil mixture), a seedling treatment (seedling spraying, seedling soil mixture, seedling irrigation, and a seedling treatment in the latter part of a seedling-raising period), a planting ditch treatment (planting ditch spraying and planting ditch soil mixture), a planting row treatment (planting row spraying, planting row soil mixture, and planting row spraying in a growing period), a planting row treatment during a seeding time (planting row spraying during a seeding time and planting row soil mixture during a seeding time), a total treatment (total soil spraying and total soil mixture), a side row treatment, a water surface treatment (water surface application and water surface application after flooding), other soil spraying treatments (the spraying of a granule agent onto leave during a growing period, the spraying of the agent to below the tree crown or around the main stem, the spraying of the agent onto the soil surface, soil surface mixture, planting hole spraying, furrow surface spraying, and the spraying of the agent to between stocks), other irrigation treatments (soil irrigation, irrigation in a seeding-raising period, an agent injection treatment, irrigation to a soil-contacting portion of plant, agent drip irrigation, and chemigation), a seedling-raising box treatment (seedling-raising box spraying, seedling-raising box irrigation, and the flooding of a seedling-raising box with an agent liquid), a seedling-raising tray treatment (seedling-raising tray spraying, seedling-raising tray irrigation, and the flooding of a seedling-raising tray with an agent liquid), a seedbed treatment (seedbed spraying, seedbed irrigation, flooded nursery seedbed spraying, and nursery immersion), a seedbed soil mixing treatment (seedbed soil mixing, seedbed soil mixture before seeding, spraying before cover soil in a seeding time, spraying after cover soil in a seeding time, and cover soil mixing), and other treatments (seeding soil mixture, plowing, surface soil mixture, the mixing of a rain-dropping portion of soil, a planting position treatment, the spraying of a granule agent to inflorescence, and paste fertilizer mixture).

The seed treatment is a treatment method, which comprises directly treating with an active ingredient, seeds, seed potatoes, bulbs, etc. of crops to be protected, or treating the neighborhood thereof with such active ingredient, so as to exhibit a control effect on arthropod pests. Specific examples of the seed treatment include a spraying treatment, a smearing treatment, an immersion treatment, an impregnation treatment, an application treatment, a film coating treatment, and a pellet coating treatment.

The water culture medium treatment is, for example, a treatment method, which comprises treating a water culture medium or the like with an active ingredient in order to infiltrate the active ingredient from the root portion of a crop to be protected to the internal portion thereof, so as to protect the crop from the damage caused by arthropod pests. Specific examples of the water culture medium treatment include water culture medium mixture and water culture medium incorporation.

The control method of the present invention can be conducted in agricultural or nonagricultural lands such as a farm land, a paddy field, a lawn, and an orchard.

When the present active compound and the pyrethroid compound are used to control arthropod pests in the agricultural field, the amount of application can be broadly altered depending on the kind and the occurring frequency of the pests to be controlled, formulation form, an application period, an application site, an application method, and climatic condition, etc. It is generally 1 to 10,000 g per 10,000 m². An emulsion, a wettable powder, a flowable agent or the like is diluted with water so that a concentration of the present active compound and the pyrethroid compound can be 0.01 to 10,000 ppm. A powder agent, a granule agent, or the like is generally applied as it is.

The present active compound and the pyrethroid compound or a water dilution thereof may be directly sprayed to arthropod pests or plants, or it may also be subjected to the soil treatment.

Otherwise, the present active compound and the pyrethroid compound may also applied using a resin preparation that is processed in the form of a sheet or a cord. The resin preparation comprising the present active compound may be twisted around crops, strung around the neighborhood of the crops, or spread on the planting soil.

The present invention can control insect pests in an agricultural land and the like, where the “plants” as described below and the like are cultivated, without giving harmful effects on the plants and the like.

Crops: corn, rice, wheat, barley, rye, oat, sorghum, cotton, soybean, peanut, buckwheat, sugarbeet, rapeseed, sunflower, sugarcane, tobacco, etc.

Vegetables: solanaceous vegetables (eggplant, tomato, pimento, pepper, potato, etc.), cucurbitaceous vegetables (cucumber, pumpkin, zucchini, watermelon, melon, etc.), brassicaceous vegetables (Japanese radish, turnip, horseradish, kohlrabi, Chinese cabbage, cabbage, leaf mustard, broccoli, cauliflower, etc.), asteraceous vegetables (burdock, Chrysanthemum coronarium, artichoke, lettuce, etc.), liliaceous vegetables (spring onion, onion, garlic, asparagus), umbelliferous vegetables (carrot, parsley, celery, parsnip, etc.), chenopodiaceous vegetables (spinach, silver beet, etc.), lamiaceous vegetables (Japanese basil, mint, basil, etc.), strawberry, sweet potato, Dioscorea japonica, colocasia antiquorum, and others.

Fruit trees; pome fleshy fruits (apple, pear, Japanese pear, amboyna, quince, etc.), stone fleshy fruits (peach, plum, nectarine, Prunus mume, Prunus avium, apricot, prune, etc.), citrus fruits (Citrus unshiu, orange, lemon, lime, grapefruit, etc.), nuts (malon, walnuts, hazelnuts, almond, pistachio, cashew nuts, macadamia nuts, etc.), sap fruits (blueberry, cranberry, blackberry, raspberry, etc.), grape, Japanese persimmon, olive, Eriobotrya japonica, banana, coffee, Phoenix dactylifera, Cocos nucifera, Elaeis guineensis, and others.

Trees other than fruit trees; tea tree, Moms alba, flowering plants, street trees (ash, birch, Benthamidia florida, Eucalyptus, Ginkgo biloba, lilac, maple, oak, poplar, Chinese redbud, Formosa sweet gum, plane tree, zelkova, Japanese arborvitae, fir, Japanese hemlock, needle juniper, pine, Japanese spruce, and Japanese yew), Jatropha, and others.

Lawns: lawn grasses (Zoysia japonica, Zoysia tenuifolia, etc.), Bermuda grasses (Cynodon dactylon, etc.), bent grasses (redtop grass, Agrostis stolonifera L., Agrostis capillaris L., etc.), blue grasses (Kentucky bluegrass, Poatrivialis L., etc.), festuca (Festuca arundinacea Schreb., Festuca rubra., creeping red fescue, etc.), ryegrasses (Australian ryegrass, perennial ryegrass, etc.), rchard grass, timothy, and others.

Others; flowers, foliage plants, and others.

The aforementioned “plants” include plants, to which resistance to HPPD inhibitors such as isoxaflutole, ALS inhibitors such as imazethapyr or thifensulfuron-methyl, EPSP synthetase inhibitors such as glyphosate, glutamine synthetase inhibitors such as the glufosinate, acetyl-CoA carboxylase inhibitors such as sethoxydim, PPO inhibitors such as flumioxazin, and herbicides such as bromoxynil, dicamba, 2,4-D, etc. has been conferred by a classical breeding method or genetic engineering technique.

Examples of a “plant” on which resistance has been conferred by a classical breeding method include rape, wheat, sunflower and rice resistant to imidazolinone ALS inhibitory herbicides such as imazethapyr, which are already commercially available under a product name of Clearfield (registered trademark). Similarly, there is soy bean on which resistance to sulfonylurea ALS inhibitory herbicides such as thifensulfuron-methyl has been conferred by a classical breeding method, which is already commercially available under a product name of STS soy bean. Similarly, examples on which resistance to acetyl-CoA carboxylase inhibitors such as trione oxime or aryloxy phenoxypropionic acid herbicides has been conferred by a classical breeding method include SR corn. The plant on which resistance to acetyl-CoA carboxylase inhibitors has been conferred is described in Proceedings of the National Academy of Sciences of the United States of America (Proc. Natl. Acad. Sci. USA), vol. 87, pp. 7175-7179 (1990). A variation of acetyl-CoA carboxylase resistant to an acetyl-CoA carboxylase inhibitor is reported in Weed Science, vol. 53, pp. 728-746 (2005) and a plant resistant to acetyl-CoA carboxylase inhibitors can be generated by introducing a gene of such an acetyl-CoA carboxylase variation into a plant by genetically engineering technology, or by introducing a variation conferring resistance into a plant acetyl-CoA carboxylase. Furthermore, plants resistant to acetyl-CoA carboxylase inhibitors or ALS inhibitors or the like can be generated by introducing a site-directed amino acid substitution variation into an acetyl-CoA carboxylase gene or the ALS gene of the plant by introduction a nucleic acid into which has been introduced a base substitution variation represented Chimeraplasty Technique (Gura T. 1999. Repairing the Genome's Spelling Mistakes. Science 285: 316-318) into a plant cell.

Examples of a plant on which resistance has been conferred by genetic engineering technology include corn, soy bean, cotton, rape, sugar beet resistant to glyphosate, which is already commercially available under a product name of RoundupReady (registered trademark), AgrisureGT, etc. Similarly, there are corn, soy bean, cotton and rape which are made resistant to glufosinate by genetic engineering technology, a kind, which is already commercially available under a product name of LibertyLink (registered trademark). A cotton made resistant to bromoxynil by genetic engineering technology is already commercially available under a product name of BXN likewise.

The aforementioned “plants” include genetically engineered crops produced using such genetic engineering techniques, which, for example, are able to synthesize selective toxins as known in genus Bacillus.

Examples of toxins expressed in such genetically engineered crops include: insecticidal proteins derived from Bacillus cereus or Bacillus popilliae; δ-endotoxins such as Cry1Ab, Cry1Ac, Cry1F, Cry1Fa2, Cry2Ab, Cry3A, Cry3Bb1 or Cry9C, derived from Bacillus thuringiensis; insecticidal proteins such as VIP1, VIP2, VIP3, or VIP3A; insecticidal proteins derived from nematodes; toxins generated by animals, such as scorpion toxin, spider toxin, bee toxin, or insect-specific neurotoxins; mold fungi toxins; plant lectin; agglutinin; protease inhibitors such as a trypsin inhibitor, a serine protease inhibitor, patatin, cystatin, or a papain inhibitor; ribosome-inactivating proteins (RIP) such as lycine, corn-RIP, abrin, luffin, saporin, or briodin; steroid-metabolizing enzymes such as 3-hydroxysteroid oxidase, ecdysteroid-UDP-glucosyl transferase, or cholesterol oxidase; an ecdysone inhibitor; HMG-COA reductase; ion channel inhibitors such as a sodium channel inhibitor or calcium channel inhibitor; juvenile hormone esterase; a diuretic hormone receptor; stilbene synthase; bibenzyl synthase; chitinase; and glucanase.

Toxins expressed in such genetically engineered crops also include: hybrid toxins of δ-endotoxin proteins such as Cry1Ab, Cry1Ac, Cry1F, Cry1Fa2, Cry2Ab, Cry3A, Cry3Bb1, Cry9C, Cry34Ab or Cry35Ab and insecticidal proteins such as VIP1, VIP2, VIP3 or VIP3A; partially deleted toxins; and modified toxins. Such hybrid toxins are produced from a new combination of the different domains of such proteins, using a genetic engineering technique. As a partially deleted toxin, Cry1Ab comprising a deletion of a portion of an amino acid sequence has been known. A modified toxin is produced by substitution of one or multiple amino acids of natural toxins.

Examples of such toxins and genetically engineered plants capable of synthesizing such toxins are described in EP-A-0 374 753, WO 93/07278, WO 95/34656, EP-A-0 427 529, EP-A-451 878, WO 03/052073, etc.

Toxins contained in such genetically engineered plants are able to confer resistance particularly to insect pests belonging to Coleoptera, Hemiptera, Diptera, Lepidoptera and Nematodes, to the plants.

Genetically engineered plants, which comprise one or multiple insecticidal pest-resistant genes and which express one or multiple toxins, have already been known, and some of such genetically engineered plants have already been on the market. Examples of such genetically engineered plants include YieldGard (registered trademark) (a corn variety for expressing Cry1Ab toxin), YieldGard Rootworm (registered trademark) (a corn variety for expressing Cry3Bb1 toxin), YieldGard Plus (registered trademark) (a corn variety for expressing Cry1 Ab and Cry3Bb1 toxins), Herculex I (registered trademark) (a corn variety for expressing phosphinotricine N-acetyl transferase (PAT) so as to confer resistance to Cry1Fa2 toxin and glufosinate), NuCOTN33B (registered trademark) (a cotton variety for expressing Cry1Ac toxin), Bollgard I (registered trademark) (a cotton variety for expressing Cry1Ac toxin), Bollgard II (registered trademark) (a cotton variety for expressing Cry1Ac and Cry2Ab toxins), VIPCOT (registered trademark) (a cotton variety for expressing VIP toxin), NewLeaf (registered trademark) (a potato variety for expressing Cry3A toxin), NatureGard (registered trademark) Agrisure (registered trademark) GT Advantage (GA21 glyphosate-resistant trait), Agrisure (registered trademark) CB Advantage (Bt11 corn borer (CB) trait), and Protecta (registered trademark).

The aforementioned “plants” also include crops produced using a genetic engineering technique, which have ability to generate antipathogenic substances having selective action.

A PR protein and the like have been known as such antipathogenic substances (PRPs, EP-A-0 392 225). Such antipathogenic substances and genetically engineered crops that generate them are described in EP-A-0 392 225, WO 95/33818, EP-A-0 353 191, etc.

Examples of such antipathogenic substances expressed in genetically engineered crops include: ion channel inhibitors such as a sodium channel inhibitor or a calcium channel inhibitor (KP1, KP4 and KP6 toxins, etc., which are produced by viruses, have been known); stilbene synthase; bibenzyl synthase; chitinase; glucanase; a PR protein; and antipathogenic substances generated by microorganisms, such as a peptide antibiotic, an antibiotic having a hetero ring, a protein factor associated with resistance to plant diseases (which is called a plant disease-resistant gene and is described in WO 03/000906). These antipathogenic substances and genetically engineered plants producing such substances are described in EP-A-0392225, WO95/33818, EP-A-0353191, etc.

The “plant” mentioned above includes plants on which advantageous characters such as characters improved in oil stuff ingredients or characters having reinforced amino acid content have been conferred by genetically engineering technology. Examples thereof include VISTIVE (registered trademark) low linolenic soy bean having reduced linolenic content) or high-lysine (high-oil) corn (corn with increased lysine or oil content).

Stack varieties are also included in which a plurality of advantageous characters such as the classic herbicide characters mentioned above or herbicide tolerance genes, harmful insect resistance genes, antipathogenic substance producing genes, characters improved in oil stuff ingredients or characters having reinforced amino acid content are combined.

When the present active compound and the pyrethroid compound are used to control arthropod pests that reside in a house (e.g. a fly, a mosquito, and a cockroach), the amount of the present active compound and the pyrethroid compound to be applied is generally 0.01 to 1,000 mg per m² of area to be treated, in the case of applying those to a floor. In the case of applying the active compound and the pyrethroid compound to a space, the amount applied thereof is generally 0.01 to 500 mg per m³ of space to be treated. An emulsion, a wettable powder, a flowable agent, or the like is generally diluted with water so that a concentration of the present active compound and the pyrethroid compound can be 0.1 to 1,000 ppm. An oil agent, an aerosol, a fumigant, a toxic bait, or the like is generally applied as it is.

### EXAMPLES

Hereinafter, the present invention will be described in more detail with reference to Production Examples of the present active compound, Reference Production Examples of the present active compound, Formulation Examples and Test Examples. However, the present invention is not necessarily limited to these Examples.

Production Examples of the present active compound will be given below.

### Production Example 1

A mixture of 1.2 g of 2-amino-4-propylphenol, 0.98 g of isonicotinic acid and 32.8 g of polyphosphoric acid was stirred while heating at 190° C. for five hours. The mixture was cooled to room temperature and then poured into an ice-cooled aqueous solution of sodium hydroxide, followed by extraction with ethyl acetate three times. The combined organic layers were washed with water and a saturated sodium chloride solution, and dried over magnesium sulfate. Activated carbon was added thereto, which was filtered through Celite™. The filtrate was concentrated under reduced pressure. The residue was subjected to silica gel column chromatography to give 0.72 g of 5-propyl-2-(pyridin-4-yl)-benzoxazole (hereinafter, referred to as “active compound 1”).

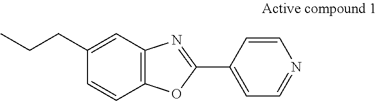

¹H-NMR (CDCl₃) δ: 8.81 (dd, J=4.6, 1.7 Hz, 2H), 8.08 (dd, J=4.5, 1.7 Hz, 2H), 7.62-7.60 (m, 1H), 7.54-7.50 (m, 1H), 7.27-7.23 (m, 1H), 2.74 (t, J=7.5 Hz, 2H), 1.76-1.66 (m, 2H), 1.31 (t, J=7.5 Hz, 3H)

### Production Example 2

Production Example 2 was carried out according to the same manner as in Production Example 1, using 2-amino-4-methylphenol instead of 2-amino-4-propylphenol to give 5-methyl-2-(pyridin-4-yl)-benzoxazole (hereinafter, referred to as “active compound 2”).

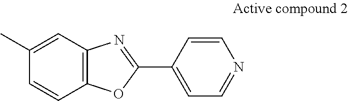

¹H-NMR (CDCl₃) δ: 8.81 (dd, J=4.5, 1.6 Hz, 2H), 8.07 (dd, J=4.5, 1.6 Hz, 2H), 7.62-7.59 (m, 1H), 7.52-7.48 (m, 1H), 7.25-7.22 (m, 1H), 2.51 (s, 3H)

### Production Example 3

Production Example 3 was carried out according to the same manner as in Production Example 1, using 2-amino-4-ethylphenol instead of 2-amino-4-propylphenol to give 5-ethyl-2-(pyridin-4-yl)-benzoxazole (hereinafter, referred to as “active compound 3”).

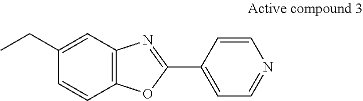

¹H-NMR (CDCl₃) δ: 8.81 (dd, J=4.6, 1.7 Hz, 2H), 8.07 (dd, J=4.4, 1.7 Hz, 2H), 7.64-7.62 (m, 1H), 7.52 (d, J=8.5 Hz, 1H), 7.27 (dd, J=8.5, 1.7 Hz, 1H), 2.80 (q, J=7.6 Hz, 2H), 1.31 (t, J=7.6 Hz, 3H)

### Production Example 4

Production Example 4 was carried out according to the same manner as in Production Example 1, using 2-amino-4-butylphenol instead of 2-amino-4-propylphenol to give 5-butyl-2-(pyridin-4-yl)-benzoxazole (hereinafter, referred to as “active compound 4”).

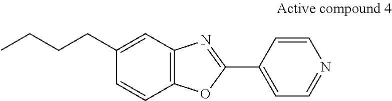

¹H-NMR (CDCl₃) δ: 8.81 (dd, J=4.4, 1.7 Hz, 2H), 8.08 (dd, J=4.6, 1.7 Hz, 2H), 7.62-7.61 (m, 1H), 7.53-7.50 (m, 1H), 7.27-7.23 (m, 1H), 2.76 (t, J=7.6 Hz, 2H), 1.71-1.62 (m, 2H), 1.44-1.33 (m, 2H), 0.95 (t, J=7.3 Hz, 3H)

### Production Example 5

Production Example 5 was carried out according to the same manner as in Production Example 1, using 2-amino-4-isopropylphenol instead of 2-amino-4-propylphenol to give 5-isopropyl-2-(pyridin-4-yl)-benzoxazole (hereinafter, referred to as “active compound 5”).

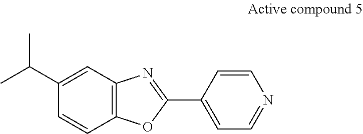

¹H-NMR (CDCl₃) δ: 8.82 (dd, J=4.5, 1.6 Hz, 2H), 8.08 (dd, J=4.5, 1.6 Hz, 2H), 7.68 (d, J=1.7 Hz, 1H), 7.53 (d, J=8.5 Hz, 1H), 7.31 (dd, J=8.4, 1.8 Hz, 1H), 3.11-3.04 (m, 1H), 1.33 (d, J=6.8 Hz, 6H)

### Production Example 6

Production Example 6 was carried out according to the same manner as in Production Example 1, using 2-amino-4-tert-butylphenol instead of 2-amino-4-propylphenol to give 5-tert-butyl-2-(pyridin-4-yl)-benzoxazole (hereinafter, referred to as “active compound 6”).

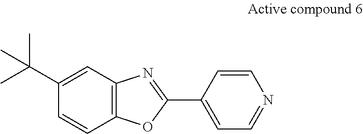

¹H-NMR (CDCl₃) δ: 8.83-8.80 (m, 2H), 8.09-8.06 (m, 2H), 7.86-7.83 (m, 1H), 7.56-7.48 (m, 2H), 1.41 (s, 9H)

### Production Example 7

Production Example 7 was carried out according to the same manner as in Production Example 1, using 2-amino-5-methylphenol instead of 2-amino-4-propylphenol to give 6-methyl-2-(pyridin-4-yl)-benzoxazole (hereinafter, referred to as “active compound 7”).

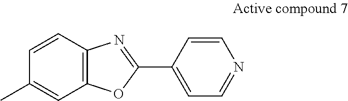

¹H-NMR (CDCl₃) δ: 8.81 (dd, J=4.5, 1.6 Hz, 2H), 8.07 (dd, J=4.5, 1.6 Hz, 2H), 7.69 (d, J=8.3 Hz, 1H), 7.43 (s, 1H), 7.23 (d, J=8.3 Hz, 1H), 2.53 (s, 3H)

### Production Example 8

A mixture of 1.22 g of N-(4-tert-butyl-2-hydroxyphenyl)isonicotinamide, 15 ml of carbon tetrachloride, 3.55 g of triphenylphosphine and 1.37 g of triethylamine was heated to reflux for three hours. The mixture was cooled to room temperature, and then water was poured into the mixture, followed by extraction with ethyl acetate twice. The combined organic layers were washed with a saturated sodium chloride solution, dried over magnesium sulfate, and then concentrated under reduced pressure. The residue was subjected to silica gel column chromatography to give 0.30 g of 6-tert-butyl-2-(pyridin-4-yl)-benzoxazole (hereinafter, referred to as “active compound 8”).

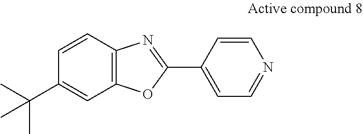

¹H-NMR (CDCl₃) δ: 8.81 (dd, J=4.6, 1.7 Hz, 2H), 8.07 (dd, J=4.4, 1.7 Hz, 2H), 7.74 (d, J=8.3 Hz, 1H), 7.65 (d, J=1.7 Hz, 1H), 7.48 (dd, J=8.5, 1.7 Hz, 1H), 1.41 (s, 9H)

### Production Example 9

Production Example 9 was carried out according to the same manner as in Production Example 1, using 2-amino-4-chlorophenol instead of 2-amino-4-propylphenol to give 5-chloro-2-(pyridin-4-yl)-benzoxazole (hereinafter, referred to as “active compound 9”).

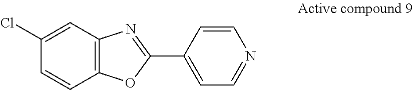

¹H-NMR (CDCl₃) δ: 8.84 (dd, J=4.4, 1.7 Hz, 2H), 8.07 (dd, J=4.4, 1.7 Hz, 2H), 7.80 (d, J=2.0 Hz, 1H), 7.56 (d, J=8.8 Hz, 1H), 7.41 (dd, J=8.8, 2.0 Hz, 1H)

### Production Example 10

Production Example 10 was carried out according to the same manner as in Production Example 1, using 2-amino-4-bromophenol instead of 2-amino-4-propylphenol to give 5-bromo-2-(pyridin-4-yl)-benzoxazole (hereinafter, referred to as “active compound 10”).

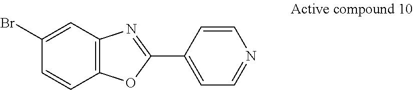

¹H-NMR (CDCl₃) δ: 8.83 (dd, J=4.4, 1.7 Hz, 2H), 8.07 (dd, J=4.4, 1.6 Hz, 2H), 7.96 (d, J=1.9 Hz, 1H), 7.55 (d, J=8.6, 1.8 Hz, 1H), 7.51 (dd, J=8.5 Hz, 1H)

### Production Example 11

To a mixture of 1.17 g of N-(2-hydroxy-5-methoxyphenyl)isonicotinamide, 1.26 g of triphenylphosphine and 25 ml of tetrahydrofuran, a mixture of 0.85 g diethyl azodicarboxylate and 5 ml of tetrahydrofuran was added dropwise. The mixture was warmed to room temperature and stirred for four hours. Water was added to the reaction mixture, followed by extraction with ethyl acetate. The combined organic layers were washed with water and a saturated sodium chloride solution, and dried over magnesium sulfate. Activated carbon was added thereto, which was filtered through Celite™. The filtrate was concentrated under reduced pressure. The residue was subjected to silica gel column chromatography to give 0.11 g of 5-methoxy-2-(pyridin-4-yl)-benzoxazole (hereinafter, referred to as “active compound 11”).

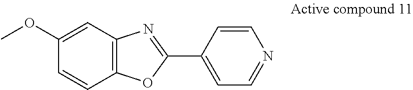

¹H-NMR (CDCl₃) δ: 8.81 (dd, J=4.4, 1.7 Hz, 2H), 8.07-8.05 (m, 2H), 7.51 (d, J=9.0 Hz, 1H), 7.29 (d, J=2.7 Hz, 1H), 7.04 (dd, J=9.0, 2.7 Hz, 1H), 3.89 (s, 3H)

### Production Example 12

To a mixture of 1.96 g of N-[5-(trifluoromethoxy)-2-hydroxyphenyl]isonicotinamide, 35 ml of tetrahydrofuran and 1.73 g of triphenylphosphine, a mixture of 1.26 g of diethyl azodicarboxylate and 5 ml of THF was added dropwise at room temperature. The resultant mixture was stirred at room temperature for two hours. To the mixture, 1.73 g of triphenylphosphine and 3.15 g of 40% toluene solution of diethyl azodicarboxylate were added and stirred for one hour. Furthermore, to the mixture, 0.58 g of triphenylphosphine and 1.05 g of 40% toluene solution of diethyl azodicarboxylate were added and stirred for one hour. The mixture solution was poured into water, followed by extraction with ethyl acetate. The combined organic layers were washed with water and a saturated sodium chloride solution, and dried over magnesium sulfate. The reaction mixture was concentrated. The residue was subjected to silica gel column chromatography to give 2-(pyridin-4-yl)-5-(trifluoromethoxy)benzoxazole (hereinafter, referred to as “active compound 12”).

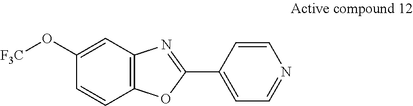

¹H-NMR (CDCl₃) δ: 8.86-8.84 (m, 2H), 8.10-8.07 (m, 2H), 7.73-7.70 (m, 1H), 7.64 (d, J=8.8 Hz, 1H), 7.35-7.30 (m, 1H)

### Production Example 13

To a mixture of 1.69 g of N-(2-hydroxy-5-trifluoromethylphenyl) isonicotinamide, 25 ml of tetrahydrofuran and 2.36 g of triphenylphosphine, 3.91 g of 40% toluene solution of diethyl azodicarboxylate was added dropwise at room temperature. After 1.3 hours, 0.6 g of triphenylphosphine and 1.0 g of 40% toluene solution of diethyl azodicarboxylate were added and stirred for further 40 minutes. Water was poured into the mixture, followed by extraction with ethyl acetate twice. The combined organic layers were washed with water and a saturated sodium chloride solution, dried over sodium sulfate, and then concentrated under reduced pressure. The residue was washed with diethyl ether, and 10 ml of methanol and 10 ml of 1 M aqueous solution of sodium hydroxide were added and stirred for two hours at room temperature. After concentrated hydrochloric acid was added to the reaction mixture while ice-cooling so as to make it acidic, the reaction mixture was washed with ethyl acetate. To the aqueous layer, 1 M aqueous solution of sodium hydroxide was added so as to make the solution alkaline, followed by extraction with ethyl acetate twice. The combined organic layers were washed with water and a saturated sodium chloride solution, and dried over magnesium sulfate and then concentrated under reduced pressure. The residue was subjected to silica gel column chromatography to give 0.44 g of 2-(pyridin-4-yl)-5-(trifluoromethyl)benzoxazole (hereinafter, referred to as “active compound 13”).

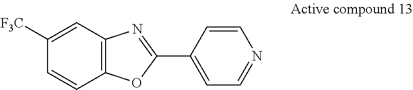

¹H-NMR (CDCl₃) δ: 8.86 (dd, J=4.4, 1.7 Hz, 2H), 8.13-8.09 (m, 3H), 7.75 (d, J=8.5 Hz, 1H), 7.72 (dd, J=8.7, 1.6 Hz, 1H)

### Production Example 14

To a mixture of 0.47 g of 2-(pyridin-4-yl)-5-(trifluoromethyl)benzoxazole and 5 ml of chloroform, 0.64 g of 65% m-chloroperbenzoic acid was added while ice-cooling. The reaction mixture was stirred while ice-cooling for 30 minutes, and then stirred at room temperature for 1.5 hours. The reaction mixture was diluted with chloroform, and washed with 5% aqueous solution of sodium hydroxide and a saturated sodium chloride solution. Organic layers were dried over anhydrous sodium sulfate, and then concentrated under reduced pressure to give 0.39 g of 4-[5-(trifluoromethyl)benzoxazole-2-yl]pyridine N-oxide (hereinafter, referred to as “active compound 14”).

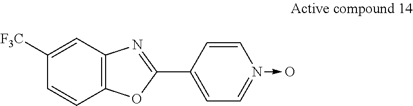

¹H-NMR (CDCl₃) δ: 8.34-8.31 (m, 2H), 8.13-8.10 (m, 2H), 8.08 (s, 1H), 7.73-7.68 (m, 2H)

### Production Example 15

A mixture of 0.8 g of N-(2-hydroxy-4-trifluoromethylphenyl)isonicotinamide, 15 ml of carbon tetrachloride, 2.23 g of triphenylphosphine and 0.86 g of triethylamine was heated to reflux for five hours. The mixture was cooled to room temperature. Then, water was poured into the mixture, followed by extraction with ethyl acetate twice. The combined organic layers were washed with water and a saturated sodium chloride solution, dried over magnesium sulfate, and then concentrated under reduced pressure. The residue was subjected to silica gel column chromatography to give 0.25 g of 2-(pyridin-4-yl)-6-(trifluoromethyl)benzoxazole (hereinafter, referred to as “active compound 15”).

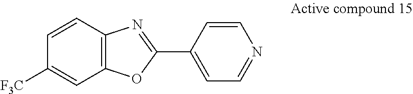

¹H-NMR (CDCl₃) δ: 8.87 (dd, J=4.5, 1.6 Hz, 2H), 8.11 (dd, J=4.4, 1.5 Hz, 2H), 7.95-7.91 (m, 2H), 7.72-7.68 (m, 1H)

### Production Example 16

To a mixture of 1.34 g of N-(1,1,3,3-tetrafluoro-6-hydroxy-1,3-dihydroisobenzofuran-5-yl)isonicotinamide, 10 ml of tetrahydrofuran and 1.07 g of triphenylphosphine, 2.67 g of 40% toluene solution of diethyl azodicarboxylate was added dropwise at room temperature. After 30 minutes, 1.07 g of triphenylphosphine was added, 2.67 g of 40% toluene solution of diethyl azodicarboxylate was added dropwise thereto and stirred for further two hours. Water was added thereto, followed by extraction with ethyl acetate twice. The combined organic layers were washed with water and a saturated sodium chloride solution, dried over magnesium sulfate, and concentrated under reduced pressure. The residue was subjected to silica gel column chromatography and the resultant solid was recrystallized to give 0.14 g of 5,5,7,7-tetrafluoro-2-pyridin-4-yl-5,7-dihydro-furo[3′,4′:4,5]benzo[1,2-d]oxazole (hereinafter, referred to as “active compound 16”).

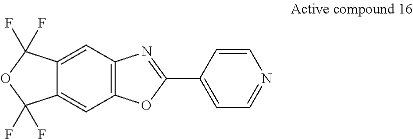

¹H-NMR (CDCl₃) δ: 8.91 (dd, J=4.4, 1.7 Hz, 2H), 8.12 (dd, J=4.5, 1.6 Hz, 2H), 8.08 (s, 1H), 7.91 (s, 1H)

### Production Example 17

A mixture of 0.35 g of 3,5-dichloro-N-(2-hydroxy-5-trifluoromethylphenyl)isonicotinamide, 5 ml of carbon tetrachloride, 0.78 g of triphenylphosphine and 0.30 g of triethylamine was heated to reflux for three hours. The mixture was cooled to room temperature, and then water was added to the mixture, followed by extraction with ethyl acetate twice. The combined organic layers were washed with a saturated sodium chloride solution, dried over magnesium sulfate, and concentrated under reduced pressure. The residue was subjected to silica gel column chromatography to give 0.18 g of 2-(3,5-dichloropyridin-4-yl)-5-(trifluoromethyl)benzoxazole (hereinafter, referred to as “active compound 17”).

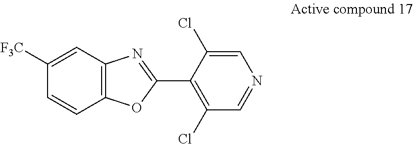

¹H-NMR (CDCl₃) δ: 8.72 (s, 2H), 8.21 (s, 1H), 7.79-7.77 (m, 21-1)

### Production Example 18

To a mixture of 0.71 g of 2-(3-chloropyridin-4-yl)methylideneamino-4-(trifluoromethyl)phenol and 10 ml of methanol, 0.80 g of iodobenzene diacetate was added at room temperature and stirred for 2.5 hours. The reaction mixture was concentrated under reduced pressure, and then water was added to the reaction mixture, followed by extraction with ethyl acetate. Organic layers were washed with a saturated sodium chloride solution, dried over anhydrous magnesium sulfate, and then concentrated under reduced pressure. The residue was subjected to silica gel column chromatography to give 0.14 g of 2-(3-chloropyridin-4-yl)-5-(trifluoromethyl)benzoxazole (hereinafter, referred to as “active compound 18”).

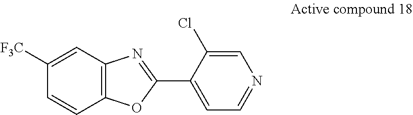

¹H-NMR (CDCl₃) δ: 8.86 (s, 1H), 8.70 (d, J=5.1 Hz, 1H), 8.20-8.18 (m, 1H), 8.10 (d, J=5.1 Hz, 1H), 7.78 (d, J=8.6 Hz, 1H), 7.75 (dd, J=8.5, 1.2 Hz, 1H)

### Production Example 19

To a mixture of 1.74 g of 3-chloro-N-[2-hydroxy-5-(trifluoromethyl)phenyl]isonicotinamide, 15 ml of tetrahydrofuran and 1.73 g of triphenylphosphine, 2.87 g of 40% toluene solution of diethyl azodicarboxylate was added dropwise at room temperature. The reaction mixture was stirred at 50° C. for 30 minutes. After 30 minutes, 0.26 g of triphenylphosphine and 0.43 g of 40% toluene solution of diethyl azodicarboxylate were added and the reaction mixture was stirred at 50° C. for one hour. The reaction mixture was cooled to room temperature and then concentrated under reduced pressure. The residue was subjected to silica gel column chromatography to give 1.44 g of active compound 18.

### Production Example 20

To a mixture of 0.45 g of 2-(3-chloropyridin-4-yl)-5-(trifluoromethyl)benzoxazole and 5 ml of chloroform, 0.53 g of 65% m-chloroperbenzoic acid was added while ice-cooling. The reaction mixture was stirred at room temperature for 5.5 hours, and was then diluted with chloroform, and washed with 5% aqueous solution of sodium hydroxide and a saturated sodium chloride solution, sequentially. Organic layers were dried over anhydrous sodium sulfate, and concentrated under reduced pressure. The residue was subjected to silica gel column chromatography to give 0.25 g of 3-chloro-4-[5-(trifluoromethyl)benzoxazole-2-yl]pyridine N-oxide (hereinafter, referred to as “active compound 19”).

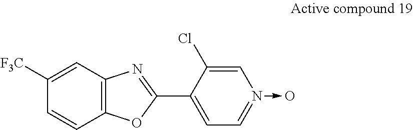

¹H-NMR (CDCl₃) δ: 8.40 (d, J=1.3 Hz, 1H), 8.21 (dd, J=7.1, 1.5 Hz, 1H), 8.17-8.14 (m, 2H), 7.77-7.72 (m, 2H)

### Production Example 21

To a mixture of 0.49 g of 2-(3-chloropyridin-4-yl)methylideneamino-4-tert-butylphenol and 10 ml of methanol, 0.57 g of iodobenzene diacetate was added at room temperature and stirred for two hours. The reaction mixture was concentrated, and then water was added thereto, followed by extraction with ethyl acetate. The organic layer was washed with a saturated aqueous solution of sodium hydrogencarbonate and a saturated sodium chloride solution sequentially, and dried over anhydrous magnesium sulfate and concentrated under reduced pressure. The residue was subjected to silica gel column chromatography to give 0.21 g of 2-(3-chloropyridin-4-yl)-5-tert-butylbenzoxazole (hereinafter, referred to as “active compound 20”).

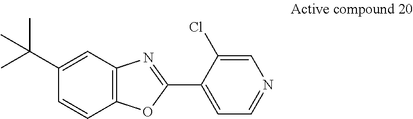

¹H-NMR (CDCl₃) δ: 8.81 (s, 1H), 8.65 (d, J=5.1 Hz, 1H), 8.07 (d, J=5.1 Hz, 1H), 7.92-7.91 (m 1H), 7.57 (dd, J=8.8, 0.7 Hz, 1H), 7.53 (dd, J=8.8, 1.8 Hz, 1H), 1.41 (s, 9H)

### Production Example 22

To a mixture of 0.77 g of 2-chloro-N-[2-hydroxy-5-(trifluoromethyl)phenyl]isonicotinamide, 20 ml of tetrahydrofuran and 0.80 g of triphenylphosphine, 1.32 g of 40% toluene solution of diethyl azodicarboxylate was added dropwise at room temperature, and the mixture solution was stirred for 1.5 hours at room temperature and then 1.5 hours at 60° C. The reaction mixture was cooled to room temperature, and then concentrated under reduced pressure. The residue was subjected to silica gel column chromatography to give 0.60 g of 2-(2-chloropyridin-4-yl)-5-(trifluoromethyl)benzoxazole (hereinafter, referred to as “active compound 21”).

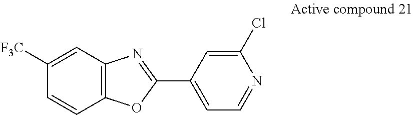

¹H-NMR (CDCl₃) δ: 8.63 (d, J=5.3, 1H), 8.17-8.12 (m, 2H), 8.05-8.03 (m, 1H), 7.77-7.72 (m, 2H)

### Production Example 23

To a mixture of 0.40 g of 2-(2-chloropyridin-4-yl)-5-(trifluoromethyl)benzoxazole and 4 ml of chloroform, 0.53 g of 65% m-chloroperbenzoic acid was added while ice-cooling. The reaction mixture was stirred while ice-cooling for 30 minutes, then stirred at room temperature for three hours, and then stirred while heating at 50° C. for 1.5 hours. To the mixture, 0.53 g of 65% m-chloroperbenzoic acid and 2 ml of chloroform were added and stirred while heating at 60° C. for five hours. The reaction mixture was cooled to room temperature, then diluted with ethyl acetate, and washed with 5% aqueous solution of sodium hydroxide and a saturated sodium chloride solution, sequentially. The organic layer was dried over anhydrous sodium sulfate and then concentrated under reduced pressure to give 0.38 g of 2-chloro-4-[5-(trifluoromethyl)benzoxazole-2-yl]pyridine N-oxide (hereinafter, referred to as “active compound 22”).

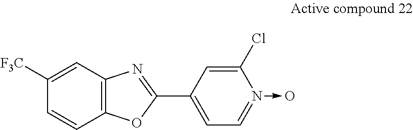

¹H-NMR (CDCl₃) δ: 8.45 (d, J=7.1 Hz, 1H), 8.36 (d, J=2.2 Hz, 1H), 8.10-8.08 (m, 1H), 8.04 (dd, J=7.1, 2.4 Hz, 1H), 7.73-7.72 (m, 2H)

### Production Example 24

To a mixture of 0.38 g of N-[2-hydroxy-5-(trifluoromethyl)phenyl]-3-methylisonicotinamide, 5 ml of tetrahydrofuran and 0.42 g of triphenylphosphine, 0.69 g of 40% toluene solution of diethyl azodicarboxylate was added dropwise at room temperature and stirred while heating at 60° C. After three hours, 5 ml of 10% aqueous solution of sodium hydroxide was added and stirred while heating at 60° C. for two hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and then concentrated under reduced pressure. The residue was subjected to silica gel column chromatography to give 0.29 g of 2-(3-methylpyridin-4-yl)-5-(trifluoromethyl)benzoxazole (hereinafter, referred to as “active compound 23”).

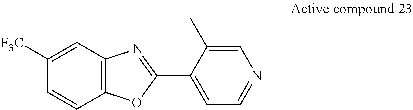

¹H-NMR (CDCl₃) δ: 8.69 (s, 1H), 8.66 (d, J=5.1 Hz, 1H), 8.16-8.14 (m, 1H), 8.04 (d, J=5.3 Hz, 1H), 7.75 (d, J=8.8 Hz, 1H), 7.71 (dd, J=8.8, 1.2 Hz, 1H), 2.83 (s, 3H)

### Production Example 25

To a mixture of 0.20 g of 2-(3-methylpyridin-4-yl)-5-(trifluoromethyl)benzoxazole and 4 ml of chloroform, 0.30 g of 65% m-chloroperbenzoic acid was added while ice-cooling. The reaction mixture was stirred at room temperature for three hours, then diluted with ethyl acetate, and washed with 5% aqueous solution of sodium hydroxide and a saturated sodium chloride solution, sequentially. The organic layer was dried over anhydrous sodium sulfate, and concentrated under reduced pressure to give 0.17 g of 3-methyl-4-[5-(trifluoromethyl)benzoxazole-2-yl]pyridine N-oxide (hereinafter, referred to as “active compound 24”).

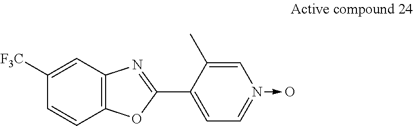

¹H-NMR (CDCl₃) δ: 8.22-8.21 (m, 1H), 8.19-8.16 (m, 1H), 8.12-8.09 (m, 2H), 7.72-7.69 (m, 2H), 2.81 (s, 3H)

### Production Example 26

To a mixture of 0.51 g of 3-fluoro-N-[2-hydroxy-5-(trifluoromethyl)phenyl]isonicotinamide, 5 ml of tetrahydrofuran and 0.53 g of triphenylphosphine, 0.89 g of 40% toluene solution of diethyl azodicarboxylate was added dropwise at room temperature. The reaction mixture was stirred while heating at 50° C. for 1.5 hours. The reaction mixture was cooled to room temperature, and then concentrated under reduced pressure. The residue was subjected to silica gel column chromatography to give 0.46 g of 2-(3-fluoropyridin-4-yl)-5-(trifluoromethyl)benzoxazole (hereinafter, referred to as “active compound 25”).

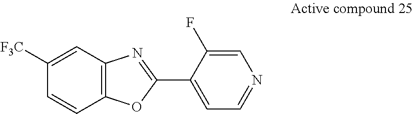

¹H-NMR (CDCl₃) δ: 8.76 (d, J=2.4 Hz, 1H), 8.66 (d, J=0.6 Hz, 1H), 8.17 (m, 1H), 8.15-8.12 (m, 1H), 7.78 (d, J=8.8 Hz, 1H), 7.75 (dd, J=8.8, 1.3 Hz, 1H)

### Production Example 27

To a mixture of 0.34 g of 2-(3-fluoropyridin-4-yl)-5-(trifluoromethyl)benzoxazole and 6 ml of chloroform, 0.48 g of 65% m-chloroperbenzoic acid was added at room temperature. The solution was stirred while heating at 50° C. for 1.5 hours. The reaction mixture was cooled to room temperature, and diluted with ethyl acetate, and then washed with a saturated aqueous solution of sodium hydrogencarbonate twice and a saturated sodium chloride solution once, sequentially. The organic layer was dried over anhydrous sodium sulfate, and concentrated under reduced pressure. The residue was subjected to silica gel column chromatography to give 0.23 g of 3-fluoro-4-[5-(trifluoromethyl)benzoxazole-2-yl]pyridine N-oxide (hereinafter, referred to as “active compound 26”).

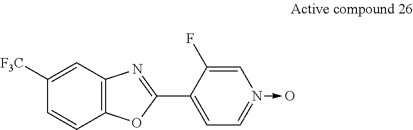

¹H-NMR (CDCl₃) δ: 8.32-8.29 (m, 1H), 8.17-8.12 (m, 3H), 7.76-7.71 (m, 2H)

### Production Example 28

To a mixture of 0.29 g of 3-bromo-N-[2-hydroxy-5-(trifluoromethyl)phenyl]isonicotinamide, 4 ml of tetrahydrofuran and 0.25 g of triphenylphosphine, 0.42 g of 40% toluene solution of diethyl azodicarboxylate was added dropwise at room temperature. The reaction mixture was stirred while heating at 50° C. for 1.5 hours. The reaction mixture was cooled to room temperature, and then concentrated under reduced pressure. The residue was subjected to silica gel column chromatography to give 0.24 g of 2-(3-bromopyridin-4-yl)-5-(trifluoromethyl)benzoxazole (hereinafter, referred to as “active compound 27”).

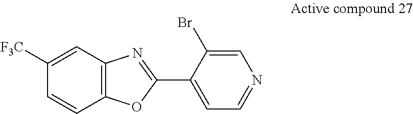

¹H-NMR (CDCl₃) δ: 9.00 (s, 1H), 8.73 (d, J=4.9 Hz, 1H), 8.20 (s, 1H), 8.06 (d, J=4.9 Hz, 1H), 7.78 (d, J=8.8 Hz, 1H), 7.75 (d, J=8.8 Hz, 1H)

### Production Example 29

To a mixture of 0.50 g of 2-(3-bromopyridin-4-yl)-5-(trifluoromethyl)benzoxazole and 5 ml of chloroform, 0.58 g of 65% m-chloroperbenzoic acid was added. The reaction mixture was stirred while heating at 50° C. for 1.5 hours. The reaction mixture was cooled to room temperature, then diluted with ethyl acetate, and washed with a saturated aqueous solution of sodium hydrogencarbonate (twice) and a saturated sodium chloride solution, sequentially. The organic layer was dried over anhydrous sodium sulfate and concentrated under reduced pressure. The residue was subjected to silica gel column chromatography to give 0.37 g of 3-bromo-4-[5-(trifluoromethyl)benzoxazole-2-yl]pyridine N-oxide (hereinafter, referred to as “active compound 28”).

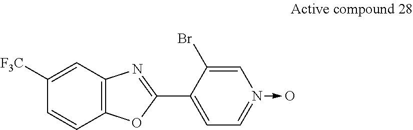

¹H-NMR (CDCl₃) δ: 8.56 (d, J=1.7 Hz, 1H), 8.24 (dd, J=7.1, 1.7 Hz, 1H), 8.16 (s, 1H), 8.13 (d, J=7.1 Hz, 1H), 7.76-7.72 (m, 2H)

### Production Example 30

To a mixture of 1.81 g of N-[2-hydroxy-5-(trifluoromethyl)phenyl]-3-iodoisonicotinamide, 20 ml of tetrahydrofuran and 1.34 g of triphenylphosphine, 2.22 g of 40% toluene solution of diethyl azodicarboxylate was added dropwise at room temperature. The reaction mixture was stirred while heating at 50° C. for one hour. The reaction mixture was cooled to room temperature, and then the reaction mixture was concentrated under reduced pressure. The residue was subjected to silica gel column chromatography to give 1.40 g of 2-(3-iodopyridin-4-yl)-5-(trifluoromethyl)benzoxazole (hereinafter, referred to as “active compound 29”).

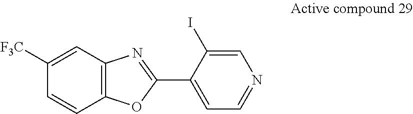

¹H-NMR (CDCl₃) δ: 9.26 (s, 1H), 8.73 (d, J=5.1 Hz, 1H), 8.21 (s, 1H), 8.01 (d, J=5.1 Hz, 1H), 7.78 (d, J=8.8 Hz, 1H), 7.75 (d, J=8.8 Hz, 1H)

### Production Example 31

To a mixture of 0.30 g of 2-(3-iodopyridin-4-yl)-5-(trifluoromethyl)benzoxazole and 3 ml of chloroform, 0.26 g of 65% m-chloroperbenzoic acid was added while ice-cooling. The reaction mixture was stirred at room temperature for 30 minutes. The reaction mixture was stirred while heating at 50° C. for one hour. Then, 0.20 g of 65% m-chloroperbenzoic acid was added thereto and stirred while heating at 50° C. for further two hours. The reaction mixture was cooled to room temperature, and then diluted with ethyl acetate, and washed with a saturated aqueous solution of sodium hydrogencarbonate and a saturated sodium chloride solution, sequentially. The organic layer was dried over anhydrous sodium sulfate, and then concentrated under reduced pressure. The residue was subjected to silica gel column chromatography to give 0.09 g of 3-iode-4-[5-(trifluoromethyl)benzoxazole-2-yl]pyridine N-oxide (hereinafter, referred to as “active compound 30”).

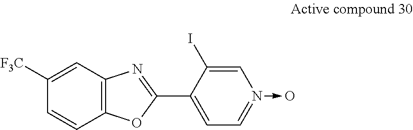

¹H-NMR (CDCl₃) δ: 8.83 (d, J=1.7 Hz, 1H), 8.25 (dd, J=7.1, 1.7 Hz, 1H), 8.18-8.15 (m, 1H), 8.04 (d, J=7.1 Hz, 1H), 7.75-7.72 (m, 2H)

### Production Example 32

A mixture of 0.39 g of 2-(3-iodopyridin-4-yl)-5-(trifluoromethyl)benzoxazole, 0.18 g of copper (1) cyanide and 2 ml of 1-methyl-2-pyrrolidinone was stirred while heating at 80° C. for 2 hours. Water and ethyl acetate were poured into the reaction mixture, which was filtered through Celite™. The resultant filtrate was washed with a saturated sodium chloride solution, dried over anhydrous sodium sulfate, and concentrated under reduced pressure. The residue was subjected to silica gel column chromatography to give 0.11 g of 2-(3-cyanopyridin-4-yl)-5-(trifluoromethyl)benzoxazole (hereinafter, referred to as “active compound 31”).

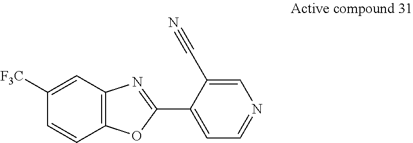

¹H-NMR (CDCl₃) δ: 9.14 (s, 1H), 9.02 (d, J=5.4 Hz, 1H), 8.29 (d, J=5.1 Hz, 1H), 8.25-8.22 (m, 1H), 7.83 (d, J=8.8 Hz, 1H), 7.79 (d, J=8.8, 1.3 Hz, 1H)

### Production Example 33

To a mixture of 0.78 g of 2-(3-iodopyridin-4-yl)-5-(trifluoromethyl)benzoxazole, 0.27 g of phenylboronic acid, 5 ml of tetrahydrofuran and 0.14 g of dichlorobis(triphenylphosphine)palladium (II), 3 ml of 10% aqueous solution of sodium hydroxide was added and heated to reflux for three hours. Water was added to the reaction mixture, followed by extraction with ethyl acetate twice. The combined organic layers were washed with water and a saturated sodium chloride solution, dried over anhydrous magnesium sulfate, and concentrated under reduced pressure. The residue was subjected to silica gel column chromatography to give 0.18 g of 2-(3-phenyl pyridin-4-yl)-5-(trifluoromethyl)benzoxazole (hereinafter, referred to as “active compound 32”).

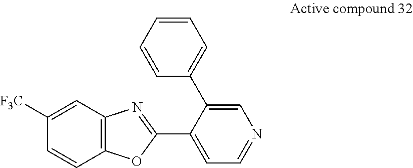

¹H-NMR (CDCl₃) δ: 8.81 (d, J=5.1 Hz, 1H), 8.80 (s, 1H), 8.05-8.02 (m, 2H), 7.62-7.59 (m, 1H), 7.45-7.38 (m, 4H), 7.35-7.30 (m, 2H)

### Production Example 35

A mixture of 1.17 g of 2-(3-iodopyridin-4-yl)-5-(trifluoromethyl)benzoxazole, 0.40 g of (trimethylsilyl)acetylene, 0.03 g of copper (1) iodide, 0.11 g of dichlorobis(triphenylphosphine)palladium (II), 2.5 ml of triethylamine and 10 ml of tetrahydrofuran was stirred while heating at 50° C. for two hours. The reaction solution was cooled to room temperature, to which tert-butyl methyl ether was added. The reaction mixture was washed with a saturated aqueous solution of sodium hydrogencarbonate and a saturated sodium chloride solution sequentially. The organic layer was dried over anhydrous magnesium sulfate, and concentrated under reduced pressure. The residue was subjected to silica gel column chromatography to give 0.50 g of 5-(trifluoromethyl) 2-[3-(trimethylsilyl)ethynyl-4-yl]-benzoxazole.

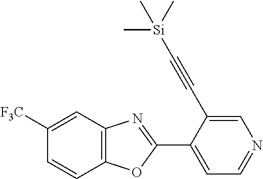

¹H-NMR (CDCl₃) δ: 8.93 (d, J=0.7 Hz, 1H), 8.71 (d, J=5.3 Hz, 1H), 8.13-8.11 (m, 1H), 8.10 (dd, J=5.3, 0.7 Hz, 1H), 7.73-7.72 (m, 2H), 0.35 (s, 9H)

To a mixture of 0.74 g of 5-(trifluoromethyl)-2-[3-(trimethylsilyl)ethynyl-4-yl]-benzoxazole and 6 ml of methanol, 0.20 g of potassium carbonate was added. The reaction mixture was stirred at room temperature for one hour. Water was added to the reaction mixture, which was extracted with ethyl acetate. The organic layer was washed with a saturated sodium chloride solution, then dried over anhydrous magnesium sulfate, and concentrated under reduced pressure. The residue was subjected to silica gel column chromatography to give 0.46 g of 2-(3-ethynylpyridin-4-yl)-5-(trifluoromethyl)benzoxazole (hereinafter, referred to as “active compound 34”).

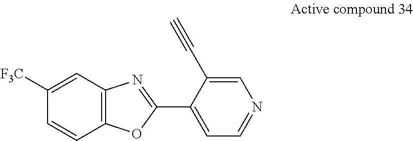

¹H-NMR (CDCl₃) δ: 8.97 (s, 1H), 8.76 (d, J=5.1 Hz, 1H), 8.19-8.17 (m, 1H), 8.10 (d, J=5.1 Hz, 1H), 7.76 (d, J=8.6 Hz, 1H), 7.73 (dd, J=8.5, 1.2 Hz, 1H), 3.63 (s, 1H)

### Production Example 36

A mixture of 0.34 g of 2-(3-ethynylpyridin-4-yl)-5-(trifluoromethyl)benzoxazole, 0.10 g of 5% palladium on carbon and 8 ml of ethyl acetate was stirred under about one atmosphere of hydrogen at room temperature for two hours. The reaction mixture was filtered through Celite™. The filtrate was concentrated under reduced pressure. The residue was subjected to silica gel column chromatography to give 0.33 g of 2-(3-ethylpyridin-4-yl)-5-(trifluoromethyl)benzoxazole (hereinafter, referred to as “active compound 35”).

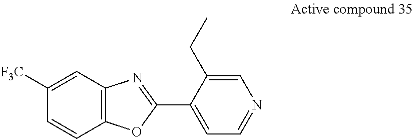

¹H-NMR (CDCl₃) δ: 8.71 (s, 1H), 8.66 (d, J=5.1 Hz, 1H), 8.16-8.14 (m, 1H), 8.01 (d, J=5.1 Hz, 1H), 7.74 (d, J=8.5 Hz, 1H), 7.71 (dd, J=8.8, 1.3 Hz, 1H), 3.29 (q, J=7.6 Hz, 2H), 1.35 (t, J=7.6 Hz, 3H)

### Production Example 37

To a mixture of 1.78 g of 3-tert-butoxycarbonylamino-N-[2-hydroxy-5-(trifluoromethyl)phenyl]isonicotinamide, 20 ml of tetrahydrofuran and 1.29 g of triphenylphosphine, 2.15 g of 40% toluene solution of diethyl azodicarboxylate was added dropwise at room temperature. The reaction mixture was stirred at room temperature for one hour and then stirred while heating at 50° C. for 30 minutes. The reaction mixture was cooled to room temperature, and then concentrated under reduced pressure. The residue was subjected to silica gel column chromatography to give 0.69 g of 2-(3-tert-butoxycarbonylamino pyridin-4-yl)-5-(trifluoromethyl)benzoxazole (hereinafter, referred to as “active compound 36”).

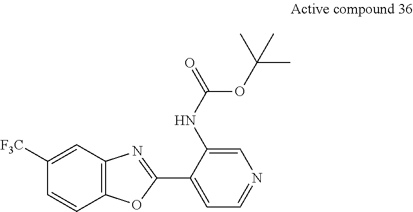

¹H-NMR (CDCl₃) δ: 10.57 (s, 1H), 9.88 (s, 1H), 8.45 (d, J=5.1 Hz, 1H), 8.17 (s, 1H), 7.99 (d, J=5.1 Hz, 1H), 7.78-7.73 (m, 2H), 1.62 (s, 9H)

### Production Example 38

A mixture of 0.28 g of 2-(3-fluoropyridin-4-yl)-5-(trifluoromethyl)benzoxazole,

0.27 g of potassium carbonate and 3 ml of methanol was stirred while heating at 60° C. for two hours. The reaction mixture was concentrated under reduced pressure. Water was added thereto, which followed by extraction with ethyl acetate twice. The combined organic layers were washed with water and a saturated sodium chloride solution, dried over anhydrous magnesium sulfate, and concentrated under reduced pressure. The residue was subjected to silica gel column chromatography to give 0.21 g of 2-(3-methoxypyridin-4-yl)-5-(trifluoromethyl)benzoxazole (hereinafter, referred to as “active compound 37”).

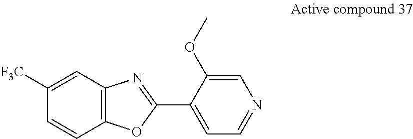

¹H-NMR (CDCl₃) δ: 8.60 (s, 1H), 8.46 (d, J=4.9 Hz, 1H), 8.16-8.14 (m, 1H), 8.02 (d, J=4.9 Hz, 1H), 7.74 (d, J=8.5 Hz, 1H), 7.69 (dd, J=8.5, 1.1 Hz, 1H), 4.16 (s, 3H)

### Production Example 39

A mixture of 0.28 g of 2-(3-fluoropyridin-4-yl)-5-(trifluoromethyl)benzoxazole, 0.15 g of phenol, 0.55 g of potassium carbonate and 2 ml of DMF was stirred at room temperature for one hour, and then stirred while heating at 50° C. for four hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and then concentrated under reduced pressure. The residue was subjected to silica gel column chromatography to give 0.24 g of 2-(3-phenoxypyridin-4-yl)-5-(trifluoromethyl)benzoxazole (hereinafter, referred to as “active compound 38”).

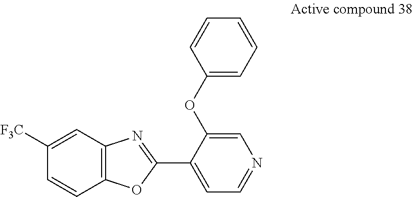

¹H-NMR (CDCl₃) δ: 8.57 (d, J=4.9 Hz, 1H), 8.47 (s, 1H), 8.14 (d, J=4.9 Hz, 1H), 8.11 (s, 1H), 7.69-7.65 (m, 2H), 7.41-7.37 (m, 2H), 7.20-7.16 (m, 1H), 7.13-7.09 (m, 2H)

### Production Example 40

A mixture of 0.06 g of 55% sodium hydride (in oil) and 2 ml of DMF was stirred at room temperature. To the mixture, a mixture solution of 0.13 g of 2,2,2-trifluoroethanol and 0.5 ml of DMF was added. The mixture solution was stirred at the same temperature for 15 minutes, and then 0.28 g of 2-(3-fluoropyridin-4-yl)-5-(trifluoromethyl)benzoxazole was stirred at room temperature for one hour. Water was added to the reaction mixture, which followed by extraction with ethyl acetate twice. The combined organic layers were washed with a saturated sodium chloride solution, dried over anhydrous magnesium sulfate, and then concentrated under reduced pressure. The residue was subjected to silica gel column chromatography to give 0.27 g of 2-[3-(2,2,2-trifluoroethyl)oxypyridin-4-yl]-5-(trifluoromethyl)benzoxazole (hereinafter, referred to as “active compound 39”).

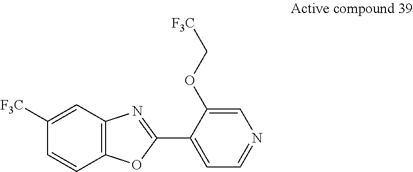

¹H-NMR (CDCl₃) δ: 8.61 (s, 1H), 8.59 (d, J=4.9 Hz, 1H), 8.15-8.14 (m, 1H), 8.11 (d, J=5.1 Hz, 1H), 7.76-7.71 (m, 2H), 4.67 (q, J=8.0 Hz, 2H)

### Production Example 41

A mixture of 0.28 g of 2-(3-fluoropyridin-4-yl)-5-(trifluoromethyl)benzoxazole,

0.14 g of methyl mercaptan sodium salt and 2 ml of DMF was stirred while heating at 50° C. for two hours. The reaction mixture was cooled to room temperature, and then water was added to the reaction mixture, followed by extraction with ethyl acetate. The organic layer was washed with a saturated sodium chloride solution, dried over anhydrous magnesium sulfate, and concentrated under reduced pressure. The resultant residue was subjected to silica gel column chromatography to give 0.21 g of 2-[3-(methylthio)pyridin-4-yl]-5-(trifluoromethyl)benzoxazole (hereinafter, referred to as “active compound 40”).

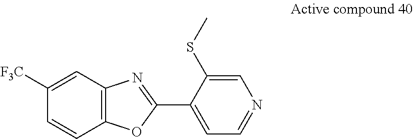

¹H-NMR (CDCl₃) δ: 8.68 (s, 1H), 8.56 (d, J=5.1 Hz, 1H), 8.22-8.20 (m, 1H), 8.02 (d, J=5.1 Hz, 1H), 7.74 (d, J=8.5 Hz, 1H), 7.71 (dd, J=8.8, 1.4 Hz, 1H), 2.68 (s, 3H)

### Production Example 42

A mixture of 0.28 g of 2-(3-fluoropyridin-4-yl)-5-(trifluoromethyl)benzoxazole, 0.20 g of ethyl mercaptan sodium salt and 2 ml of DMF was stirred at room temperature for one hour. Water was added to the reaction mixture, and was extracted with ethyl acetate. The organic layer was washed with a saturated sodium chloride solution, dried over anhydrous magnesium sulfate, and concentrated under reduced pressure. The residue was subjected to silica gel column chromatography to give 0.28 g of 2-(3-ethylthio pyridin-4-yl)-5-(trifluoromethyl)benzoxazole (hereinafter, referred to as “active compound 41”).

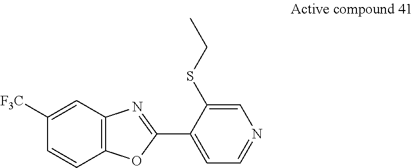

¹H-NMR (CDCl₃) δ: 8.72 (s, 1H), 8.55 (d, J=5.1 Hz, 1H), 8.21 (s, 1H), 8.01 (d, J=5.1 Hz, 1H), 7.76-7.70 (m, 2H), 3.20 (q, J=7.5 Hz, 2H), 1.48 (t, J=7.5 Hz, 3H)

### Production Example 43

A mixture of 0.28 g of 2-(3-fluoropyridin-4-yl)-5-(trifluoromethyl)benzoxazole, 0.15 g of 1-propanethiol, 0.40 g of potassium carbonate and 2 ml of DMF was stirred while heating at 50° C. for one hour. The reaction mixture was cooled to room temperature, and then water was added to the reaction mixture, which was extracted with ethyl acetate. The organic layer was washed with a saturated sodium chloride solution, dried over anhydrous magnesium sulfate, and concentrated under reduced pressure. The residue was subjected to silica gel column chromatography to give 0.30 g of 2-(3-propylthiopyridin-4-yl)-5-(trifluoromethyl)benzoxazole (hereinafter, referred to as “active compound 42”).

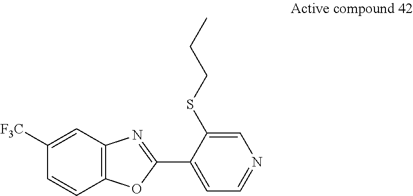

¹H-NMR (CDCl₃) δ: 8.72 (s, 1H), 8.55 (d, J=5.1 Hz, 1H), 8.23-8.21 (m, 1H), 8.01 (d, J=5.1 Hz, 1H), 7.75 (d, J=8.8 Hz, 1H), 7.71 (dd, J=8.8, 1.5 Hz, 1H), 3.12 (t, J=7.6 Hz, 2H), 1.87-1.80 (m, 2H), 1.13 (t, J=7.6 Hz, 3H)

### Production Example 44

To a mixture of 0.28 g of 2-(3-fluoropyridin-4-yl)-5-(trifluoromethyl)benzoxazole, 0.50 g of potassium carbonate and 2 ml of DMF, a mixture of 0.15 g of 2-propanethiol and 0.5 ml of DMF was added. The reaction mixture was stirred while heating at 60° C. for two hours. The reaction mixture was cooled to room temperature, and then water was added to the reaction mixture, which was extracted with ethyl acetate. The organic layer was washed with 5% aqueous solution of potassium carbonate and a saturated sodium chloride solution, sequentially, dried over anhydrous magnesium sulfate, and concentrated under reduced pressure. The residue was subjected to silica gel column chromatography to give 0.26 g of 2-(3-isopropylthiopyridin-4-yl)-5-(trifluoromethyl)benzoxazole (hereinafter, referred to as “active compound 43”).

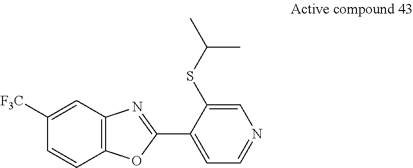

¹H-NMR (CDCl₃) δ: 8.79 (s, 1H), 8.57 (d, J=5.1 Hz, 1H), 8.22-8.20 (m, 1H), 7.99 (d, J=5.1 Hz, 1H), 7.75 (d, J=8.8 Hz, 1H), 7.71 (dd, J=8.8, 1.4 Hz, 1H), 3.78 (sep, J=6.6 Hz, 1H), 1.45 (d, J=6.6 Hz, 6H)

### Production Example 45

Production Example 45 was carried out according to the same manner as in Production Example 43, using tert-butyl mercaptan instead of 2-propanethiol. Thus, 2-(3-tert-butylthiopyridin-4-yl)-5-(trifluoromethyl)benzoxazole (hereinafter, referred to as “active compound 44”) was obtained.

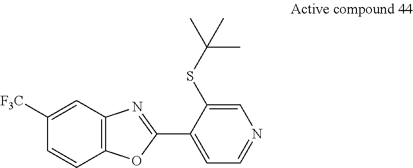

¹H-NMR (CDCl₃) δ: 8.99 (d, J=0.7 Hz, 1H), 8.77 (d, J=5.1 Hz, 1H), 8.18-8.16 (m, 1H), 7.93 (dd, J=5.1, 0.7 Hz, 1H), 7.77 (d, J=8.8 Hz, 1H), 7.73 (dd, J=8.8, 1.5 Hz, 1H), 1.24 (s, 9H)

### Production Example 46

Production Example 46 was carried out according to the same manner as in Production Example 43, using 1-pentanethiol instead of 2-propanethiol. Thus, 2-(3-pentylthiopyridin-4-yl)-5-(trifluoromethyl)benzoxazole (hereinafter, referred to as “active compound 45”) was obtained.

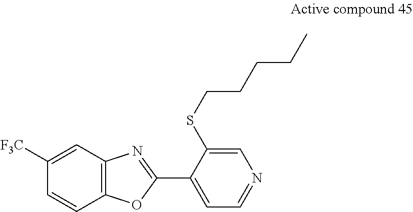

¹H-NMR (CDCl₃) δ: 8.72 (s, 1H), 8.55 (d, J=5.2 Hz, 1H), 8.23-8.21 (m, 1H), 8.00 (d, J=5.1, 1H), 7.75 (d, J=8.6 Hz, 1H), 7.71 (dd, J=8.8, 1.6 Hz, 1H), 3.13 (t, J=7.6 Hz, 2H), 1.81 (m, 2H), 1.50 (m, 2H), 1.38 (m, 2H), 0.92 (t, J=7.5 Hz, 3H)

### Production Example 47

To a mixture of 0.28 g of 2-(3-fluoropyridin-4-yl)-5-(trifluoromethyl)benzoxazole, 0.50 g of potassium carbonate and 2 ml of DMF, 0.15 g of 2,2,2-trifluoroethanethiol was added. The reaction mixture was stirred at room temperature for 1.2 hours. Water was added to reaction mixture, which followed by extraction with ethyl acetate twice. The combined organic layers were washed with saturated sodium chloride solution, dried over anhydrous magnesium sulfate, and concentrated under reduced pressure. The residue was subjected to silica gel column chromatography to give 0.32 g of 2-[3-(2,2,2-trifluoroethylthio)pyridin-4-yl]-5-(trifluoromethyl)benzoxazole (hereinafter, referred to as “active compound 46”).

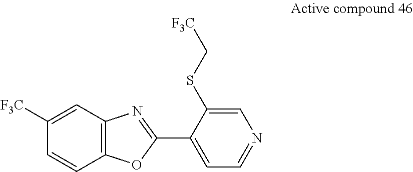

¹H-NMR (CDCl₃) δ: 8.94 (s, 1H), 8.74 (d, J=5.1 Hz, 1H), 8.22-8.21 (m, 1H), 8.06 (d, J=5.1 Hz, 1H), 7.78-7.73 (m, 2H), 3.76 (q, J=9.5 Hz, 2H)

### Production Example 48

Production Example 48 was carried out according to the same manner as in Production Example 43 except for using benzyl mercaptan instead of 2-propanethiol. Thus, 2-(3-benzylthiopyridin-4-yl)-5-(trifluoromethyl)benzoxazole (hereinafter, referred to as “active compound 47”) was obtained.

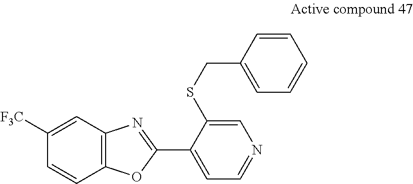

¹H-NMR (CDCl₃) δ: 8.75 (s, 1H), 8.56 (d, J=5.2 Hz, 1H), 8.19-8.18 (m, 1H), 8.00 (dd, J=5.2, 0.8 Hz, 1H), 7.74 (d, J=8.6 Hz, 1H), 7.70 (dd, J=8.8, 1.5 Hz, 1H), 7.43-7.40 (m, 2H), 7.35-7.27 (m, 3H), 4.36 (s, 2H)

### Production Example 49

Production Example 49 was carried out according to the method as in Production Example 43 except for using 4-chlorobenzyl mercaptan instead of 2-propanethiol. Thus, 2-[3-(4-chlorobenzylthio)pyridin-4-yl]-5-(trifluoromethyl)benzoxazole (hereinafter, referred to as “active compound 48”) was obtained.

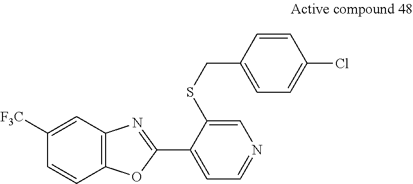

¹H-NMR (CDCl₃) δ: 8.71 (s, 1H), 8.58 (d, J=5.1 Hz, 1H), 8.20-8.18 (m, 1H), 8.00 (d, J=5.1 Hz, 1H), 7.75-7.70 (m, 2H), 7.35-7.32 (m, 2H), 7.29-7.26 (m, 2H), 4.32 (s, 2H)

### Production Example 50

To a mixture of 0.28 g of 2-(3-fluoropyridin-4-yl)-5-(trifluoromethyl)benzoxazole, 0.40 g of potassium carbonate and 2 ml of DMF, a mixture of 0.17 g of thiophenol and 0.5 ml of DMF was added. The reaction mixture was stirred at room temperature for one hour. Water was added to the reaction mixture, which was extracted with ethyl acetate. The organic layer was washed with a saturated sodium chloride solution, dried over anhydrous magnesium sulfate, and concentrated under reduced pressure. The residue was subjected to silica gel column chromatography to give 0.30 g of 2-[3-(phenylthio)pyridin-4-yl]-5-(trifluoromethyl)benzoxazole (hereinafter, referred to as “active compound 49”).

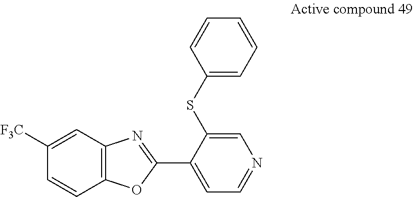

¹H-NMR (CDCl₃) δ: 8.51 (d, J=5.1 Hz, 1H), 8.23 (s, 1H), 8.20 (s, 1H), 8.02 (d, J=5.1 Hz, 1H), 7.76 (d, J=8.8 Hz, 1H), 7.74 (dd, J=8.8, 1.4 Hz, 1H), 7.65-7.61 (m, 2H), 7.48-7.45 (m, 3H)

### Production Example 51

Production Example 51 was carried out according to the same manner as in Production Example 50 except for using 4-chlorothiophenol instead of thiophenol. Thus, 2-[3-(4-chloro-phenylthio)pyridin-4-yl]-5-(trifluoromethyl)benzoxazole (hereinafter, referred to as “active compound 50”) was obtained.

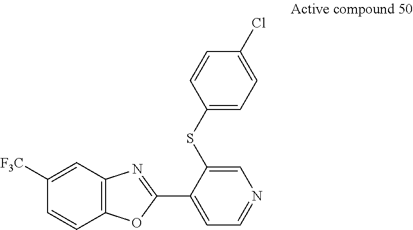

¹H-NMR (CDCl₃) δ: 8.54 (d, J=5.1 Hz, 1H), 8.23-8.22 (m, 1H), 8.20 (s, 1H), 8.03 (d, J=5.1 Hz, 1H), 7.77 (d, J=8.8 Hz, 1H), 7.74 (dd, J=8.8, 1.2 Hz, 1H), 7.57-7.54 (m, 2H), 7.46-7.43 (m, 2H)

### Production Example 53

A mixture of 1.41 g of 2-(3-fluoropyridin-4-yl)-5-(trifluoromethyl)benzoxazole,

1.85 g of phthalimide potassium and 8 ml of DMF was stirred while heating at 120° C. After six hours, 0.92 g of phthalimide potassium was added and stirred while heating at 140° C. for further one hour. The reaction mixture was cooled to room temperature, and then water was added to the reaction mixture, which followed by extraction with ethyl acetate twice. The combined organic layers were washed with water and a saturated sodium chloride solution, sequentially, dried over anhydrous magnesium sulfate, and concentrated under reduced pressure. The residue was subjected to silica gel column chromatography to give 1.26 g of N-{4-[5-(trifluoromethyl)benzoxazole-2-yl]pyridin-3-yl}phthalimide.

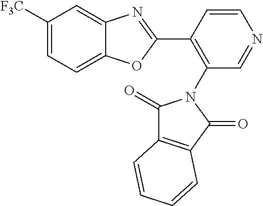

¹H-NMR (CDCl₃) δ: 8.95 (d, J=5.1 Hz, 1H), 8.82 (s, 1H), 8.27 (d, J=5.1 Hz, 1H), 8.04-7.99 (m, 2H), 7.92-7.88 (m, 2H), 7.73-7.70 (m, 1H), 7.64 (dd, J=8.8, 1.2 Hz, 1H), 7.57 (d, J=8.8 Hz, 1H)

To a mixture of 0.41 g of N-{4-[5-(trifluoromethyl)benzoxazole-2-yl]pyridin-3-yl}phthalimide and 5 ml of ethanol, 0.3 ml of hydrazine monohydrate was added and stirred at room temperature for 1.5 hours. To the reaction mixture, ethanol was added and filtrated, and the filtrate was concentrated. The residue was diluted with ethyl acetate, and washed with water and then with a saturated sodium chloride solution. The organic layer was dried over anhydrous magnesium sulfate, and then concentrated under reduced pressure. The residue was subjected to silica gel column chromatography to give 0.19 g of 2-(3-aminopyridin-4-yl)-5-(trifluoromethyl)benzoxazole (hereinafter, referred to as “active compound 52”).

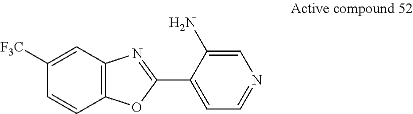

¹H-NMR (CDCl₃) δ: 8.34 (d, J=0.5 Hz, 1H), 8.08-8.06 (m, 2H), 7.83 (d, J=5.4 Hz, 1H), 7.72 (d, J=8.8 Hz, 1H), 7.68 (dd, J=8.8, 1.5 Hz, 1H), 6.14 (br s, 2H)

### Production Example 54

A mixture of 0.31 g of 2-(3-fluoropyridin-4-yl)-5-(trifluoromethyl)benzoxazole, 0.21 g of pyrrolidine, 0.55 g of potassium carbonate and 2 ml of DMF was stirred while heating at 60° C. for one hour. The reaction mixture was cooled to room temperature, and then water was added to the reaction mixture, followed by extraction with ethyl acetate twice.

The combined organic layers were washed with a saturated sodium chloride solution, dried over anhydrous magnesium sulfate, and then concentrated under reduced pressure. The residue was subjected to silica gel column chromatography to give 0.37 g of 2-[3-(pyrrolidine-1-yl)pyridin-4-yl]-5-(trifluoromethyl)benzoxazole (hereinafter, referred to as “active compound 53”).

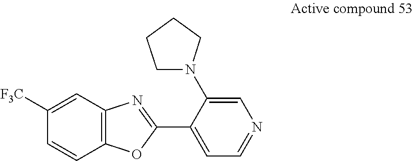

¹H-NMR (CDCl₃) δ: 8.40 (s, 1H), 8.10 (d, J=4.9 Hz, 1H), 8.09-8.07 (m, 1H), 7.71 (d, J=8.5 Hz, 1H), 7.69 (dd, J=8.6, 1.7 Hz, 1H), 7.56 (d, J=5.1 Hz, 1H), 3.28-3.24 (m, 4H), 1.97-1.93 (m, 4H)

### Production Example 55

A mixture of 0.28 g of 2-(3-fluoropyridin-4-yl)-5-(trifluoromethyl)benzoxazole, 0.17 g of piperidine, 0.55 g of potassium carbonate and 2 ml of DMF was stirred while heating at 50° C. for two hours, and then at 80° C. for 1.3 hours. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.34 g of 2-[3-(piperidine-1-yl)pyridin-4-yl]-5-(trifluoromethyl)benzoxazole (hereinafter, referred to as “active compound 54”).

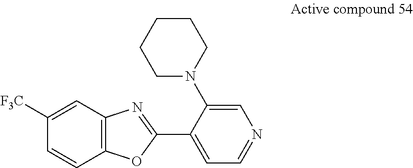

¹H-NMR (CDCl₃) δ: 8.54 (s, 1H), 8.36 (d, J=5.1 Hz, 1H), 8.12-8.11 (m, 1H), 7.89 (d, J=5.1 Hz, 1H), 7.73 (d, J=8.7 Hz, 1H), 7.69 (dd, J=8.8, 1.6 Hz, 1H), 3.11-3.09 (m, 4H), 1.81-1.75 (m, 4H), 1.66-1.59 (m, 2H)

### Production Example 56

Production Example 56 was carried out according to the same manner as in Production Example 55, using morpholine instead of piperidine. Thus, 2-[3-(morpholin-4-yl)pyridin-4-yl]-5-(trifluoromethyl)benzoxazole (hereinafter, referred to as “active compound 55”) was obtained.

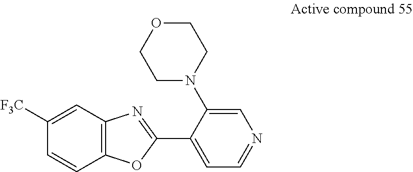

¹H-NMR (CDCl₃) δ: 8.57 (s, 1H), 8.46 (d, J=4.9 Hz, 1H), 8.13-8.11 (m, 1H), 7.97 (d, J=4.9 Hz, 1H), 7.74 (d, J=8.6 Hz, 1H), 7.71 (dd, J=8.7, 1.7 Hz, 1H), 3.96-3.93 (m, 4H), 3.21-3.18 (m, 4H)

### Production Example 57

A mixture of 0.31 g of 2-(3-fluoropyridin-4-yl)-5-(trifluoromethyl)benzoxazole, 0.14 g of imidazole, 0.55 g of potassium carbonate and 2 ml of DMF was stirred while heating at room temperature for 1.5 hours, and then at 60° C. for 1.5 hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.31 g of 2-[3-(imidazole-1-yl)pyridin-4-yl]-5-(trifluoromethyl)benzoxazole (hereinafter, referred to as “active compound 56”).

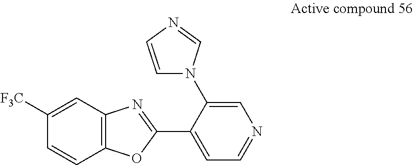

¹H-NMR (CDCl₃) δ: 8.93 (d, J=5.1 Hz, 1H), 8.82 (s, 1H), 8.23 (d, J=5.1 Hz, 1H), 8.08-8.06 (m, 1H), 7.72-7.71 (m, 1H), 7.69 (dd, J=8.5, 1.3 Hz, 1H), 7.59 (d, J=8.5 Hz, 1H), 7.29-7.28 (m, 1H), 7.13-7.11 (m, 1H)

### Production Example 58

A mixture of 0.28 g of 2-(3-fluoropyridin-4-yl)-5-(trifluoromethyl)benzoxazole, 0.18 g of 4-(trifluoromethyl)-1H-imidazole, 0.55 g of potassium carbonate and 2 ml of DMF was stirred while heating at 50° C. for 1.5 hours. Then, the reaction mixture was cooled to room temperature. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.40 g of 2-{3-[4-(trifluoromethyl)imidazole-1-yl]pyridin-4-yl}-5-(trifluoromethyl)benzoxazole (hereinafter, referred to as “active compound 57”).

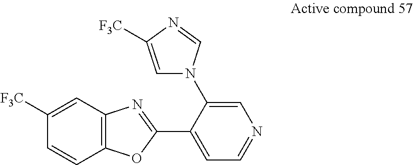

¹H-NMR (CDCl₃) δ: 9.00 (d, J=5.2 Hz, 1H), 8.84 (s, 1H), 8.31 (d, J=5.1 Hz, 1H), 8.06-8.04 (m, 1H), 7.77-7.75 (m, 1H), 7.74-7.70 (m, 1H), 7.62 (d, J=8.6 Hz, 1H), 7.52-7.50 (m, 1H)

### Production Example 59

A mixture of 0.24 g of 2-(3-fluoropyridin-4-yl)-5-(trifluoromethyl)benzoxazole, 0.14 g of pyrazole, 0.69 g of potassium carbonate and 4 ml of DMF was stirred while heating at 50° C. for two hours. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.22 g of 2-[3-(pyrazole-1-yl)pyridin-4-yl]-5-(trifluoromethyl)benzoxazole (hereinafter, referred to as “active compound 58”).

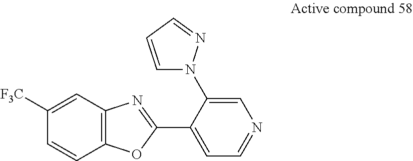

¹H-NMR (CDCl₃) δ: 8.93 (s, 1H), 8.87 (d, J=5.1 Hz, 1H), 8.10 (d, J=5.1 Hz, 1H), 8.08-8.06 (m, 1H), 7.77 (d, J=2.2 Hz, 1H), 7.72 (d, J=1.7 Hz, 1H), 7.66 (dd, J=8.6, 1.3 Hz, 1H), 7.53 (d, J=8.8 Hz, 1H), 6.55-6.53 (m, 1H)

### Production Example 60

A mixture of 0.28 g of 2-(3-fluoropyridin-4-yl)-5-(trifluoromethyl)benzoxazole, 0.19 g of 3-bromopyrazole, 0.55 g of potassium carbonate and 2 ml of DMF was stirred while heating at 50° C. for 1.5 hours. Then, the reaction mixture was cooled to room temperature. Water was added to the reaction mixture, followed by extraction with ethyl acetate twice. The combined organic layers were washed with a saturated sodium chloride solution, dried over anhydrous magnesium sulfate, and concentrated under reduced pressure.

The residue was subjected to silica gel column chromatography to give 0.31 g of 2-[3-(3-bromopyrazole-1-yl)pyridin-4-yl]-5-(trifluoromethyl)benzoxazole (hereinafter, referred to as “active compound 59”).

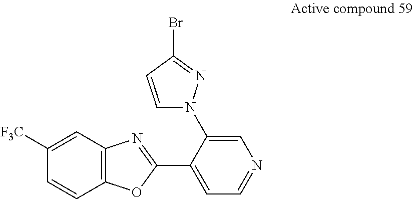

¹H-NMR (CDCl₃) δ: 8.92 (s, 1H), 8.89 (d, J=5.1 Hz, 1H), 8.16 (d, J=5.1 Hz, 1H), 8.08-8.07 (m, 1H), 7.69 (dd, J=8.8, 1.2 Hz, 1H), 7.66 (d, J=2.4 Hz, 1H), 7.59 (d, J=8.8 Hz, 1H), 6.57 (d, J=2.4 Hz, 1H)

### Production Example 61

A mixture of 0.28 g of 2-(3-fluoropyridin-4-yl)-5-(trifluoromethyl)benzoxazole, 0.18 g of 3-trifluoromethylpyrazole, 0.55 g of potassium carbonate and 3 ml of DMF was stirred while heating at 60° C. for one hour. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and then concentrated under reduced pressure. The residue was subjected to silica gel column chromatography to give 0.34 g of 2-[3-(3-trifluoromethylpyrazole-1-yl)pyridin-4-yl]-5-(trifluoromethyl)benzoxazole (hereinafter, referred to as “active compound 60”).

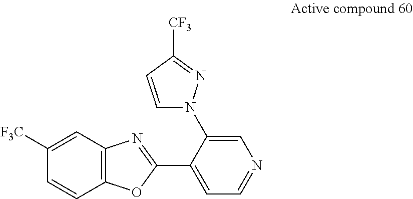

¹H-NMR (CDCl₃) δ: 8.95 (d, J=5.2 Hz, 1H), 8.94 (s, 1H), 8.22 (dd, J=5.2, 0.7 Hz, 1H), 8.05-8.03 (m, 1H), 7.84-7.82 (m, 1H), 7.68 (dd, J=8.8, 1.3 Hz, 1H), 7.54 (d, J=8.8 Hz, 1H), 6.83 (d, J=2.2 Hz, 1H)

### Production Example 62

A mixture of 0.28 g of 2-(3-fluoropyridin-4-yl)-5-(trifluoromethyl)benzoxazole, 0.11 g of 4-methylpyrazole, 0.55 g of potassium carbonate and 3 ml of DMF was stirred while heating at 60° C. for 1.5 hours. To the mixture, 0.05 g of 4-methylpyrazole was added and further stirred while heating at 60° C. for 1.5 hours. Then, the reaction mixture was cooled to room temperature. Water was added to the reaction mixture, followed by extraction with ethyl acetate twice. The combined organic layers were washed with a saturated sodium chloride solution, dried over anhydrous magnesium sulfate, and then concentrated under reduced pressure. The residue was subjected to silica gel column chromatography to give 0.25 g of 2-[3-(4-methylpyrazole-1-yl)pyridin-4-yl]-5-(trifluoromethyl)benzoxazole (hereinafter, referred to as “active compound 61”).

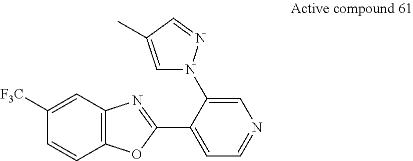

¹H-NMR (CDCl₃) δ: 8.89 (d, J=0.5 Hz, 1H), 8.81 (d, J=5.1 Hz, 1H), 8.08-8.07 (m, 1H), 8.04 (dd, J=5.1, 0.6 Hz, 1H), 7.67-7.65 (m, 1H), 7.57-7.54 (m, 2H), 7.51 (s, 1H), 2.19 (s, 3H)

### Production Example 63

A mixture of 0.28 g of 2-(3-fluoropyridin-4-yl)-5-(trifluoromethyl)benzoxazole, 0.18 g of 4-(trifluoromethyl)pyrazole, 0.55 g of potassium carbonate and 2 ml of DMF was stirred while heating at 50° C. for 1.5 hours. The reaction mixture was cooled to room temperature. Water was added to the reaction mixture, followed by extraction with ethyl acetate twice. The combined organic layers were washed with a saturated sodium chloride solution, dried over anhydrous magnesium sulfate, and then concentrated under reduced pressure. The residue was subjected to silica gel column chromatography to give 0.36 g of 2-{3-[4-(trifluoromethyl)pyrazole-1-yl]pyridin-4-yl}-5-(trifluoromethyl)benzoxazole (hereinafter, referred to as “active compound 62”).

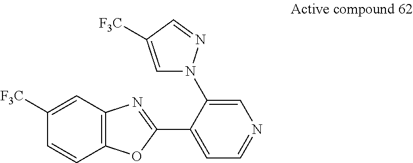

¹H-NMR (CDCl₃) δ: 8.96 (d, J=5.1 Hz, 1H), 8.93 (d, J=0.5 Hz, 1H), 8.21 (dd, J=5.1, 0.5 Hz, 1H), 8.13-8.11 (m, 1H), 8.05-8.04 (m, 1H), 7.95 (s, 1H), 7.71-7.68 (m, 1H), 7.56 (d, J=8.8 Hz, 1H)

### Production Example 64

A mixture of 0.28 g of 2-(3-fluoropyridin-4-yl)-5-(trifluoromethyl)benzoxazole, 0.10 g of 1H-1,2,4-triazole, 0.55 g of potassium carbonate and 2 ml of DMF was stirred while heating at 50° C. for 1.5 hours. Then, the reaction mixture was cooled to room temperature. Water was added to the reaction mixture, followed by extraction with ethyl acetate twice. The combined organic layers were washed with a saturated sodium chloride solution, dried over anhydrous magnesium sulfate, and then concentrated under reduced pressure. The residue was subjected to silica gel column chromatography to give 0.26 g of 2-[3-(1,2,4-triazole-1-yl)pyridin-4-yl]-5-(trifluoromethyl)benzoxazole (hereinafter, referred to as “active compound 63”).

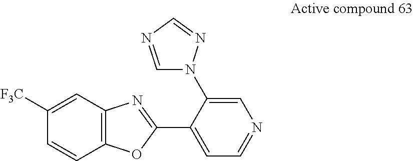

¹H-NMR (CDCl₃) δ: 8.99 (d, J=5.3 Hz, 1H), 8.92 (d, J=0.8 Hz, 1H), 8.52 (s, 1H), 8.25 (dd, J=5.3, 0.6 Hz, 1H), 8.19 (s, 1H), 8.05-8.04 (m, 1H), 7.71-7.69 (m, 1H), 7.61-7.59 (m, 1H)

### Production Example 65

To a mixture of 0.42 g of N-[3-chloro-5-(trifluoromethyl)-2-hydroxyphenyl]isonicotinamide, 5 ml of tetrahydrofuran and 0.38 g of triphenylphosphine, 0.64 g of 40% toluene solution of diethyl azodicarboxylate was added dropwise at room temperature. The reaction mixture was stirred while heating at room temperature for one hour and then at 50° C. for 2.5 hours. The reaction mixture was cooled to room temperature, and then concentrated under reduced pressure. The residue was subjected to silica gel column chromatography to give 2-(pyridin-4-yl)-7-chloro-5-(trifluoromethyl)benzoxazole (hereinafter, referred to as “active compound 64”).

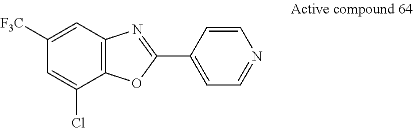

¹H-NMR (CDCl₃) δ: 8.89-8.88 (m, 2H), 8.16-8.13 (m, 2H), 8.02-8.01 (m 1H), 7.72-7.71 (m, 1H)

### Production Example 66

To a mixture of 0.49 g of N-[2-hydroxy-5-(pentafluoroethyl)phenyl]isonicotinamide, 5 ml of tetrahydrofuran and 0.46 g of triphenylphosphine, 0.77 g of 40% toluene solution of diethyl azodicarboxylate was added dropwise at room temperature. The reaction mixture was stirred for 1.8 hours. The reaction mixture was concentrated under reduced pressure. The residue was subjected to silica gel column chromatography to give 0.41 g of 5-(pentafluoroethyl)-2-(pyridin-4-yl)-benzoxazole (hereinafter, referred to as “active compound 65”).

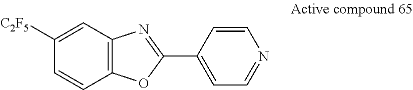

¹H-NMR (CDCl₃) δ: 8.88-8.86 (m, 2H), 8.12-8.10 (m, 3H), 7.77 (d, J=8.8 Hz, 1H), 7.70-7.67 (m, 1H)

### Production Example 67

To a mixture of 0.24 g of 3-chloro-N-[2-hydroxy-5-(pentafluoroethyl)phenyl]isonicotinamide, 4 ml of tetrahydrofuran and 0.21 g of triphenylphosphine, 0.34 g of 40% toluene solution of diethyl azodicarboxylate was added dropwise at room temperature. The reaction mixture was stirred for 1.8 hours. The reaction mixture was concentrated under reduced pressure. The residue was subjected to silica gel column chromatography to give 0.19 g of 2-(3-chloropyridin-4-yl)-5-(pentafluoroethyl)benzoxazole (hereinafter, referred to as “active compound 66”).

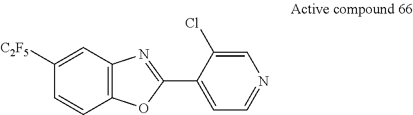

¹H-NMR (CDCl₃) δ: 8.86 (s, 1H), 8.71 (d, J=5.1 Hz, 1H), 8.18 (s, 1H), 8.10 (d, J=5.1 Hz, 1H), 7.80 (d, J=8.5 Hz, 1H), 7.72 (d, J=8.8 Hz, 1H)

### Production Example 68

To a mixture of 0.79 g of N-[2-hydroxy-5-(heptafluoroisopropyl)phenyl]isonicotinamide, 8 ml of tetrahydrofuran and 0.60 g of triphenylphosphine, 0.99 g of 40% toluene solution of diethyl azodicarboxylate was added dropwise at room temperature. The reaction mixture was stirred for 2.3 hours. The reaction mixture was concentrated under reduced pressure. The residue was subjected to silica gel column chromatography to give 2-(pyridin-4-yl)-5-(heptafluoroisopropyl)benzoxazole (hereinafter, referred to as “active compound 67”).

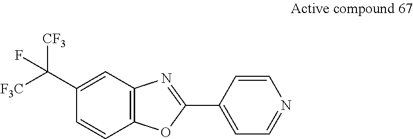

¹H-NMR (CDCl₃) δ: 8.88-8.86 (m, 2H), 8.14 (s, 1H), 8.12-8.10 (m, 2H), 7.78 (d, J=8.8 Hz, 1H), 7.71 (d, J=8.8 Hz, 1H)

### Production Example 69

To a mixture of 0.90 g of 3-chloro-N-[2-hydroxy-5-(heptafluoroisopropyl)phenyl]isonicotinamide, 10 ml of tetrahydrofuran and 0.68 g of triphenylphosphine, 1.13 g of 40% toluene solution of diethyl azodicarboxylate was added dropwise at room temperature. The reaction mixture was stirred for 1.2 hours. The reaction mixture was concentrated under reduced pressure. The residue was subjected to silica gel column chromatography to give 0.58 g of 2-(3-chloropyridin-4-yl)-5-(heptafluoroisopropyl)benzoxazole (hereinafter, referred to as “active compound 68”).

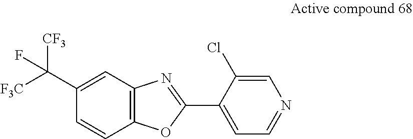

¹H-NMR (CDCl₃) δ: 8.86 (s, 1H), 8.71 (d, J=5.1 Hz, 1H), 8.21 (s, 1H), 8.09 (d, J=4.9 Hz, 1H), 7.81 (d, J=8.8 Hz, 1H), 7.74 (d, J=8.7 Hz, 1H)

### Production Example 70

A mixture of 0.28 g of 2-(3-fluoropyridin-4-yl)-5-(trifluoromethyl)benzoxazole, 0.27 g of potassium carbonate and 3 ml of ethanol was stirred while heating at 60° C. for two hours and then at 90° C. for 2.5 hours. The reaction mixture was cooled to room temperature, and then concentrated under reduced pressure. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.18 g of 2-(3-ethoxypyridin-4-yl)-5-(trifluoromethyl)benzoxazole (hereinafter, referred to as “active compound 69”).

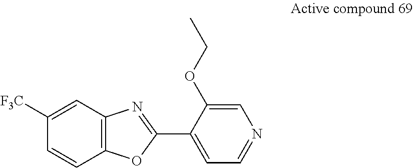

¹H-NMR (CDCl₃) δ: 8.57 (s, 1H), 8.43 (d, J=4.8 Hz, 1H), 8.14-8.12 (m, 1H), 8.00 (d, J=4.8 Hz, 1H), 7.75-7.67 (m, 2H), 4.39 (q, J=7.0 Hz, 2H), 1.58 (t, J=7.0 Hz, 3H)

### Production Example 71

To a mixture of 0.28 g of 2-(3-fluoropyridin-4-yl)-5-(trifluoromethyl)benzoxazole and 3 ml of 2-propanol, 52 mg of 60% sodium hydride (in oil) was added while ice-cooling. The mixture was stirred for 1.5 hours and then heated to room temperature and stirred for 1.5 hours. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.12 g of 2-(3-isopropoxypyridin-4-yl)-5-(trifluoromethyl)benzoxazole (hereinafter, referred to as “active compound 70”).

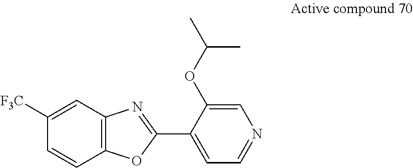

¹H-NMR (CDCl₃) δ: 8.57 (s, 1H), 8.41 (d, J=5.1 Hz, 1H), 8.13-8.12 (m, 1H), 8.00 (d, J=5.1 Hz, 1H), 7.74-7.67 (m, 2H), 4.87-4.78 (m, 1H), 1.49 (d, J=6.0 Hz, 6H)

### Production Example 72

A mixture of 0.28 g of 2-(3-fluoropyridin-4-yl)-5-(trifluoromethyl)benzoxazole, 0.27 g of potassium carbonate, and 3 ml of propanol was heated to reflux while stirring for six hours. The reaction mixture was cooled to room temperature, and then concentrated under reduced pressure. Water was added the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.25 g of 2-(3-propoxypyridin-4-yl)-5-(trifluoromethyl)benzoxazole (hereinafter, referred to as “active compound 71”).

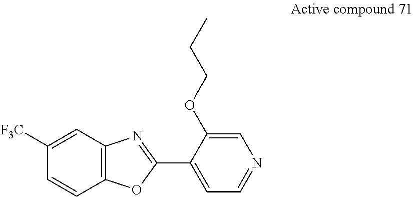

¹H-NMR (CDCl₃) δ: 8.56 (s, 1H), 8.43 (d, J=5.0 Hz, 1H), 8.13-8.11 (m, 1H), 8.01 (d, J=5.1 Hz, 1H), 7.74-7.67 (m, 2H), 4.27 (t, J=6.5, 2H), 2.02-1.92 (m, 2H), 1.15 (t, J=7.5 Hz, 3H)

### Production Example 73

A mixture of 0.28 g of 2-(3-fluoropyridin-4-yl)-5-(trifluoromethyl)benzoxazole, 0.27 g of potassium carbonate and 3 ml of butanol was stirred while heating at 100° C. for six hours. To the mixture, 0.14 g of potassium carbonate was added, and the reaction mixture was stirred while heating at 100° C. for further four hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.24 g of 2-(3-butoxypyridin-4-yl)-5-(trifluoromethyl)benzoxazole (hereinafter, referred to as “active compound 72”).

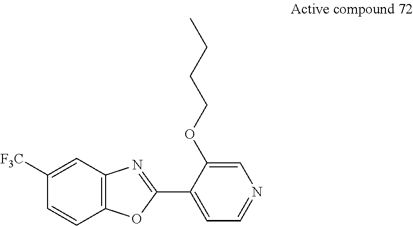

¹H-NMR (CDCl₃) δ: 8.57 (s, 1H), 8.42 (d, J=4.8 Hz, 1H), 8.13-8.11 (m, 1H), 8.01 (d, J=4.8 Hz, 1H), 7.73-7.67 (m, 2H), 4.31 (t, J=6.5 Hz, 2H), 1.97-1.88 (m, 2H), 1.67-1.55 (m, 2H), 1.03 (t, J=7.5 Hz, 3H)

### Production Example 74

A mixture of 0.28 g of 2-(3-fluoropyridin-4-yl)-5-(trifluoromethyl)benzoxazole, 0.27 g of potassium carbonate and 3 ml of 2-propyne-1-ol was stirred while heating at 100° C. for two hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.20 g of 2-(3-(2-propyne-1-yloxy)pyridin-4-yl)-5-(trifluoromethyl)benzoxazole (hereinafter, referred to as “active compound 73”).

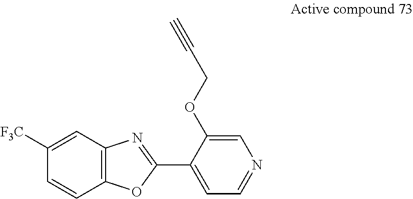

¹H-NMR (CDCl₃) δ: 8.75 (s, 1H), 8.51 (d, J=4.8 Hz, 1H), 8.16-8.14 (m, 1H), 8.05 (d, J=5.1 Hz, 1H), 7.77-7.69 (m, 2H), 5.05-5.03 (m, 2H), 2.64-2.62 (m, 1H)

### Production Example 75

A mixture of 0.28 g of 2-(3-fluoropyridin-4-yl)-5-(trifluoromethyl)benzoxazole, 0.27 g of potassium carbonate and 3 ml of allyl alcohol was stirred while heating at 100° C. for two hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.24 g of 2-(3-allyloxypyridin-4-yl)-5-(trifluoromethyl)benzoxazole (hereinafter, referred to as “active compound 74”).

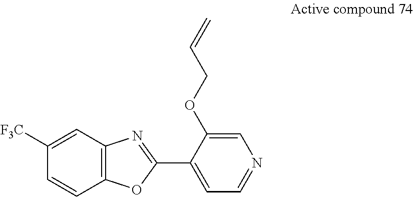

¹H-NMR (CDCl₃) δ: 8.57 (s, 1H), 8.45 (d, J=4.9 Hz, 1H), 8.15-8.13 (m, 1H), 8.03 (d, J=4.9 Hz, 1H), 7.75-7.68 (m, 2H), 6.19-6.09 (m, 1H), 5.70-5.62 (m, 1H), 5.44-5.38 (m, 1H), 4.92-4.86 (m, 2H)

### Production Example 76

A mixture of 0.28 g of 2-(3-fluoropyridin-4-yl)-5-(trifluoromethyl)benzoxazole, 0.27 g of potassium carbonate and 3 ml of 2,2,3,3,3-pentafluoropropanol was heated to reflux while stirring for 5.5 hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.33 g of 2-[3-2,2,3,3,3-pentafluoropropoxy)pyridin-4-yl]-5-(trifluoromethyl)benzoxazole (hereinafter, referred to as “active compound 75”).

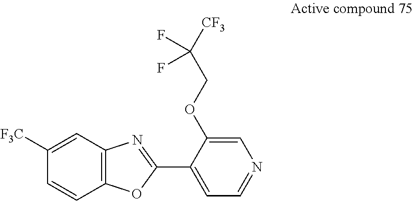

¹H-NMR (CDCl₃) δ: 8.61-8.58 (m, 2H), 8.14-8.11 (m, 2H), 7.73-7.72 (m, 2H), 4.77-4.70 (m, 2H)

### Production Example 77

To a mixture of 0.69 g of N-[2-hydroxy-5-(trifluoromethylthio)phenyl]isonicotinamide, 9 ml of tetrahydrofuran, and 0.63 g of triphenylphosphine, 1.05 g of 40% toluene solution of diethyl azodicarboxylate was added dropwise at room temperature and stirred for three hours. To the mixture, 0.21 g of triphenylphosphine and 0.35 g of 40% toluene solution of diethyl azodicarboxylate were added. The reaction mixture was stirred for further two hours. The reaction mixture was concentrated under reduced pressure. The residue was subjected to silica gel column chromatography and the resultant crystals were washed with methanol to give 0.17 g of 2-(pyridin-4-yl)-5-(trifluoromethylthio)benzoxazole (hereinafter, referred to as “active compound 76”).

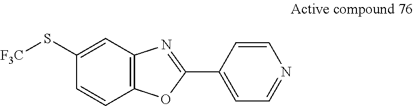

¹H-NMR (CDCl₃) δ: 8.86 (dd, J=4.3, 1.7 Hz, 2H), 8.17-8.16 (m, 1H), 8.10 (dd, J=4.3, 1.7 Hz, 2H), 7.74 (dd, J=8.7, 1.4 Hz, 1H), 7.69 (d, J=8.5 Hz, 1H)

### Production Example 78

To a mixture of 0.64 g of 3-chloro-N-[2-hydroxy-5-(trifluoromethylthio)phenyl]isonicotinamide, 6 ml of tetrahydrofuran and 0.53 g of triphenylphosphine, 0.87 g of 40% toluene solution of diethyl azodicarboxylate was added dropwise at room temperature and stirred for 1.5 hours. The reaction mixture was concentrated under reduced pressure. The residue was subjected to silica gel column chromatography to give 0.57 g of 2-(3-chloropyridin-4-yl)-5-(trifluoromethylthio)benzoxazole (hereinafter, referred to as “active compound 77”).

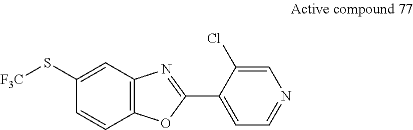

¹H-NMR (CDCl₃) δ: 8.85 (s, 1H), 8.70 (d, J=5.1 Hz, 1H), 8.24 (d, J=1.7 Hz, 1H), 8.09 (d, J=5.1 Hz, 1H), 7.78 (dd, J=8.5, 1.7 Hz, 1H), 7.72 (d, J=8.5 Hz, 1H)

### Production Example 79

To a mixture of 0.55 g of N-[5-chloro-2-hydroxy-4-(trifluoromethyl)phenyl]isonicotinamide, 6 ml of tetrahydrofuran and 0.50 g of triphenylphosphine, 0.83 g of 40% toluene solution of diethyl azodicarboxylate was added dropwise at room temperature. The reaction mixture was stirred for 1.5 hours. The reaction mixture was concentrated under reduced pressure. The residue was subjected to silica gel column chromatography, and the resultant crystals were washed with methanol to give 0.11 g of 5-chloro-2-(pyridin-4-yl)-6-(trifluoromethyl)benzoxazole (hereinafter, referred to as “active compound 78”).

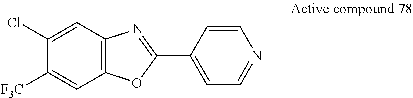

¹H-NMR (CDCl₃) δ: 8.88 (dd, J=4.3, 1.7 Hz, 2H), 8.10 (dd, J=4.5, 1.7 Hz, 2H), 8.01 (s, 1H), 7.97 (s, 1H)

### Production Example 80

To a mixture of 0.67 g of 3-chloro-N-[5-chloro-2-hydroxy-4-(trifluoromethyl)phenyl]isonicotinamide, 7 ml of tetrahydrofuran and 0.55 g of triphenylphosphine, 0.91 g of 40% toluene solution of diethyl azodicarboxylate was added dropwise at room temperature. The reaction mixture was stirred for 1.5 hours. To the mixture, 0.14 g of triphenylphosphine and 0.23 g of 40% toluene solution of diethyl azodicarboxylate were added and stirred for further one hour. The reaction mixture was concentrated under reduced pressure. The residue was subjected to silica gel column chromatography, and the resultant crystals were washed with isopropanol and hexane to give 0.37 g of 5-chloro-2-(3-chloropyridin-4-yl)-6-(trifluoromethyl)benzoxazole (hereinafter, referred to as “active compound 79”).

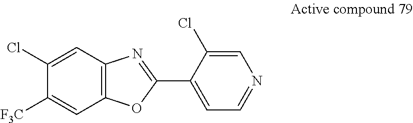

¹H-NMR (CDCl₃) δ: 8.87 (s, 1H), 8.72 (d, J=5.1 Hz, 1H), 8.09 (d, J=5.1 Hz, 1H), 8.06 (s, 1H), 8.03 (s, 1H)

### Production Example 81

To a mixture of 1.01 g of N-[4-chloro-2-hydroxy-5-(trifluoromethyl)phenyl]isonicotinamide, 10 ml of tetrahydrofuran and 0.92 g of triphenylphosphine, 1.53 g of 40% toluene solution of diethyl azodicarboxylate was added dropwise at room temperature, and the reaction mixture was stirred for two hours. The reaction mixture was concentrated under reduced pressure. The residue was subjected to silica gel column chromatography and the resultant crystals washed with methanol to give 0.66 g of 6-chloro-2-(pyridin-4-yl)-5-(trifluoromethyl)benzoxazole (hereinafter, referred to as “active compound 80”).

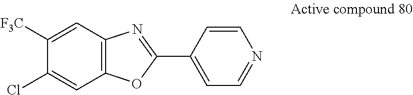

¹H-NMR (CDCl₃) δ: 8.87 (dd, J=4.3, 1.7 Hz, 2H), 8.18 (s, 1H), 8.08 (dd, J=4.3, 1.7 Hz, 2H), 7.81 (s, 1H)

### Production Example 82

To a mixture of 0.46 g of 3-chloro-N-[4-chloro-2-hydroxy-5-(trifluoromethyl)phenyl]isonicotinamide, 5 ml of tetrahydrofuran and 0.38 g of triphenylphosphine, 0.63 g of 40% toluene solution of diethyl azodicarboxylate was added dropwise at room temperature, and the reaction mixture was stirred for two hours. The reaction mixture was concentrated under reduced pressure. The residue was subjected to silica gel column chromatography to give 0.39 g of 6-chloro-2-(3-chloropyridin-4-yl)-5-(trifluoromethyl)benzoxazole (hereinafter, referred to as “active compound 81”).

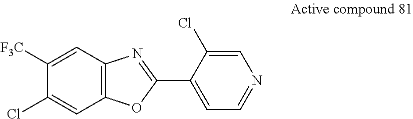

¹H-NMR (CDCl₃) δ: 8.86 (s, 1H), 8.71 (d, J=5.1 Hz, 1H), 8.26 (s, 1H), 8.08 (d, J=5.1 Hz, 1H), 7.86 (s, 1H)

### Production Example 83

A mixture of 0.28 g of 2-(3-aminopyridin-4-yl)-5-(trifluoromethyl)benzoxazole and 3 ml of acetic anhydride was stirred while heating at 60° C. for two hours. The reaction mixture was cooled to room temperature, and then water was added to the reaction mixture, followed by extraction with ethyl acetate twice. The combined organic layers were washed with a saturated aqueous solution of sodium hydrogencarbonate and a saturated sodium chloride solution, dried over anhydrous magnesium sulfate, and concentrated under reduced pressure. The residue was washed with ethyl acetate to give 0.17 g of N-[4-(5-trifluoromethylbenzoxazole-2-yl)pyridin-3-yl]acetamide (hereinafter, referred to as “active compound 82”).

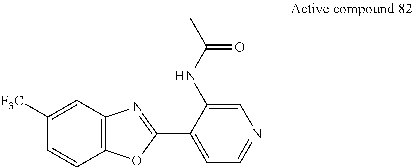

¹H-NMR (DMSO-d₆) δ: 10.92 (br s, 1H), 9.52 (s, 1H), 8.57 (d, J=5.1 Hz, 1H), 8.44-8.42 (m, 1H), 8.12 (d, J=8.7 Hz, 1H), 8.09-8.07 (m, 1H), 7.93-7.90 (m, 1H), 2.26 (s, 3H)

### Production Example 84

A mixture of 0.28 g of 2-(3-fluoropyridin-4-yl)-5-(trifluoromethyl)benzoxazole, 0.55 g of potassium carbonate, 0.14 g of methylamine hydrochloride, and 3 ml of DMF was stirred while heating at 60° C. for three hours. To the mixture, 0.55 g of potassium carbonate and 0.14 g of methylamine hydrochloride were added, and the reaction mixture was stirred while heating for further two hours. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography, and resultant crystals were washed with diethyl ether to give 0.13 g of methyl-[4-(5-trifluoromethylbenzoxazole-2-yl)pyridin-3-yl]amine (hereinafter, referred to as “active compound 83”).

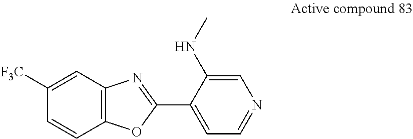

¹H-NMR (CDCl₃) δ: 8.35 (s, 1H), 8.08-8.04 (m, 2H), 7.94-7.87 (br m, 1H), 7.84 (d, J=5.1 Hz, 1H), 7.71 (d, J=8.7 Hz, 1H), 7.69-7.65 (m, 1H), 3.16 (d, J=5.1 Hz, 3H)

### Production Example 85

A mixture of 0.28 g of 2-(3-fluoropyridin-4-yl)-5-(trifluoromethyl)benzoxazole, 0.55 g of potassium carbonate, 0.16 g of ethylamine hydrochloride and 3 ml of DMF was stirred while heating at 80° C. for 4.5 hours. To the mixture, 0.55 g of potassium carbonate, 0.16 g of ethylamine hydrochloride and 2 ml of DMF were added, and the reaction mixture was stirred while heating for further three hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.19 g of ethyl-[4-(5-trifluoromethylbenzoxazole-2-yl)pyridin-3-yl]amine (hereinafter, referred to as “active compound 84”).

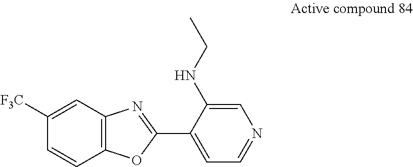

¹H-NMR (CDCl₃) δ: 8.35 (s, 1H), 8.08-8.06 (m, 1H), 8.04 (d, J=5.1 Hz, 1H), 7.92-7.87 (br m, 1H), 7.85 (d, J=5.1 Hz, 1H), 7.71 (d, J=8.7 Hz, 1H), 7.69-7.65 (m, 1H), 3.54-3.45 (m, 2H), 1.46 (t, J=7.1 Hz, 3H)

### Production Example 86

A mixture of 0.28 g of 2-(3-fluoropyridin-4-yl)-5-(trifluoromethyl)benzoxazole, 0.69 g of potassium carbonate, 0.30 g of isopropylamine and 3 ml of DMF was stirred while heating at 50° C. for 1.5 hours and at 80° C. for 4 hours. To the mixture, 0.30 g of isopropylamine was added and stirred while heating for further three hours. To the reaction mixture, water was added, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.21 g of isopropyl-[4-(5-trifluoromethylbenzoxazole-2-yl)pyridin-3-yl]amine (hereinafter, referred to as “active compound 85”).

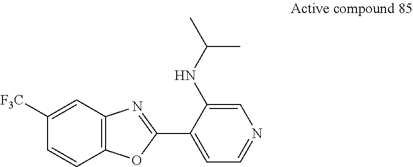

¹H-NMR (CDCl₃) δ: 8.36 (s, 1H), 8.09-8.07 (m, 1H), 8.00 (d, J=5.1 Hz, 1H), 7.95-7.89 (br m, 1H), 7.85 (d, J=5.1 Hz, 1H), 7.70 (d, J=8.5 Hz, 1H), 7.69-7.65 (m, 1H), 4.03-3.94 (m, 1H), 1.42 (d, J=6.3 Hz, 6H)

### Production Example 87

To a mixture of 0.68 g of 3-chloro-N-(1,1,3,3-tetrafluoro-6-hydroxy-1,3-dihydroisobenzofuran-5-yl)isonicotinamide, 8 ml of tetrahydrofuran and 0.55 g of triphenylphosphine, 0.90 g of 40% toluene solution of diethyl azodicarboxylate was added dropwise at room temperature, and the reaction mixture was stirred for 1.5 hours. The reaction mixture was concentrated under reduced pressure. The residue was subjected to silica gel column chromatography to give 0.55 g of 2-(3-chloropyridin-4-yl)-5,5,7,7-tetrafluoro-5,7-dihydro-furo[3′,4′:4,5]benzo[1,2-d]oxazole (hereinafter, referred to as “active compound 86”).

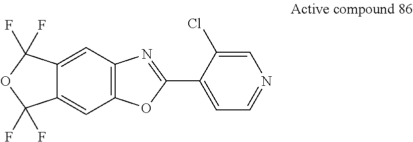

¹H-NMR (CDCl₃) δ: 8.89 (s, 1H), 8.74 (d, J=5.1 Hz, 1H), 8.16 (s, 1H), 8.11 (d, J=5.1 Hz, 1H), 7.96 (s, 1H)

### Production Example 88

To a mixture of 1.46 g of 3-fluoro-N-(1,1,3,3-tetrafluoro-6-hydroxy-1,3-dihydroisobenzofuran-5-yl)isonicotinamide, 10 ml of tetrahydrofuran and 2.02 g of triphenylphosphine, 0.90 g of 40% toluene solution of diethyl azodicarboxylate was added dropwise at room temperature, and the reaction mixture was stirred for one hour. The reaction mixture was concentrated under reduced pressure. The residue was subjected to silica gel column chromatography to give 1.09 g of 5,5,7,7-tetrafluoro-2-(3-fluoropyridin-4-yl)-5,7-dihydro-furo[3′,4′:4,5]benzo[1,2-d]oxazole (hereinafter, referred to as “active compound 87”).

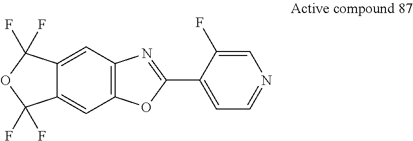

¹H-NMR (CDCl₃) δ: 8.80-8.78 (m, 1H), 8.71-8.68 (m, 1H), 8.17-8.12 (m, 2H), 7.96-7.94 (m, 1H)

### Production Example 89

A mixture of 0.28 g of 5,5,7,7-tetrafluoro-2-(3-fluoropyridin-4-yl)-5,7-dihydro-furo[3′,4′:4,5]benzo[1,2-d]oxazole, 0.24 g of potassium carbonate and 3 ml of methanol was stirred while heating at 60° C. for 3.5 hours. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.13 g of 5,5,7,7-tetrafluoro-2-(3-methoxypyridin-4-yl)-5,7-dihydro-furo[3′,4′:4,5]benzo[1,2-d]oxazole (hereinafter, referred to as “active compound 88”).

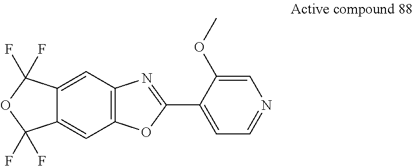

¹H-NMR (CDCl₃) δ: 8.63 (s, 1H), 8.49 (d, J=4.9 Hz, 1H), 8.10 (s, 1H), 8.03 (d, J=4.9 Hz, 1H), 7.91 (s, 1H), 4.17 (s, 3H)

### Production Example 90

A mixture of 44 mg of 60% sodium hydride (in oil) and 2 ml of DMF was stirred at room temperature. To the mixture, a mixture solution of 0.11 g of 2,2,2-trifluoroethanol and 0.5 ml of DMF was added. The mixture solution was stirred for 15 minutes, and then, 0.28 g of 5,5,7,7-tetrafluoro-2-(3-fluoropyridin-4-yl)-5,7-dihydro-furo[3′,4′:4,5]benzo[1,2-d]oxazole was added and stirred at room temperature for one hour. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.25 g of 5,5,7,7-tetrafluoro-2-[3-(2,2,2-trifluoroethoxy)pyridin-4-yl]-5,7-dihydro-furo[3′,4′:4,5]benzo[1,2-d]oxazole (hereinafter, referred to as “active compound 89”).

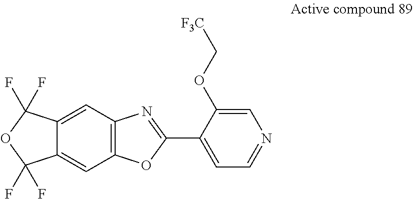

¹H-NMR (CDCl₃) δ: 8.63-8.61 (m, 2H), 8.12 (d, J=4.9 Hz, 1H), 8.11 (s, 1H), 7.91 (s, 1H), 4.69 (q, J=7.8 Hz, 2H)

### Production Example 91

To a mixture of 2.08 g of 3-fluoro-N-[4-chloro-2-hydroxy-5-(trifluoromethyl)phenyl]isonicotinamide, 13 ml of tetrahydrofuran and 1.79 g of triphenylphosphine, 2.98 g of 40% toluene solution of diethyl azodicarboxylate was added dropwise at room temperature. The reaction mixture was stirred for one hour. The reaction mixture was concentrated under reduced pressure. The residue was subjected to silica gel column chromatography to give 1.74 g of 6-chloro-2-(3-fluoropyridin-4-yl)-5-(trifluoromethyl)benzoxazole (hereinafter, referred to as “active compound 90”).

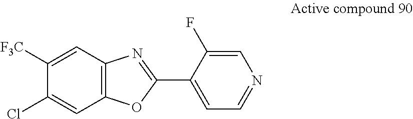

¹H-NMR (CDCl₃) δ: 8.77-8.75 (m, 1H), 8.68-8.65 (m, 1H), 8.24 (s, 1H), 8.13-8.08 (m, 1H), 7.85 (s, 1H)

### Production Example 92

A mixture of 0.28 g of 6-chloro-2-(3-fluoropyridin-4-yl)-5-(trifluoromethyl)benzoxazole, 0.24 g of potassium carbonate and 3 ml of methanol was stirred while heating at 60° C. for two hours. Water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.13 g of 6-chloro-2-(3-methoxypyridin-4-yl)-5-(trifluoromethyl)benzoxazole (hereinafter, referred to as “active compound 91”).

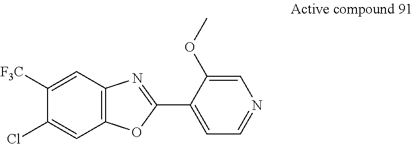

¹H-NMR (CDCl₃) δ: 8.60 (s, 1H), 8.47 (d, J=4.9 Hz, 1H), 8.21 (s, 1H), 7.99 (d, J=4.9 Hz, 1H), 7.81 (s, 1H), 4.16 (s, 3H)

### Production Example 93

A mixture of 46 mg of 60% sodium hydride (in oil) and 2 ml of DMF was stirred at room temperature, to which a mixture solution of 0.12 g of 2,2,2-trifluoroethanol and 0.5 ml of DMF was added. After 15 minutes, 0.28 g of 6-chloro-2-(3-fluoropyridin-4-yl)-5-(trifluoromethyl)benzoxazole was added and stirred at room temperature for one hour. Water was added to the reaction mixture, followed by extraction with ethyl acetate twice. The combined organic layers were washed with a saturated sodium chloride solution, dried over anhydrous magnesium sulfate, and then concentrated under reduced pressure. The residue was subjected to silica gel column chromatography to give 0.26 g of 6-chloro-2-[3-(2,2,2-trifluoroethoxy)pyridin-4-yl]-5-(trifluoromethyl)benzoxazole (hereinafter, referred to as “active compound 92”).

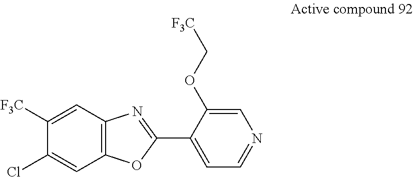

¹H-NMR (CDCl₃) δ: 8.60 (s, 1H), 8.59 (d, J=4.9 Hz, 1H), 8.21 (s, 1H), 8.08 (d, J=5.1 Hz, 1H), 7.81 (s, 1H), 4.66 (q, J=8.0 Hz, 2H)

### Production Example 94

Production Example 94 was carried out according to the same manner as in Production Example 78, using N-[4-chloro-2-hydroxy-5-(trifluoromethyl)phenyl]-3-ethyl isonicotinamide instead of 3-chloro-N-[2-hydroxy-5-(trifluoromethylthio)phenyl]isonicotinamide, and thus 0.17 g of 6-chloro-2-(3-ethylpyridin-4-yl)-5-(trifluoromethyl)benzoxazole (hereinafter, referred to as “active compound 93”) was obtained.

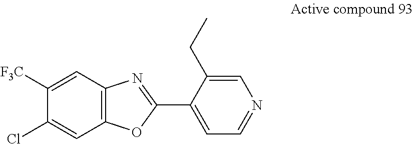

¹H-NMR (CDCl₃) δ: 8.72 (s, 1H), 8.67 (d, J=5.1 Hz, 1H), 8.21 (s, 1H), 7.98 (d, J=5.1 Hz, 1H), 7.81 (s, 1H), 3.27 (q, J=7.5 Hz, 2H), 1.34 (t, J=7.4 Hz, 3H)

### Production Example 95

Production Example 95 was carried out according to the same manner as in Production Example 22, using 3-chloro-N-[4-fluoro-2-hydroxy-5-(trifluoromethyl)phenyl]isonicotinamide instead of 2-chloro-N-[2-hydroxy-5-(trifluoromethyl)phenyl]isonicotinamide, and thus 0.63 g of 2-(3-chloropyridin-4-yl)-6-fluoro-5-(trifluoromethyl)benzoxazole (hereinafter, referred to as “active compound 94”) was obtained.

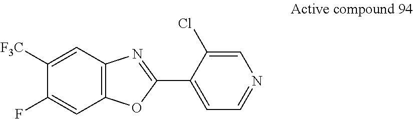

¹H-NMR (CDCl₃) δ: 8.86 (s, 1H), 8.70 (d, J=5.1 Hz, 1H), 8.17 (d, J=6.3 Hz, 1H), 8.06 (d, J=5.1 Hz, 1H), 7.54 (d, J=9.0 Hz, 1H)

### Production Example 96

Production Example 96 was carried out according to the same manner as in Production Example 78, using 3-chloro-N-[2-fluoro-6-hydroxy-3-(trifluoromethyl)phenyl]isonicotinamide instead of 3-chloro-N-[2-hydroxy-5-(trifluoromethylthio)phenyl]isonicotinamide, and thus 56 mg of 2-(3-chloropyridin-4-yl)-4-fluoro-5-(trifluoromethyl)benzoxazole (hereinafter, referred to as “active compound 95”) was obtained.

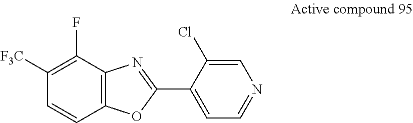

¹H-NMR (CDCl₃) δ: 8.86 (s, 1H), 8.71 (d, J=5.1 Hz, 1H), 8.12 (d, J=5.1 Hz, 1H), 7.73 (dd, J=8.5, 6.3 Hz, 1H), 7.57 (d, J=8.6 Hz, 1H)

### Production Example 97

Production Example 97 was carried out according to the same manner as in Production Example 78, using N-[2-chloro-6-hydroxy-3-(trifluoromethyl)phenyl]isonicotinamide instead of 3-chloro-N-[2-hydroxy-5-(trifluoromethylthio)phenyl]isonicotinamide, and thus 91 mg of 4-chloro-2-(pyridin-4-yl)-5-(trifluoromethyl)benzoxazole (hereinafter, referred to as “active compound 96”) was obtained.

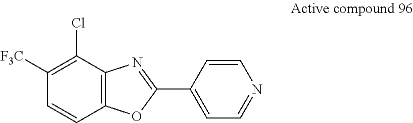

¹H-NMR (CDCl₃) δ: 8.88 (dd, J=4.4, 1.7 Hz, 2H), 8.15 (dd, J=4.5, 1.6 Hz, 2H), 7.80 (d, J=8.8 Hz, 1H), 7.63 (d, J=8.8 Hz, 1H)

### Production Example 98

Production Example 98 was carried out according to the same manner as in Production Example 22, using 3-isopropoxy-N-(1,1,3,3-tetrafluoro-6-hydroxy-1,3-dihydroisobenzofuran-5-yl)isonicotinamide instead of 2-chloro-N-[2-hydroxy-5-(trifluoromethyl)phenyl]isonicotinamide, and thus 0.12 g of 5,5,7,7-tetrafluoro-2-(3-isopropoxypyridin-4-yl)-5,7-dihydro-furo[3′,4′:4,5]benzo[1,2-d]oxazole (hereinafter, referred to as “active compound 97”) was obtained.

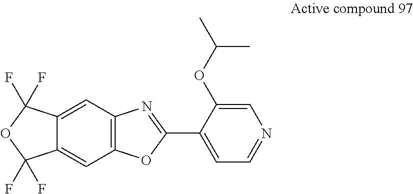

¹H-NMR (CDCl₃) δ: 8.59 (s, 1H), 8.42 (d, J=5.1 Hz, 1H), 8.08 (s, 1H), 8.01 (d, J=5.1 Hz, 1H), 7.89 (s, 1H), 4.92-4.82 (m, 1H), 1.50 (d, J=6.1 Hz, 6H)

### Production Example 99

Production Example 99 was carried out according to the same manner as in Production Example 78, using 3-ethyl-N-(1,1,3,3-tetrafluoro-6-hydroxy-1,3-dihydroisobenzofuran-5-yl)isonicotinamide instead of 3-chloro-N-[2-hydroxy-5-(trifluoromethylthio)phenyl]isonicotinamide and thus 0.40 g of 2-(3-ethylpyridin-4-yl)-5,5,7,7-tetrafluoro-5,7-dihydro-furo[3′,4′:4,5]benzo[1,2-d]oxazole (hereinafter, referred to as “active compound 98”) was obtained.

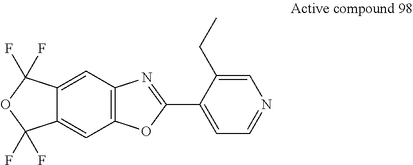

¹H-NMR (CDCl₃) δ: 8.75 (s, 1H), 8.70 (d, J=5.0 Hz, 1H), 8.11 (s, 1H), 8.02 (d, J=5.1 Hz, 1H), 7.91 (s, 1H), 3.29 (q, J=7.5 Hz, 2H), 1.35 (t, J=7.5 Hz, 3H)

### Production Example 100

Production Example 100 was carried out according to the same manner as in Production Example 78, using N-(5-tert-butyl-2-hydroxyphenyl)-3-fluoro isonicotinamide instead of 3-chloro-N-[2-hydroxy-5-(trifluoromethylthio)phenyl]isonicotinamide, and thus 3.1 g of 5-tert-butyl-2-(3-fluoropyridin-4-yl)benzoxazole (hereinafter, referred to as “active compound 99”) was obtained.

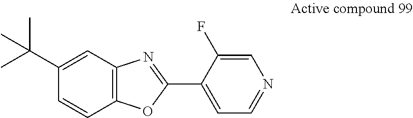

¹H-NMR (CDCl₃) δ: 8.72-8.70 (m, 1H), 8.62-8.59 (m, 1H), 8.12-8.09 (m, 1H), 7.91-7.89 (m, 1H), 7.59-7.51 (m, 2H), 1.41 (s, 9H)

### Production Example 101

Production Example 101 was carried out according to the same manner as in Production Example 38, using 5-tert-butyl-2-(3-fluoropyridin-4-yl)benzoxazole instead of 2-(3-fluoropyridin-4-yl)-5-(trifluoromethyl)benzoxazole, and thus 0.27 g of 5-tert-butyl-2-(3-methoxypyridin-4-yl)benzoxazole (hereinafter, referred to as “active compound 100”) was obtained.

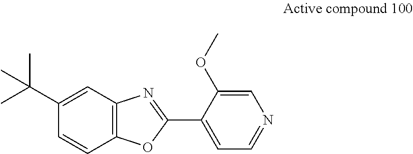

¹H-NMR (CDCl₃) δ: 8.56 (s, 1H), 8.43 (d, J=4.9 Hz, 1H), 8.00 (d, J=4.9 Hz, 1H), 7.89 (d, J=1.8 Hz, 1H), 7.54 (d, J=8.5 Hz, 1H), 7.48 (dd, J=8.8, 2.0 Hz, 1H), 4.15 (s, 3H), 1.40 (s, 9H)

### Production Example 102

Production Example 102 was carried out according to the same manner as in Production Example 40, using 5-tert-butyl-2-(3-fluoropyridin-4-yl)benzoxazole instead of 2-(3-fluoropyridin-4-yl)-5-(trifluoromethyl)benzoxazole to give 0.33 g of 5-tert-butyl-2-[3-(2,2,2-trifluoroethoxy)pyridin-4-yl]benzoxazole (hereinafter, referred to as “active compound 101”) was obtained.

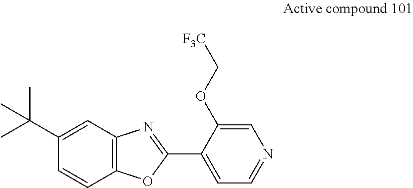

¹H-NMR (CDCl₃) δ: 8.59 (s, 1H), 8.56 (d, J=4.9 Hz, 1H), 8.08 (d, J=4.9 Hz, 1H), 7.86 (d, J=1.7 Hz, 1H), 7.55 (d, J=8.8 Hz, 1H), 7.51 (dd, J=8.7, 1.8 Hz, 1H), 4.65 (q, J=8.0 Hz, 2H), 1.41 (s, 9H)

### Production Example 103

A mixture of 2.07 g of 5-tert-butyl-2-(3-fluoropyridin-4-yl)benzoxazole, 4.23 g of potassium carbonate and 8 ml of benzyl alcohol was stirred while heating at 100° C. for 8.5 hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 2.2 g of 2-(3-benzyloxypyridin-4-yl)-5-tert-butylbenzoxazole (hereinafter, referred to as “active compound 102”).

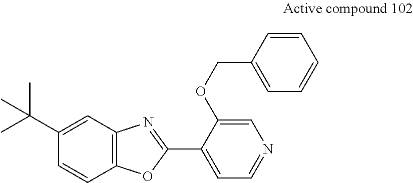

¹H-NMR (CDCl₃) δ: 8.56 (s, 1H), 8.41 (d, J=4.9 Hz, 1H), 8.03 (d, J=4.9 Hz, 1H), 7.88-7.86 (m, 1H), 7.59-7.55 (m, 2H), 7.54-7.47 (m, 2H), 7.43-7.37 (m, 2H), 7.36-7.30 (m, 1H), 5.42 (s, 2H), 1.41 (s, 9H)

### Production Example 104

A mixture of 2.1 g of 2-(3-benzyloxypyridin-4-yl)-5-tert-butylbenzoxazole, 0.58 g of 5% palladium on carbon and 50 ml of acetic acid was stirred under about one atmosphere of hydrogen at room temperature for six hours. The reaction mixture was filtered through Celite™. The filtrate was concentrated under reduced pressure. The residue was subjected to silica gel column chromatography to give 1.3 g of 4-(5-tert-butylbenzoxazole-2-yl)pyridin-3-ol (hereinafter, referred to as “active compound 103”).

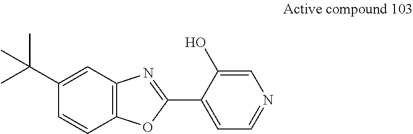

¹H-NMR (CDCl₃) δ: 11.21 (br s, 1H), 8.60 (s, 1H), 8.31 (d, J=4.9 Hz, 1H), 7.83-7.80 (m, 2H), 7.58 (d, J=8.5 Hz, 1H), 7.53 (dd, J=8.7, 1.8 Hz, 1H), 1.42 (s, 9H)

### Production Example 105

To a mixture of 0.30 g of 4-(5-tert-butylbenzoxazole-2-yl)pyridin-3-ol, 0.17 g of potassium carbonate and 3 ml of DMF, 0.21 g of isopropyl iodide was added at room temperature. The reaction mixture was stirred while heating at 60° C. for two hours. The mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.21 g of 5-tert-butyl-2-(3-isopropoxypyridin-4-yl)benzoxazole (hereinafter, referred to as “active compound 104”).

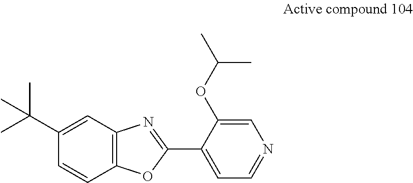

¹H-NMR (CDCl₃) δ: 8.53 (s, 1H), 8.38 (d, J=4.9 Hz, 1H), 7.98 (d, J=5.0 Hz, 1H), 7.86-7.84 (m, 1H), 7.55-7.46 (m, 2H), 4.81-4.70 (m, 1H), 1.47 (d, J=6.1 Hz, 6H), 1.41 (s, 9H)

### Production Example 106

Production Example 106 was carried out according to the same manner as in Production Example 78, using N-(5-tert-butyl-2-hydroxyphenyl)-3-ethyl isonicotinamide instead of 3-chloro-N-[2-hydroxy-5-(trifluoromethylthio)phenyl]isonicotinamide, and thus 0.19 g of 5-tert-butyl-2-(3-ethylpyridin-4-yl)benzoxazole (hereinafter, referred to as “active compound 105”) was obtained.

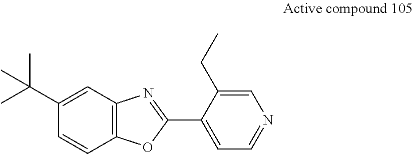

¹H-NMR (CDCl₃) δ: 8.67 (s, 1H), 8.61 (d, J=5.1 Hz, 1H), 7.99 (d, J=5.1 Hz, 1H), 7.87-7.85 (m, 1H), 7.56-7.47 (m, 2H), 3.29 (q, J=7.5 Hz, 2H), 1.41 (s, 9H), 1.34 (t, J=7.5 Hz, 3H)

### Production Example 107

Production Example 106 was carried out according to the same manner as in Production Example 78, using N-(5-tert-butyl-2-hydroxyphenyl)-2-chloro-5-trifluoromethylisonicotinamide instead of 3-chloro-N-[2-hydroxy-5-(trifluoromethylthio)phenyl]isonicotinamide, and thus 0.59 g of 5-tert-butyl-2-[2-chloro-5-(trifluoromethyl)pyridin-4-yl]benzoxazole (hereinafter, referred to as “active compound 106”) was obtained.

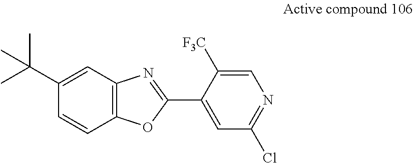

¹H-NMR (CDCl₃) δ: 8.89 (s, 1H), 8.23 (s, 1H), 7.90-7.88 (m, 1H), 7.58-7.57 (m, 2H), 1.41 (s, 9H)

### Production Example 108

A mixture of 0.40 g of 5-tert-butyl-2-(2-chloro-5-trifluoromethylpyridin-4-yl)benzoxazole, 0.59 g of 5% palladium on carbon and 25 ml of acetic acid was stirred under about one atmosphere of hydrogen at room temperature for 15 hours. The reaction mixture was filtered through Celite™. The filtrate was concentrated under reduced pressure. The residue was subjected to silica gel column chromatography to give 0.19 g of 5-tert-butyl-2-(3-trifluoromethylpyridin-4-yl)benzoxazole (hereinafter, referred to as “active compound 107”).

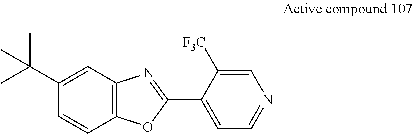

¹H-NMR (CDCl₃) δ: 9.13 (s, 1H), 8.98 (d, J=5.1 Hz, 1H), 8.14 (d, J=5.1 Hz, 1H), 7.89 (dd, J=1.7, 0.7 Hz, 1H), 7.58 (d, J=8.6, 0.7 Hz, 1H), 7.54 (dd, J=8.8, 1.8 Hz, 1H), 1.41 (s, 9H)

### Production Example 109

Production Example 109 was carried out according to the same manner as in Production Example 78, using 3-chloro-N-(2-hydroxy-5-trifluoromethoxyphenyl)isonicotinamide of instead of 3-chloro-N-[2-hydroxy-5-(trifluoromethylthio)phenyl]isonicotinamide, and thus 0.32 g of 2-(3-chloropyridin-4-yl)-5-(trifluoromethoxy)benzoxazole (hereinafter, referred to as “active compound 108”) was obtained.

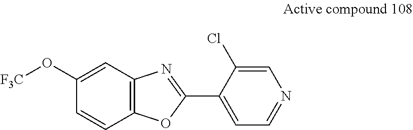

¹H-NMR (CDCl₃) δ: 8.85-8.84 (m, 1H), 8.69 (d, J=5.1 Hz, 1H), 8.09-8.07 (m, 1H), 7.79-7.77 (m, 1H), 7.69-7.66 (m, 1H), 7.38-7.34 (m, 1H)

### Production Example 110

Production Example 110 was carried out according to the same manner as in Production Example 22, using 3-ethyl-N-[2-hydroxy-5-(trifluoromethoxy)phenyl]isonicotinamide instead of 2-chloro-N-[2-hydroxy-5-(trifluoromethyl)phenyl]isonicotinamide, and thus 0.32 g of 2-(3-ethylpyridin-4-yl)-5-(trifluoromethoxy)benzoxazole (hereinafter, referred to as “active compound 109”) was obtained.

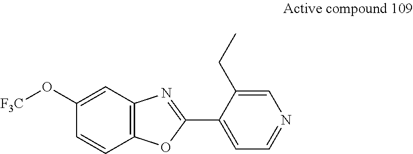

¹H-NMR (CDCl₃) δ: 8.70 (s, 1H), 8.65 (d, J=5.1 Hz, 1H), 7.99 (d, J=5.1 Hz, 1H), 7.74-7.72 (m, 1H), 7.65-7.62 (m, 1H), 7.34-7.30 (m, 1H), 3.28 (q, J=7.5 Hz, 2H), 1.34 (t, J=7.5 Hz, 3H)

### Production Example 111

Production Example 111 was carried out according to the same manner as in Production Example 40, using 2,2-difluoroethanol instead of 2,2,2-trifluoroethanol, and thus 0.24 g of 2-[3-(2,2-difluoroethoxy)pyridin-4-yl]-5-(trifluoromethyl)benzoxazole (hereinafter, referred to as “active compound 110”) was obtained.

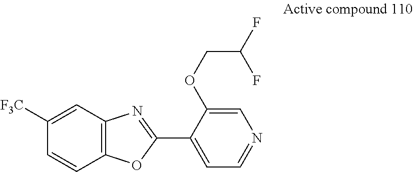

¹H-NMR (CDCl₃) δ: 8.59 (s, 1H), 8.55 (d, J=4.9 Hz, 1H), 8.14 (s, 1H), 8.07 (d, J=4.9 Hz, 1H), 7.76-7.70 (m, 2H), 6.28 (tt, J=54.9, 4.0 Hz, 1H), 4.51 (td, J=12.8, 4.0 Hz, 2H)

### Production Example 112

Production Example 112 was carried out according to the same manner as in Production Example 40, using 1,1,1-trifluoro-2-propanol instead of 2,2,2-trifluoroethanol, and thus 0.31 g of 2-[3-(1-methyl-2,2,2-trifluoroethoxy)pyridin-4-yl]-5-(trifluoromethyl)benzoxazole (hereinafter, referred to as “active compound 111”) was obtained.

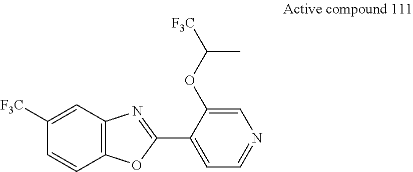

¹H-NMR (CDCl₃) δ: 8.61 (s, 1H), 8.55 (d, J=4.9 Hz, 1H), 8.14-8.12 (m, 1H), 8.09 (d, J=4.9 Hz, 1H), 7.76-7.70 (m, 2H), 4.97-4.87 (m, 1H), 1.69 (d, J=6.6 Hz, 3H)

### Production Example 113

Production Example 113 was carried out according to the same manner as in Production Example 40, using 2,2,3,3-tetrafluoropropanol instead of 2,2,2-trifluoroethanol, and thus 0.34 g of 2-[3-(2,2,3,3-tetrafluoropropoxy)pyridin-4-yl]-5-(trifluoromethyl)benzoxazole (hereinafter, referred to as “active compound 112”) was obtained.

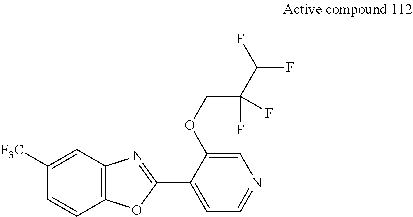

¹H-NMR (CDCl₃) δ: 8.58 (d, J=5.1 Hz, 1H), 8.56 (s, 1H), 8.13-8.12 (m, 1H), 8.10 (d, J=4.9 Hz, 1H), 7.74-7.73 (m, 2H), 6.75-6.44 (m, 1H), 4.71-4.63 (m, 2H)

### Production Example 114

Production Example 114 was carried out according to the same manner as in Production Example 103, using 2-(3-fluoropyridin-4-yl)-5-(trifluoromethyl)benzoxazole instead of 5-tert-butyl-2-(3-fluoropyridin-4-yl)benzoxazole, and thus 4.6 g of 2-(3-benzyloxypyridin-4-yl)-5-(trifluoromethyl)benzoxazole (hereinafter, referred to as “active compound 113”) was obtained.

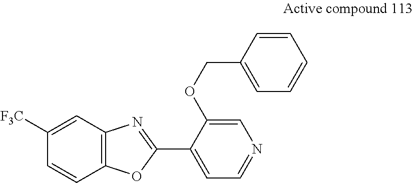

¹H-NMR (CDCl₃) δ: 8.62 (s, 1H), 8.45 (d, J=4.9 Hz, 1H), 8.15-8.13 (m, 1H), 8.05 (d, J=5.0

Hz, 1H), 7.73-7.67 (m, 2H), 7.60-7.54 (m, 2H), 7.45-7.39 (m, 2H), 7.38-7.33 (m, 1H), 5.44 (s, 2H)

### Production Example 115

A mixture of 4.69 g of 2-(3-benzyloxypyridin-4-yl)-5-(trifluoromethyl)benzoxazole, 1.0 g of 5% palladium on carbon and 70 ml of acetic acid was stirred under about one atmosphere of hydrogen at room temperature for nine hours. The reaction mixture was filtered through Celite™. The filtrate was concentrated under reduced pressure. The residue was subjected to silica gel column chromatography to give 3.44 g of 4-[5-(trifluoromethyl)benzoxazole-2-yl]pyridin-3-ol (hereinafter, referred to as “active compound 114”).

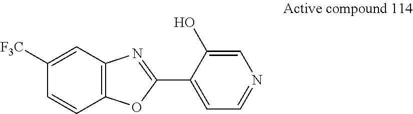

¹H-NMR (CDCl₃) δ: 10.84 (br s, 1H), 8.63 (s, 1H), 8.35 (d, J=4.9 Hz, 1H), 8.12-8.09 (m, 1H), 7.86 (d, J=5.1 Hz, 1H), 7.79 (d, J=8.8 Hz, 1H), 7.76 (dd, J=8.5, 1.7 Hz, 1H)

### Production Example 116

To a mixture of 0.28 g of 4-[5-(trifluoromethyl)benzoxazole-2-yl]pyridin-3-ol, 0.28 g of potassium carbonate and 2 ml of DMF, a mixture of 0.29 g of cyclopentyl bromide and 2 ml of DMF was added at room temperature. The reaction mixture was stirred while heating at 60° C. for four hours. The reaction mixture was cooled to room temperature, and then water was added to the reaction mixture, followed by extraction with ethyl acetate twice.

The combined organic layers were washed with water and a saturated sodium chloride solution, dried over anhydrous magnesium sulfate, and concentrated under reduced pressure.

The residue was subjected to silica gel column chromatography to give 0.29 g of 2-(3-cyclopentyloxypyridin-4-yl)-5-(trifluoromethyl)benzoxazole (hereinafter, referred to as “active compound 115”).

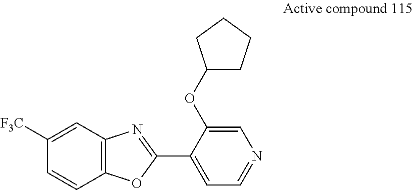

¹H-NMR (CDCl₃) δ: 8.56 (s, 1H), 8.39 (d, H=4.9 Hz, 1H), 8.13-8.10 (m, 1H), 8.00 (d, J=4.9 Hz, 1H), 7.73-7.66 (m, 2H), 5.13-5.06 (m, 1H), 2.08-1.99 (m, 4H), 1.96-1.84 (m, 2H), 1.77-1.65 (m, 2H)

### Production Example 117

Production Example 117 was carried out according to the same manner as in Production Example 72, using isobutyl alcohol instead of propanol, and thus 0.24 g of 2-(3-isobutoxypyridin-4-yl)-5-(trifluoromethyl)benzoxazole (hereinafter, referred to as “active compound 116”) was obtained.

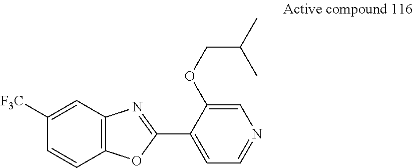

¹H-NMR (CDCl₃) δ: 8.55 (s, 1H), 8.42 (d, J=5.1 Hz, 1H), 8.12-8.11 (m, 1H), 8.02 (d, J=5.1 Hz, 1H), 7.73-7.67 (m, 2H), 4.06 (d, J=6.3 Hz, 2H), 2.32-2.20 (m, 1H), 1.14 (d, J=6.6 Hz, 6H)

### Production Example 118

Production Example 118 was carried out according to the same manner as in Production Example 72, using 2,2-dimethyl-1-propanol instead of propanol, and thus 0.23 g of 2-[3-(2,2-dimethylpropoxy)pyridin-4-yl]-5-(trifluoromethyl)benzoxazole (hereinafter, referred to as “active compound 117”) was obtained.

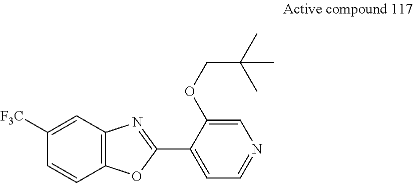

¹H-NMR (CDCl₃) δ: 8.53 (s, 1H), 8.42 (d, J=4.9 Hz, 1H), 8.12-8.10 (m, 1H), 8.04 (d, J=4.9 Hz, 1H), 7.72-7.66 (m, 2H), 3.93 (s, 2H), 1.15 (s, 9H)

### Production Example 119

Production Example 119 was carried out according to the same manner as in Production Example 72, using cyclopropane methanol instead of propanol, and thus 0.23 g of 2-[3-(cyclopropylmethoxy)pyridin-4-yl]-5-(trifluoromethyl)benzoxazole (hereinafter, referred to as “active compound 118”) was obtained.

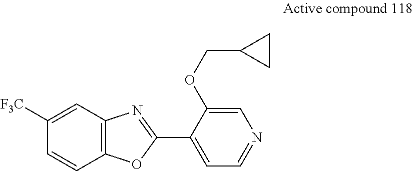

¹H-NMR (CDCl₃) δ: 8.57 (s, 1H), 8.44 (d, J=5.1 Hz, 1H), 8.14-8.12 (m, 1H), 8.01 (d, J=5.0 Hz, 1H), 7.75-7.68 (m, 2H), 4.19 (d, J=6.5 Hz, 2H), 1.45-1.34 (m, 1H), 0.73-0.65 (m, 2H), 0.51-0.45 (m, 2H)

### Production Example 120

Production Example 120 was carried out according to the same manner as in Production Example 116, using 2-bromobutane instead of cyclopentyl bromide, and thus 0.14 g of 2-(3-sec-butoxypyridin-4-yl)-5-(trifluoromethyl)benzoxazole (hereinafter, referred to as “active compound 119”) was obtained.

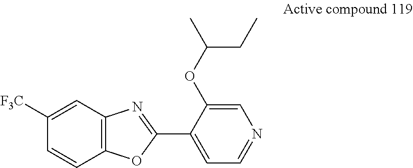

¹H-NMR (CDCl₃) δ: 8.56 (s, 1H), 8.39 (d, J=5.1 Hz, 1H), 8.13-8.11 (m, 1H), 8.00 (d, J=5.1 Hz, 1H), 7.73-7.66 (m, 2H), 4.68-4.58 (m, 1H), 1.96-1.73 (m, 2H), 1.45 (d, J=6.1 Hz, 3H), 1.07 (t, J=7.4 Hz, 3H)

### Production Example 121

A mixture of 0.28 g of 2-(3-fluoropyridin-4-yl)-5-(trifluoromethyl)benzoxazole, 0.27 g of potassium carbonate and 3 ml of 2-methoxyethanol was stirred while heating at 80° C. for 2.5 hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography to give 0.23 g of 2-[3-(2-methoxyethoxy)pyridin-4-yl]-5-(trifluoromethyl)benzoxazole (hereinafter, referred to as “active compound 120”).

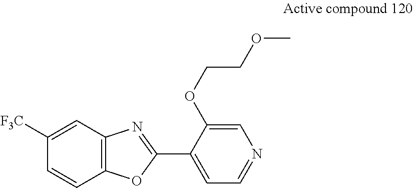

¹H-NMR (CDCl₃) δ: 8.61 (s, 1H), 8.46 (d, J=4.9 Hz, 1H), 8.13-8.11 (m, 1H), 8.02 (d, J=4.9 Hz, 1H), 7.73-7.67 (m, 2H), 4.48-4.42 (m, 2H), 3.94-3.87 (m, 2H), 3.50 (s, 3H)

### Production Example 122

Production Example 122 was carried out according to the same manner as in Production Example 121, using 3-methoxy-1-propanol instead of 2-methoxyethanol, and thus 0.23 g of 2-[3-(3-methoxypropoxy)pyridin-4-yl]-5-(trifluoromethyl)benzoxazole (hereinafter, referred to as “active compound 121”) was obtained.

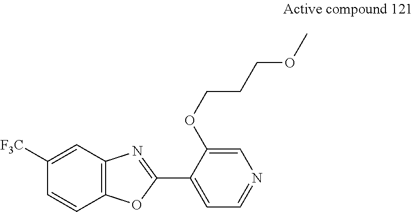

¹H-NMR (CDCl₃) δ: 8.59 (s, 1H), 8.43 (d, J=5.0 Hz, 1H), 8.13-8.10 (m, 1H), 8.01 (d, J=4.9 Hz, 1H), 7.74-7.67 (m, 2H), 4.40 (t, J=6.2 Hz, 2H), 3.69 (t, J=6.1 Hz, 2H), 3.37 (s, 3H), 2.23-2.17 (m, 2H)

### Production Example 123

Production Example 123 was carried out according to the same manner as in Production Example 116, using 2-bromoethyl ethyl ether instead of cyclopentyl bromide, and thus 0.10 g of 2-[3-(2-ethoxy ethoxy)pyridin-4-yl]-5-(trifluoromethyl)benzoxazole (hereinafter, referred to as “active compound 122”) was obtained.

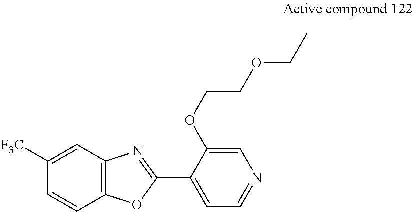

¹H-NMR (CDCl₃) δ: 8.62 (s, 1H), 8.45 (d, J=4.9 Hz, 1H), 8.12-8.10 (m, 1H), 8.01 (d, J=4.9 Hz, 1H), 7.73-7.67 (m, 2H), 4.48-4.43 (m, 2H), 3.96-3.91 (m, 2H), 3.66 (q, J=7.1 Hz, 2H), 1.24 (t, J=7.1 Hz, 3H)

### Production Example 124

Production Example 124 was carried out according to the same manner as in Production Example 72, using pentanol instead of propanol, and thus 0.29 g of 2-(3-pentyloxypyridin-4-yl)-5-(trifluoromethyl)benzoxazole (hereinafter, referred to as “active compound 123”) was obtained.

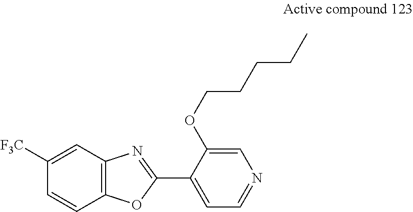

¹H-NMR (CDCl₃) δ: 8.56 (s, 1H), 8.42 (d, J=4.9 Hz, 1H), 8.13-8.10 (m, 1H), 8.01 (d, J=4.9 Hz, 1H), 7.73-7.67 (m, 2H), 4.29 (t, J=6.5 Hz, 2H), 1.99-1.90 (m, 2H), 1.62-1.52 (m, 2H), 1.49-1.37 (m, 2H), 0.96 (t, J=7.2 Hz, 3H)

### Production Example 125

Production Example 125 was carried out according to the same manner as in Production Example 72, using hexanol instead of propanol, and thus 0.23 g of 2-(3-hexyloxypyridin-4-yl)-5-(trifluoromethyl)benzoxazole (hereinafter, referred to as “active compound 124”) was obtained.

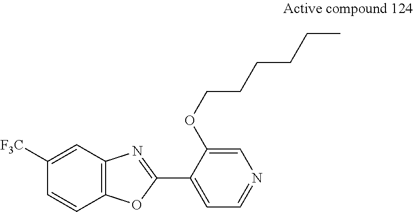

¹H-NMR (CDCl₃) δ: 8.56 (s, 1H), 8.42 (d, J=5.0 Hz, 1H), 8.15-8.09 (m, 1H), 8.01 (d, J=5.1 Hz, 1H), 7.74-7.68 (m, 2H), 4.32-4.27 (m, 2H), 1.98-1.88 (m, 2H), 1.61-1.52 (m, 2H), 1.42-1.31 (m, 4H), 0.95-0.88 (m, 3H)

### Production Example 126

Production Example 126 was carried out according to the same manner as in Production Example 78, using N-[2-hydroxy-5-(trifluoromethyl)phenyl]-3-(trifluoromethyl)isonicotinamide instead of 3-chloro-N-[2-hydroxy-5-(trifluoromethylthio)phenyl]isonicotinamide, an thus 0.55 g of 5-trifluoromethyl-2-[3-(trifluoromethyl)pyridin-4-yl]-benzoxazole (hereinafter, referred to as “active compound 125”) was obtained.

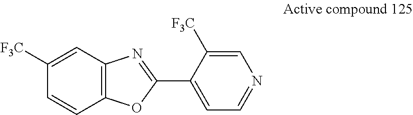

¹H-NMR (CDCl₃) δ: 9.18 (s, 1H), 9.04 (d, J=4.9 Hz, 1H), 8.20-8.18 (m, 1H), 8.16 (d, J=5.1 Hz, 1H), 7.81-7.74 (m, 2H)

### Production Example 127

A mixture of 0.50 g of 4-[5-(trifluoromethyl)benzoxazole-2-yl]pyridin-3-ol, 1.23 g of potassium carbonate and 14 ml of DMF was stirred while heating at 70° C. for three hours with chlorodifluoromethane gas injected. By stopping injection of gas, the mixture was cooled to room temperature and allowed to stand overnight. Water was added to the reaction mixture, followed by extraction with ethyl acetate twice. The combined organic layers were washed with water and a saturated sodium chloride solution, dried over anhydrous magnesium sulfate, and concentrated under reduced pressure. The residue was subjected to silica gel column chromatography to give 0.11 g of 2-(3-difluoromethoxypyridin-4-yl)-5-(trifluoromethyl)benzoxazole (hereinafter, referred to as “active compound 126”).

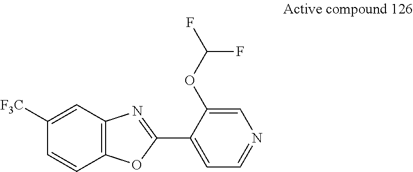

¹H-NMR (CDCl₃) δ: 8.80 (s, 1H), 8.74 (d, J=5.1 Hz, 1H), 8.18-8.16 (m, 1H), 8.15 (d, J=5.1 Hz, 1H), 7.79-7.72 (m, 2H), 6.82 (t, J=73.0 Hz, 1H)

### Production Example 128

Production Example 128 was carried out according to the same manner as in Production Example 39, using 3-hydroxy pyridine instead of phenol, and thus 0.30 g of 2-[3-(pyridin-3-yloxy)-pyridin-4-yl]-5-(trifluoromethyl)benzoxazole (hereinafter, referred to as “active compound 127”) was obtained.

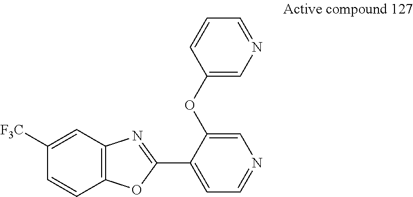

¹H-NMR (CDCl₃) δ: 8.67 (d, J=5.1 Hz, 1H), 8.54 (s, 1H), 8.53-8.52 (m, 1H), 8.45-8.42 (m, 1H), 8.20-8.18 (m, 1H), 8.10-8.08 (m, 1H), 7.71-7.65 (m, 2H), 7.40-7.36 (m, 1H), 7.35-7.30 (m, 1H),

### Production Example 129

To a mixture of 0.40 g of 2-(3-iodopyridin-4-yl)-5-(trifluoromethyl)benzoxazole, 0.21 g of 3-pyridine boronic acid, 8 ml of 1,4-dioxane and 0.07 g of dichlorobis(triphenylphosphine)palladium (II), a mixture of 0.40 g of sodium carbonate and 3 ml of water was added and heated to reflux for two hours. The reaction mixture was cooled to room temperature, and then water was added to the reaction mixture, followed by extraction with ethyl acetate. The combined organic layers were washed with water and a saturated sodium chloride solution, dried over anhydrous magnesium sulfate, and concentrated under reduced pressure. The residue was subjected to silica gel column chromatography to give 0.36 g of 4-(5-trifluoromethyl-benzoxazole-2-yl)-[3,3′]bipyridinyl (hereinafter, referred to as “active compound 128”).

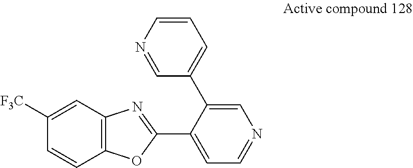

¹H-NMR (CDCl₃) δ: 8.89 (d, J=5.1 Hz, 1H), 8.77 (s, 1H), 8.74-8.69 (m, 1H), 8.68-8.62 (m, 1H), 8.18-8.13 (m, 1H), 8.04-7.99 (m, 1H), 7.73-7.68 (m, 1H), 7.67-7.62 (m, 1H), 7.54-7.47 (m, 1H), 7.43-7.36 (m, 1H)

### Production Example 130

Production Example 130 was carried out according to the same manner as in Production Example 129, using 4-pyridine boronic acid instead of 3-pyridine boronic acid, and thus 0.20 g of 4-(5-trifluoromethyl-benzoxazole-2-yl)-[3,4′]bipyridinyl (hereinafter, referred to as “active compound 129”) was obtained.

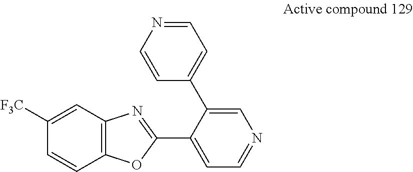

¹H-NMR (CDCl₃) δ: 8.90 (d, J=5.1 Hz, 1H), 8.75 (s, 1H), 8.70 (dd, J=4.4, 1.7 Hz, 2H), 8.14-8.12 (m, 1H), 8.03-8.02 (m, 1H), 7.67-7.63 (m, 1H), 7.50 (d, J=8.5 Hz, 1H), 7.28 (dd, J=4.4, 1.7, 2H)

### Production Example 131

A mixture of 0.30 g of 2-(3-aminopyridin-4-yl)-5-(trifluoromethyl)benzoxazole and 3 ml of trifluoroacetic anhydride was stirred while heating at 60° C. for 15 minutes. The reaction mixture was cooled to room temperature, and then water and a saturated aqueous solution of sodium hydrogencarbonate were added to the reaction mixture. The precipitated crystals were filtered. The resultant crystals were dissolved in ethyl acetate. The resultant solution was washed with a saturated sodium chloride solution, dried over anhydrous magnesium sulfate, and concentrated under reduced pressure. The residue was subjected to silica gel column chromatography to give 0.32 g of 2,2,2-trifluoro-N-[4-(5-trifluoromethylbenzoxazole-2-yl)pyridin-3-yl]acetamide (hereinafter, referred to as “active compound 130”).

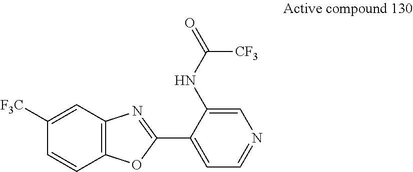

¹H-NMR (DMSO-d₆) δ: 12.66 (br s, 1H), 10.11 (s, 1H), 8.71 (d, J=5.1 Hz, 1H), 8.15-8.14 (m, 1H), 8.12 (d, J=5.1 Hz, 1H), 7.85-7.79 (m, 2H)

### Production Example 132

To a mixture of 0.28 g of 2-(3-fluoropyridin-4-yl)-5-(trifluoromethyl)benzoxazole, 0.14 g of potassium carbonate and 3 ml of DMF, 3 ml of a THF solution of dimethylamine was added and stirred while heating at 60° C. for 3.3 hours. The reaction mixture was cooled to room temperature, and then water was added to the reaction mixture, followed by extraction with ethyl acetate twice. The combined organic layers were washed with a saturated sodium chloride solution, dried over anhydrous magnesium sulfate, and concentrated under reduced pressure. The residue was subjected to silica gel column chromatography, and the resultant crystals were washed with diethyl ether to give 0.27 g of dimethyl-{4-[5-(trifluoromethyl)benzoxazole-2-yl]pyridin-3-yl}amine (hereinafter, referred to as “active compound 131”).

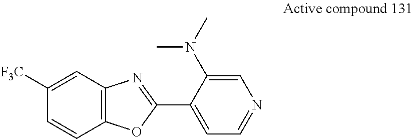

¹H-NMR (CDCl₃) δ: 8.53 (s, 1H), 8.28 (d, J=5.1 Hz, 1H), 8.13-8.11 (m, 1H), 7.79 (d, J=5.1 Hz, 1H), 7.74-7.71 (m, 1H), 7.70-7.67 (m, 1H), 2.93 (s, 6H)

### Production Example 133

Production Example 133 was carried out according to the same manner as in Production Example 86, using N-isopropylmethylamine instead of isopropylamine, and thus 0.17 g of isopropyl-methyl-{4-[5-(trifluoromethyl)benzoxazole-2-yl]pyridin-3-yl}amine (hereinafter, referred to as “active compound 132”) was obtained.

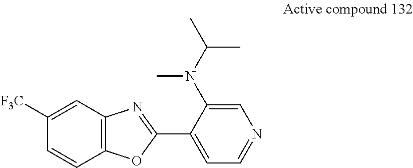

¹H-NMR (CDCl₃) δ: 8.53 (s, 1H), 8.29 (d, J=4.9 Hz, 1H), 8.11-8.09 (m, 1H), 7.79 (d, J=4.9 Hz, 1H), 7.73-7.66 (m, 2H), 3.57-3.45 (m, 1H), 2.82 (s, 3H), 1.15 (d, J=6.6 Hz, 6H)

### Production Example 134

To a mixture of 0.60 g of 2-(3-ethylthio pyridin-4-yl)-5-(trifluoromethyl)benzoxazole and 8 ml of chloroform, 0.64 g of 70% m-chloroperbenzoic acid was added while ice-cooling and stirred at 0° C. for one hour. The reaction mixture was diluted with chloroform, washed with 5% aqueous solution of sodium hydroxide and a saturated sodium chloride solution, dried over anhydrous magnesium sulfate, and concentrated under reduced pressure. The residue was subjected to silica gel column chromatography to give 0.21 g of 2-[3-(ethanesulfonyl)pyridin-4-yl]-5-(trifluoromethyl)benzoxazole (hereinafter, referred to as “active compound 133”) and 0.30 g of 2-[3-(ethanesulfinyl)pyridin-4-yl]-5-(trifluoromethyl)benzoxazole (hereinafter, referred to as “active compound 134”).

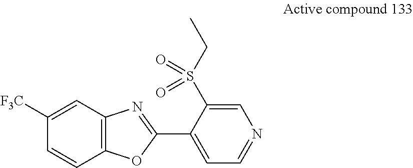

¹H-NMR (CDCl₃) δ: 9.44-9.43 (m, 1H), 9.09 (d, J=4.9 Hz, 1H), 8.17-8.14 (m, 1H), 7.96-7.94 (m, 1H), 7.78-7.75 (m, 2H), 3.93 (q, J=7.5 Hz, 2H), 1.46 (t, J=7.6 Hz, 3H)

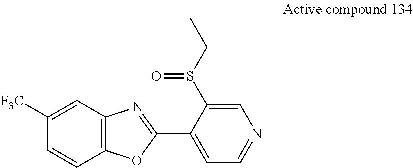

¹H-NMR (CDCl₃) δ: 9.45-9.44 (m, 1H), 8.99 (d, J=5.1 Hz, 1H), 8.18-8.17 (m, 1H), 8.13-8.11 (m, 1H), 7.81-7.76 (m, 2H), 3.53-3.41 (m, 1H), 3.15-3.04 (m, 1H), 1.45 (t, J=7.4 Hz, 3H)

### Production Example 135

Production Example 135 was carried out according to the same manner as in Production Example 134, using 2-(3-methylthiopyridin-4-yl)-5-(trifluoromethyl)benzoxazole instead of 2-(3-ethylthiopyridin-4-yl)-5-(trifluoromethyl)benzoxazole, and thus 0.26 g of 2-[3-(methanesulfonyl)pyridin-4-yl]-5-(trifluoromethyl)benzoxazole (hereinafter, referred to as “active compound 135”) and 0.37 g of 2-[3-(methanesulfinyl)pyridin-4-yl]-5-(trifluoromethyl)benzoxazole (hereinafter, referred to as “active compound 136”) were obtained.

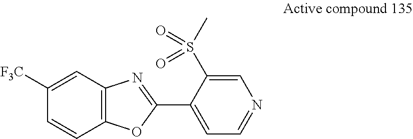

¹H-NMR (CDCl₃) δ: 9.51 (s, 1H), 9.11 (d, J=4.9 Hz, 1H), 8.19-8.16 (m, 1H), 7.97 (d, J=5.0 Hz, 1H), 7.80-7.76 (m, 2H), 3.72 (s, 3H)

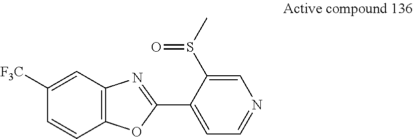

¹H-NMR (CDCl₃) δ: 9.55 (s, 1H), 9.01 (d, J=5.1 Hz, 1H), 8.21-8.19 (m, 1H), 8.12-8.10 (m, 1H), 7.82-7.76 (m, 2H), 3.13 (s, 3H)

### Production Example 136

Production Example 136 was carried out according to the same manner as in Production Example 78, using N-[2-hydroxy-5-(trifluoromethyl)phenyl]-3-(methoxymethyl)isonicotinamide instead of 3-chloro-N-[2-hydroxy-5-(trifluoromethylthio)phenyl]isonicotinamide, and thus 0.26 g of 2-[3-(methoxymethyl)pyridin-4-yl]-5-(trifluoromethyl)benzoxazole (hereinafter, referred to as “active compound 137”) was obtained.

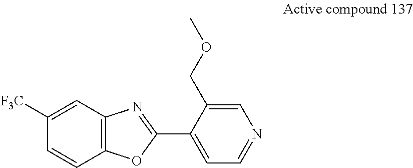

¹H-NMR (CDCl₃) δ: 9.02-9.01 (m, 1H), 8.78 (d, J=5.1 Hz, 1H), 8.17-8.15 (m, 1H), 8.08-8.05 (m, 1H), 7.77-7.71 (m, 2H), 5.12 (s, 2H), 3.57 (s, 3H)

### Production Example 137

Production Example 137 was carried out according to the same manner as in Production Example 22, using N-[2-hydroxy-5-(trifluoromethyl)pyridin-3-yl]isonicotinamide instead of 2-chloro-N-[2-hydroxy-5-(trifluoromethyl)phenyl]isonicotinamide, and thus 0.32 g of 2-pyridin-4-yl-6-(trifluoromethyl)oxazolo[5,4-b]pyridine (hereinafter, referred to as “active compound 138”) was obtained.

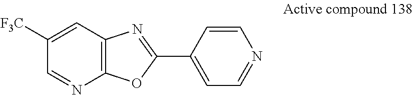

¹H-NMR (CDCl₃) δ: 8.90 (dd, J=4.5, 1.6 Hz, 2H), 8.76-8.74 (m, 1H), 8.40-8.38 (m, 1H), 8.14 (dd, J=4.4, 1.7 Hz, 2H)

### Production Example 138

Production Example 138 was carried out according to the same manner as in Production Example 22, using 3-chloro-N-[2-hydroxy-5-(trifluoromethyl)pyridin-3-yl]isonicotinamide instead of 2-chloro-N-[2-hydroxy-5-(trifluoromethyl)phenyl]isonicotinamide, and thus 0.72 g of 2-(3-chloropyridin-4-yl)-6-(trifluoromethyl)oxazolo[5,4-b]pyridine (hereinafter, referred to as “active compound 139”) was obtained.

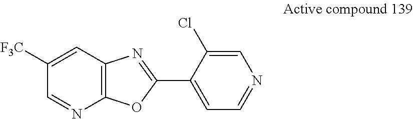

¹H-NMR (CDCl₃) δ: 8.89 (s, 1H), 8.80-8.77 (m, 1H), 8.74 (d, J=5.1 Hz, 1H), 8.48-8.46 (m, 1H), 8.13 (d, J=5.1 Hz, 1H)

### Production Example 139

To a mixture of 0.45 g of 2-(3-chloropyridin-4-yl)-6-(trifluoromethyl)oxazolo[5,4-b]pyridine and 5 ml of chloroform, 0.48 g of 70% m-chloroperbenzoic acid was added in ice-cooling and stirred while heating at room temperature for four hours and at 50° C. for two hours. The reaction mixture was cooled to room temperature, then diluted with chloroform, and washed with 5% aqueous solution of sodium hydroxide and a saturated sodium chloride solution, sequentially. The organic layer was dried over anhydrous magnesium sulfate, and then concentrated under reduced pressure.

The residue was subjected to silica gel column chromatography to give 0.36 g of 2-(3-chloro-1-oxypyridin-4-yl)-6-(trifluoromethyl)oxazolo[5,4-b]pyridine (hereinafter, referred to as “active compound 140”).

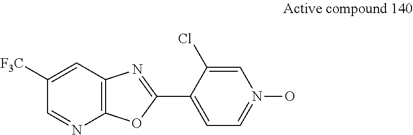

¹H-NMR (CDCl₃) δ: 8.77-8.74 (m, 1H), 8.43-8.42 (m, 1H), 8.41 (d, J=1.7 Hz, 1H), 8.23 (dd, J=7.0, 1.6 Hz, 1H), 8.19 (d, J=6.9 Hz, 1H)

### Production Example 140

Production Example 140 was carried out according to the same manner as in Production Example 22, using 3-fluoro-N-[2-hydroxy-5-(trifluoromethyl)pyridin-3-yl]isonicotinamide instead of 2-chloro-N-[2-hydroxy-5-(trifluoromethyl)phenyl]isonicotinamide, and thus 1.72 g of 2-(3-fluoropyridin-4-yl)-6-(trifluoromethyl)oxazolo[5,4-b]pyridine (hereinafter, referred to as “active compound 141”) was obtained.

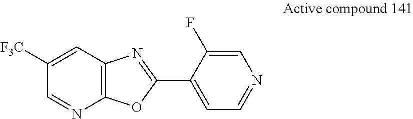

¹H-NMR (CDCl₃) δ: 8.81-8.76 (m, 2H), 8.70 (d, J=5.1 Hz, 1H), 8.46-8.43 (m, 1H), 8.17-8.13 (m, 1H)

### Production Example 141

Production Example 141 was carried out according to the same manner as in Production Example 22, using N-[2-hydroxy-5-(trifluoromethyl)pyridin-3-yl]-3-methylisonicotinamide instead of 2-chloro-N-[2-hydroxy-5-(trifluoromethyl)phenyl]isonicotinamide, and thus 0.23 g of 2-(3-methylpyridin-4-yl)-6-(trifluoromethyl)oxazolo[5,4-b]pyridine (hereinafter, referred to as “active compound 142”) was obtained.

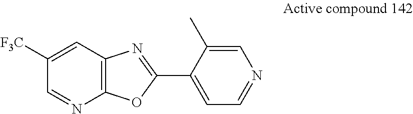

¹H-NMR (CDCl₃) δ: 8.76-8.74 (m, 1H), 8.72 (s, 1H), 8.70 (d, J=5.1 Hz, 1H), 8.43-8.41 (m, 1H), 8.09 (d, J=5.1 Hz, 1H), 2.84 (s, 3H)

### Production Example 142

Production Example 142 was carried out according to the same manner as in Production Example 22, using 3-ethyl-N-[2-hydroxy-5-(trifluoromethyl)pyridin-3-yl]isonicotinamide instead of 2-chloro-N-[2-hydroxy-5-(trifluoromethyl)phenyl]isonicotinamide, and thus 0.16 g of 2-(3-ethylpyridin-4-yl)-6-(trifluoromethyl)oxazolo[5,4-b]pyridine (hereinafter, referred to as “active compound 143”) was obtained.

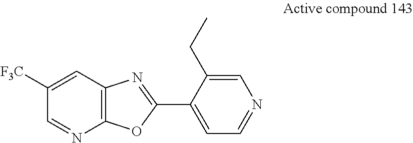

¹H-NMR (CDCl₃) δ: 8.76-8.73 (m, 2H), 8.70 (d, J=5.1 Hz, 1H), 8.43-8.41 (m, 1H), 8.07 (d, J=5.1 Hz, 1H), 3.30 (q, J=7.5 Hz, 2H), 1.36 (t, J=7.5 Hz, 3H)

### Production Example 143

Production Example 143 was carried out according to the same manner as in Production Example 22, using N-[2-hydroxy-5-(trifluoromethyl)pyridin-3-yl]-3-(trifluoromethyl)isonicotinamide instead of 2-chloro-N-[2-hydroxy-5-(trifluoromethyl)phenyl]isonicotinamide, and thus 0.22 g of 6-trifluoromethyl-2-[3-(trifluoromethyl)pyridin-4-yl]oxazolo[5,4-b]pyridine (hereinafter, referred to as “active compound 144”) was obtained.

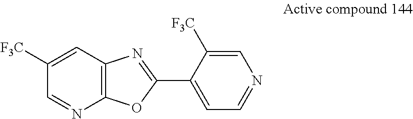

¹H-NMR (CDCl₃) δ: 9.21 (s, 1H), 9.08 (d, J=5.1 Hz, 1H), 8.81-8.79 (m, 1H), 8.49-8.47 (m, 1H), 8.17 (d, J=5.1 Hz, 1H)

### Production Example 144

Production Example 144 was carried out according to the same manner as in Production Example 78, using N-[2-hydroxy-5-(trifluoromethyl)pyridin-3-yl]-3-methoxyisonicotinamide instead of 3-chloro-N-[2-hydroxy-5-(trifluoromethylthio)phenyl]isonicotinamide, and thus 0.27 g of 2-(3-methoxypyridin-4-yl)-6-(trifluoromethyl)oxazolo[5,4-b]pyridine (hereinafter, referred to as “active compound 145”) was obtained.

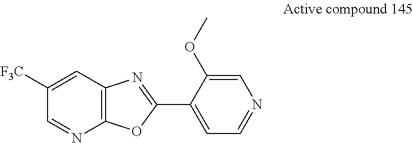

¹H-NMR (CDCl₃) δ: 8.75-8.72 (m, 1H), 8.63 (s, 1H), 8.49 (d, J=4.9 Hz, 1H), 8.41-8.40 (m, 1H), 8.06-8.04 (m, 1H), 4.18 (s, 3H)

### Production Example 145

Production Example 145 was carried out according to the same manner as in Production Example 78, using N-[2-hydroxy-5-(trifluoromethyl)pyridin-3-yl]-3-methylthioisonicotinamide instead of 3-chloro-N-[2-hydroxy-5-(trifluoromethylthio)phenyl]isonicotinamide, and thus 1.07 g of 2-(3-methylthiopyridin-4-yl)-6-(trifluoromethyl)oxazolo[5,4-b]pyridine (hereinafter, referred to as “active compound 146”) was obtained.

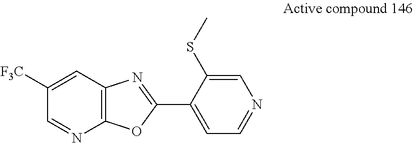

¹H-NMR (CDCl₃) δ: 8.76-8.74 (m, 1H), 8.71 (s, 1H), 8.60 (d, J=5.1 Hz, 1H), 8.48-8.46 (m, 1H), 8.09 (d, J=5.1 Hz, 1H), 2.70 (s, 3H)

### Production Example 146

Production Example 146 was carried out according to the same manner as in Production Example 134, using 2-(3-methylthiopyridin-4-yl)-6-trifluoromethyl-oxazolo[5,4-b]pyridine instead of 2-(3-ethylthiopyridin-4-yl)-5-(trifluoromethyl)benzoxazole, and thus 0.20 g of 2-[3-(methanesulfonyl)pyridin-4-yl]-6-(trifluoromethyl)oxazolo[5,4-b]pyridine (hereinafter, referred to as “active compound 147”) and 0.29 g of 2-[3-(methanesulfinyl)pyridin-4-yl]-6-(trifluoromethyl)oxazolo[5,4-b]pyridine (hereinafter, referred to as “active compound 148”) were obtained.

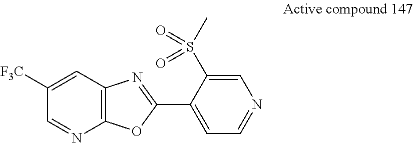

¹H-NMR (CDCl₃) δ: 9.52 (d, J=0.5 Hz, 1H), 9.14 (t, J=5.1 Hz, 1H), 8.81-8.79 (m, 1H), 8.47-8.46 (m, 1H), 8.00 (dd, J=5.0, 0.6 Hz, 1H), 3.69 (s, 3H)

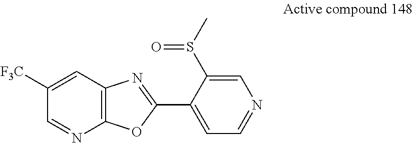

¹H-NMR (CDCl₃) δ: 9.59 (s, 1H), 9.07-9.05 (m, 1H), 8.82-8.80 (m, 1H), 8.51-8.19 (m, 1H), 8.19-8.16 (m, 1H), 3.12 (s, 3H)

### Production Example 147

Production Example 147 was carried out according to the same manner as in Production Example 78, using N-[2-hydroxy-5-(trifluoromethyl)pyridin-3-yl]-3-ethylthioisonicotinamide instead of 3-chloro-N-[2-hydroxy-5-(trifluoromethylthio)phenyl]isonicotinamide, and thus 1.06 g of 2-(3-ethylthiopyridin-4-yl)-6-(trifluoromethyl)oxazolo[5,4-b]pyridine (hereinafter, referred to as “active compound 149”) was obtained.

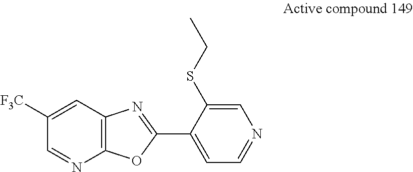

¹H-NMR (CDCl₃) δ: 8.77-8.73 (m, 2H), 8.59 (d, J=5.1 Hz, 1H), 8.48-8.47 (m, 1H), 8.08-8.06 (m, 1H), 3.21 (q, J=7.4 Hz, 2H), 1.49 (t, J=7.3 Hz, 3H)

### Production Example 148

Production Example 148 was carried out according to the same manner as in Production Example 134, using 2-(3-ethylthiopyridin-4-yl)-6-trifluoromethyl-oxazolo[5,4-b]pyridine instead of 2-(3-ethylthiopyridin-4-yl)-5-(trifluoromethyl)benzoxazole, and thus 0.29 g of 2-[3-(ethanesulfonyl)pyridin-4-yl]-6-(trifluoromethyl)oxazolo[5,4-b]pyridine (hereinafter, referred to as “active compound 150”) and 0.20 g of 2-[3-(ethanesulfinyl)pyridin-4-yl]-6-(trifluoromethyl)oxazolo[5,4-b]pyridine (hereinafter, referred to as “active compound 151”) were obtained.

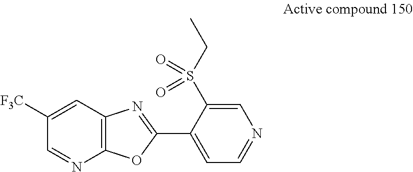

¹H-NMR (CDCl₃) δ: 9.46-9.45 (m, 1H), 9.14 (d, J=4.9 Hz, 1H), 8.80-8.79 (m, 1H), 8.46-8.44 (m, 1H), 7.99-7.97 (m, 1H), 3.88 (q, J=7.5 Hz, 2H), 1.48 (t, J=7.3 Hz, 3H)

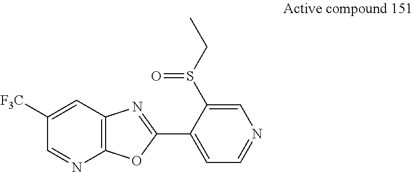

¹H-NMR (CDCl₃) δ: 9.48 (s, 1H), 9.04 (d, J=5.1 Hz, 1H), 8.82-8.80 (m, 1H), 8.49-8.47 (m, 1H), 8.19-8.17 (m, 1H), 3.51-3.39 (m, 1H), 3.14-3.04 (m, 1H), 1.44 (t, J=7.4 Hz, 3H)

### Production Example 149

Production Example 149 was carried out according to the same manner as in Production Example 78, using N-[2-hydroxy-5-(trifluoromethyl)pyridin-3-yl]-3-(methoxymethyl)isonicotinamide instead of 2-chloro-N-[2-hydroxy-5-(trifluoromethyl)phenyl]isonicotinamide, and thus 0.29 g of 2-[3-(methoxymethyl)pyridin-4-yl]-6-(trifluoromethyl)oxazolo[5,4-b]pyridine (hereinafter, referred to as “active compound 152”) was obtained.

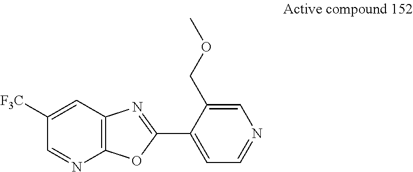

¹H-NMR (CDCl₃) δ: 9.04 (s, 1H), 8.82 (d, J=5.1 Hz, 1H), 8.77-8.75 (m, 1H), 8.44-8.42 (m, 1H), 8.12 (d, J=5.1 Hz, 1H), 5.11 (s, 2H), 3.56 (s, 3H)

### Production Example 150

Production Example 150 was carried out according to the same manner as in Production Example 22, using N-[2-hydroxy-6-(trifluoromethyl)pyridin-3-yl]-isonicotinamide instead of 2-chloro-N-[2-hydroxy-5-(trifluoromethyl)phenyl]isonicotinamide, and thus 0.27 g of 2-(pyridin-4-yl)-5-(trifluoromethyl)oxazolo[5,4-b]pyridine (hereinafter, referred to as “active compound 153”) was obtained.

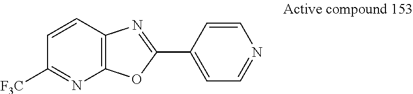

¹H-NMR (CDCl₃) δ: 8.91 (dd, J=4.4, 1.7 Hz, 2H), 8.30 (d, J=8.0 Hz, 1H), 8.14 (dd, J=4.4, 1.7 Hz, 2H), 7.85 (d, J=8.0 Hz, 1H)

### Production Example 151

Production Example 151 was carried out according to the same manner as in Production Example 78, using 3-chloro-N-[2-hydroxy-6-(trifluoromethyl)pyridin-3-yl]-isonicotinamide instead of 3-chloro-N-[2-hydroxy-5-(trifluoromethylthio)phenyl]isonicotinamide, and thus 0.42 g of 2-(3-chloropyridin-4-yl)-5-(trifluoromethyl)oxazolo[5,4-b]pyridine (hereinafter, referred to as “active compound 154”) was obtained.

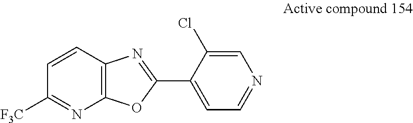

¹H-NMR (CDCl₃) δ: 8.89 (s, 1H), 8.74 (d, J=5.1 Hz, 1H), 8.38 (d, J=8.0 Hz, 1H), 8.14-8.12 (m, 1H), 7.88 (d, J=8.0 Hz, 1H)

### Production Example 152

Production Example 152 was carried out according to the same manner as in Production Example 139, using 2-(3-chloropyridin-4-yl)-5-trifluoromethyl-oxazolo[5,4-b]pyridine instead of 2-(3-chloropyridin-4-yl)-6-trifluoromethyl-oxazolo[5,4-b]pyridine, and thus 0.14 g of 2-(3-chloro-1-oxypyridin-4-yl)-5-(trifluoromethyl)oxazolo[5,4-b]pyridine (hereinafter, referred to as “active compound 155”) was obtained.

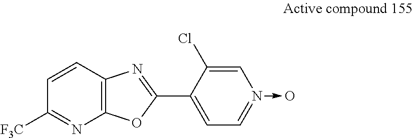

¹H-NMR (CDCl₃) δ: 8.41 (d, J=1.7 Hz, 1H), 8.33 (d, J=8.0 Hz, 1H), 8.23 (dd, J=7.1, 1.7 Hz, 1H), 8.19 (d, J=7.1 Hz, 1H), 7.86 (d, J=8.1 Hz, 1H)

### Production Example 153

Production Example 153 was carried out according to the same manner as in Production Example 1, using 2-amino-6-methylpyridin-3-ol instead of 2-amino-4-propylphenol, and thus 0.62 g of 5-methyl-2-pyridin-4-yl-oxazolo[4,5-b]pyridine (hereinafter, referred to as “active compound 156”) was obtained.

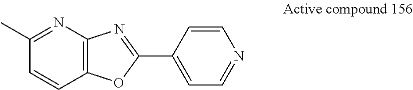

¹H-NMR (CDCl₃) δ: 8.85 (dd, J=4.5, 1.6 Hz, 2H), 8.13 (dd, J=4.5, 1.6 Hz, 2H), 7.82 (d, J=8.5 Hz, 1H), 7.24 (d, J=8.5 Hz, 1H), 2.72 (s, 3H)

### Production Example 154

Production Example 154 was carried out according to the same manner as in Production Example 1, using 2-amino-6-methylpyridin-3-ol and 3-chloroisonicotinic acid instead of 2-amino-4-propylphenol and isonicotinic acid, and thus 0.44 g of 2-(3-chloropyridin-4-yl)-5-methyl-oxazolo[4,5-b]pyridine (hereinafter, referred to as “active compound 157”) was obtained.

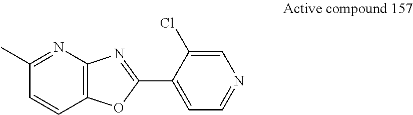

¹H-NMR (CDCl₃) δ: 8.83 (s, 1H), 8.69 (d, J=5.1 Hz, 1H), 8.16 (d, J=5.1 Hz, 1H), 7.86 (d, J=8.5 Hz, 1H), 7.28 (d, J=8.4 Hz, 1H), 2.74 (s, 3H)

### Production Example 155

Production Example 154 was carried out according to the same manner as in Production Example 22, using 3-benzyloxy-N-[2-hydroxy-5-(trifluoromethyl)pyridin-3-yl]-isonicotinamide instead of 2-chloro-N-[2-hydroxy-5-(trifluoromethyl)phenyl]isonicotinamide, and thus 2.23 g of 2-[3-(benzyloxy)pyridin-4-yl]-6-trifluoromethyl-oxazolo[5,4-b]pyridine (hereinafter, referred to as “active compound 158”) was obtained.

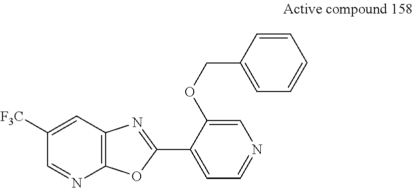

¹H-NMR (CDCl₃) δ: 8.75-8.73 (m, 1H), 8.63 (s, 1H), 8.47 (d, J=4.9 Hz, 1H), 8.40-8.38 (m, 1H), 8.06 (d, J=4.9 Hz, 1H), 7.60-7.56 (m, 2H), 7.45-7.40 (m, 2H), 7.38-7.32 (m, 1H), 5.47 (s, 2H)

### Production Example 156

A mixture of 1.7 g of 2-[3-(benzyloxy)pyridin-4-yl]-6-trifluoromethyl-oxazolo[5,4-b]pyridine, 40 ml of ethyl acetate and 10% palladium on carbon was reacted under the conditions of 40 bar and 40° C. for two hours. The reaction solution was concentrated under reduced pressure. The residue was subjected to silica gel column chromatography to give 1.0 g of 4-(6-trifluoromethyl-oxazolo[5,4-b]pyridin-2-yl)pyridin-3-ol (hereinafter, referred to as “active compound 159”).

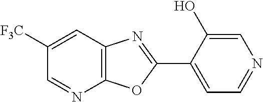

¹H-NMR (CDCl₃) δ: 10.57 (s, 1H), 8.79-8.78 (m, 1H), 8.67 (s, 1H), 8.41-8.39 (m, 2H), 7.91 (d, J=5.1 Hz, 1H)

### Production Example 157

To a mixture of 0.26 g of 4-(6-trifluoromethyl-oxazolo[5,4-b]pyridin-2-yl)pyridin-3-ol, 0.14 g of potassium carbonate and 3 ml of DMF, 0.17 g of isopropyl iodide was added at room temperature and stirred while heating at 60° C. for 1.5 hours. To the reaction solution, 38 mg of potassium carbonate and 47 mg of isopropyl iodide were added, and the reaction solution was stirred while heating at 60° C. for two hours. The reaction solution was cooled to room temperature, and then water was added to the reaction mixture, followed by extraction with ethyl acetate twice. The combined organic layers were washed with water and a saturated sodium chloride solution, dried over anhydrous magnesium sulfate, and concentrated under reduced pressure. The residue was subjected to silica gel column chromatography to give 0.16 g of 2-(3-isopropoxypyridin-4-yl)-6-trifluoromethyl-oxazolo[5,4-b]pyridine (hereinafter, referred to as “active compound 160”).

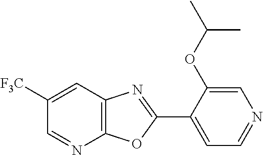

¹H-NMR (CDCl₃) δ: 8.73-8.71 (m, 1H), 8.60 (s, 1H), 8.43-8.41 (m, 1H), 8.39-8.38 (m, 1H), 8.02 (d, J=5.1 Hz, 1H), 4.94-4.83 (m, 1H), 1.52 (d, J=6.1 Hz, 6H)

### Production Example 158

To a mixture of 0.25 g of 4-(6-trifluoromethyl-oxazolo[5,4-b]pyridin-2-yl)pyridin-3-ol, 0.14 g of potassium carbonate and 3 ml of DMF, a mixture of 0.15 g of ethyl iodide and 1 ml of DMF was added at room temperature and stirred while heating at 60° C. for 1.5 hours. To the reaction mixture, 70 mg of potassium carbonate and 53 mg of iodoethane were added, and the reaction solution was stirred while heating at 60° C. for 3.5 hours. The reaction solution was cooled to room temperature, and then water was added to the reaction mixture, followed by extraction with ethyl acetate twice. The combined organic layers were washed with water and a saturated sodium chloride solution, dried over anhydrous magnesium sulfate, and concentrated under reduced pressure. The residue was subjected to silica gel column chromatography to give 60 mg of 2-(3-ethoxypyridin-4-yl)-6-trifluoromethyl-oxazolo[5,4-b]pyridine (hereinafter, referred to as “active compound 161”).

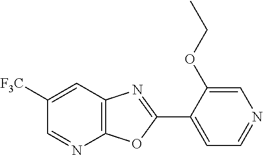

¹H-NMR (CDCl₃) δ: 8.74-8.72 (m, 1H), 8.60 (s, 1H), 8.45 (d, J=4.9 Hz, 1H), 8.40-8.38 (m, 1H), 8.04-8.02 (m, 1H), 4.41 (q, J=6.9 Hz, 2H), 1.60 (t, J=7.0 Hz, 3H)

### Production Example 159

To a mixture of 0.31 g of 4-(6-trifluoromethyl-oxazolo[5,4-b]pyridin-2-yl)pyridin-3-ol, 0.23 g of potassium carbonate and 3 ml of DMF, a mixture of 0.50 g of trifluoromethanesulfonate(2,2-difluoroethyl)ester and 7 ml of DMF was added at room temperature, and then stirred while heating at 60° C. for six hours. The reaction mixture was cooled to room temperature, and then water was added to the reaction mixture, followed by extraction with ethyl acetate twice. The combined organic layers were washed with water and a saturated sodium chloride solution, dried over anhydrous magnesium sulfate, and concentrated under reduced pressure. The residue was subjected to silica gel column chromatography to give 0.10 g of 2-[3-(2,2-difluoroethoxy)pyridin-4-yl]-6-trifluoromethyl-oxazolo[5,4-b]pyridine (hereinafter, referred to as “active compound 162”).

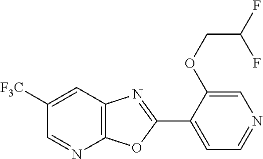

¹H-NMR (CDCl₃) δ: 8.76-8.74 (m, 1H), 8.62 (s, 1H), 8.57 (d, J=5.1 Hz, 1H), 8.41-8.40 (m, 1H), 8.09 (d, J=5.1 Hz, 1H), 6.30 (tt, J=54.8, 4.0 Hz, 1H), 4.53 (td, J=12.7, 4.1 Hz, 2H)

### Production Example 160

A mixture of 0.69 g of N-(2-hydroxy-5-trifluoromethylpyridin-3-yl)-3-(2,2,2-trifluoroethoxy)-isonicotinamide and 6.33 g of phosphorus oxychloride was heated to 120° C., stirred under heating for 4 hours, cooled to room temperature and then concentrated under reduced pressure. After water was added to the crude product under ice cooling, a saturated sodium hydrogen carbonate solution was added until the pH becomes about 7. The precipitated crystal was washed with water, collected by filtration and then dried under reduced pressure. Furthermore, the precipitated crystal was washed with methyl tert-butyl ether, washed with hexane and then dried under reduced pressure to obtain 0.38 g of 2-[2-(2,2,2-trifluoroethoxy)-phenyl]-6-trifluoromethyl-oxazolo[5,4-b]pyridine (hereinafter, referred to as “active compound 163”).

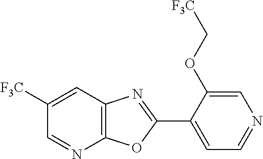

¹H-NMR (CDCl₃) δ: 8.77-8.75 (m, 1H), 8.65-8.61 (m, 2H), 8.43-8.41 (m, 1H), 8.13 (d, J=4.9 Hz, 1H), 4.70 (q, J=8.0 Hz, 2H)

Reference Production Examples for producing production intermediates of the above-mentioned active compounds will be described below.

### Reference Production Example 1

To a mixture of 5.0 g of 4-propylphenol and 35 ml of acetic acid, a mixture of 3.80 g of 61% nitric acid and 10 ml of acetic acid was added dropwise with the temperature kept at 10-15° C., which was stirred for four hours. The reaction mixture was poured into ice water and extracted with ethyl acetate. The combined organic layers were washed with water, a saturated aqueous solution of sodium hydrogencarbonate and a saturated sodium chloride solution, dried over magnesium sulfate, and then concentrated under reduced pressure to give 6.65 g of 4-propyl-2-nitrophenol.

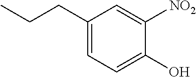

¹H-NMR (CDCl₃) δ: 10.46 (s, 1H), 7.89 (d, J=2.2 Hz, 1H), 7.40 (dd, J=8.5, 2.2 Hz, 1H), 7.08 (d, J=8.5 Hz, 1H), 2.58 (t, J=7.8 Hz, 2H), 1.69-1.59 (m, 2H), 0.94 (t, J=7.3 Hz, 3H)

A mixture of 6.65 g of 4-propyl-2-nitrophenol, 55 ml of ethyl acetate and 1.0 g of 5% palladium on carbon was stirred under about one atmosphere of hydrogen at room temperature for two hours. The mixture was filtered through Celite™. The filtrate was concentrated under reduced pressure to give 5.17 g of 2-amino-4-propylphenol.

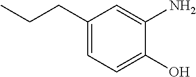

¹H-NMR (CDCl₃) δ: 6.64 (d, J=7.9 Hz, 1H), 6.59 (d, J=2.0 Hz, 1H), 6.49 (dd, J=8.0, 2.0 Hz, 1H), 3.74 (br s, 2H), 2.44 (t, J=7.8 Hz, 2H), 1.63-1.52 (m, 2H), 0.91 (t, J=7.3 Hz, 3H)

### Reference Production Example 2

4-butyl-2-nitrophenol was obtained according to the same manner as that of Reference Production Example 1 using 4-butylphenol instead of 4-propylphenol.

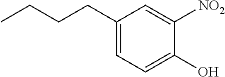

¹H-NMR (CDCl₃) δ: 10.46 (s, 1H), 7.89 (d, J=2.2 Hz, 1H), 7.41 (dd, J=8.5, 2.2 Hz, 1H), 7.07 (d, J=8.5 Hz, 1H), 2.60 (t, J=7.6 Hz, 2H), 1.65-1.53 (m, 2H), 1.41-1.30 (m, 2H), 0.93 (t, J=7.3 Hz, 3H)

2-amino-4-butylphenol was obtained according to the same manner as that of Reference Production Example 1, using 4-butyl-2-nitrophenol instead of 4-propyl-2-nitrophenol.

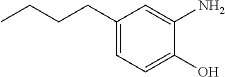

¹H-NMR (CDCl₃) δ: 6.64 (d, J=8.0 Hz, 1H), 6.59 (d, J=2.0 Hz, 1H), 6.49 (dd, J=8.0, 2.0 Hz, 1H), 3.60 (br s, 2H), 2.47 (t, J=7.6 Hz, 2H), 1.59-1.49 (m, 2H), 1.38-1.27 (m, 2H), 0.91 (t, J=7.3 Hz, 3H)

### Reference Production Example 3

A mixture of 7 g of 4-methoxy-2-nitrophenol, 50 ml of ethyl acetate and 1.3 g of 5% palladium on carbon was stirred under about one atmosphere of hydrogen at room temperature for 3.3 hours. The reaction mixture was filtered through Celite™. The filtrate was concentrated under reduced pressure to give 2-amino-4-methoxyphenol. This is used in the following reaction without purification.

A mixture of 2.5 g of a crude product of 2-amino-4-methoxyphenol, 3.2 g of isonicotinic acid chloride hydrochloride and 20 ml of pyridine was heated to reflux for 12 hours. The reaction mixture was poured into ice water, and precipitated deposits are collected by filtration. The obtained solid was dissolved in ethyl acetate, washed with water and a saturated sodium chloride solution, and dried over magnesium sulfate. Activated carbon was added thereto, followed by filtration through Celite™. The filtrate was concentrated under reduced pressure to give N-(2-hydroxy-5-methoxyphenyl)isonicotinamide.

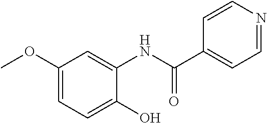

¹H-NMR (DMSO-d₆) δ: 9.50 (br s, 1H), 8.79-8.75 (m, 2H), 7.89-7.83 (m, 2H), 7.36-7.30 (m, 1H), 6.87-6.81 (m, 1H), 6.70-6.64 (m, 1H), 3.69 (s, 3H)

### Reference Production Example 4

4-ethyl-2-nitrophenol was obtained according to the same manner as that of Reference Production Example 1, using 4-ethylphenol instead of 4-propylphenol.

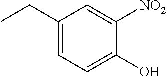

¹H-NMR (CDCl₃) δ: 10.46 (s, 1H), 7.91 (d, J=2.1 Hz, 1H), 7.43 (dd, J=8.5, 2.2 Hz, 1H), 7.08 (d, J=8.7 Hz, 1H), 2.64 (q, J=7.8 Hz, 2H), 1.25 (t, J=7.8 Hz, 3H)

2-amino-4-ethylphenol was obtained according to the same manner as that of Reference Production Example 1, using 4-ethyl-2-nitrophenol instead of 4-propyl-2-nitrophenol.

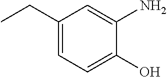

¹H-NMR (CDCl₃) δ: 6.65 (d, J=8.0 Hz, 1H), 6.61 (d, J=2.1 Hz, 1H), 6.53-6.49 (m, 1H), 3.84 (br s, 2H), 2.51 (q, J=7.6 Hz, 2H), 1.18 (t, J=7.6 Hz, 3H)

### Reference Production Example 5

4-isopropyl-2-nitrophenol was obtained according to the same manner as that of Reference Production Example 1, using 4-isopropylphenol instead of 4-propylphenol.

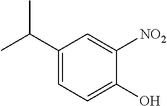

¹H-NMR (CDCl₃) δ: 10.46 (s, 1H), 7.93 (d, J=2.1 Hz, 1H), 7.47 (dd, J=8.5, 2.2 Hz, 1H), 7.09 (d, J=8.6 Hz, 1H), 2.97-2.86 (m, 1H), 1.25 (d, J=7.0 Hz, 6H)

2-amino-4-isopropylphenol was obtained according to the same manner as that of Reference Production Example 1, using 4-isopropyl-2-nitrophenol instead of 4-propyl-2-nitrophenol.

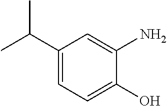

¹H-NMR (CDCl₃) δ: 6.66 (d, J=8.2 Hz, 1H), 6.64 (d, J=2.1 Hz, 1H), 6.54 (dd, J=8.0, 2.2 Hz, 1H), 4.60 (br s, 1H), 3.58 (br s, 2H), 2.84-2.70 (m, 1H), 1.19 (d, J=7.0 Hz, 6H)

### Reference Production Example 6

4-tert-butyl-2-nitrophenol was obtained according to the same manner as that of Reference Production Example 1, using 4-tert-butylphenol instead of 4-propylphenol.

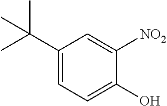

¹H-NMR (CDCl₃) δ: 10.47 (s, 1H), 8.07 (d, J=2.4 Hz, 1H), 7.64 (dd, J=8.8, 2.4 Hz, 1H), 7.10 (d, J=8.8 Hz, 1H), 1.33 (s, 9H)

2-amino-4-tert-butylphenol was obtained according to the same manner as that of Reference Production Example 1, using 4-tert-butyl-2-nitrophenol instead of 4-propyl-2-nitrophenol.

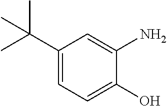

¹H-NMR (CDCl₃) δ: 6.80 (d, J=2.2 Hz, 1H), 6.70 (dd, J=8.2, 2.2 Hz, 1H), 6.66 (d, J=8.2, 1H), 3.59 (br s, 2H), 1.26 (s, 9H)

### Reference Production Example 7

2-amino-4-trifluoromethylphenol was obtained according to the same manner as that of Reference Production Example 1, using 2-nitro-4-trifluoromethylphenol instead of 4-propyl-2-nitrophenol.

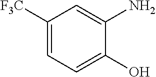

¹H-NMR (CDCl₃) δ: 6.98 (d, J=2.2 Hz, 1H), 6.95-6.92 (m, 1H), 6.76 (d, J=8.3, 1H), 5.33 (br s, 1H), 3.80 (br s, 2H)

A mixture of 2.84 g of 2-amino-4-trifluoromethylphenol, 1.97 g of isonicotinic acid, 3.69 g of WSC [1-ethyl-3-(3-dimethylaminopropyl)carbodiimide hydrochloride] and 20 ml of pyridine was stirred while heating at 80° C. for four hours. The reaction mixture was cooled to room temperature, and then water was poured, followed by extraction with ethyl acetate twice. The combined organic layers were washed with water and a saturated sodium chloride solution, dried over magnesium sulfate, and then concentrated under reduced pressure. The residue was washed with an ethyl acetate-hexane mixture solvent to give 1.69 g of N-(2-hydroxy-5-trifluoromethylphenyl)isonicotinamide.

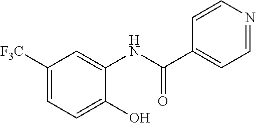

¹H-NMR (DMSO-d₆) δ: 10.82 (br s, 1H), 9.94 (br s, 1H), 8.80-8.78 (m, 2H), 8.05 (d, J=2.0 Hz, 1H), 7.88-7.86 (m, 2H), 7.43 (dd, J=8.5, 2.0 Hz, 1H), 7.10 (d, J=8.6 Hz, 1H)

### Reference Production Example 8

To a mixture of 5 g of 3-tert-butylphenol and 30 ml of acetic acid, a mixture of 3.0 g of 70% nitric acid and 10 ml of acetic acid was added dropwise with the temperature kept at 10-15° C. and stirred for two hours. The reaction mixture was poured into ice water and extracted with ethyl acetate twice. The combined organic layers were washed with water, a saturated aqueous solution of sodium hydrogencarbonate and a saturated sodium chloride solution, dried over magnesium sulfate, and then concentrated under reduced pressure. The residue was subjected to silica gel column chromatography to give 1.82 g of 5-tert-butyl-2-nitrophenol.

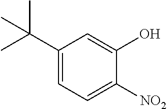

¹H-NMR (CDCl₃) δ: 10.60 (s, 1H), 8.01 (d, J=9.0 Hz, 1H), 7.13 (d, J=2.2, 1H), 7.01 (dd, J=9.0, 2.0 Hz, 1H), 1.33 (s, 9H)

2-amino-5-tert-butylphenol was obtained according to the same manner as that of Reference Production Example 1, using 5-tert-butyl-2-nitrophenol instead of 4-propyl-2-nitrophenol.

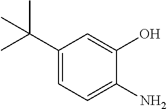

A mixture of 1.44 g of 2-amino-5-tert-butylphenol, 1.07 g of isonicotinic acid, 2.17 g of WSC and 15 ml of pyridine was stirred while heating at 80° C. for five hours. The reaction mixture was cooled to room temperature, and then water was poured. Precipitated solid was filtered and washed with water and diethyl ether to give 1.22 g of N-(4-tert-butyl-2-hydroxyphenyl)isonicotinamide.

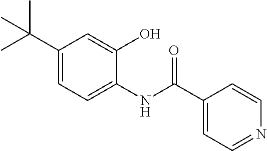

¹H-NMR (CDCl₃+DMSO-d₆) δ: 9.32 (br s, 1H), 9.12 (br s, 1H), 8.81-8.77 (m, 2H), 7.85-7.78 (m, 3H), 7.03 (d, J=1.9, 1H), 6.93 (dd, J=8.5, 1.9 Hz, 1H), 1.31 (s, 9H)

### Reference Production Example 9

To 7.5 g of 3-trifluoromethylphenol, 9 ml of 70% nitric acid was added dropwise at room temperature and the reaction mixture was stirred for one hour. The reaction mixture was poured into an ice-cooled saturated aqueous solution of sodium hydrogencarbonate, followed by extraction with ethyl acetate twice. The combined organic layers washed with water and a saturated sodium chloride solution, dried over magnesium sulfate, and concentrated under reduced pressure. The residue was subjected to silica gel column chromatography to give 1.56 g of 2-nitro-5-trifluoromethylphenol.

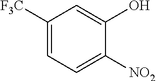

¹H-NMR (CDCl₃) δ: 10.59 (s, 1H), 8.25 (d, J=8.8 Hz, 1H), 7.48-7.46 (m, 1H), 7.27-7.23 (m, 1H)

2-amino-5-trifluoromethylphenol was obtained according to the same manner as that of Reference Production Example 1, using 2-nitro-5-trifluoromethylphenol instead of 4-propyl-2-nitrophenol.

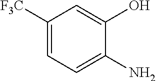

¹H-NMR (CDCl₃+DMSO-d₆) δ: 9.03 (br s, 1H), 7.01 (d, J=1.8 Hz, 1H), 6.95-6.91 (m, 1H), 6.71-6.66 (m, 1H), 4.13 (br s, 2H)

A mixture of 1.30 g of 2-amino-5-trifluoromethylphenol, 0.9 g of isonicotinic acid, 1.83 g of WSC and 15 ml of pyridine was stirred while heating at 80° C. for three hours. The mixture was cooled to room temperature, and then water was poured. Precipitated solid was filtered and washed with water, and then dried under reduced pressure to give 1.5 g of N-(2-hydroxy-4-trifluoromethylphenyl)isonicotinamide.

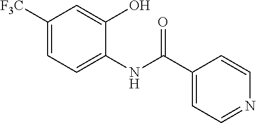

¹H-NMR (DMSO-d₆) δ: 8.82-8.76 (m, 2H), 7.98-7.93 (m, 1H), 7.89-7.85 (m, 2H), 7.23-7.17 (m, 2H)

### Reference Production Example 10

A mixture of 6.8 g of 1,1,3,3-tetrafluoro-5-hydroxy-6-nitro-1,3-dihydroisobenzofuran and 20 ml of acetic acid was added dropwise to a mixture, which was heated to 80° C., of 7.8 g of electrolytic iron, 20 ml of acetic acid and 20 ml of water, and then the reaction mixture was stirred for one hour. The mixture was cooled to room temperature, and then water was added, followed by extraction with ethyl acetate twice. The combined organic layers were washed with water, a saturated aqueous solution of sodium hydrogencarbonate, and a saturated sodium chloride solution, and dried over magnesium sulfate. Activated carbon was added, followed by filtration through Celite™. The filtrates were concentrated under reduced pressure to give 4.43 g of 6-amino-1,1,3,3-tetrafluoro-5-hydroxy-1,3-dihydroisobenzofuran.

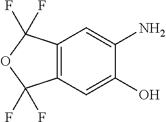

¹H-NMR (DMSO-d₆) δ: 10.65 (br s, 1H), 6.90 (s, 1H), 6.84 (s, 1H), 5.70 (br s, 2H)

A mixture of 2.0 g of 6-amino-1,1,3,3-tetrafluoro-5-hydroxy-1,3-dihydroisobenzofuran, 1.1 g of isonicotinic acid, 2.23 g of WSC and 15 ml of pyridine was stirred while heating at 80° C. for three hours. The reaction mixture was cooled to room temperature, and then water was poured into the reaction mixture. Precipitated solid was filtered and washed with water and dried under reduced pressure to give 1.34 g of N-(1,1,3,3-tetrafluoro-6-hydroxy-1,3-dihydroisobenzofuran-5-yl)isonicotinamide.

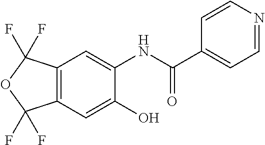

¹H-NMR (DMSO-d₆) δ: 10.07 (br s, 1H), 8.80 (dd, J=4.4, 1.5 Hz, 2H), 8.36 (s, 1H), 7.87 (dd, J=4.4, 1.5 Hz, 2H), 7.28 (s, 1H)

### Reference Production Example 11

A mixture of 1 g of 3,5-dichloroisonicotinic acid and 5 ml of thionyl chloride was heated to reflux for seven hours. Then, the mixture was cooled to room temperature, and then concentrated under reduced pressure. The residue was dissolved in 3 ml of DMF, which was added dropwise to a mixture of 2-amino-4-trifluoromethylphenol, 5 ml of DMF and 1.05 g of triethylamine at 0° C. The reaction mixture was stirred at room temperature for two hours, and then water was added thereto, followed by extraction with ethyl acetate twice. The combined organic layers were washed with water and a saturated sodium chloride solution, dried over magnesium sulfate, and concentrated under reduced pressure. The residue was washed with diethyl ether to give 0.75 g of 3,5-dichloro-N-(2-hydroxy-5-trifluoromethylphenyl)isonicotinamide.

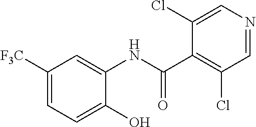

¹H-NMR (CDCl₃+DMSO-d₆) δ: 9.03 (br s, 1H), 8.59 (s, 2H), 8.45 (d, J=2.0 Hz, 1H), 7.30 (dd, J=8.5, 2.2 Hz, 1H), 7.04 (d, J=8.5 Hz, 1H)

### Reference Production Example 12

A mixture of 0.89 g of 2-amino-4-(trifluoromethyl)phenol, 0.71 g of 3-chloro-4-pyridinecarboxyaldehyde and 5 ml of ethanol was heated to reflux for three hours. The reaction mixture was concentrated and the residue was washed with an ethyl acetate-hexane mixture solvent to give 0.71 g of 2-(3-chloropyridin-4-yl)methylideneamino-4-(trifluoromethyl)phenol.

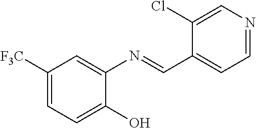

¹H-NMR (CDCl₃) δ: 9.14 (s, 1H), 8.76 (s, 1H), 8.65 (d, J=5.1 Hz, 1H), 8.01 (d, J=5.1 Hz, 1H), 7.62 (m, 1H), 7.56 (d, J=8.6 Hz, 1H), 7.35 (br s, 1H), 7.14 (d, J=8.6 Hz, 1H)

### Reference Production Example 13

To a mixture of 1.77 g of 2-amino-4-(trifluoromethyl)phenol, 1.58 g of 3-chloroisonicotinic acid and 15 ml of pyridine, 2.70 g of WSC was added and stirred while heating at 60° C. for four hours. The reaction mixture was cooled to room temperature, and then concentrated under reduced pressure. Water was added to the residue, followed by extraction with ethyl acetate twice. The combined organic layers were washed with a saturated sodium chloride solution, dried over anhydrous sodium sulfate, and then concentrated under reduced pressure. The residue was washed with a mixture solvent of tert-butyl methyl ether and hexane to give 1.80 g of 3-chloro-N-[2-hydroxy-5-(trifluoromethyl)phenyl]isonicotinamide.

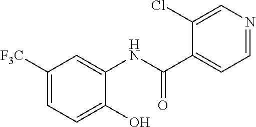

¹H-NMR (DMSO-d₆) δ: 10.89 (br s, 1H), 10.19 (br s, 1H), 8.75 (s, 1H), 8.64 (d, J=4.9 Hz, 1H), 8.32 (d, J=2.0 Hz, 1H), 7.63 (d, J=4.9 Hz, 1H), 7.40 (dd, J=8.5, 2.1 Hz, 1H), 7.08 (d, J=8.5 Hz, 1H)

### Reference Production Example 14

To a mixture of 0.71 g of 2-amino-4-(trifluoromethyl)phenol, 0.63 g of 2-chloroisonicotinic acid and 7 ml of pyridine, 1.05 g of WSC was added and stirred while heating at 60° C. for four hours. The reaction mixture was cooled to room temperature, and then concentrated under reduced pressure. Water was added to the residue, followed by extraction with ethyl acetate twice. The combined organic layers were washed with a saturated sodium chloride solution, dried over anhydrous sodium sulfate, and then concentrated under reduced pressure. The residue was subjected to silica gel column chromatography to give 0.77 g of 2-chloro-N-[2-hydroxy-5-(trifluoromethyl)phenyl]isonicotinamide.

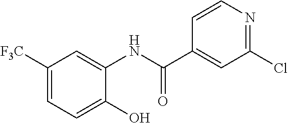

¹H-NMR (DMSO-d₆) δ: 10.12 (br s, 1H), 8.62 (d, J=5.1 Hz, 1H), 8.03-7.97 (m, 2H), 7.87 (dd, J=5.2, 1.3 Hz, 1H), 7.46-7.43 (m, 1H), 7.10 (d, J=8.2 Hz, 1H)

### Reference Production Example 15

A mixture of 0.62 g of 2-amino-4-(trifluoromethyl)phenol, 0.48 g of 3-methyl isonicotinic acid, 0.86 g of WSC and 5 ml of pyridine was stirred while heating at 60° C. for three hours. The reaction mixture was cooled to room temperature, and then the reaction mixture was concentrated. Water was poured into the residue, followed by extraction with ethyl acetate. The organic layer was washed with water and a saturated sodium chloride solution, sequentially. The organic layer was dried over anhydrous sodium sulfate, and then concentrated under reduced pressure. The residue was washed with a mixture solvent of tert-butyl methyl ether and hexane to give 0.38 g of N-[2-hydroxy-5-(trifluoromethyl)phenyl]-3-methylisonicotinamide.

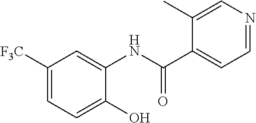

¹H-NMR (DMSO-d₆) δ: 9.83 (br s, 1H), 8.55 (s, 1H), 8.52 (d, J=5.1 Hz, 1H), 8.18 (s, 1H), 7.47 (d, J=5.1 Hz, 1H), 7.40 (dd, J=8.8, 1.9 Hz, 1H), 7.06 (d, J=8.8 Hz, 1H), 2.39 (s, 3H)

### Reference Production Example 16

While a mixture of 3.54 g of diisopropylamine and 50 ml of tetrahydrofuran was cooled in a dry ice-acetone bath, 20 ml of 1.6 M hexane solution of n-butyllithium was added while stirring so that the temperature of the reaction mixture did not exceed −40° C. Thereafter, the reaction mixture was stirred for 30 minutes. Then, a mixture of 2.91 g of 3-fluoropyridine and 3 ml of tetrahydrofuran was added so that the temperature of the reaction mixture did not exceed −60° C. The mixture was further stirred for 30 minutes. After crushed dry ice was added to the reaction mixture, cooling was stopped. Then, the reaction mixture was stirred until the temperature returned to room temperature. Water was added to the reaction mixture, and most part of hexane and tetrahydrofuran was removed under reduced pressure. The residue was washed with tert-butyl methyl ether, and the aqueous layers were collected. To the collected aqueous layer, concentrated hydrochloric acid was added while ice-cooling, and pH of the mixture was made to be 3 and stirred for one hour. Precipitates were collected by filtration and dried under reduced pressure to give 3.59 g of 3-fluoroisonicotinic acid.

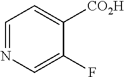

¹H-NMR (DMSO-d₆) δ: 8.74 (d, J=2.4 Hz, 1H), 8.58 (d, J=4.9 Hz, 1H), 7.80-7.77 (m, 1H)

### Reference Production Example 17

A mixture of 0.49 g of 3-fluoroisonicotinic acid, 0.62 g of 2-amino-4-(trifluoromethyl)phenol, 1.00 g of WSC and 6 ml of pyridine was stirred while heating at 80° C. for two hours. The reaction mixture was cooled to room temperature, and then concentrated. Water was poured into the residue, followed by extraction with ethyl acetate.

The organic layer was washed with a saturated sodium chloride solution. The organic layer was dried over anhydrous sodium sulfate, and then concentrated under reduced pressure. The residue was washed with a tert-butyl methyl ether-hexane mixture solvent to give 0.51 g of 3-fluoro-N-[2-hydroxy-5-(trifluoromethyl)phenyl]isonicotinamide.

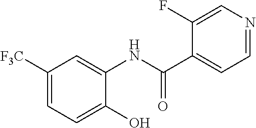

¹H-NMR (DMSO-d₆) δ: 11.09 (s, 1H), 9.98 (br s, 1H), 8.76 (m, 1H), 8.60 (d, J=4.6 Hz, 1H), 8.39 (d, J=2.2 Hz, 1H), 7.78-7.75 (m 1H), 7.41 (dd, J=8.6, 2.2 Hz, 1H), 7.09 (d, J=8.6 Hz, 1H)

### Reference Production Example 18

A mixture of 3.54 g of diisopropylamine and 50 ml of tetrahydrofuran was stirred while cooling in a dry ice-acetone bath. To the reaction mixture, 20 ml of 1.6 M hexane solution of n-butyllithium was added so that the temperature of the reaction mixture did not exceed −40° C. The reaction mixture was stirred for 30 minutes. Then, a mixture of 4.74 g of 3-bromopyridine and 5 ml of tetrahydrofuran was added so that the temperature of the reaction mixture did not exceed −60° C. The reaction mixture was stirred for further 30 minutes. Crushed dry ice was added to the reaction mixture and then cooling was stopped. The reaction mixture was stirred until the temperature retuned to room temperature. Water was added thereto, most of hexane and tetrahydrofuran was removed under reduced pressure.

The residue was washed with tert-butyl methyl ether, and the aqueous layers were collected.

To the collected aqueous layers, concentrated hydrochloric acid was added while ice-cooling so that pH of the mixture was made to be 3 and stirred for one hour, followed by extraction with ethyl acetate three times. The combined organic layers were washed with a saturated sodium chloride solution, dried over anhydrous sodium sulfate, and concentrated under reduced pressure to give 0.69 g of 3-bromo isonicotinic acid.

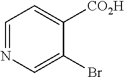

¹H-NMR (DMSO-d₆) δ: 8.74 (s, 1H), 8.67 (d, J=4.9 Hz, 1H), 7.69 (d, J=4.9 Hz, 1H)

### Reference Production Example 19

A mixture of 0.69 g of 3-bromo isonicotinic acid, 0.60 g of 2-amino-4-(trifluoromethyl)phenol, 1.00 g of WSC and 6 ml of pyridine was stirred while heating at 80° C. for two hours. The reaction mixture was cooled to room temperature, and then concentrated. Water was added to the residue, followed by extraction with ethyl acetate. The organic layer was washed with a saturated sodium chloride solution, then dried over anhydrous sodium sulfate, and concentrated under reduced pressure. The residue was washed with a mixture solvent of ethyl acetate and hexane to give 0.29 g of 3-bromo-N-[2-hydroxy-5-(trifluoromethyl)phenyl]isonicotinamide.

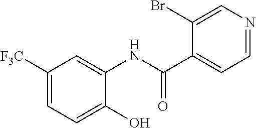

### Reference Production Example 20

Water was added to 3.20 g of sodium hydroxide to make 30 ml of aqueous solution in total. To the solution, 5.83 g of 3-iodo-isonicotinic acid methyl ester (U.S. Pat. No. 6,277,871B1, O'Conner et al.) was added. The mixture solution was stirred while heating at 60° C. for three hours. The reaction mixture was cooled in ice, to which concentrated hydrochloric acid was added to adjust pH to 2-3. Precipitates were collected by filtration and dried under reduced pressure to give 5.21 g of 3-iodo-isonicotinic acid.

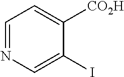

¹H-NMR (DMSO-d₆) δ: 9.04 (s, 1H), 8.64 (d, J=5.1 Hz, 1H), 7.65 (d, J=5.1 Hz, 1H)

### Reference Production Example 21

A mixture of 1.78 g of 3-iodo-isonicotinic acid, 1.38 g of WSC and 12 ml of pyridine was stirred while heating at 50° C. for 15 minutes. Then, 1.15 g of 2-amino-4-(trifluoromethyl)phenol was added to the reaction mixture. The reaction mixture was stirred while heating at 80° C. for two hours. The reaction mixture was returned to room temperature, and concentrated under reduced pressure. Water was added to the residue, followed by extraction with ethyl acetate. The organic layer was washed with a saturated sodium chloride solution, dried over anhydrous sodium sulfate, and then concentrated under reduced pressure to give 1.81 g of N-[2-hydroxy-5-(trifluoromethyl)phenyl]-3iodo isonicotinamide.

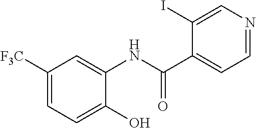

¹H-NMR (DMSO-d₆) δ: 10.85 (br s, 1H), 10.09 (br s, 1H), 8.97 (s, 1H), 8.64-8.62 (m, 1H), 8.29-8.27 (m, 1H), 7.54-7.51 (m 1H), 7.42-7.38 (m, 1H), 7.07 (d, J=8.5 Hz, 1H)

### Reference Production Example 22

To a mixture of 3.69 g of nicotinic acid and 30 ml of toluene, 3.64 g of diisopropylethylamine, then 8.67 g of diphenylphosphoryl azide was added. The reaction mixture was stirred at room temperature for 30 minutes. To the reaction mixture, 4 ml of tert-butyl alcohol was added. The reaction mixture was stirred while heating at 80° C. for six hours. The reaction mixture was cooled to room temperature, then the reaction mixture was diluted with ethyl acetate, washed with water and then with a saturated sodium chloride solution, dried over anhydrous sodium sulfate, and concentrated under reduced pressure. The residue was washed with a mixture solvent of ethyl acetate and hexane to give 4.07 g of 3-(tert-butoxycarbonyl amino)pyridine.

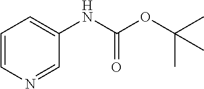

¹H-NMR (CDCl₃) δ: 8.46 (d, J=2.7 Hz, 1H), 8.28 (dd, J=4.9, 1.2 Hz, 1H), 8.03-7.96 (m, 1H), 7.25-7.21 (m, 1H), 7.04 (br s, 1H), 1.53 (s, 9H)

While a mixture of 1.16 g of 3-(tert-butoxycarbonyl amino)pyridine and 25 ml of tetrahydrofuran was cooled in a dry ice-acetone bath, 8.5 ml of 1.65 M hexane solution of n-butyllithium was added so that the temperature of the reaction mixture did not exceed −60° C.

The reaction mixture was stirred for 15 minutes. Cooling was stopped. Then, the reaction mixture was stirred until the temperature became 0° C. The reaction mixture was cooled in a dry ice-acetone bath again. After injection of carbon dioxide, cooling was stopped, and the reaction mixture was stirred at room temperature for two hours. After water was added, most of tetrahydrofuran and hexane was removed by concentration under reduced pressure. The residue was ice-cooled and 3N hydrochloric acid was added so as to adjust pH to about 3. Extraction with a mixture solvent (4:1) of ethyl acetate to tetrahydrofuran was carried out several times. The combined organic layers were washed with a saturated sodium chloride solution, dried over anhydrous sodium sulfate, and concentrated under reduced pressure to give 0.53 g of 3-(tert-butoxycarbonyl amino)isonicotinic acid.

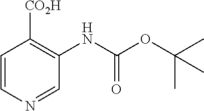

¹H-NMR (DMSO-d₆) δ: 10.07 (s, 1H), 9.37 (s, 1H), 8.35 (d, J=5.1 Hz, 1H), 7.76 (d, J=5.1 Hz, 1H), 1.49 (s, 9H)

To a mixture of 1.15 g of WSC and 8 ml of pyridine, 1.43 g of 3-tert-butoxycarbonylamino isonicotinic acid was added and stirred at room temperature for 15 minutes. To the reaction mixture, 1.06 g of 2-amino-4-(trifluoromethyl)phenol was added and stirred while heating at 60° C. for two hours. Thereafter, the mixture reaction was cooled to room temperature, and then concentrated under reduced pressure. Water was added to the residue, followed by extraction with ethyl acetate twice. The combined organic layers were washed with a saturated sodium chloride solution, dried over anhydrous sodium sulfate, and then concentrated under reduced pressure to give 1.79 g of 3-tert-butoxycarbonylamino-N-[2-hydroxy-5-(trifluoromethyl)phenyl] isonicotinamide.

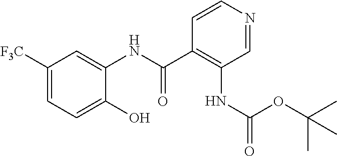

### Reference Production Example 23

To a mixture of 5.0 g of 60% sodium hydride (in oil) and 70 ml of DMF, a mixture of 4-iodophenol and 25 ml of DMF was added dropwise while ice-cooling, and stirred for one hour. The temperature was increased to room temperature, a mixture of 12.9 g of chloromethyl ethyl ether and 10 ml of DMF was added dropwise, and stirred for further one hour. The reaction mixture was poured into ice water, and extracted with ethyl acetate three times. The combined organic layers was washed with water and a saturated sodium chloride solution, dried over anhydrous magnesium sulfate, and concentrated under reduced pressure to give 32 g of a crude product of 1-ethoxymethoxy-4-iodobenzene. The crude product was used for the next reaction without purification.

A mixture of 7.5 g of crude product of 1-ethoxymethoxy-4-iodobenzene, 10.0 g of sodium pentafluoropropionate salt, 10.27 g of copper (1) iodide, 120 ml of DMF and 45 ml of toluene was stirred while heating at 140 to 150° C. for one hour to remove about 40 ml of toluene. The reaction mixture was heated to reflux at 160 to 170° C. for further five hours, and then cooled to room temperature and poured into ice water. To the reaction mixture, 200 ml of diethyl ether was added. The reaction mixture was filtered through Celite™. The filtrate was extracted with diethyl ether. The combined organic layers were washed with water and a saturated sodium chloride solution, dried over anhydrous magnesium sulfate, and concentrated under reduced pressure to give 5.45 g of 1-ethoxymethoxy-4-pentafluoroethyl benzene.

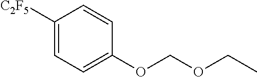

¹H-NMR (CDCl₃) δ: 7.51 (d, J=8.9 Hz, 2H), 7.13 (d, J=8.9 Hz, 2H), 5.27 (s, 2H), 3.73 (q, J=7.0 Hz, 2H), 1.23 (t, J=7.0, 3H) 7.39 g of 1-ethoxymethoxy-4-pentafluoroethyl benzene, 30 ml of acetone and 30 ml of 6 M hydrochloric acid were stirred while heating at 50° C. for 2.5 hours. The reaction mixture was cooled to room temperature, and then poured into water, followed by extraction with ethyl acetate. The combined organic layers were washed with water and a saturated sodium chloride solution, dried over anhydrous magnesium sulfate, and concentrated under reduced pressure. The residue was subjected to silica gel column chromatography to give 4-(pentafluoroethyl)phenol.

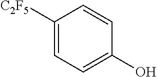

¹H-NMR (CDCl₃) δ: 7.47 (d, 8.5 Hz, 2H), 6.93 (d, 8.5 Hz, 2H), 5.74 (br s, 1H)

To a mixture of 1.70 g of 4-(pentafluoroethyl)phenol, 6 ml of acetic acid and 2.0 ml of concentrated sulfuric acid, a mixture of 0.80 g of 69% nitric acid and 1 ml of acetic acid was added dropwise while ice-cooling, and stirred at room temperature for three hours. The reaction mixture was poured into ice water, followed by extraction with ethyl acetate three times. The combined organic layers were washed with water and a saturated sodium chloride solution, dried over sodium sulfate, and concentrated under reduced pressure. The residue was subjected to silica gel column chromatography to give 1.40 g of 4-(pentafluoroethyl)-2-nitrophenol.

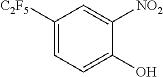

¹H-NMR (CDCl₃) δ: 10.02 (s, 1H), 8.40 (d, J=2.0 Hz, 1H), 7.79 (dd, J=9.0, 2.0 Hz, 1H), 7.32 (d, J=9.0 Hz, 1H)

A mixture of 1.38 g of 4-(pentafluoroethyl)-2-nitrophenol, 15 ml of ethyl acetate and 0.15 g of 5% palladium on carbon was stirred under about one atmosphere of hydrogen at room temperature for four hours. The reaction mixture was filtered through Celite™.

The filtrate was concentrated under reduced pressure. The residue was washed with hexane to give 1.02 g of 2-amino-4-(pentafluoroethyl)phenol.

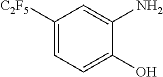

¹H-NMR (CDCl₃) δ: 6.94 (s, 1H), 6.91 (d, J=8.3 Hz, 1H), 6.78 (d, J=8.3 Hz, 1H), 5.34 (br s, 1H), 3.82 (br s, 2H)

To a mixture of 0.44 g of WSC and 4 ml of pyridine, 0.28 g of isonicotinic acid was added, and the reaction mixture was stirred at room temperature for 15 minutes. To the reaction mixture, 0.45 g of 2-amino-4-(pentafluoroethyl)phenol that had been obtained in the above-mentioned reaction was added and stirred while heating at 60° C. for two hours. The reaction mixture was cooled to room temperature, and the concentrated under reduced pressure. Water was added to the residue, followed by extraction with ethyl acetate twice. The combined organic layers were washed with water and a saturated sodium chloride solution, dried over anhydrous sodium sulfate, and then concentrated under reduced pressure.

The residue was subjected to silica gel column chromatography to give 0.50 g of N-[2-hydroxy-5-(pentafluoroethyl)phenyl]isonicotinamide.

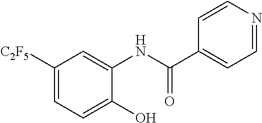

¹H-NMR (DMSO-d₆) δ: 10.89 (br s, 1H), 9.93 (br s, 1H), 8.79 (d, J=5.4 Hz, 2H), 8.03 (d, J=2.0 Hz, 1H), 7.88 (d, J=5.6 Hz, 2H), 7.39 (dd, J=8.5, 2.0 Hz, 1H), 7.14 (d, J=8.6 Hz, 1H)

### Reference Production Example 24

To a mixture of 0.44 g of WSC and 4 ml of pyridine, 0.36 g of 3-chloroisonicotinic acid was added. The reaction mixture was stirred at room temperature for 15 minutes. To the reaction mixture, 0.45 g of 2-amino-4-(pentafluoroethyl)phenol was added and stirred while heating at 60° C. for two hours. The reaction mixture was cooled to room temperature, and then concentrated under reduced pressure. Water was added to the residue, followed by extraction with ethyl acetate twice. The combined organic layers were washed with water and a saturated sodium chloride solution, dried over anhydrous sodium sulfate, and concentrated under reduced pressure. The residue was subjected to silica gel column chromatography to give 0.25 g of 3-chloro-N-[2-hydroxy-5-(pentafluoroethyl)phenyl]isonicotinamide.

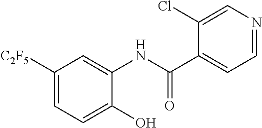

¹H-NMR (DMSO-d₆) δ: 10.99 (br s, 1H), 10.20 (br s, 1H), 8.75 (s, 1H), 8.64 (d, J=4.9 Hz, 1H), 8.31 (d, J=2.2 Hz, 1H), 7.64 (d, J=4.6 Hz, 1H), 7.36 (dd, J=8.6, 2.1 Hz, 1H), 7.11 (d, J=8.6 Hz, 1H)

### Reference Production Example 25

To a mixture of 3.92 g of 4-(heptafluoroisopropyl)aniline, 20 ml of acetic acid, 3.0 g of concentrated sulfuric acid and 3 ml of water, an aqueous solution of 1.14 g of sodium nitrite was gradually added dropwise while ice-cooling, and stirred for 30 minutes while ice-cooling, and the stirred while heating at 80° C. for one hour. The reaction mixture was cooed to room temperature, and then the reaction mixture was poured into water, followed by extraction with ethyl acetate three times. The combined organic layers were washed with a saturated sodium chloride solution, dried over anhydrous sodium sulfate, and then concentrated under reduced pressure. The residue was subjected to silica gel column chromatography to give 3.60 g of mixture containing 4-(heptafluoroisopropyl)phenol.

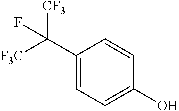

¹H-NMR (CDCl₃) δ: 7.48 (d, J=8.9 Hz, 2H), 6.96-6.92 (m, 2H), 5.64 (br s, 1H)

To a mixture of 3.60 g of mixture containing 4-(heptafluoroisopropyl)phenol, 8 ml of acetic acid, and 2.5 g of concentrated sulfuric acid, a mixture of 1.05 g of 69% nitric acid and 1 ml of acetic acid was added dropwise while ice-cooling, and then stirred at room temperature for two hours. The reaction mixture was poured into water, and extracted with ethyl acetate three times. The combined organic layers were washed with a saturated sodium chloride solution, dried over anhydrous sodium sulfate, and concentrated under reduced pressure. The residue was subjected to silica gel column chromatography to give 2.96 g of 4-(heptafluoroisopropyl)-2-nitrophenol.

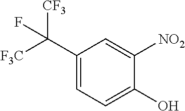

¹H-NMR (CDCl₃) δ: 10.76 (s, 1H), 8.42 (d, J=2.4 Hz, 1H), 7.79 (dd, J=9.0, 2.0 Hz, 1H), 7.34 (d, J=9.0 Hz, 1H)

A mixture of 2.95 g of 4-(heptafluoroisopropyl)-2-nitrophenol, 20 ml of ethyl acetate and 0.30 g of 5% palladium on carbon was stirred in a hydrogen atmosphere at room temperature for four hours. The reaction mixture was filtered through Celite™. The filtrate was concentrated under reduced pressure. The residue was subjected to silica gel column chromatography to give 2.08 g of 2-amino-4-(heptafluoroisopropyl)phenol.

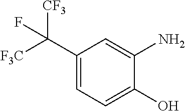

¹H-NMR (CDCl₃) δ: 6.96 (s, 1H), 6.89 (d, J=8.6 Hz, 1H), 6.78 (d, J=8.6 Hz, 1H), 5.38 (br s, 1H), 3.84 (br s, 2H)

To a mixture of 0.58 g of WSC and 5 ml of pyridine, 0.37 g of isonicotinic acid was added. The reaction mixture was stirred at room temperature for 25 minutes. To the reaction mixture, 0.75 g of 2-amino-4-(heptafluoroisopropyl)phenol was added and was stirred while heating at 60° C. for three hours. The mixture was cooled to room temperature, and then concentrated under reduced pressure. Then, water was added to the residue, followed by extraction with ethyl acetate twice. The combined organic layers were washed with water and a saturated sodium chloride solution, dried over anhydrous sodium sulfate, and concentrated under reduced pressure. The residue was subjected to silica gel column chromatography to give 0.79 g of N-[2-hydroxy-5-(heptafluoroisopropyl)phenyl]isonicotinamide.

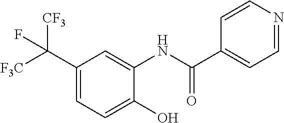

¹H-NMR (DMSO-d₆) δ: 10.83 (br s, 1H), 9.92 (br s, 1H), 8.80-8.78 (m, 2H), 8.06 (br s, 1H), 7.88-7.86 (m, 2H), 7.36 (dd, J=8.8, 2.0 Hz, 1H), 7.15 (d, J=8.8 Hz, 1H)

### Reference Production Example 26

To a mixture of 0.58 g of WSC and 5 ml of pyridine 5 ml, 0.48 g of 3-chloroisonicotinic acid was added. The reaction mixture was stirred at room temperature for 25 minutes. To the reaction mixture, 0.75 g of 2-amino-4-(heptafluoroisopropyl)phenol was added and was stirred while heating at 60° C. for three hours. The reaction mixture was cooled to room temperature, the 0.24 g of 3-chloroisonicotinic acid and 0.29 g of WSC was added and stirred while heating at 60° C. for 1.5 hours and then at 80° C. for 1.3 hours. The mixture reaction was cooled to room temperature, and then concentrated under reduced pressure. Then, water was added to the residue, followed by extraction with ethyl acetate twice. The combined organic layers were washed with a saturated sodium chloride solution, was dried over anhydrous sodium sulfate, and concentrated under reduced pressure. The residue was subjected to silica gel column chromatography to give 0.90 g of 3-chloro-N-[2-hydroxy-5-(heptafluoroisopropyl)phenyl]isonicotinamide.

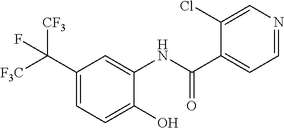

¹H-NMR (DMSO-d₆) δ: 10.19 (br s, 1H), 8.75 (s, 1H), 8.63 (d, J=4.9 Hz, 1H), 8.36 (d, J=1.9 Hz, 1H), 7.65 (d, J=4.9 Hz, 1H), 7.32 (dd, J=8.8, 2.0 Hz, 1H), 7.12 (d, J=8.8 Hz, 1H)

### Reference Production Example 27

To a mixture of 3.78 g of 2-chloro-4-(trifluoromethyl)phenol, 12 ml of acetic acid and 3 ml of concentrated sulfuric acid, a mixture of 21.5 g of 69% nitric acid and 2 ml of acetic acid was added while ice-cooling. The reaction mixture was stirred while heating at room temperature for 30 minutes and then at 60° C. for two hours. After the reaction mixture was cooled to room temperature, then the reaction mixture was poured into water, and extracted with ethyl acetate three times. The combined organic layers were washed with saturated sodium chloride solution, dried over anhydrous sodium sulfate, and concentrated under reduced pressure. The residue was subjected to silica gel column chromatography to give 5.01 g of a mixture containing 2-chloro-6-nitro-4-(trifluoromethyl)phenol.

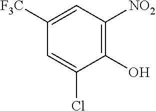

¹H-NMR (CDCl₃) δ: 11.26 (br s, 1H), 8.36 (m, 1H), 7.95 (d, J=2.2 Hz, 1H)

A mixture of 5.01 g of a mixture containing 2-chloro-4-(trifluoromethyl)-6-nitrophenol, 15 ml of ethyl acetate and 1.0 g of 5% palladium on carbon was stirred under about one atmosphere of hydrogen at room temperature for 15 hours. The mixture was filtered through Celite™. The filtrate was concentrated under reduced pressure. The residue was subjected to silica gel column chromatography to give 2.78 g of 2-amino-6-chloro-4-(trifluoromethyl)phenol.

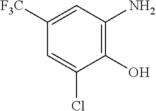

¹H-NMR (CDCl₃) δ: 7.00 (m, 1H), 6.84 (d, J=2.2 Hz, 1H), 5.80 (br s, 1H), 4.05 (br s, 2H)

To a mixture of 0.58 g of WSC and 5 ml pyridine, 0.37 g of isonicotinic acid was added. The reaction mixture was stirred at room temperature for 15 minutes. To the reaction mixture, 0.63 g of 2-amino-6-chloro-4-(trifluoromethyl)phenol that had been obtained in the above-mentioned reaction was added. The reaction mixture was stirred while heating at 60° C. for three hours. The reaction mixture was cooled to room temperature, and then concentrated under reduced pressure. Water was added to the residue, followed by extraction with ethyl acetate twice. The combined organic layers were washed with a saturated sodium chloride solution, then dried over anhydrous sodium sulfate, and concentrated under reduced pressure. The residue was washed with a mixture solvent of tert-butyl methyl ether and hexane to give 0.42 g of N-[3-chloro-5-(trifluoromethyl)-2-hydroxyphenyl]isonicotinamide.

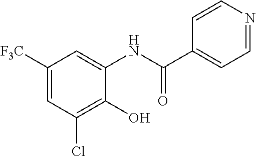

¹H-NMR (DMSO-d₆) δ: 10.27 (br s, 1H), 8.81-8.79 (m, 2H), 7.90-7.88 (m, 2H), 7.86 (d, J=2.0 Hz, 1H), 7.68-7.67 (m, 1H)

### Reference Production Example 28

To a mixture of 4.0 g of 4-trifluoromethoxy phenol and 25 ml of acetic acid, a mixture of 2.02 g of 70% nitric acid and 10 ml of acetic acid was added dropwise with the temperature kept at 10-15° C. The reaction mixture was stirred for five hours. The reaction mixture was poured into ice water and extracted with ethyl acetate. The combined organic layers were washed with water, a saturated aqueous solution of sodium hydrogencarbonate and a saturated sodium chloride solution, dried over sodium sulfate, and then concentrated under reduced pressure to give 4.53 g of 4-trifluoromethoxy-2-nitrophenol.

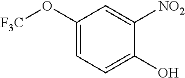

¹H-NMR (CDCl₃) δ: 10.50 (s, 1H), 8.02-7.99 (m, 1H), 7.50-7.45 (m, 1H), 7.22 (d, J=9.1 Hz, 1H)

A mixture of 4.53 g of 4-trifluoromethoxy-2-nitrophenol, 35 ml of ethyl acetate and 1.0 g of 5% palladium on carbon was stirred under about one atmosphere of hydrogen at room temperature for 1.7 hours. The mixture was filtered through Celite™. The filtrate was concentrated under reduced pressure to give 3.92 g of 2-amino-4-trifluoromethoxy phenol.

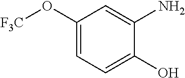

To a mixture of 2.5 g of 2-amino-4-trifluoromethoxy phenol, 2.62 g of triethylamine and 15 ml of DMF, 2.31 g of 4-isonicotinic acid chloride hydrochloride was added while ice-cooling. The reaction mixture was stirred for 3.3 hours. The reaction mixture was poured into water and precipitated crystals were filtered and dried under reduced pressure to give 2.19 g of N-[5-(trifluoromethoxy)-2-hydroxyphenyl]isonicotinamide.

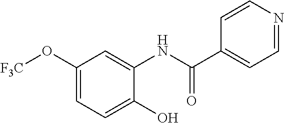

¹H-NMR (DMSO-d₆) δ: 8.78 (dd, J=4.4, 1.7 Hz, 2H), 7.86 (dd, J=4.4, 1.6 Hz, 2H), 7.80-7.77 (m, 1H), 7.10-7.05 (m, 1H), 6.99 (d, J=8.7 Hz, 1H)

### Reference Production Example 29

A mixture of 0.41 g of 2-amino-4-tert-butylphenol, 0.35 g of 3-chloro-4-pyridinecarboxyaldehyde and 2.5 ml of ethanol was heated to reflux for three hours. The reaction mixture was concentrated. The residue was subjected to silica gel column chromatography to give 0.50 g of 2-(3-chloropyridin-4-yl)methylideneamino-4-tert-butylphenol.

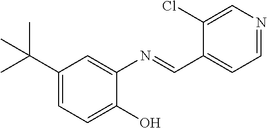

¹H-NMR (CDCl₃) δ: 9.07 (s, 1H), 8.71 (s, 1H), 8.60 (d, J=5.1 Hz, 1H), 8.01 (d, J=5.1 Hz, 1H), 7.36-7.33 (m, 2H), 7.02 (s, 1H), 7.00-6.97 (m, 1H), 1.35 (s, 9H)

### Reference Production Example 30

To a mixture of 4.8 g of 4-(trifluoromethylthio)phenol and 20 ml of acetic acid, a mixture of 2.5 g of 70% nitric acid and 1 ml of acetic acid and then 1.5 ml of concentrated sulfuric acid were added dropwise with the internal temperature kept at 10-15° C. The reaction mixture was stirred for three hours. The reaction mixture was poured into ice water and extracted with ethyl acetate. The combined organic layers were washed with water, a saturated aqueous solution of sodium hydrogencarbonate and a saturated sodium chloride solution, dried over magnesium sulfate, and then concentrated under reduced pressure to give 5.94 g of 2-nitro-4-(trifluoromethylthio)phenol.

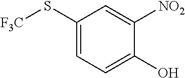

¹H-NMR (CDCl₃) δ: 10.78 (br s, 1H), 8.44 (s, 1H), 7.83 (d, J=8.8, 1H), 7.24 (d, J=8.8 Hz, 1H)

A mixture of 5.49 g of 2-nitro-4-(trifluoromethylthio)phenol and 10 ml of ethyl acetate was added dropwise to a mixture, which was heated to 80° C., of 6.4 g of electrolytic iron, 10 ml of acetic acid and 20 ml of water. The reaction mixture was stirred for 30 minutes. The mixture was cooled to room temperature, and then water was added, followed by extraction with ethyl acetate twice. The combined organic layers were washed with water, a saturated aqueous solution of sodium hydrogencarbonate and a saturated sodium chloride solution, dried over magnesium sulfate, and then concentrated under reduced pressure. The residue was subjected to silica gel column chromatography to give 2.0 g of 2-amino-4-(trifluoromethylthio)phenol.

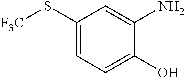

¹H-NMR (CDCl₃) δ: 7.04 (d, J=2.0 Hz, 1H), 6.97 (dd, J=8.0, 2.0 Hz, 1H), 6.73 (d, J=8.0 Hz, 1H), 5.16 (br s, 1H), 3.74 (br s, 2H)

A mixture of 0.70 g of 2-amino-4-(trifluoromethylthio)phenol, 0.83 g of WSC, 0.41 g of isonicotinic acid and 7 ml of pyridine was stirred while heating at 80° C. for three hours. The reaction mixture was cooled to room temperature, and then water was poured into the reaction mixture, followed by extraction with ethyl acetate three times. The combined organic layers were washed with water and a saturated sodium chloride solution, dried over anhydrous magnesium sulfate, and then concentrated under reduced pressure. The residue was subjected to silica gel column chromatography to give 0.42 g of N-[2-hydroxy-5-(trifluoromethylthio)phenyl)isonicotinamide.

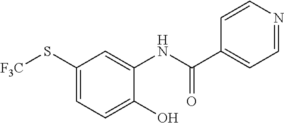

¹H-NMR (DMSO-d₆) δ: 9.89 (br s, 1H), 8.78 (dd, J=4.3, 1.7 Hz, 2H), 8.05 (d, J=2.2 Hz, 1H), 7.87 (dd, J=4.3, 1.7 Hz, 2H), 7.42 (dd, J=8.5, 2.2 Hz, 1H), 7.05 (d, J=8.5 Hz, 1H)

### Reference Production Example 31

A mixture of 0.60 g of 2-amino-4-(trifluoromethylthio)phenol, 0.45 g of 3-chloroisonicotinic acid, 0.71 g of WSC and 6 ml of pyridine was stirred while heating at 80° C. for three hours. The reaction mixture was cooled to room temperature, and then water was added to the reaction mixture, followed by extraction with ethyl acetate three times. The combined organic layers were washed with water and a saturated sodium chloride solution, dried over anhydrous magnesium sulfate, and then concentrated under reduced pressure. The residue was subjected to silica gel column chromatography to give 0.63 g of 3-chloro-N-[2-hydroxy-5-(trifluoromethylthio)phenyl]isonicotinamide.

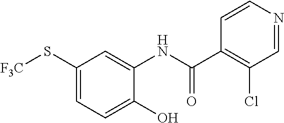

¹H-NMR (DMSO-d₆) δ: 10.89 (br s, 1H), 10.14 (br s, 1H), 8.74 (s, 1H), 8.63 (d, J=4.8 Hz, 1H), 8.31 (d, J=2.2 Hz, 1H), 7.63 (d, J=4.8 Hz, 1H), 7.39 (dd, J=8.5, 2.2 Hz, 1H), 7.03 (d, J=8.5 Hz, 1H)

### Reference Production Example 32

To a mixture of 5.0 g of 4-chloro-3-trifluoromethylphenol and 20 ml of acetic acid, 1.5 ml of concentrated sulfuric acid and then 2.6 g of 69% nitric acid were added dropwise while ice-cooling. To the reaction mixture, 3 ml of concentrated sulfuric acid was added dropwise at room temperature, and stirred for three hours. The reaction mixture was poured into ice water, and extracted with ethyl acetate. The combined organic layers were washed with water, a saturated aqueous solution of sodium hydrogencarbonate and a saturated sodium chloride solution, dried over magnesium sulfate, and then concentrated under reduced pressure. The residue was subjected to silica gel column chromatography to give 2.3 g of 4-chloro-2-nitro-5-trifluoromethylphenol, 1.57 g of 4-chloro-2-nitro-3-trifluoromethylphenol.

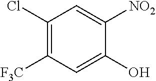

¹H-NMR (CDCl₃) δ: 10.43 (s, 1H), 8.27 (s, 1H), 7.57 (s, 1H)

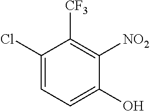

¹H-NMR (CDCl₃) δ: 7.53 (d, J=9.0 Hz, 1H), 7.24 (d, J=9.0 Hz, 1H)

A mixture of 2.3 g of 4-chloro-2-nitro 5-trifluoromethylphenol and 10 ml of ethyl acetate was added dropwise to a mixture, which was heated to 80° C., of 2.6 g of electrolytic iron, 10 ml of acetic acid and 20 ml of water, and then the reaction mixture was stirred for one hour. The mixture was cooled to room temperature, and then water was added, followed by extraction with ethyl acetate. The combined organic layers were washed with water, a saturated aqueous solution of sodium hydrogencarbonate and a saturated sodium chloride solution, dried over magnesium sulfate, and then concentrated under reduced pressure. The residue was subjected to silica gel column chromatography to give 1.7 g of 2-amino-4-chloro-5-trifluoromethylphenol.

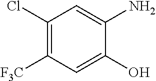

¹H-NMR (CDCl₃) δ: 6.99 (s, 1H), 6.77 (s, 1H), 5.01 (br s, 1H), 4.09 (br s, 2H)

A mixture of 0.70 g of 2-amino-4-chloro-5-trifluoromethylphenol, 0.79 g of WSC, 0.39 g of isonicotinic acid and 6 ml of pyridine was stirred while heating at 80° C. for three hours. The reaction mixture was cooled to room temperature, and then water was added, followed by extraction with ethyl acetate three times. The combined organic layers were washed with water and a saturated sodium chloride solution, dried over anhydrous magnesium sulfate, and then concentrated under reduced pressure. The residue was subjected to silica gel column chromatography to give 0.54 g of N-[5-chloro-2-hydroxy-4-trifluoromethylphenyl]isonicotinamide.

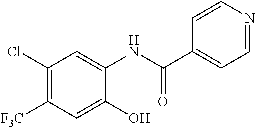

¹H-NMR (DMSO-d₆) δ: 10.08 (br s, 1H), 8.80 (dd, J=4.3, 1.7 Hz, 2H), 8.13 (s, 1H), 7.86 (dd, J=4.3, 1.7 Hz, 2H), 7.32 (s, 1H)

### Reference Production Example 33

A mixture of 0.60 g of 2-amino-4-chloro-5-trifluoromethylphenol, 0.43 g of 3-chloroisonicotinic acid, 0.67 g of WSC and 5 ml of pyridine was stirred while heating at 80° C. for three hours. The reaction mixture was cooled to room temperature, and then water was added, followed by extraction with ethyl acetate three times. The combined organic layers were washed with water and a saturated sodium chloride solution, dried anhydrous magnesium sulfate, and then concentrated under reduced pressure. The residue was subjected to silica gel column chromatography to give 0.67 g of 3-chloro-N-[5-chloro-2-hydroxy-4-trifluoromethylphenyl]isonicotinamide.

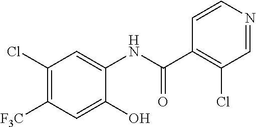

¹H-NMR (DMSO-d₆) δ: 8.75 (s, 1H), 8.64 (d, J=4.8 Hz, 1H), 8.36 (s, 1H), 7.62 (d, J=4.8 Hz, 1H), 7.28 (s, 1H)

### Reference Production Example 34

A mixture of 1.57 g of 4-chloro-2-nitro-3-trifluoromethylphenol and 5 ml of ethyl acetate was added dropwise to a mixture, which was heated to 80° C., of 1.8 g of electrolytic iron, 7 ml of acetic acid and 7 ml of water, which was stirred for 30 minutes. The mixture was cooled to room temperature, and then water was added, followed by extraction with ethyl acetate. The combined organic layers were washed with water, a saturated aqueous solution of sodium hydrogencarbonate and a saturated sodium chloride solution, dried over magnesium sulfate, and then concentrated under reduced pressure. The residue was subjected to silica gel column chromatography to give 1.1 g of 2-amino-4-chloro-3-trifluoromethylphenol.

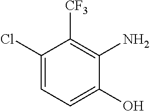

¹H-NMR (CDCl₃) δ: 6.72 (d, J=8.3 Hz, 1H), 6.68 (d, J=8.3 Hz, 1H), 5.48 (br s, 1H), 4.67 (br s, 2H)

A mixture of 0.75 g of 2-amino-4-chloro-3-trifluoromethylphenol, 0.84 g of WSC, 0.42 g of isonicotinic acid and 5 ml of pyridine was stirred while heating at 80° C. for three hours. To the reaction mixture, 0.1 g of isonicotinic acid was added, and the reaction mixture was stirred while heating for further three hours. The reaction mixture was cooled to room temperature, and then water was added, followed by extraction with ethyl acetate three times. The combined organic layers were washed with water and a saturated sodium chloride solution, dried over anhydrous magnesium sulfate, and then concentrated under reduced pressure. The residue was subjected to silica gel column chromatography to give 0.54 g of N-[3-chloro-6-hydroxy-2-trifluoromethylphenyl]isonicotinamide.

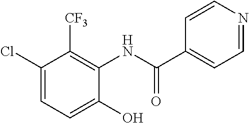

¹H-NMR (DMSO-d₆) δ: 10.47 (br s, 1H), 10.20 (br s, 1H), 8.80 (dd, J=4.6, 1.4 Hz, 2H), 7.85 (dd, J=4.6, 1.4 Hz, 2H), 7.51 (d, J=8.9 Hz, 1H), 7.22 (d, J=8.9 Hz, 1H)

### Reference Production Example 35

A mixture of 10 g of 2,4-dichloro-5-nitrobenzotrifluoride, 4.15 g of potassium acetate and 60 ml of DMF was stirred while heating at 60° C. for one hour and at 80° C. for three hours. To the reaction mixture, 4.15 g of potassium acetate was added. The reaction mixture was stirred while heating at 80° C. for further one hour. The reaction mixture was cooled to room temperature, and 1 M hydrochloric acid was added thereto, followed by extraction with ethyl acetate. The combined organic layers were washed with water and a saturated sodium chloride solution, dried over magnesium sulfate, and then concentrated under reduced pressure. The residue was subjected to silica gel column chromatography to give 7.55 g of 5-chloro-2-nitro-4-trifluoromethylphenol.

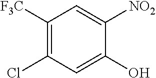

¹H-NMR (CDCl₃) δ: 10.81 (s, 1H), 8.49 (s, 1H), 7.37 (s, 1H)

A mixture of 7.55 g of 5-chloro-2-nitro-4-trifluoromethylphenol and 10 ml of ethyl acetate was added dropwise to a mixture, which was heated to 80° C., of 8.7 g of electrolytic iron, 30 ml of acetic acid and 50 ml of water, and then the reaction mixture was stirred at the same temperature for 30 minutes. The mixture was cooled to room temperature, and then water was added, followed by extraction with ethyl acetate. The combined organic layers were washed with water, a saturated aqueous solution of sodium hydrogencarbonate and a saturated sodium chloride solution, dried over magnesium sulfate, and then concentrated under reduced pressure. The residue was subjected to silica gel column chromatography to give 5.4 g of 2-amino-5-chloro-4-trifluoromethylphenol.

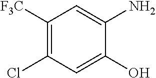

¹H-NMR (CDCl₃) δ: 7.03 (s, 1H), 6.84 (s, 1H), 5.93 (br s, 1H), 3.81 (br s, 2H)

A mixture of 1.2 g of 2-amino-5-chloro-4-trifluoromethylphenol, 1.35 g of WSC, 0.67 g of isonicotinic acid and 10 ml of pyridine was stirred while heating at 80° C. for three hours. The reaction mixture was cooled to room temperature, and then water was added, followed by extraction with ethyl acetate three times. The combined organic layers were washed with water and a saturated sodium chloride solution, dried over anhydrous magnesium sulfate, and then concentrated under reduced pressure. The residue was subjected to silica gel column chromatography to give 1.01 g of N-[4-chloro-2-hydroxy-5-trifluoromethylphenyl]isonicotinamide.

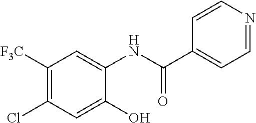

¹H-NMR (DMSO-d₆) δ: 10.03 (br s, 1H), 8.79 (dd, J=4.3, 1.7 Hz, 2H), 8.14 (s, 1H), 7.86 (dd, J=4.3, 1.7 Hz, 2H), 7.16 (s, 1H)

### Reference Production Example 36

A mixture of 0.50 g of 2-amino-5-chloro-4-trifluoromethylphenol, 0.36 g of 3-chloroisonicotinic acid, 0.56 g of WSC and 5 ml of pyridine was stirred while heating at 80° C. for three hours. The reaction mixture was cooled to room temperature, and then water was added, followed by extraction with ethyl acetate three times. The combined organic layers were washed with water and a saturated sodium chloride solution, dried over anhydrous magnesium sulfate, and then concentrated under reduced pressure. The residue was subjected to silica gel column chromatography to give 0.46 g of 3-chloro-N-[4-chloro-2-hydroxy-5-trifluoromethylphenyl]isonicotinamide.

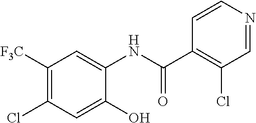

¹H-NMR (DMSO-d₆) δ: 10.32 (br s, 1H), 8.75 (s, 1H), 8.64 (d, J=4.8 Hz, 1H), 8.43 (s, 1H), 7.63 (d, J=4.8 Hz, 1H), 7.13 (s, 1H)

### Reference Production Example 37

A mixture of 0.68 g of 6-amino-1,1,3,3-tetrafluoro-5-hydroxy-1,3-dihydroisobenzofuran, 0.48 g of 3-chloroisonicotinic acid, 0.76 g of WSC and 7 ml of pyridine was stirred while heating at 80° C. for three hours. The reaction mixture was cooled to room temperature, and then water was added, followed by extraction with ethyl acetate three times. The combined organic layers were washed with water and a saturated sodium chloride solution, then dried over anhydrous magnesium sulfate, and then concentrated under reduced pressure. The residue was subjected to silica gel column chromatography to give 0.68 g of 3-chloro-N-(1,1,3,3-tetrafluoro-6-hydroxy-1,3-dihydroisobenzofuran-5-yl)isonicotinamide.

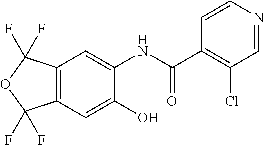

¹H-NMR (DMSO-d₆) δ: 10.47 (br s, 1H), 8.76 (s, 1H), 8.65 (d, J=4.6 Hz, 1H), 8.55 (s, 1H), 7.64 (d, J=4.8 Hz, 1H), 7.27 (s, 1H)

### Reference Production Example 38

A mixture of 1.5 g of 6-amino-1,1,3,3-tetrafluoro-5-hydroxy-1,3-dihydroisobenzofuran, 0.95 g of 3-fluoroisonicotinic acid, 1.68 g of WSC and 13 ml of pyridine was stirred while heating at 80° C. for two hours. The reaction mixture was cooled to room temperature, and then water was added, followed by extraction with ethyl acetate three times. The combined organic layers were washed with water and a saturated sodium chloride solution, dried over anhydrous magnesium sulfate, and then concentrated under reduced pressure. The residue was subjected to silica gel column chromatography to give 1.46 g of 3-fluoro-N-(1,1,3,3-tetrafluoro-6-hydroxy-1,3-dihydroisobenzofuran-5-yl)isonicotinamide.

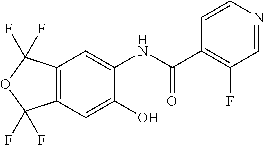

¹H-NMR (DMSO-d₆) δ: 10.21 (br s, 1H), 8.79-8.77 (m, 1H), 8.63-8.58 (m, 2H), 7.81-7.76 (m, 1H), 7.30 (s, 1H)

### Reference Production Example 39

A mixture of 2.0 g of 2-amino-5-chloro-4-trifluoromethylphenol, 1.33 g of 3-fluoroisonicotinic acid, 2.36 g of WSC and 15 ml of pyridine was stirred while heating at 80° C. for 3.5 hours. The reaction mixture was cooled to room temperature, and then water was added, followed by extraction with ethyl acetate three times. The combined organic layers were washed with water and a saturated sodium chloride solution, then dried over anhydrous magnesium sulfate, and then concentrated under reduced pressure. The residue was subjected to silica gel column chromatography to give 2.08 g of 3-fluoro-N-[4-chloro-2-hydroxy-5-trifluoromethylphenyl]isonicotinamide.

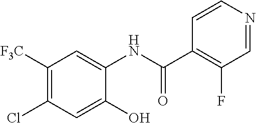

¹H-NMR (DMSO-d₆) δ: 11.57 (br s, 1H), 10.08 (br s, 1H), 8.77-8.75 (m, 1H), 8.61-8.58 (m, 1H), 8.48 (s, 1H), 7.78-7.73 (m, 1H), 7.15 (s, 1H)

### Reference Production Example 40

A mixture of 0.62 g of 3-ethyl isonicotinic acid 4 ml of thionyl chloride was heated to reflux for 2.5 hours. The reaction mixture was cooled to room temperature, the reaction mixture was concentrated under reduced pressure to give 3-ethyl isonicotinic acid chloride. A mixture of the resultant 3-ethyl isonicotinic acid chloride and 3 ml of DMF was added dropwise to a mixture of 0.87 g of 2-amino-5-chloro-4-trifluoromethylphenol, 0.83 g of triethylamine and 3 ml of DMF while ice-cooling. The reaction mixture was stirred at room temperature for two hours, and then water was added to the reaction mixture, followed by extraction with ethyl acetate twice. The combined organic layers were washed with water and a saturated sodium chloride solution, dried over anhydrous magnesium sulfate, and then concentrated under reduced pressure. The residue was subjected to silica gel column chromatography to give 0.23 g of N-[4-chloro-2-hydroxy-5-(trifluoromethyl)phenyl]-3-ethyl isonicotinamide.

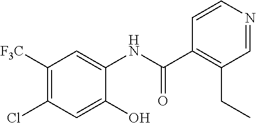

¹H-NMR (DMSO-d₆) δ: 9.98 (br s, 1H), 8.58-8.56 (m, 1H), 8.53 (d, J=4.8 Hz, 1H), 8.25 (s, 1H), 7.45 (d, J=4.9 Hz, 1H), 7.11 (s, 1H), 2.76 (q, J=7.6 Hz, 2H), 1.19 (t, J=7.6 Hz, 3H)

### Reference Production Example 41

A mixture of 0.69 g of 3-chloroisonicotinic acid, 5 ml of thionyl chloride and 30 mg of DMF was heated to reflux for 3.5 hours. The reaction mixture was cooled to room temperature, and then the reaction mixture was concentrated under reduced pressure to give 3-chloroisonicotinic acid chloride. A mixture of the resultant 3-chloroisonicotinic acid chloride and 4 ml of DMF was added dropwise to a mixture of 0.85 g of 2-amino-5-fluoro-4-trifluoromethylphenol, 0.88 g of triethylamine and 4 ml of DMF while ice-cooling. Thereafter, the reaction mixture was stirred at room temperature for one hour and at 50° C. for one hour. The reaction mixture was cooled to room temperature, and then water was added, followed by extraction with ethyl acetate twice. The combined organic layers wee washed with water and a saturated sodium chloride solution, then dried over anhydrous magnesium sulfate, and then concentrated under reduced pressure. The resultant solid was washed with diethyl ether to give 0.77 g of 3-chloro-N-[4-fluoro-2-hydroxy-5-(trifluoromethyl)phenyl]-isonicotinamide.

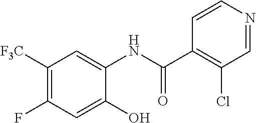

¹H-NMR (DMSO-d₆) δ: 10.20 (br s, 1H), 8.75 (s, 1H), 8.64 (d, J=4.8 Hz, 1H), 8.23 (d, J=8.5 Hz, 1H), 7.62 (d, J=4.8 Hz, 1H), 6.91-6.85 (m, 1H)

### Reference Production Example 42

3-chloro-N-[2-fluoro-6-hydroxy-3-(trifluoromethyl)phenyl]-isonicotinamide was obtained according to the same manner as that of Reference Production Example 41 using 2-amino-3-fluoro-4-trifluoromethylphenol instead of 2-amino-5-fluoro-4-trifluoromethylphenol.

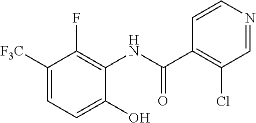

¹H-NMR (DMSO-d₆) δ: 11.15 (br s, 1H), 10.22 (br s, 1H), 8.79 (s, 1H), 8.67 (d, J=4.6 Hz, 1H), 7.62 (d, J=4.6 Hz, 1H), 7.58-7.52 (m, 1H), 6.92 (d, J=8.8 Hz, 1H)

### Reference Production Example 43

A mixture of 0.17 g of 2-amino-3-chloro-4-trifluoromethylphenol, 0.99 g of isonicotinic acid, 0.19 g of WSC and 3 ml of pyridine was stirred while heating at 80° C. for two hours. The mixture was cooled to room temperature, and then water was poured, followed by extraction with ethyl acetate three times. The combined organic layers were washed with water and a saturated sodium chloride solution, dried over anhydrous magnesium sulfate, and concentrated under reduced pressure. The residue was subjected to silica gel column chromatography to give 0.15 g of N-[2-chloro-6-hydroxy-3-(trifluoromethyl)phenyl]isonicotinamide.

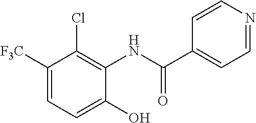

¹H-NMR (DMSO-d₆) δ: 10.98 (br s, 1H), 10.24 (br s, 1H), 8.82-8.79 (m, 2H), 7.94-7.85 (m, 2H), 7.67 (d, J=8.8 Hz, 1H), 7.06 (d, J=8.9 Hz, 1H)

### Reference Production Example 44

3-ethyl-N-(1,1,3,3-tetrafluoro-6-hydroxy-1,3-dihydroisobenzofuran-5-yl)isonicotinamide was obtained according to the same manner as that of Reference Production Example 40 using 6-amino-1,1,3,3-tetrafluoro-5-hydroxy-1,3-dihydroisobenzofuran instead of 2-amino-5-chloro-4-trifluoromethylphenol.

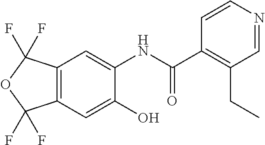

¹H-NMR (DMSO-d₆) δ: 10.10 (br s, 1H), 8.60-8.58 (m, 1H), 8.54 (d, J=4.9 Hz, 1H), 8.44 (s, 1H), 7.45 (d, J=4.9 Hz, 1H), 7.26 (s, 1H), 2.77 (q, J=7.6 Hz, 2H), 1.20 (t, J=7.6 Hz, 3H)

### Reference Production Example 45

A mixture of 1.5 g of 3-fluoroisonicotinic acid, 5 ml of thionyl chloride and 50 mg of DMF was heated to reflux for two hours. The reaction mixture was cooled to room temperature, and then the reaction mixture was concentrated under reduced pressure to give 3-fluoroisonicotinic acid chloride. A mixture of the resultant 3-fluoroisonicotinic acid chloride and 5 ml of DMF was added dropwise to a mixture of 1.76 g of 2-amino-4-tert-butylphenol, 2.18 g of triethylamine and 10 ml of DMF while ice-cooling. The reaction mixture was stirred at room temperature for 1.5 hours and at 50° C. for 30 minutes. The reaction mixture was cooled to room temperature, and then water was added. Precipitated crystals were collected by filtration. The resultant crystals were dissolved in ethyl acetate, washed with water and a saturated sodium chloride solution, dried over anhydrous magnesium sulfate, concentrated under reduced pressure to give 2.41 g of N-(5-tert-butyl-2-hydroxyphenyl)-3-fluoroisonicotinamide.

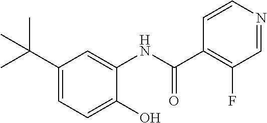

¹H-NMR (DMSO-d₆) δ: 9.73 (br s, 1H), 8.76-8.74 (m, 1H), 8.61-8.58 (m, 1H), 7.99 (d, J=2.4 Hz, 1H), 7.80-7.76 (m, 1H), 7.06 (dd, J=8.5, 2.4 Hz, 1H), 6.84 (d, J=8.5 Hz, 1H), 1.26 (s, 9H)

### Reference Production Example 46

N-(5-tert-butyl-2-hydroxyphenyl)-3-ethyl isonicotinamide was obtained according to the same manner as that of Reference Production Example 40 using 2-amino-4-tert-butylphenol instead of 2-amino-5-chloro-4-trifluoromethylphenol.

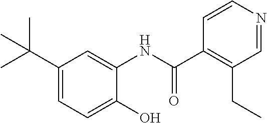

¹H-NMR (DMSO-d₆) δ: 9.66 (br s, 1H), 9.51 (br s, 1H), 8.58-8.56 (m, 1H), 8.52 (d, J=4.9 Hz, 1H), 7.65 (d, J=2.4 Hz, 1H), 7.45 (d, J=4.9 Hz, 1H), 7.07 (dd, J=8.5, 2.4 Hz, 1H), 6.83 (d, J=8.5 Hz, 1H), 2.79 (q, J=7.6 Hz, 2H), 1.21 (t, J=7.6 Hz, 3H)

### Reference Production Example 47

A mixture of 0.66 g of 2-chloro-5-trifluoromethyl isonicotinic acid and 4 ml of thionyl chloride was heated to reflux for 2.5 hours. The reaction mixture was cooled to room temperature, and concentrated under reduced pressure to give 2-chloro-5-trifluoromethyl isonicotinic acid chloride. A mixture of the resultant 2-chloro-5-trifluoromethyl isonicotinic acid chloride and 4 ml of DMF was added dropwise to a mixture of 0.48 g of 2-amino-4-tert-butylphenol, 0.59 g of triethylamine and 4 ml of DMF while ice-cooling. The reaction mixture was stirred at room temperature for one hour, and stirred while heating at 50° C. for one hour. The mixture was cooled to room temperature, and water was added to the reaction mixture, followed by extraction with ethyl acetate twice. The combined organic layers were washed with water and a saturated sodium chloride solution, dried over anhydrous magnesium sulfate, and concentrated under reduced pressure.

The residue was subjected to silica gel column chromatography to give 0.75 g of N-(5-tert-butyl-2-hydroxyphenyl)-2-chloro-5-trifluoromethylisonicotinamide.

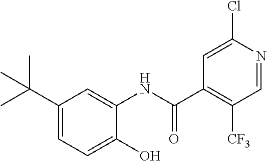

¹H-NMR (DMSO-d₆) δ: 8.92 (s, 1H), 7.98 (s, 1H), 7.84 (d, J=2.4 Hz, 1H), 7.06 (dd, J=8.5, 2.4 Hz, 1H), 6.83 (d, J=8.5 Hz, 1H), 1.25 (s, 9H)

### Reference Production Example 48

A mixture of 0.35 g of 2-amino-4-trifluoromethoxy phenol, 0.29 g of 3-chloroisonicotinic acid, 1.04 g of (benzotriazole-1-yloxy)tris(dimethylamino)phosphonium hexafluorophosphate (hereinafter, referred to as a BOP reagent), 0.24 g of triethylamine and 5 ml of DMF was stirred at room temperature for two hours. Water was added to the reaction mixture, precipitated solid was collected by filtration. The resultant solid was dissolved in ethyl acetate. Then, the organic layer was washed with a saturated sodium chloride solution, dried over anhydrous magnesium sulfate, and concentrated under reduced pressure.

The residue was subjected to silica gel column chromatography to give 0.43 g of 3-chloro-N-[2-hydroxy-5-(trifluoromethoxy)phenyl]isonicotinamide.

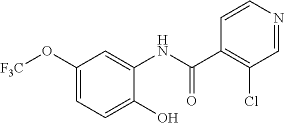

¹H-NMR (DMSO-d₆) δ: 10.37 (br s, 1H), 10.15 (br s, 1H), 8.75-8.73 (m, 1H), 8.64-8.61 (m, 1H), 8.04-8.01 (m, 1H), 7.63-7.60 (m, 1H), 7.07-7.02 (m, 1H), 6.98-6.94 (m, 1H)

### Reference Production Example 49

A mixture of 0.72 g of 3-trifluoromethyl isonicotinic acid and 4 ml of thionyl chloride was heated to reflux for 1.5 hours. The reaction mixture was cooled to room temperature, and the reaction mixture was concentrated under reduced pressure to give 3-trifluoromethyl isonicotinic acid chloride. A mixture of the resultant 3-trifluoromethyl isonicotinic acid chloride and 4 ml of DMF was added dropwise to a mixture of 0.66 g of 2-amino-4-trifluoromethylphenol, 0.76 g of triethylamine, 4 ml of DMF while ice-cooling. The reaction mixture was stirred at room temperature for one hour and stirred while heating at 50° C. for 2.5 hours. The reaction mixture was cooled to room temperature, and then water was added to the reaction mixture, followed by extraction with ethyl acetate twice. The combined organic layers were washed with water and a saturated sodium chloride solution, dried over anhydrous magnesium sulfate, and concentrated under reduced pressure.

The residue was washed with diethyl ether to give 0.62 g of N-[2-hydroxy-5-(trifluoromethyl)phenyl]-3-(trifluoromethyl)isonicotinamide.

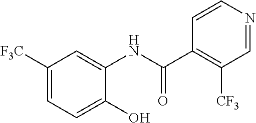

¹H-NMR (DMSO-d₆) δ: 9.06-9.04 (m, 1H), 8.98 (d, J=5.1 Hz, 1H), 8.28-8.25 (m, 1H), 7.74 (d, J=4.9 Hz, 1H), 7.41-7.37 (m, 1H), 7.06 (d, J=8.8 Hz, 1H)

### Reference Production Example 50

To a mixture of 10.0 g of 3-hydroxymethylpyridine and 200 ml of THF, 3.7 g of 60% sodium hydride (in oil) was added in small portions at room temperature and then stirred for 15 minutes. To the reaction mixture, 13.0 g of methyl iodide was added dropwise, and the reaction mixture was stirred at room temperature for three hours. To the reaction mixture, 25 ml of water was added. Then, the reaction mixture was concentrated under reduced pressure. To the residue, 25 ml of water was added, followed by extraction with ethyl acetate three times. The combined organic layers were washed with a saturated sodium chloride solution, dried over anhydrous magnesium sulfate, and concentrated under reduced pressure. The residue was subjected to silica gel column chromatography to give 8.17 g of 3-methoxymethylpyridine.

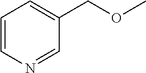

¹H-NMR (CDCl₃) δ: 8.59-8.57 (m, 1H), 8.56-8.54 (m, 1H), 7.70-7.66 (m, 1H), 7.31-7.27 (m, 1H), 4.47 (s, 2H), 3.41 (s, 3H)

### Reference Production Example 51

A mixture of 7.74 g of 3-methoxymethylpyridine, 60 ml of acetic acid and 7.5 g of 30% hydrogen peroxide solution was stirred while heating at 80° C. for four hours. The reaction mixture was cooled to room temperature, and then sodium carbonate was added in small portions. The reaction mixture was subjected to filtration, and washed with ethyl acetate. The resultant filtrate was washed with a saturated aqueous solution of sodium hydrogensulfite and a saturated sodium chloride solution, and dried over anhydrous sodium carbonate. Activated carbon was added, followed by filtration through Celite™. The filtrate was concentrated under reduced pressure to give 2.66 g of 3-methoxymethylpyridine N-oxide.

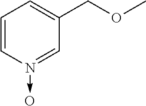

¹H-NMR (CDCl₃) δ: 8.24-8.21 (m, 1H), 8.16-8.13 (m, 1H), 7.29-7.22 (m, 2H), 4.43 (s, 2H), 3.43 (s, 3H)

### Reference Production Example 52

A mixture of 2.66 g of 3-methoxymethylpyridine N-oxide and 9.0 g of iodoethane was stirred while heating at 60° C. for one hour. The reaction mixture was cooled to room temperature, diethyl ether was added thereto. Precipitated crystals were collected by filtration. To a mixture of the resultant solid and 20 ml of water, a mixture of 1.80 g of sodium cyanide and 7 ml of water was added dropwise at 50° C., and the reaction mixture was stirred while heating at the same temperature for one hour. The reaction mixture was cooled to room temperature, followed by extraction with diethyl ether three times. The combined organic layers were washed with a saturated sodium chloride solution, dried over anhydrous magnesium sulfate, and concentrated under reduced pressure. The residue was subjected to silica gel column chromatography to give 0.89 g of 3-methoxymethyl isonicotinonitrile.

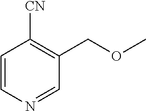

¹H-NMR (CDCl₃) δ: 8.86 (d, J=0.7 Hz, 1H), 8.73 (d, J=4.9 Hz, 1H), 7.53 (dd, J=4.9, 0.7 Hz, 1H), 4.66 (s, 2H), 3.51 (s, 3H)

### Reference Production Example 53

A mixture of 0.89 g of 3-methoxymethyl isonicotinonitrile, 0.72 g of sodium hydroxide, 6 ml of ethanol and 6 ml of water was heated to reflux for three hours. The reaction mixture was cooled to room temperature, and concentrated under reduced pressure. 3 Mhydrochloric acid was added so that pH of the resultant residue became about 3. The reaction mixture was concentrated under reduced pressure. To the resultant solid, 40 ml of ethanol was added. The mixture was heated to reflux for five minutes, and subjected to hot filtration. The solid collected by filtration was subjected to the same operation twice by using 40 ml each of ethanol. Combined filtrates were concentrated to give 1.0 g of 3-methoxy isonicotinic acid.

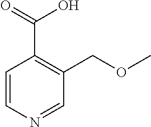

¹H-NMR (DMSO-d₆) δ: 8.77-8.75 (m, 1H), 8.67 (d, J=5.1 Hz, 1H), 7.72-7.69 (m, 1H), 4.75 (s, 2H), 3.35 (s, 3H)

### Reference Production Example 54

A mixture of 0.40 g of 2-amino-4-(trifluoromethyl)phenol, 0.38 g of 3-methoxymethyl isonicotinic acid, 1.30 g of BOP reagent, 0.30 g of triethylamine, and 20 ml of DMF was stirred at room temperature for four hours. Water was added to the reaction mixture, and the reaction mixture was extracted with ethyl acetate twice. The combined organic layers were washed with a saturated sodium chloride solution, dried over anhydrous magnesium sulfate, and concentrated under reduced pressure. The residue was subjected to silica gel column chromatography to give 0.64 g of N-[2-hydroxy-5-(trifluoromethyl)phenyl]-3(methoxymethyl)isonicotinamide.

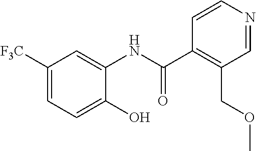

¹H-NMR (DMSO-d₆) δ: 10.89 (br s, 1H), 10.00 (br s, 1H), 8.70 (s, 1H), 8.69 (d, J=4.9 Hz, 1H), 8.32-8.30 (m, 1H), 7.60 (d, J=4.9 Hz, 1H), 7.42-7.38 (m, 1H), 7.08 (d, J=8.5 Hz, 1H), 4.63 (s, 2H), 3.33 (s, 3H)

### Reference Production Example 55

A mixture of 3.13 g of 2-hydroxy-3-nitro-5-trifluoromethylpyridine, 40 ml of methanol and 0.85 g of 5% palladium on carbon was stirred under about one atmosphere of hydrogen at room temperature for two hours. The reaction mixture was filtered through Celite™. The filtrate was concentrated under reduced pressure to give 2.66 g of 3-amino-2-hydroxy-5-trifluoromethylpyridine.

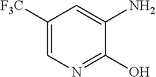

¹H-NMR (DMSO-d₆) δ: 11.83 (br s, 1H), 7.11-7.08 (m, 1H), 6.49-6.48 (m, 1H), 5.50 (br s, 2H)

### Reference Production Example 56

A mixture of 1.0 g of 3-amino-2-hydroxy-5-trifluoromethylpyridine, 0.69 g of isonicotinic acid, 1.40 g of WSC and 7 ml of pyridine was stirred while heating at 80° C. for two hours. The reaction mixture was cooled to room temperature, and then water was added to the reaction mixture, followed by extraction with ethyl acetate three times. The combined organic layers were washed with water and a saturated sodium chloride solution, dried over anhydrous magnesium sulfate, and concentrated under reduced pressure. The residue was subjected to silica gel column chromatography to give 1.22 g of N-[2-hydroxy-5-(trifluoromethyl)pyridin-3-yl]isonicotinamide.

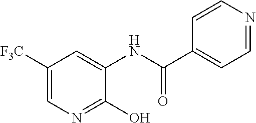

¹H-NMR (DMSO-d₆) δ: 12.76 (br s, 1H), 9.76 (s, 1H), 8.79 (dd, J=4.5, 1.6 Hz, 2H), 8.44 (d, J=2.4 Hz, 1H), 7.85-7.81 (m, 3H)

### Reference Production Example 57

A mixture of 0.88 g of 3-chloroisonicotinic acid, 5 ml of thionyl chloride and 20 mg of DMF was heated to reflux for three hours. After the reaction mixture was cooled to room temperature, it was concentrated under reduced pressure to give 3-chloroisonicotinic acid chloride. The resultant 3-chloroisonicotinic acid chloride and 4 ml of DMF was added dropwise to a mixture of 1.0 g of 3-amino-2-hydroxy-5-trifluoromethylpyridine, 1.14 g of triethylamine and 8 ml of DMF while ice-cooling. The reaction mixture was stirred at room temperature for one hour, and then stirred while heating at 50° C. for 30 minutes. The reaction mixture was cooled to room temperature, and then water was added to the reaction mixture, followed by extraction with ethyl acetate twice. The combined organic layers were washed with water and a saturated sodium chloride solution, dried over anhydrous magnesium sulfate, and concentrated under reduced pressure. The residue was subjected to silica gel column chromatography to give 0.87 g of 3-chloro-N-[2-hydroxy-5-(trifluoromethyl)pyridin-3-yl]isonicotinamide.

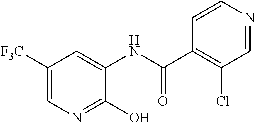

¹H-NMR (CDCl₃) δ: 12.59 (br s, 1H), 9.18 (br s, 1H), 8.85-8.83 (m, 1H), 8.77 (s, 1H), 8.69 (d, J=4.9 Hz, 1H), 7.69 (d, J=4.9 Hz, 1H), 7.55-7.53 (m, 1H)

### Reference Production Example 58

3-fluoro-N-[2-hydroxy-5-(trifluoromethyl)pyridin-3-yl] isonicotinamide was obtained according to the same manner as that of Reference Production Example 57 using 3-fluoroisonicotinic acid instead of 3-chloroisonicotinic acid.

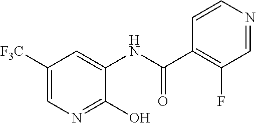

¹H-NMR (DMSO-d₆) δ: 12.78 (br s, 1H), 10.10 (d, J=5.6 Hz, 1H), 8.78 (d, J=2.2 Hz, 1H), 8.61 (d, J=4.8 Hz, 1H), 8.53 (d, J=2.4 Hz, 1H), 7.84-7.82 (m, 1H), 7.80-7.77 (m, 1H)

### Reference Production Example 59

N-[2-hydroxy-5-(trifluoromethyl)pyridin-3-yl]-3-methylisonicotinamide was obtained according to the same manner as that of Reference Production Example 578 using methyl isonicotinic acid instead of 3-chloroisonicotinic acid.

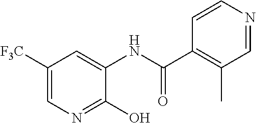

¹H-NMR (CDCl₃) δ: 12.79 (br s, 1H), 8.81-8.79 (m, 1H), 8.73-8.70 (m, 1H), 8.63-8.60 (m, 2H), 7.56-7.54 (m, 1H), 7.43-7.41 (m, 1H), 2.53 (s, 3H)

### Reference Production Example 60

3-ethyl-N-[2-hydroxy-5-(trifluoromethyl)pyridin-3-yl]isonicotinamide was obtained according to the same manner as that of Reference Production Example 57 using 3-ethyl isonicotinic acid instead of 3-chloroisonicotinic acid.

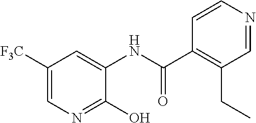

¹H-NMR (DMSO-d₆) δ: 12.67 (br s, 1H), 9.87 (br s, 1H), 8.57 (s, 1H), 8.52 (d, J=4.8 Hz, 1H), 8.45 (d, J=2.4 Hz, 1H), 7.82-7.79 (m, 1H), 7.41 (d, J=4.8 Hz, 1H), 2.73 (q, J=7.6 Hz, 2H), 1.18 (t, J=7.6 Hz, 3H)

### Reference Production Example 61

N-(2-hydroxy-5-trifluoromethylpyridin-3-yl)-3-trifluoromethylisonicotinamide was obtained according to the same manner as that of Reference Production Example 57 using 3-trifluoromethyl isonicotinic acid instead of 3-chloroisonicotinic acid.

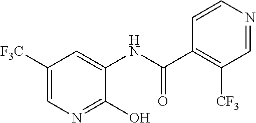

¹H-NMR (DMSO-d₆) δ: 12.67 (br s, 1H), 10.54 (br s, 1H), 9.02 (s, 1H), 8.95 (d, J=5.1 Hz, 1H), 8.48 (d, J=2.7 Hz, 1H), 7.83-7.80 (m, 1H), 7.69 (d, J=5.1 Hz, 1H)

### Reference Production Example 62

A mixture of 1.73 g of 3-methoxyisonicotinonitrile, 1.03 g of sodium hydroxide and 20 ml of ethanol was heated to reflux for 20 hours. The mixture was cooled to room temperature, and then concentrated under reduced pressure. 3 M hydrochloric acid was added so that pH of the resultant residue became about 3, and the residue was concentrated under reduced pressure again. To the resultant solid, 40 ml of ethanol was added. The reaction mixture was heated to reflux for five minutes, and subjected to hot filtration. The solid collected by filtration was subjected to the same operation twice by using 40 ml each of ethanol. The combined filtrates were concentrated to give 1.97 g of 3-methoxy isonicotinic acid.

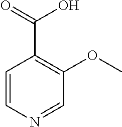

¹H-NMR (DMSO-d₆) δ: 8.55 (s, 1H), 8.30 (d, J=4.9 Hz, 1H), 7.53 (d, J=4.7 Hz, 1H), 3.94 (s, 3H)

### Reference Production Example 63

N-[2-hydroxy-5-(trifluoromethyl)pyridin-3-yl]-3-methoxyisonicotinamide was obtained according to the same manner as that of Reference Production Example 57 using 3-methoxy isonicotinic acid instead of 3-chloroisonicotinic acid.

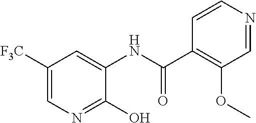

¹H-NMR (DMSO-d₆) δ: 12.74 (br s, 1H), 10.83 (br s, 1H), 8.73 (s, 1H), 8.57-8.55 (m, 1H), 8.44 (d, J=4.9 Hz, 1H), 7.89 (d, J=4.9 Hz, 1H), 7.81-7.77 (m, 1H), 4.18 (s, 3H)

### Reference Production Example 64

To a mixture of 2.0 g of 3-chloroisonicotinonitrile and 8 ml of DMF, 1.02 g of sodium thiomethoxide was added while ice-cooling. The reaction mixture was stirred at 0° C. for one hour. The reaction mixture was concentrated under reduced pressure, to which ethyl acetate was added for filtering out insoluble matters. Filtrates were concentrated under reduced pressure, and the resultant residue was subjected to silica gel column chromatography to give 2.11 g of 3-methylthioisonicotinonitrile.

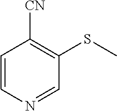

¹H-NMR (CDCl₃) δ: 8.65 (s, 1H), 8.53 (d, J=5.1 Hz, 1H), 7.46-7.44 (m, 1H), 2.66 (s, 3H)

### Reference Production Example 65

3-methylthioisonicotinic acid was obtained according to the same manner as that of Reference Production Example 62 using 3-methylthioisonicotinonitrile instead of 3-methoxyisonicotinonitrile.

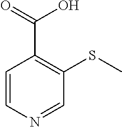

¹H-NMR (DMSO-d₆) δ: 13.73 (br s, 1H), 8.62 (s, 1H), 8.46 (d, J=5.1 Hz, 1H), 7.70 (d, J=5.0 Hz, 1H), 2.54 (s, 3H)

### Reference Production Example 66

N-[2-hydroxy-5-(trifluoromethyl)pyridin-3-yl]-3-methylthio isonicotinamide was obtained according to the same manner as that of Reference Production Example 57 using 3-methylthioisonicotinic acid instead of 3-chloroisonicotinic acid.

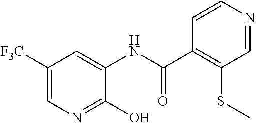

¹H-NMR (DMSO-d₆) δ: 12.68 (br s, 1H), 10.00 (br s, 1H), 8.65 (s, 1H), 8.49 (d, J=4.9 Hz, 1H), 8.47-8.45 (m, 1H), 7.82-7.78 (m, 1H), 7.50-7.48 (m, 1H), 2.55 (s, 3H)

### Reference Production Example 67

3-ethylthioisonicotinonitrile was obtained according to the same manner as that of Reference Production Example 64 using sodium thioethoxide instead of sodium thiomethoxide.

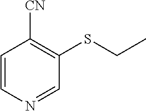

¹H-NMR (CDCl₃) δ: 8.73 (s, 1H), 8.56 (d, J=4.8 Hz, 1H), 7.47 (d, J=4.8 Hz, 1H), 3.13 (q, J=7.2 Hz, 2H), 1.39 (t, J=7.3 Hz, 3H)

### Reference Production Example 68

3-ethylthio isonicotinic acid was obtained according to the same manner as that of Reference Production Example 62 using 3-ethylthioisonicotinonitrile instead of 3-methoxyisonicotinonitrile.

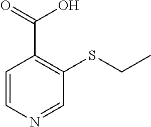

¹H-NMR (DMSO-d₆) δ: 13.72 (br s, 1H), 8.65 (s, 1H), 8.45 (d, J=5.1 Hz, 1H), 7.67 (d, J=5.0 Hz, 1H), 3.09 (q, J=7.3 Hz, 2H), 1.27 (t, J=7.4 Hz, 3H)

### Reference Production Example 69

N-[2-hydroxy-5-(trifluoromethyl)pyridin-3-yl]-3-ethylthio isonicotinamide was obtained according to the same manner as that of Reference Production Example 57 using 3-ethylthio isonicotinic acid instead of 3-chloroisonicotinic acid.

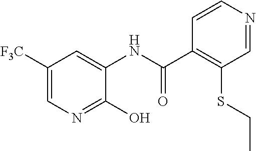

¹H-NMR (DMSO-d₆) δ: 12.67 (br s, 1H), 10.11 (br s, 1H), 8.70 (s, 1H), 8.52 (d, J=4.9 Hz, 1H), 8.49-8.47 (m, 1H), 7.82-7.79 (m, 1H), 7.50 (d, J=5.0 Hz, 1H), 3.04 (q, J=7.4 Hz, 2H), 1.21 (t, J=7.3 Hz, 3H)

### Reference Production Example 70

A mixture of 0.51 g of 3-amino-2-hydroxy-5-trifluoromethylpyridine, 0.48 g of 3-methoxymethyl isonicotinic acid, 1.65 g of BOP reagent, 0.38 g of triethylamine and 6 ml of DMF was stirred at room temperature for one hour, and further stirred while heating at 50° C. for two hours. Water was added to the reaction mixture, followed by extraction with ethyl acetate twice. The combined organic layers were washed with a saturated sodium chloride solution, dried over anhydrous magnesium sulfate, and concentrated under reduced pressure.

The residue was subjected to silica gel column chromatography to give 0.58 g of N-[2-hydroxy-5-(trifluoromethyl)pyridin-3-yl]-3-(methoxymethyl)isonicotinamide.

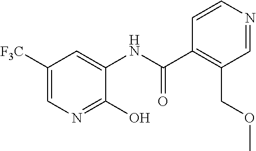

¹H-NMR (DMSO-d₆) δ: 12.67 (br s, 1H), 10.18 (br s, 1H), 8.71-8.67 (m, 2H), 8.54-8.51 (m, 1H), 7.80 (s, 1H), 7.58 (d, J=4.8 Hz, 1H), 4.58 (s, 2H), 3.33 (s, 3H)

### Reference Production Example 71

To a mixture of 0.80 g of 3-amino-2-hydroxy-6-trifluoromethylpyridine, 1.14 g of triethylamine and 10 ml of DMF, 0.88 g of isonicotinic acid chloride hydrochloride was added while ice-cooling. The reaction mixture was stirred at room temperature for one hour and further stirred while heating at 50° C. for one hour. To the reaction mixture, 0.88 g of isonicotinic acid chloride hydrochloride and 1.1 g of triethylamine were added, and the reaction mixture was stirred while heating at 50° C. for further 1.5 hours. The reaction mixture was cooled to room temperature, and water was added to the reaction mixture. Precipitated crystals were collected by filtration. The resultant solid was dissolved in ethyl acetate, then washed with a saturated sodium chloride solution, dried over anhydrous magnesium sulfate, and concentrated under reduced pressure. The residue was subjected to silica gel column chromatography to give 0.91 g of N-[2-hydroxy-6-(trifluoromethyl)pyridin-3-yl]-isonicotinamide.

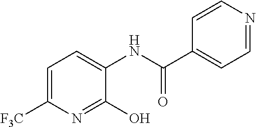

¹H-NMR (DMSO-d₆) δ: 9.98 (br s, 1H), 8.79 (dd, J=4.4, 1.5 Hz, 2H), 8.39 (d, J=7.8 Hz, 1H), 7.85 (dd, J=4.5, 1.6 Hz, 2H), 7.40-7.19 (m, 1H)

### Reference Production Example 72

N-[2-hydroxy-6-(trifluoromethyl)pyridin-3-yl]-3-chloroisonicotinamide was obtained according to the same manner as that of Reference Production Example 57 using 3-amino-2-hydroxy-6-trifluoromethylpyridine instead of 3-amino-2-hydroxy-5-trifluoromethylpyridine.

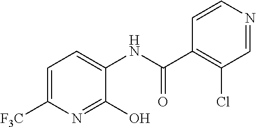

¹H-NMR (DMSO-d₆) δ: 10.47 (br s, 1H), 8.74 (s, 1H), 8.63 (d, J=4.9 Hz, 1H), 8.57 (s, 1H), 7.60 (d, J=4.8 Hz, 1H), 7.51-7.31 (m, 1H)

### Reference Production Example 73

2-amino-6-methylpyridin-3-ol was obtained according to the same manner as that of Reference Production Example 1 using 6-methyl-2-nitropyridin-3-ol instead of 4-propyl-2-nitrophenol.

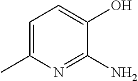

¹H-NMR (DMSO-d₆) δ: 9.11 (br s, 1H), 6.71 (d, J=7.5 Hz, 1H), 6.21 (d, J=7.5 Hz, 1H), 5.30 (br s, 2H), 2.14 (s, 3H)

### Reference Production Example 74

A mixture of 0.59 g of 60% sodium hydride (in oil) and 5 ml of DMF was stirred while ice-cooling. To the reaction mixture, 1.59 g of benzyl alcohol was added. The reaction mixture was stirred at the same temperature for 10 minutes. To the reaction mixture, 2.0 g of 3-chloroisonicotinonitrile was added, and the reaction mixture was stirred at the same temperature for 30 minutes and at room temperature for 1.5 hours. The reaction mixture was concentrated under reduced pressure, and then to ethyl acetate was added to the reaction mixture, followed by filtration of insoluble matters. The filtrate was concentrated under reduced pressure and the resultant residue was subjected to silica gel column chromatography to give 2.64 g of 3-benzyloxy isonicotinonitrile.

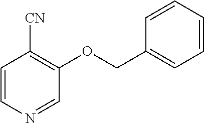

¹H-NMR (CDCl₃) δ: 8.52 (s, 1H), 8.36 (d, J=4.6 Hz, 1H), 7.48-7.33 (m, 6H), 5.33 (s, 2H)

### Reference Production Example 75

3-benzyloxy isonicotinic acid was obtained according to the same manner as that of Reference Production Example 62 using 3-benzyloxy isonicotinonitrile instead of 3-methoxy isonicotinonitrile.

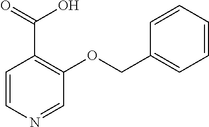

¹H-NMR (DMSO-d₆) δ: 13.41 (br s, 1H), 8.59 (s, 1H), 8.29 (d, J=4.6 Hz, 1H), 7.53 (d, J=4.6 Hz, 1H), 7.51-7.46 (m, 2H), 7.44-7.37 (m, 2H), 7.36-7.30 (m, 1H), 5.34 (s, 2H)

### Reference Production Example 76

3-benzyloxy-N-[2-hydroxy-5-(trifluoromethyl)pyridin-3-yl]-isonicotinamide was obtained according to the same manner as that of Reference Production Example 70 using 3-benzyloxy isonicotinic acid instead of 3-methoxymethyl isonicotinic acid.

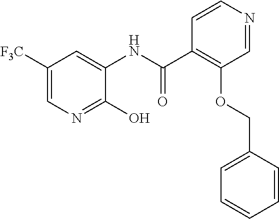

¹H-NMR (DMSO-d₆) δ: 12.76 (br s, 1H), 10.80 (br s, 1H), 8.76 (s, 1H), 8.57-8.55 (m, 1H), 8.38 (d, J=4.9 Hz, 1H), 7.85 (d, J=4.9 Hz, 1H), 7.79 (s, 1H), 7.63-7.58 (m, 2H), 7.41-7.29 (m, 3H), 5.61 (s, 2H)

### Reference Production Example 77

A mixture of 10.0 g of 3-ethylpyridine, 60 ml of acetic acid and 12 ml of 30% hydrogen peroxide solution was stirred while heating at 80° C. for 2.5 hours. To the reaction mixture, 7 ml of 30% hydrogen peroxide solution was added, and the reaction mixture was stirred while heating at 80° C. for further seven hours. The reaction mixture was cooled to room temperature, and sodium carbonate was added to the reaction mixture in small portions.

The reaction mixture was filtered, and washed with ethyl acetate. The resultant filtrate was washed with a saturated aqueous solution of sodium hydrogensulfite and a saturated sodium chloride solution, dried over anhydrous water sodium carbonate. Activated carbon was added, followed by filtration through Celite™. The filtrate was concentrated under reduced pressure to give 6.0 g of 3-ethylpyridine N-oxide.

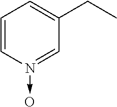

¹H-NMR (CDCl₃) δ: 8.12 (s, 1H), 8.10-8.08 (m, 1H), 7.23-7.18 (m, 1H), 7.16-7.12 (m, 1H), 2.64 (q, J=7.6 Hz, 2H), 1.26 (t, J=7.7 Hz, 3H)

### Reference Production Example 78

A mixture of 6.0 g of 3-ethylpyridine N-oxide and 23 g of iodoethane was stirred while heating at 60° C. for one hour. The reaction mixture was cooled to room temperature, and diethyl ether was added. Precipitated crystal was collected by filtration. To a mixture of the resultant solid and 55 ml of water, a mixture of 4.46 g of sodium cyanide and 16 ml of water 16 ml was added dropwise at 50° C., and stirred while heating at the same temperature for one hour. The reaction mixture was cooled to room temperature, followed by extraction with diethyl ether three times. The combined organic layers were washed with a saturated sodium chloride solution, dried over anhydrous magnesium sulfate, and concentrated under reduced pressure. The residue was subjected to silica gel column chromatography to give 2.7 g of 3-ethyl isonicotinonitrile.

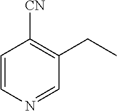

¹H-NMR (CDCl₃) δ: 8.69 (s, 1H), 8.61 (d, J=4.9 Hz, 1H), 7.48-7.46 (m, 1H), 2.90 (q, J=7.6 Hz, 2H), 1.35 (t, J=7.6 Hz, 3H)

### Reference Production Example 79

A mixture of 2.7 g of 3-ethyl isonicotinonitrile, 1.63 g of sodium hydroxide, 20 ml of ethanol and 20 ml of water was heated to reflux for five hours. The reaction mixture was cooled to room temperature, and concentrated under reduced pressure. 3 M hydrochloric acid was added so that pH of the resultant residue became about 3, which was concentrated under reduced pressure again. To the resultant solid, 50 ml of ethanol was added and heated to reflux for five minutes, followed by hot filtration. To the solid collected by filtration, the same operation was carried out by using 50 ml each of ethanol. Combined filtrates were concentrated to give 2.49 g of 3-ethyl isonicotinic acid.

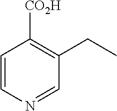

¹H-NMR (DMSO-d₆) δ: 13.58 (br s, 1H), 8.59 (s, 1H), 8.54 (d, J=5.0 Hz, 1H), 7.60 (d, J=5.0 Hz, 1H), 2.89 (q, J=7.5 Hz, 2H), 1.17 (t, J=7.4 Hz, 3H)

### Reference Production Example 80

To a mixture of 1.39 g of 3-chloro-isonicotinonitrile, 1.10 g of 2,2,2-trifluoroethanol and 5 mL of DMF, 0.40 g of 60% sodium hydride (oily) was added under ice cooling, followed by stirring for 20 minutes, heating to room temperature and further stirring for 7.5 hours. After ice cooling again, 0.20 g of 60% sodium hydride (oily) was added, followed by heating to room temperature and further stirring for 15 hours. Under ice cooling, water was added and the precipitated crystal was washed with water, collected by filtration and then dried under reduced pressure to obtain 1.63 g of 3-(2,2,2-trifluoroethoxy)-isonicotinonitrile.

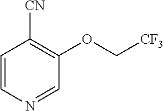

¹H-NMR (CDCl₃) δ: 8.53-8.52 (br m, 1H), 8.51 (d, J=4.9 Hz, 1H), 7.53 (dd, J=4.9, 0.6 Hz, 1H), 4.62 (q, J=7.7 Hz, 2H)

A mixture of 1.50 g of 3-(2,2,2-trifluoroethoxy)-isonicotinonitrile, 22 ml of ethanol and 11 mL of an aqueous 2 N sodium hydroxide solution was stirred at room temperature for 14 hours. Thereafter, the mixture was heated under reflux for 2 hours. After cooling to room temperature, water was added to the reaction solution, followed by washing with toluene. The aqueous layer was ice-cooled and concentrated hydrochloric acid was added until the pH becomes 1 to 2. The aqueous solution was concentrated under reduced pressure and the obtained crystal was dissolved in a solution of chloroform and ethanol in a mixing ratio of 1:1. Insolubles were removed by filtration and the filtrate was concentrated under reduced pressure to obtain 1.26 g of 3-(2,2,2-trifluoroethoxy)-isonicotinic acid.

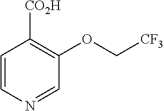

¹H-NMR (DMSO-d₆) δ: 8.69 (s, 1H), 8.47 (d, J=4.9 Hz, 1H), 7.71 (d, J=4.9 Hz, 1H), 5.00 (q, J=8.7 Hz, 2H)

### Reference Production Example 81

To a mixture of 0.60 g of 3-(2,2,2-trifluoroethoxy)-isonicotinic acid, 5 mL of chloroform and one drop of DMF, 0.35 mL of oxalylchloride was added dropwise under ice cooling, followed by heating to room temperature and further stirring for 1 hour. After ice cooling again, 0.13 mL of oxalyl chloride was added dropwise, followed by heating to room temperature and further stirring for 10 minutes. The reaction solution was concentrated under reduced pressure to obtain 3-(2,2,2-trifluoroethoxy)-isonicotinic acid chloride.

The obtained acid chloride was dissolved in 5 mL of THF and the obtained solution was added to a mixture of 0.48 g 3-amino-5-trifluoromethylpyridin-2-ol and 3 mL of THF under ice cooling, followed by heating to room temperature and further stirring for 22.5 hours. Furthermore, 0.46 g of sodium hydrogen carbonate was added, followed by stirring for 4.5 hours. Under ice cooling, water was added and the precipitated crystal was washed with water, collected by filtration and then dried under reduced pressure to obtain 0.81 g of N-(2-hydroxy-5-trifluoromethylpyridin-3-yl)-3-(2,2,2-trifluoroethoxy)-isonicotinamide.

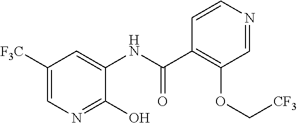

¹H-NMR (DMSO-d₆) δ: 12.70 (br s, 1H), 10.17 (br s, 1H), 8.75 (s, 1H), 8.55 (d, J=2.4 Hz, 1H), 8.49 (d, J=4.9 Hz, 1H), 7.82-7.79 (m, 2H), 5.16 (q, J=8.7 Hz, 2H)

Formulation Examples will be shown below. In the following examples, the part represents part by weight.

### Formulation Example 1

One (1) part of any one of the above-mentioned active compounds 1 to 163 and 9 parts of any one of the above-mentioned pyrethroid compounds (1) to (12) are dissolved in a mixture of 35 parts of xylene and 35 parts of N,N-dimethylformamide. To the mixture, 14 parts of polyoxyethylene styrylphenyl ether and 6 parts of calcium dodecylbenzenesulfonate are added. The mixture is well stirred and mixed to give 10% emulsion for each of the active compounds.

### Formulation Example 2

Five (5) parts of any one of the above-mentioned active compounds 1 to 163 and 15 parts of any one of the above-mentioned pyrethroid compounds (1) to (12) are added to a mixture of 4 parts of sodium lauryl sulfate, 2 parts of calcium lignin sulfonate, 20 parts of fine powder of water-containing synthetic silicon oxide and 54 parts of diatomite. The mixture is well stirred and mixed to give 20% wettable powder for each of the active compounds.

### Formulation Example 3

To 1 part of any one of the above-mentioned active compounds 1 to 163 and 1 part of any one of the above-mentioned pyrethroid compounds (1) to (12), 1 part of fine powder of water-containing synthetic silicon oxide, 2 parts of calcium lignin sulfonate, 30 parts of bentonite and 65 parts of kaolin clay are added, followed by sufficient stirring and mixing. Then, a suitable amount of water is added to the mixture. The mixture is further stirred, granulated by a granulator, and air-dried to give 2% granules for each of the active compounds.

### Formulation Example 4

Dissolved are 0.9 parts of any one of the above-mentioned active compounds 1 to 163 and 0.1 part of any one of the above-mentioned pyrethroid compounds (1) to (12) in a suitable amount of acetone. To the solution, 5 parts of fine powder of synthesized hydrated silicon oxide, 0.3 parts of PAP (isopropyl phosphate) and 93.7 parts of Fubasami clay are added. The mixture solution is sufficiently stirred and mixed, and acetone is removed by evaporation to give 1% dusting powder formulation for each of the active compounds.

### Formulation Example 5

Thirty-five (35) parts of mixture of polyoxyethylene alkyl ether sulfate ammonium salt and white carbon (weight ratio of 1:1), 8 parts of any one of the above-mentioned active compounds 1 to 163 and 2 parts of any one of the above-mentioned pyrethroid compounds (1) to (12), and 55 parts of water are mixed. The mixture is pulverized by wet method to give 10% flowables for each of the active compounds.

### Formulation Example 6

Dissolved are 0.04 parts of any one of the above-mentioned active compounds 1 to 163 and 0.06 parts of any one of the above-mentioned pyrethroid compounds (1) to (12) is dissolved in 5 parts of xylene and 5 parts of trichloroethane, which is mixed with 89.9 parts of deodorized kerosene to give 0.1% oil solution for each of the active compounds.

### Formulation Example 7

Seven (7) mg of any one of the above-mentioned active compounds 1 to 163 and 3 mg of any one of the above-mentioned pyrethroid compounds (1) to (12) are dissolved in 0.5 ml of acetone. The solution is treated into 5 g of solid feed powder for animals (Breeding Solid Feed Powder CE-2, available from Japan Clea Co., Ltd.) and mixed homogeneously. Then, acetone is removed by evaporation to give a poisonous bait for each of the active compounds.

### Formulation Example 8

Put are 0.03 parts of any one of the above-mentioned active compounds 1 to 163, 0.07 parts of any one of the above-mentioned pyrethroid compounds (1) to (12) and 49.9 parts of Neo-chiozol (Chuo Kasei Co., Ltd.) into an aerosol can, to which an aerosol valve is attached. Then, 25 parts of dimethyl ether and 25 parts of LPG are filled in the aerosol can, followed by shaking and attachment of an actuator. Thus, an oil-based aerosol is obtained.

### Formulation Example 9

Five (5) parts of xylene, 0.5 parts of any one of the above-mentioned active compounds 1 to 163, 0.1 parts of any one of the above-mentioned pyrethroid compounds (1) to (12), 0.01 parts of BHT (2,6-di-tert-butyl-4-methylphenol), 3.39 parts of deodorized kerosene and 1 part of emulsifier {Atmos 300 (registered trade name for ATMOS CHEMICAL LTD)} are mixed and dissolved. The mixture solution and 50 parts of distilled water are filled in an aerosol container, and a valve is fixed to the container. 40 parts of propellant (LPG) are charged under pressure through the valve to give an aqueous aerosol.

### Formulation Example 10

Two (2) parts of any one of the above-mentioned active compounds 1 to 163, 8 parts of any one of the above-mentioned pyrethroid compounds (1) to (12), and 10 parts of harmful organism controlling agent (containing isomers and salt thereof) that can be mixed and formulated with the active compound and the pyrethroid compound, such as insecticide, acaricide, nematicide or antimicrobial agent, plant hormone, plant growth regulator and herbicide, synergist, or agents for reducing drug-induced sufferings are added to a mixture of 4 parts of sodium lauryl sulfate, 2 parts of calcium lignin sulfonate, 20 parts of fine powder of synthesized hydrated silicon oxide and 54 parts of diatomite. The mixture is well stirred and mixed to give mixed wettable powder.

Arthropod pest control effects of the compositions of the present invention will be shown below by Test Examples.

### Test Example 1

### Pesticidal Effect of Artificial Diet Irrigation Treatment on Common Cutworm (Spodoptela litura)

Each of the compounds 18, 70, 77, 109, 128, 139, 143 and 146 as the present active compound was formulated according to the method of Formulation Example 1 and diluted to a prescribed concentration. Each of an esfenvalerate emulsifiable concentrate manufactured by Sumitomo Chemical Co., Ltd. under the product name of Sumi-Alpha (registered trademark) emulsifiable concentrate, and a fenpropathrin emulsifiable concentrate manufactured by Sumitomo Chemical Co., Ltd. under the product name of Rody (registered trademark) emulsifiable concentrate was diluted to a prescribed concentration. The dilution of each present active compound and the dilution of each pyrethroid compound were mixed to prepare a test chemical solution of prescribed concentration. On a polyethylene cup having a diameter of 5.5 cm, a filter paper having the same size as the cup bottom was put and an artificial diet Insecta LF (Nosan Corporation) was placed thereon after being sliced into pieces having a thickness of 6 mm and cut into half, and then the diet was irrigated with 2 mL of the test chemical solution. The test chemical solution was air-dried and 5 fourth instar larvae of Common cutworm were released, and then the polyethylene cup was capped.

After 6 days, the number of surviving larvae was checked and a control value (%) was calculated by the following equation. The results are shown in Tables 43 and 44.

Control value (%)={1−(Cb×Tai)/(Cai×Tb))×100

wherein symbols represents the following meanings.
Cb: Number of bugs in non-treated group before treatment
Cai: Number of bugs in a non-treated group on observation
Tb: Number of bugs in treated group before treatment
Tai: Number of bugs in treated group on observation

TABLE 43
Pesticidal effect of artificial diet irrigation
treatment on Common cutworm

| | Treatment | Control |
|---|---|---|
| Test compounds | concentration (ppm) | value (%) |
| Esfenvalerate + Compound 18 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 70 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 77 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 109 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 128 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 139 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 143 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 146 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |

As shown in Table 43, the compositions of each of the compounds 18, 70, 77, 109, 128, 139, 143 and 146 and esfenvalerate showed a high pesticidal efficacy against Common cutworm (Spodoptela litura).

TABLE 44
Pesticidal effect of artificial diet irrigation
treatment on Common cutworm

| | Treatment | Control |
|---|---|---|
| Test compounds | concentration (ppm) | value (%) |
| Fenpropathrin + Compound 18 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 70 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 77 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 109 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 128 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 139 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 143 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 146 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |

As shown in Table 44, the compositions of each of the compounds 18, 70, 77, 109, 128, 139, 143 and 146 and fenpropathrin showed a high pesticidal efficacy against Common cutworm (Spodoptela litura).

### Test Example 2

### Pesticidal Effect of Artificial Diet Irrigation Treatment on Common Cutworm (Spodoptela litura)

Each of the compounds 39, 116, 117 and 163 as the present active compound was formulated according to the method of Formulation Example 1 and diluted to a prescribed concentration. Each of an esfenvalerate emulsifiable concentrate manufactured by Sumitomo Chemical Co., Ltd. under the product name of Sumi-Alpha (registered trademark) emulsifiable concentrate, and a fenpropathrin emulsifiable concentrate manufactured by Sumitomo Chemical Co., Ltd. under the product name of Rody (registered trademark) emulsifiable concentrate was diluted to a prescribed concentration. The dilution of each present active compound and the dilution of each pyrethroid compound were mixed to prepare a test chemical solution of prescribed concentration. On a polyethylene cup having a diameter of 5.5 cm, a filter paper having the same size as the cup bottom was put and an artificial diet Insecta LF (Nosan Corporation) was placed thereon after being sliced into pieces having a thickness of 6 mm and cut into half, and then the diet was irrigated with 2 mL of the test chemical solution. The test chemical solution was air-dried and 5 fourth instar larvae of Common cutworm were released, and then the polyethylene cup was capped. After 6 days, the number of surviving larvae was checked and a control value (%) was calculated by the same equation as in Test Example 1. The results are shown in Tables 45 and 46.

TABLE 45
Pesticidal effect of artificial diet irrigation
treatment on Common cutworm

| | Treatment | Control |
|---|---|---|
| Test compounds | concentration (ppm) | value (%) |
| Esfenvalerate + Compound 39 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 116 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 117 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Esfenvalerate + Compound 163 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| | 100 + 100 | 100 |

As shown in Table 45, the compositions of each of the compounds 39, 116, 117 and 163 and esfenvalerate showed a high pesticidal efficacy against Common cutworm (Spodoptela litura).

TABLE 46
Pesticidal effect of artificial diet irrigation
treatment on Common cutworm

| | Treatment | Control |
|---|---|---|
| Test compounds | concentration (ppm) | value (%) |
| Fenpropathrin + Compound 39 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 116 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 117 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| Fenpropathrin + Compound 163 | 25 + 0.25 | 100 |
| | 25 + 2.5 | 100 |
| | 25 + 25 | 100 |
| | 1 + 100 | 100 |
| | 10 + 100 | 100 |
| | 100 + 100 | 100 |
| | 100 + 100 | 100 |

As shown in Table 45, the compositions of each of the compounds 39, 116, 117 and 163 and fenpropathrin showed a high pesticidal efficacy against Common cutworm (Spodoptela litura).

### INDUSTRIAL APPLICABILITY

According to the present invention, it becomes possible to provide a composition for controlling arthropod pests having high activity and a method for effectively controlling arthropod pests.

1. An arthropod pests control composition comprising, as active ingredients, the following (A) and (B):
(A) a condensed heterocyclic compound represented by formula (1): 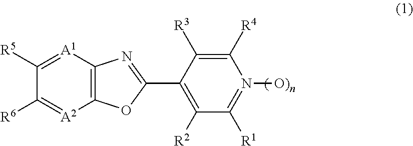
wherein
each of A¹ and A² independently represents a nitrogen atom or ═C(R⁷)—;
each of R¹ and R⁴ independently represents a halogen atom or a hydrogen atom;
each of R² and R³ independently represents a C1-C6 acyclic hydrocarbon group optionally substituted with one or more members selected from Group X; a C3-C6 alicyclic hydrocarbon group optionally substituted with one or more members selected from Group X; a phenyl group optionally substituted with one or more members selected from Group Y; a benzyl group optionally substituted with one or more members selected from Group Y; a 5- or 6-membered heterocyclic group optionally substituted with one or more members selected from Group Y; —OR⁸; —NR⁸R⁹; —NR⁸C(O)R⁹; —NR¹⁰C(O)NR⁹R¹⁴; —NR¹⁰CO₂R¹⁵; —S(O)ₘR⁸; —CO₂R¹⁰; —CONR⁸R⁹; —C(O)R¹⁰; —C(NOR⁸)R¹⁰; —CONR¹⁰NR¹¹R¹²; a cyano group; a nitro group; a halogen atom; or a hydrogen atom;
each of R⁵ and R⁶ independently represents a C1-C6 acyclic hydrocarbon group optionally substituted with one or more members selected from Group X; a C3-C6 alicyclic hydrocarbon group optionally substituted with one or more members selected from Group X; —OR¹³; —S(O)ₘR¹³; a halogen atom; or a hydrogen atom; except that both R⁵ and R⁶ represent hydrogen atoms; or R⁵ and R⁶, together with 6-membered ring constituent atoms to which they bind, may form a 5- or 6-membered ring optionally substituted with one or more members selected from Group Z;
R⁷ represents a C1-C3 alkyl group optionally substituted with one or more halogen atoms; a C1-C3 alkoxy group optionally substituted with one or more halogen atoms; a cyano group; a halogen atom; or a hydrogen atom;
each of R⁸ and R⁹ independently represents a C1-C6 acyclic hydrocarbon group optionally substituted with one or more members selected from Group X; a C4-C7 cycloalkylmethyl group optionally substituted with one or more members selected from Group X; a C3-C6 alicyclic hydrocarbon group optionally substituted with one or more members selected from Group X; a phenyl group optionally substituted with one or more members selected from Group Y; a benzyl group optionally substituted with one or more members selected from Group Y; a 5- or 6-membered heterocyclic group optionally substituted with one or more members selected from Group Y; or a hydrogen atom; provided that R⁸ does not represent a hydrogen atom when m in —S(O)ₘR⁸ is 1 or 2;
each of R¹⁹ and R′⁴ independently represents a C1-C4 alkyl group optionally substituted with one or more halogen atoms; or a hydrogen atom;
each of R¹¹ and R¹² independently represents a C1-C4 alkyl group optionally substituted with one or more halogen atoms; a C2-C4 alkoxycarbonyl group; or a hydrogen atom;
R¹³ represents a C1-C6 acyclic hydrocarbon group optionally substituted with one or more members selected from Group X; or a C3-C6 alicyclic hydrocarbon group optionally substituted with one or more members selected from Group X;
R¹⁵ represents a C1-C4 alkyl group optionally substituted with one or more halogen atoms;
m represents 0, 1, or 2;
n represents 0 or 1;
Group X: the group consisting of a C1-C4 alkoxy group optionally substituted with one or more halogen atoms; a cyano group; and a halogen atom;
Group Y: the group consisting of a C1-C4 alkyl group optionally substituted with one or more halogen atoms; a C1-C4 alkoxy group optionally substituted with one or more halogen atoms; a cyano group; a nitro group; and a halogen atom; and
Group Z: the group consisting of a C1-C3 alkyl group optionally substituted with one or more halogen atoms; and a halogen atom; and
(B) a pyrethroid compound.

2. The arthropod pests control composition according to claim 1, wherein the pyrethroid compound is selected from the group consisting of esfenvalerate, fenpropathrin, fenvalerate, alpha-cypermethrin, bifenthrin, cypermethrin, deltamethrin, ethofenprox, lambda-cyhalothrin, permethrin, tefluthrin and zeta-cypermethrin.

3. The arthropod pests control composition according to claim 1, wherein a weight ratio of the condensed heterocyclic compound represented by formula (1) to the pyrethroid compound is in the range of 0.1:99.9 to 99.9:0.1.

4. A method for controlling arthropod pests which comprises applying effective amounts of the condensed heterocyclic compound represented by formula (1) of claim 1 and a pyrethroid compound to the arthropod pests or a locus where the arthropod pests inhabit.

5. A method for controlling arthropod pests which comprises applying effective amounts of the condensed heterocyclic compound represented by formula (1) of claim 1 and a pyrethroid compound to a plant or soil for growing plant.

6. Combined use of the condensed heterocyclic compound represented by formula (1) of claim 1 and a pyrethroid compound for controlling arthropod pests.
